(19) United States
(12) Patent Application Publication
(10) Pub. No.: US 2011/0173235 A1
(43) Pub. Date: Jul. 14, 2011

(54) SESSION AUTOMATED RECORDING TOGETHER WITH RULES BASED INDEXING, ANALYSIS AND EXPRESSION OF CONTENT

(76) Inventors: James A. Aman, Telford, PA (US); John C. Gallatig, Hatfield, PA (US); Cherstopher P. Zubriski, Harleysville, PA (US)

(21) Appl. No.: 13/063,585

(22) PCT Filed: Sep. 14, 2009
(86) PCT No.: PCT/US09/56805

§ 371 Date: Mar. 11, 2011

Related U.S. Application Data
(60) Provisional application No. 61/192,034, filed on Sep. 15, 2008.

(51) Int. Cl. G06F 17/30

(52) U.S. Cl. 707/792; 707/E17.055

(57) ABSTRACT

A system for contextualizing disorganized content (2a) captured from any live session (1) using external devices 30-xd to first detect & record 30-1 session activities (1d) being conducted by session attendees (1c). Activities (1d) become normalized tracked object data 2-otd for differentiation 30-2 into normalized session marks 3-pm denoting thresholded activity (1d) changes. Normalized marks 3-pm are integrated 30-3 into normalized events 4-pe using a “mark creates, start or stops event” model. Events 4-pe may be synthesized 30-4 via waveform convolution forming new combined events 40se, or used as containers to summarize the occurrences of marks 3-pm or other events 4-pe, the results of which create new summary marks 3-sm. Calculation marks 3-tm may also be synthesized 30-4 for sampling various session data at various session times. During content expression 30-5 events 4-pe and 4-se can be automatically named and foldered creating index (2i) and organized content (2b).

### RELATED APPLICATIONS

The present invention is related to U.S. 61/192,034, a provisional application filed on Sep. 15, 2008 entitled SESSION AUTOMATED RECORDING TOGETHER WITH RULES BASED INDEXING, ANALYSIS AND EXPRESSION OF CONTENT, of which the present application claims priority.

### FIELD OF INVENTION

The present invention is a comprehensive protocol and system for automatically contextualizing and organizing content via the process steps of recording, differentiating, integrating, synthesizing, expressing, compressing, storing, aggregating and interactively reviewing any set of data/content crossed with either itself or any other set of data/content, all controlled by the use of external, context based rules that are exchangeable with ownership. The system is designed to handle any type of content ranging from typically expected video and audio to less usual types of data now made more prevalently available due to the increasing number of data sensing methods, including but not limited to machine vision systems (typically UV through IR,) MEMS (electro-mechanical,) RF, UWB and similar longer wavelength detection systems, mechanical, chemical or photo transducers, as well as all forms of digital content especially including that information representing virtual world activities.

### BACKGROUND

The main purpose of the present invention is to provide universal protocols and a corresponding open system for accepting varied data streams into a generic, rules based and therefore externally controlled, automatic content contextualization and organization system. Heretofore, the creation of contextualized, organized content has either been relegated to human based systems and or very narrow automated systems. For instance, with respect to traditional video content, the professional sports industry provides two major examples as are discussed below.

For the broad market, the typical content of interest is the game broadcast that includes a blend of video from perhaps eight distinct views, overlaid graphics providing identification and analysis, as well as audio commentary. The creation of a typical broadcast is very people intensive and therefore expensive and in several ways lacking the benefits of tight information integration. The present inventors have addressed systems and methods for automating the generation of this type of content in a prior PCT application number US-05/13132 entitled AUTOMATIC EVENT VIDEOING, TRACKING AND CONTENT GENERATION SYSTEM. These prior teachings focused on leveraging the continuous tracking of game participants and objects built upon the prior U.S. Pat. No. 6,567,116 B1 entitled MULTIPLE OBJECT TRACKING SYSTEM from the same inventors, into a control system for automatically videoing the game from multiple angles and for further choosing and assembling these views into a desired broadcast stream.

The prior specifications also showed how the information from the video based overhead tracking system could be additionally purposed to create a new type of overhead view with significant zooming capability corresponding to its unique compression strategy. With regard to side video compression, the invention showed that using combinations of the overhead tracking information and side-view cameras ideally equipped with stereoscopic or alternative 3d capabilities, these side-view streams could be readily segmented into the foreground (equaling the game participants and objects,) the fixed background (equaling the arena and playing surface,) and the moving background (equaling the fans.) Using tight integration of ongoing participant and game object location with frame-by-frame video capture, the invention showed that significant levels of compression could be obtained well beyond the current state of the art, but still with current protocols and standards. Numerous other benefits were both taught and are obvious to those skilled in the necessary arts taught in these prior specifications.

In addition to this first example of contextualized, organized content there other examples addressed by the present inventors in both prior U.S. application Ser. No. 11/899,488 entitled SYSTEM FOR RELATING SCOREBOARD INFORMATION WITH EVENT VIDEO and PCT application US 2007/019725 entitled SYSTEM AND METHODS FOR TRANSLATING SPORTS TRACKING DATA INTO STATISTICS AND PERFORMANCE MEASUREMENTS. In particular, these applications teach how various data streams such as ongoing changes to the official game clock in relation to the location of the game participants and objects can be combined in novel ways to generate meaningful classified time based content which is the underpinning for the broader contextualization of organized content. Hence, by tracking the participants and game objects it is possible to automatically and objectively determine a large number of statistics traditionally determined by subjective human observation, as well as a new class of information essentially beyond manual systems. These prior and new sets of data, all automatically generated as taught in the prior applications, being time based in nature and therefore frame relatable to the corresponding video stream(s), provide an important means for uniquely describing (contextualizing) individual video segments, which leads to indexing (organizing) of the same.

With respect to this second example of content, the marketplace has several vendors such as XOS Tech and Steva who provide software systems that allow operators to view an ongoing video stream of an event while simultaneously marking various time points indicative of types of content, e.g. a shot, a hit or a face-off. These systems are therefore designed to relate segments of video to key statistics, essentially contextualizing. They typically also allow the user to then sort the video segments by like statistic, essentially organizing thus providing an index for jumping into the video stream or clipping selected segments. These systems have several obvious drawbacks including the limits of human observation and its attendant accuracy, the limits of the data (i.e. a single view) that is reasonably consumable at one time, and the limit of human dexterity and speed that necessarily lessen the number of observations that can be entered into the system, even if each observation were perfect and contained the highest accuracy.

What is needed is a system that can create contextualized and organized content automatically, following external rules constructed by a user community. Such preferred systems would ideally be open to all types of data for recording, i.e. not just video and audio as found in the prior two examples. The preferred systems would also accept all current or future types of automatically sensed information following a universal protocol thus abstracting the data detection source(s) from the subsequent integration process. This protocol would thereby serve to normalize various unrelated data sources into a structured asynchronous real-time data transfer method such that these often multiple disparate source data streams ultimately combine into a single normalized stream ready for integration—again, following externalized rules. In the preferred system as taught herein, this is the first stage of detecting, recording and differentiating disorganized content.

However, differentiated content is still not quantified, qualified or classified. The preferred system then further accepts one or more streams of recorded data while in parallel it applies additional external rules to integrate the differentiated normalize stream of combined source data. Such integration would result at least in the automatic recognition of the leading and trailing edges of individual video segments, or chunks of relevant content. The preferred integration also tags these edges and therefore ultimately uniquely classifies each individual segment, the core of contextualization. Essentially, following rules, the preferred system relates the incoming differentiated information (data) recognizing that something of interest is happening between two time points in the recoded data stream and in the process uniquely names, or classifies, each now segmented time frame.

The original source data can be viewed as the bottom of the content pyramid where differentiated data represents the next tier, significantly smaller in size and containing the interested features. Above this tier, the set of all named time segments, or integrated data, is still smaller and yet increasing in consumable value. In the preferred system, the integration process should itself feedback its own differentiated data stream into the integrator. This mechanism allows for external rules to among other things count like segment occurrences and even more importantly construct nested “combined” time segments built upon various inclusive and exclusive combinations of those already determined, without limit.

After differentiating one or more source data streams in order to find potential leading and trailing time segment edges, and then connecting these edges under rules based conditions into distinctly classified and typed time segments, the preferred system then uses these individual time segments as buckets for the counting or measuring of any and all other streams of differentiated source data—a step herein referred to as synthesis. For instance, during a sporting contest, the official game clock sequentially starts continues and the stops. Each start and then stop moment is ideally differentiated into a distinct datum. Likewise, at least for the sport of ice hockey, penalty clocks keep time relating to participants held out of game play. And finally, using any of several semi-automated or automated detectors, the fact of a shot taken at the opponent's net can also be differentiated in time. The ideal integrator first forms time segments representing individual stretches of official game play, i.e. while the game clock is running using the differentiated datum. The integrator would likewise form separate time segments for all penalties. The time a player spends in the penalty box in real-time may stretch across moments when the game clock is stopped, or essentially outside of the time bounds of any particular official game play time segment. The preferred integrator allows these two primary types of time segments, i.e. official game play and player penalty, to then be combined exclusively, similar to a logical AND, to essentially create new typically shorter time segments, e.g. in this case representing official game play while (AND) player on penalty. In ice hockey, this exclusive combination is referred to as a power play time segment. After completing this integration, the preferred system then applies other rules to determine, or count, the number of shots taken within the various potential time segments. For example, the total shots taken during time segments representing official game play vs. power play.

Now that the original content is broken down into meaningful segments, where each segment is classified, quantified and qualified, it is preferred and useful to potentially express these segments in forms more consumable to an external receiver, whether this receiver is a human or automated system. For a person, the expression could be a video clip where the time frame is used to pull out video for transmission. For an automated system, the expression could be a statistic for uploading to a web-site, or merging into a database. The preferred invention is capable of several forms of expression that include description, such as dynamic naming or expanded prose and move into translation of this naming into audio commentary, with appropriate inflection. Like differentiation, integration and synthesis, the step of expression is preferable also controlled via external rules.

At this point, the preferred system is capable of compressing the originally recorded and controllably expressed content by various techniques, especially including those already adopted as standards such as MPEG for video/audio or MP3 for audio. Expression also includes the ideas of mixing data streams, such as video and descriptive, where in this case descriptive is either or both graphic overlay of synthesized stats or expressed names or the audio translation of generated prose. The preferred system then also optionally determines which if any recorded or expressed data should be aggregated into any of a number of repositories, possible managed through clearing houses responsible for serving external requests for the automatic forwarding of data matching specific filter criteria. And finally, the preferred system provides an interactive means for users to consume this highly semantic, segmented data. This interaction ideally includes searching, reviewing and even rating or otherwise subjectively differentiating this hereto for objectively differentiated data. These new subjective differentiations are then preferably fed back into the original data sets post session allowing for new rounds of integration, synthesis, expression, etc.

### SUMMARY OF THE INVENTION

The present invention is both comprehensive in scope and detailed in description. Because of the unusual breadth of specification and before describing any one figure in detail, the entire application is first presented in summary.

In the most abstract sense, the present teaching describes a “black box” into which a live activity is presented and out of which a set of usable organized content is output. Theoretically, the “live activity” has no limit and for instance could be regarding any real, animate or inanimate object such as people, animals, machines, the environment, or some combination etc. The activity could also be virtual, such as a multi-player video game or abstract, such as the concept of a “center-of-play” in a sporting game, for which there is not actual real object. Furthermore, the activities can be conducted by a single or multiple individuals of the types just described. However, the live aspect is fundamental to the purposes herein addressed; therefore, this is a black box for translating live activity into organized content, or organized recordings. While this is not a black box for translating one or more pre-recorded sets of content into new content, as the reader will see, the organizational aspects of the present invention do in fact provide for the accumulation and mixing of on-going content over time.

The present invention can also be thought of as a black box because of the usual implication that a black box itself is automated, or automatic. The goals of the present invention are to be labor-free from the point of view of the black box owner, and then as much labor free as possible from the activity participants and observers perspective. And finally, the present invention would be even better described as a “programmable black box,” where programmability implies that the rules followed by the black box are external to the box and if they are changed, then so also the behavior of the box is changed. Before looking inside the box, it is also instructive to compare the present invention to one of its nearest counterparts; namely a broadcasting crew at a professional event such as a sporting contest (which is the “live activity.”) This crew is responsible for both creating a recording (disorganized content) and then also organizing that recording, at least to some lesser extent. In fact, this is the one of the main issues addressed by the present invention; specifically that a manual based broadcast crew does minimal organizing of the data in comparison to the ultimate marketplace needs. This lack of organization detail is often optionally addressed by layering an additional index onto the original recordings via a post-live, manual activity. Sticking with the sports example, one such post-live organizational tool would be “video breakdown” software operated by a person watching the recorded event and then inserting index entries at key time-line locations so that the end result is a more detailed index for randomly accessing the now more organized content.

Describing a live activity as a single “session,” than the aforementioned video breakdown is both intra-session and micro in its nature, and allows the end viewer to switch between indexed moments within a single session. Conversely, a cable distributor responsible for aggregating multiple sporting events along with other broadcast productions to be presented for choosing by the end viewer, naturally creates an index into the list of all available content. This inter-session index takes the macro view and allows the viewer to switch between entire sessions.

While the present invention is specifically designed to address both intra and inter-session content organization, the operating assumption is that all content must therefore be recorded through some instance of the invention. Hence, the present invention is not attempting to integrate content that it organizes automatically with content created manually and then post organized, (as in the example of a sporting contest captured by the broadcasting crew and post indexed via “video breakdown” software.)

With this understanding, the figures are broken into the following general categories (which are not necessarily the order in which they appear in the specification):
“system”: teaching various physical and logical ways of understanding the black box at higher levels;
“external devices”: teaching various inputs to the black box that are used to collect and input human, human-machine and machine-only observations of the session and its live activity;
“tracked objects”: teaching both the universal data processing for first assembling movement data regarding the real, virtual and abstract objects that perform the session activities and also universal data storage for then representing the assembled movements;
“differentiation”: teaching the translation of tracked object movement data into activity observations;
“data objects”: teaching the software classes for creating the apparatus of the black box, for representing the external rules to govern the box, and for representing the content processed by the box;
“internal structures”: teaching the relationships between the black box apparatus, external rules and content for best understanding the methods of content contextualization performed by the box;
“integrator”: teaching how the black box assembles external observations into the initial content index;
“synthesizer”: teaching how the black box further convolves, summarizes and calculates to create an ever more detailed index;
“session areas”: teaching the abstraction of real physical session areas into logical content data further relatable to the tracking data and activity observations;
“expresser”: teaching ways in which the block box automatically names and folders the content index entries;
“recording compressor”: teaching the ways the black box controllable manages, mixes and blends the session recordings in response to the forming index;
“session media player”: teaching a user interactive content viewing tool that is highly interwoven with the content index and recordings, and
“session processor”: teaching the internal apparatus of the black box in further detail than the “system figures.”

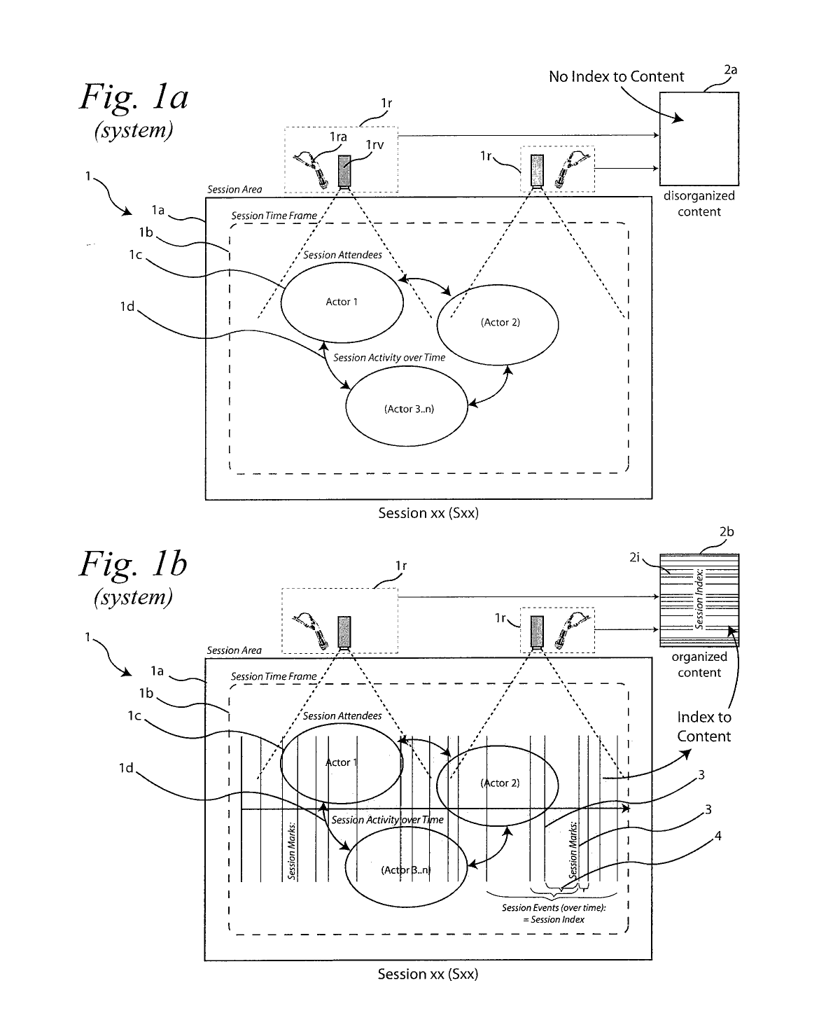

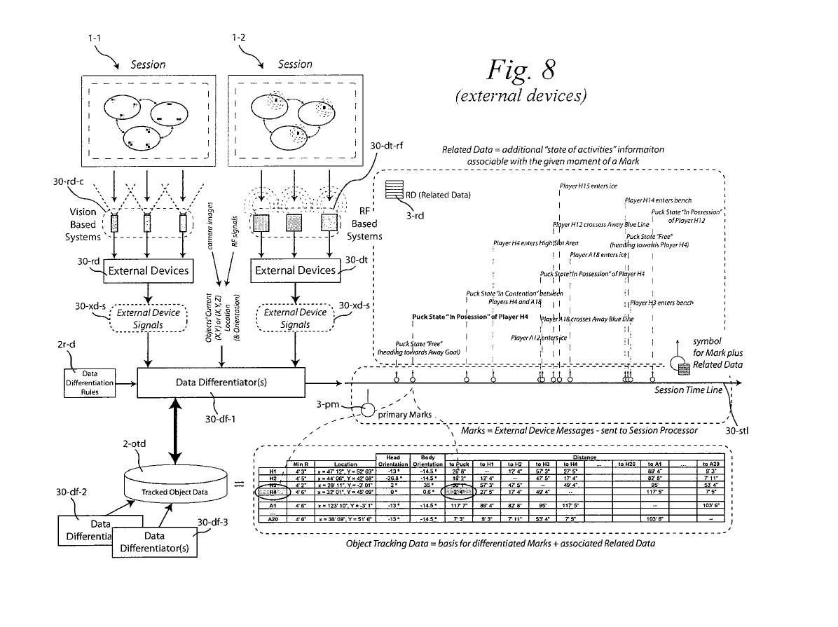

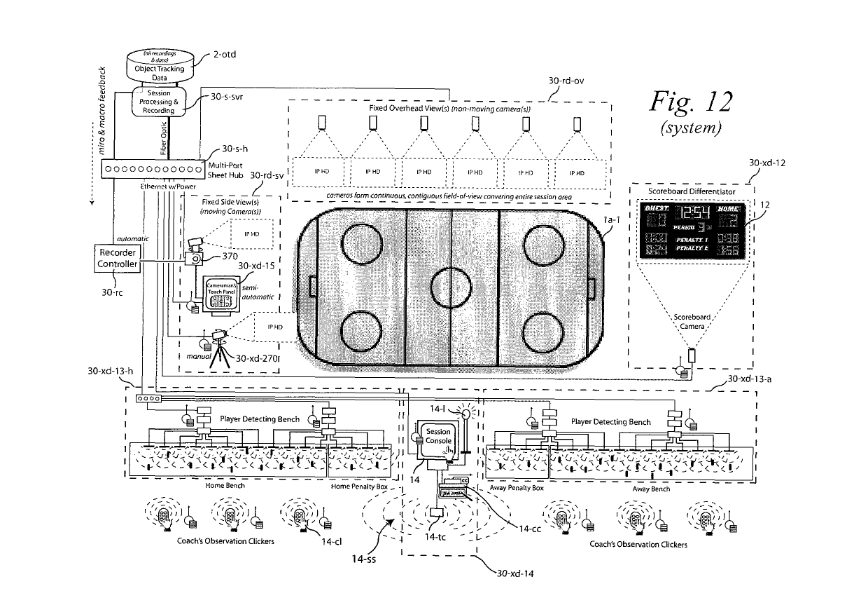

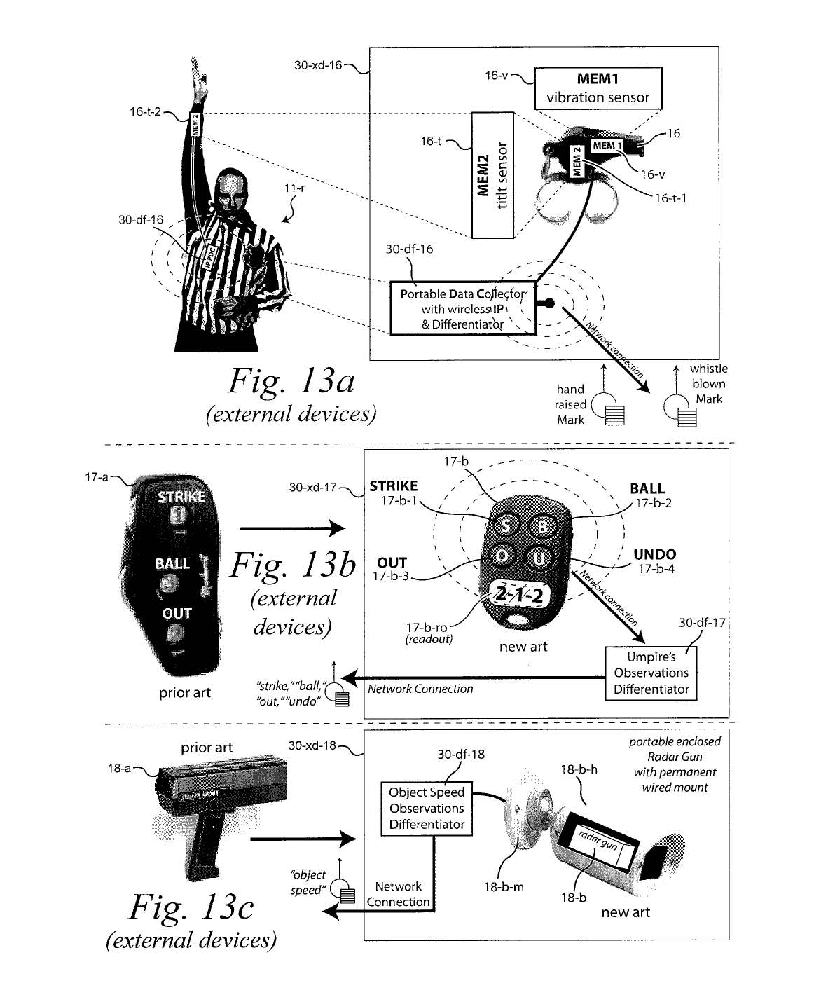

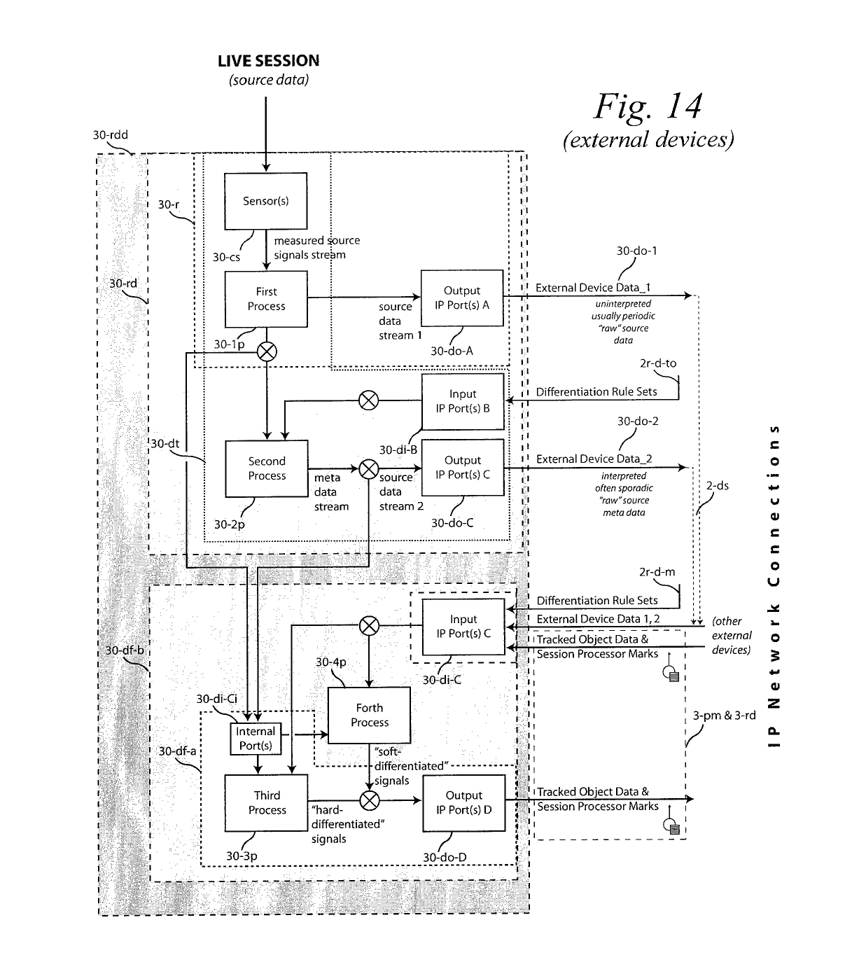

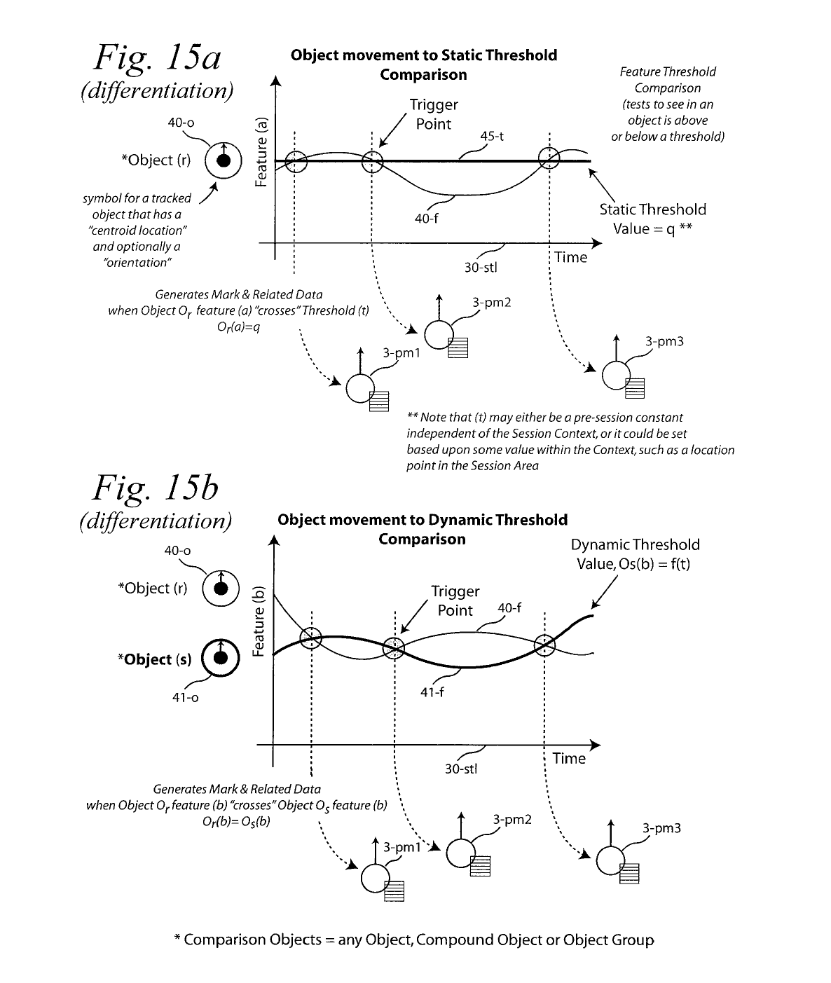

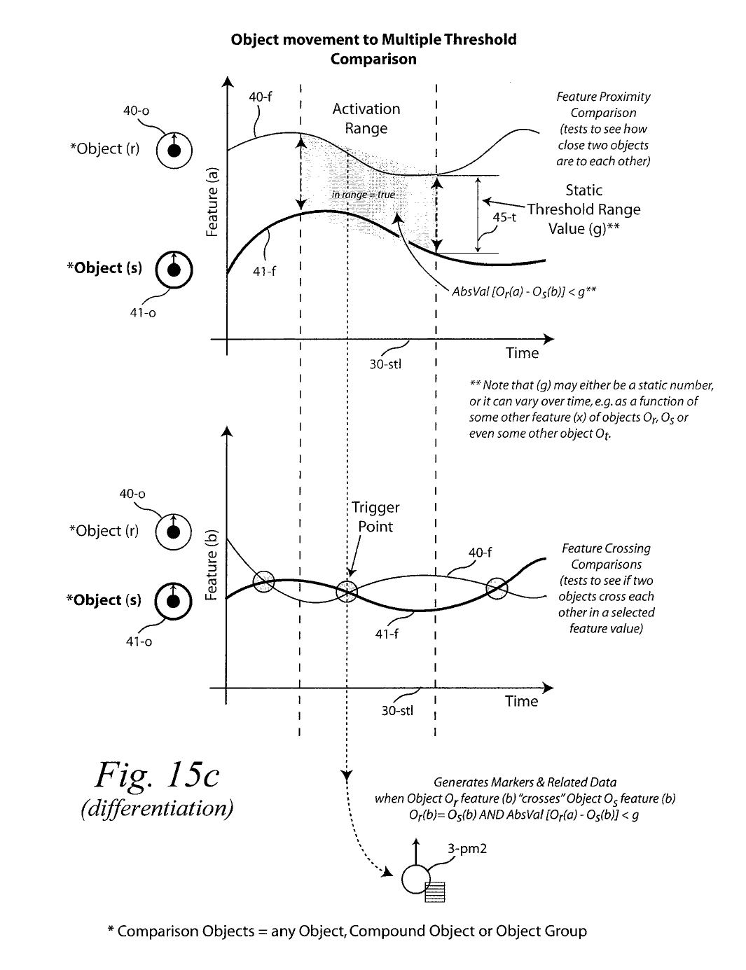

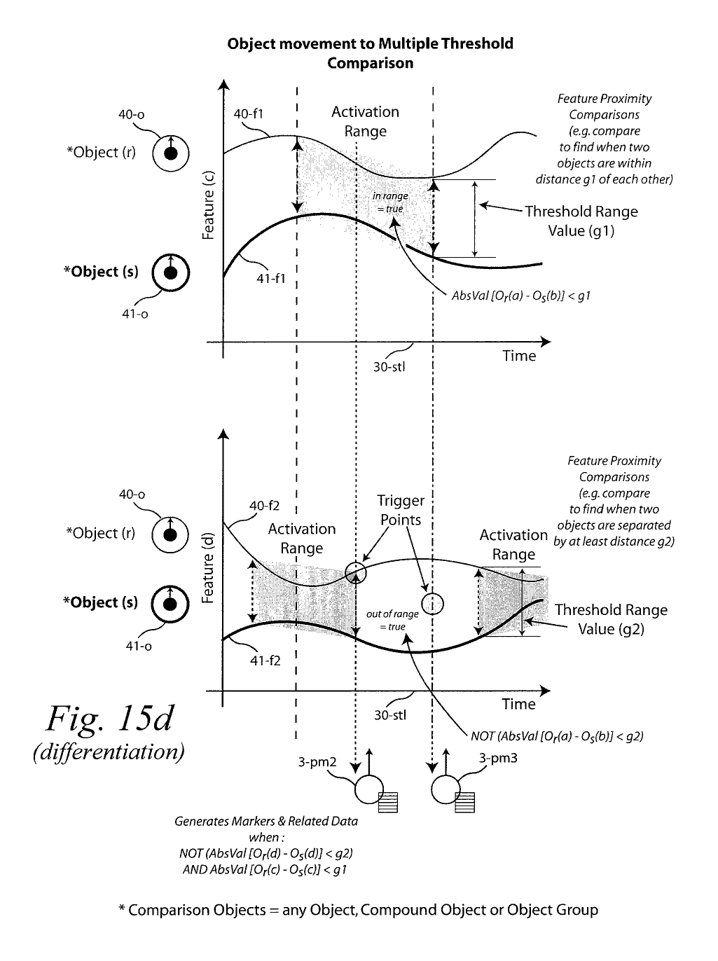

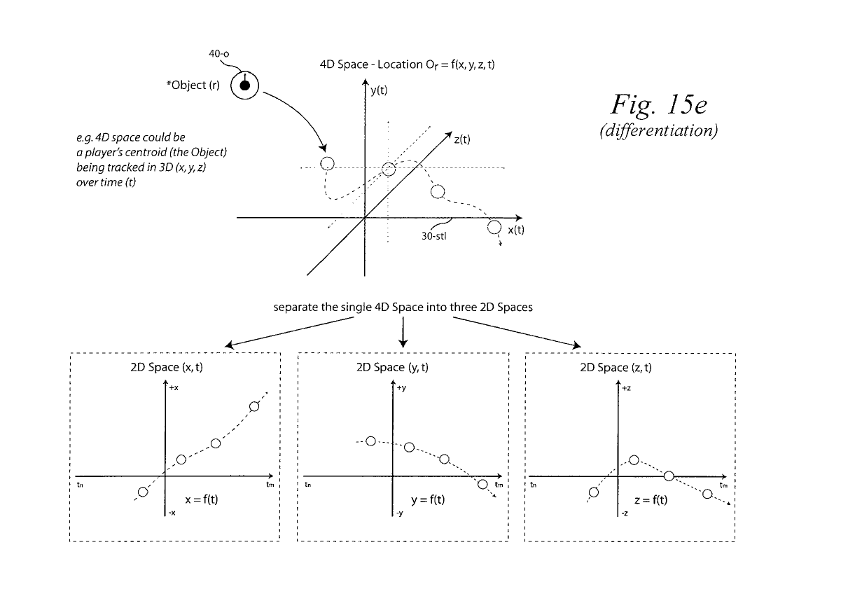

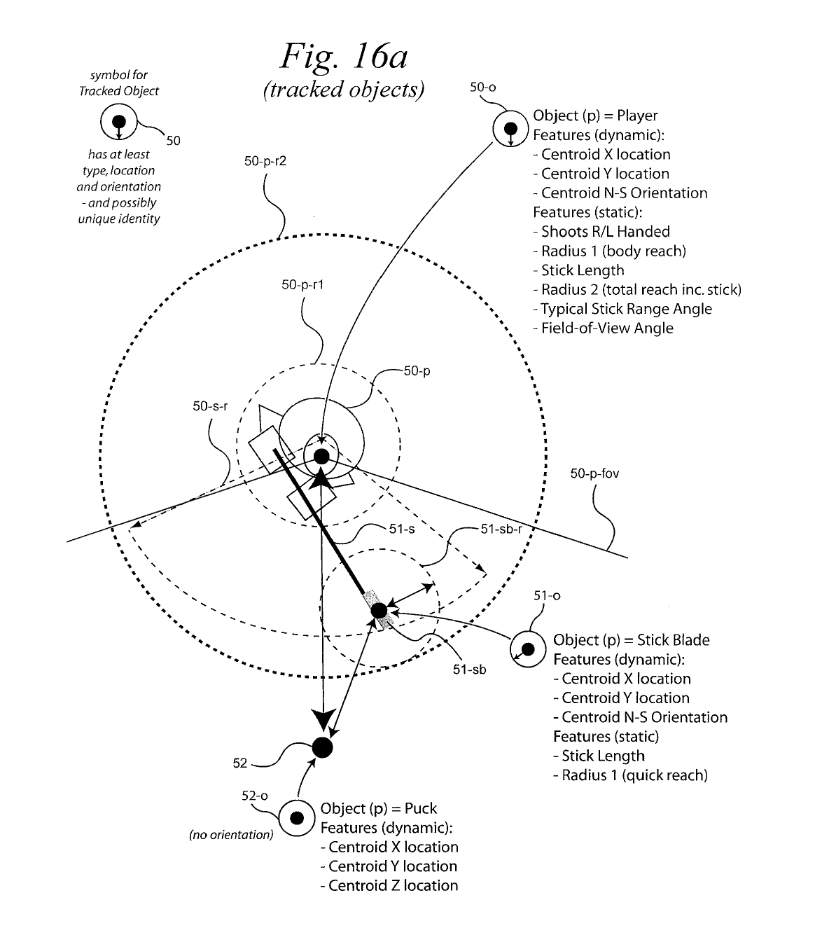

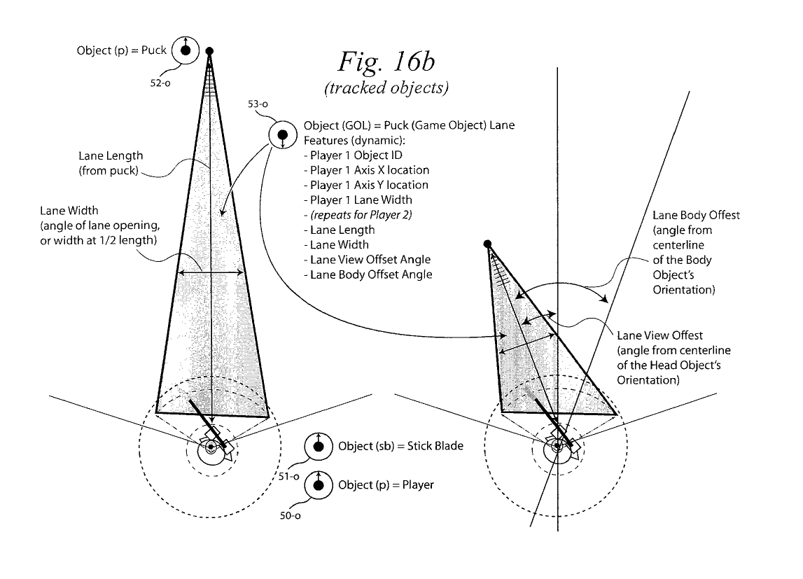

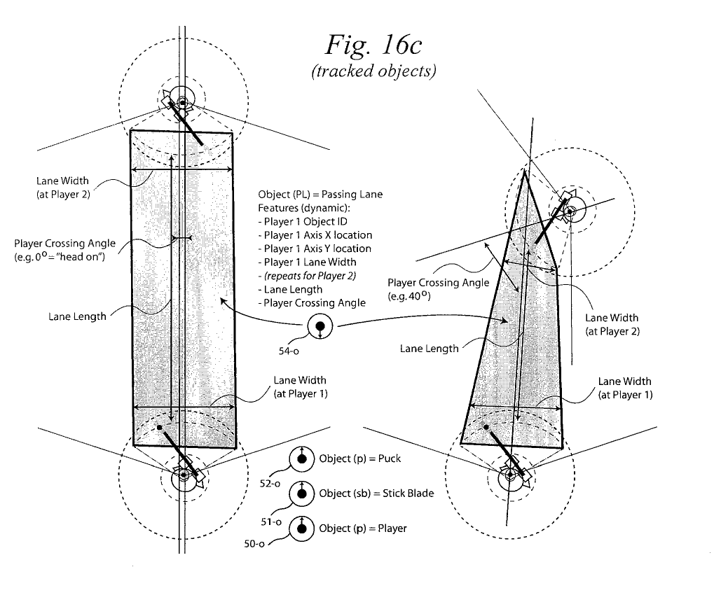

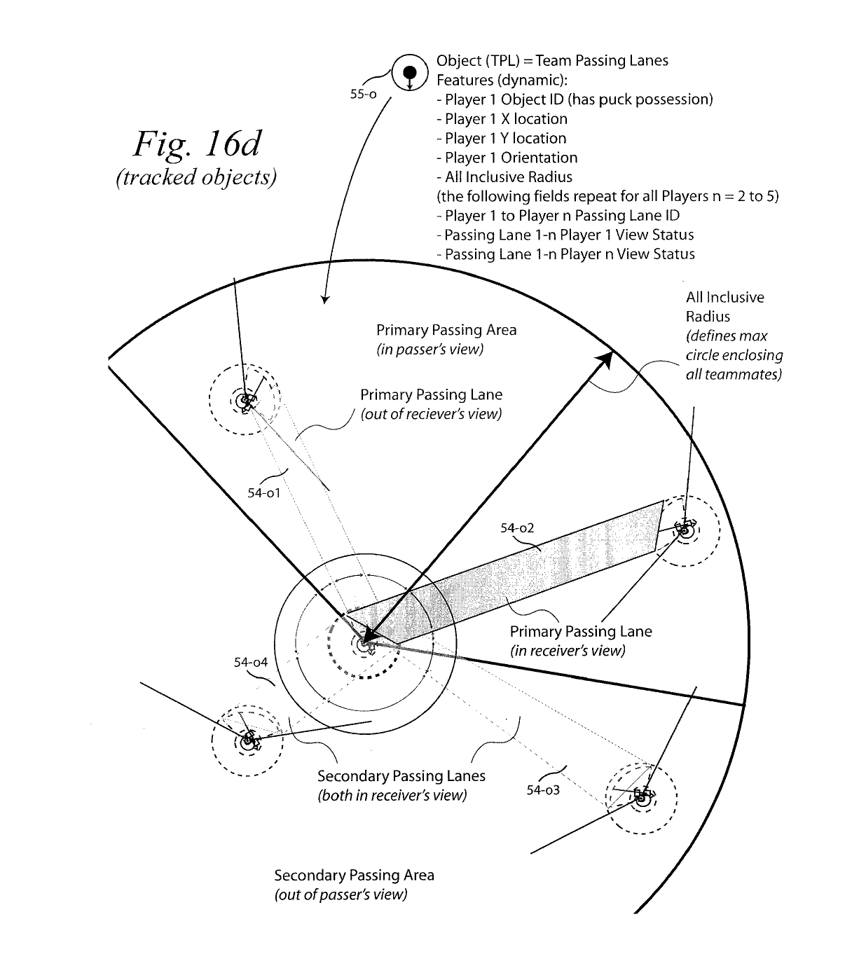

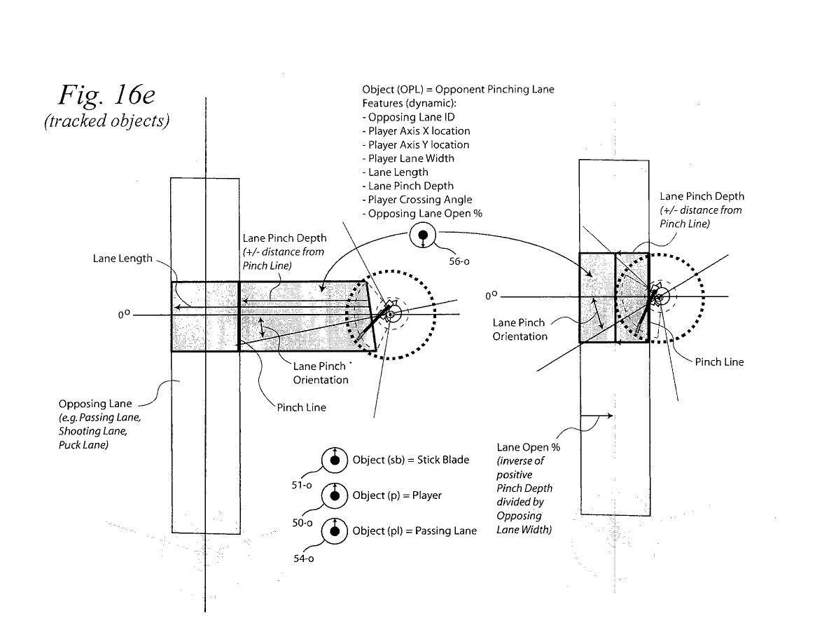

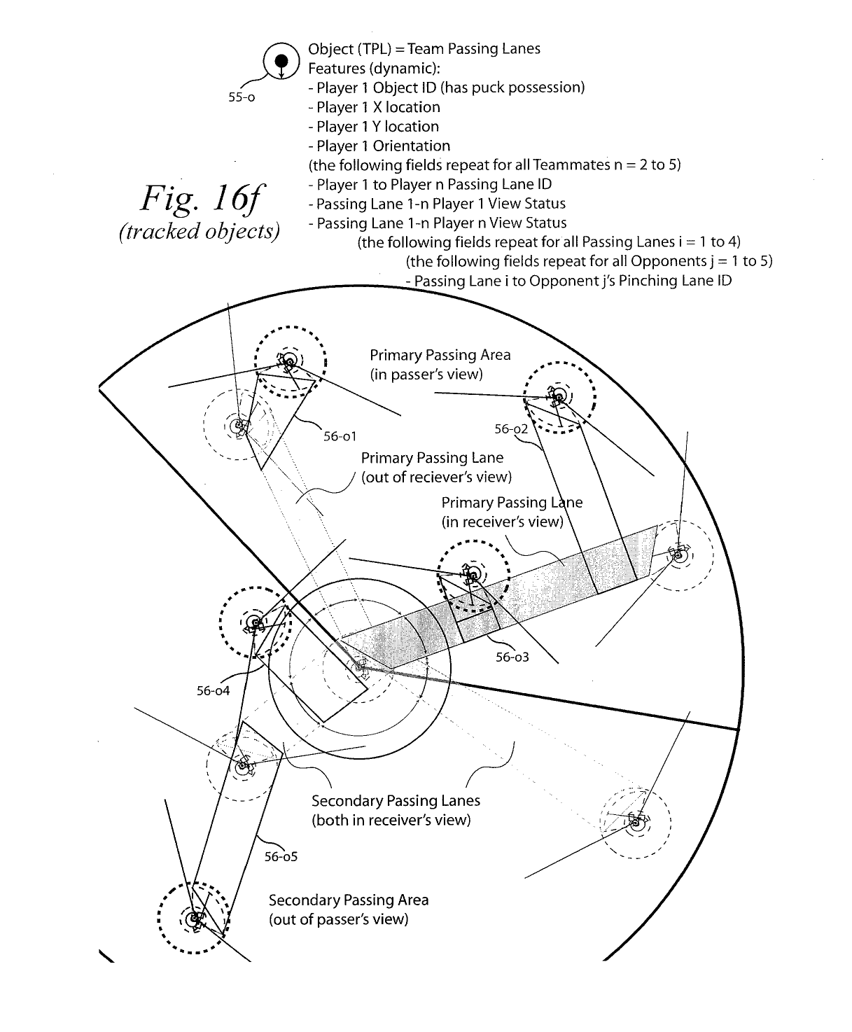

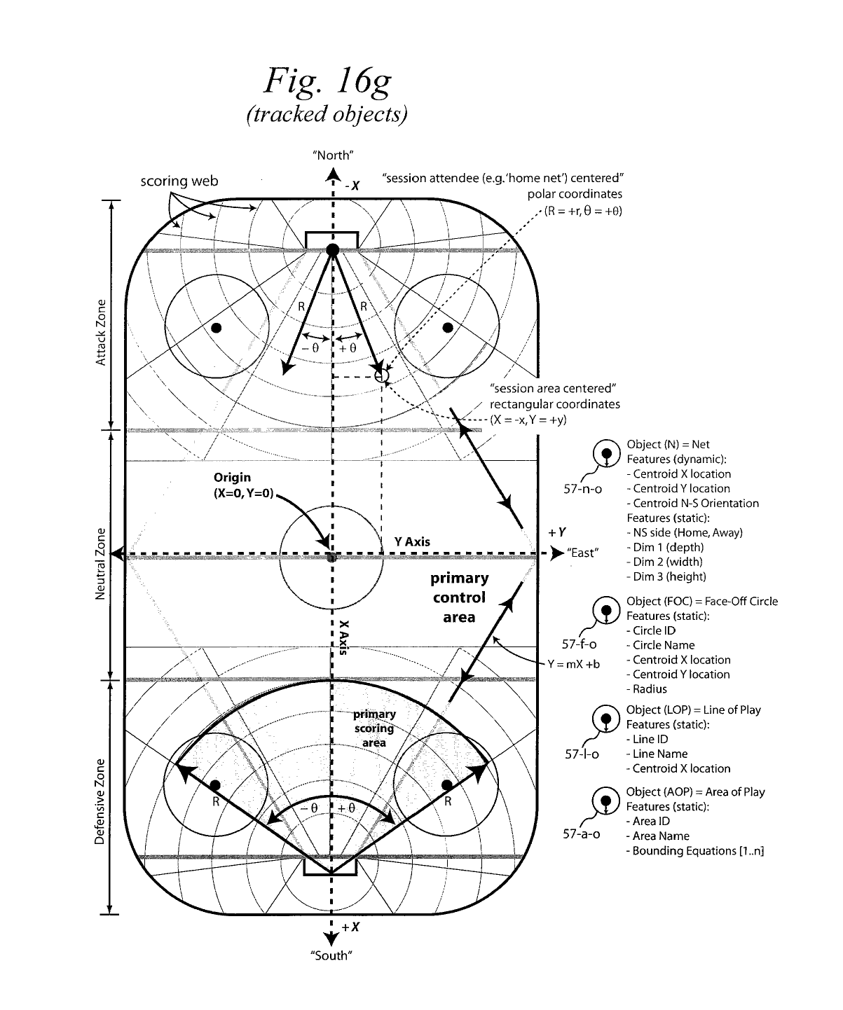

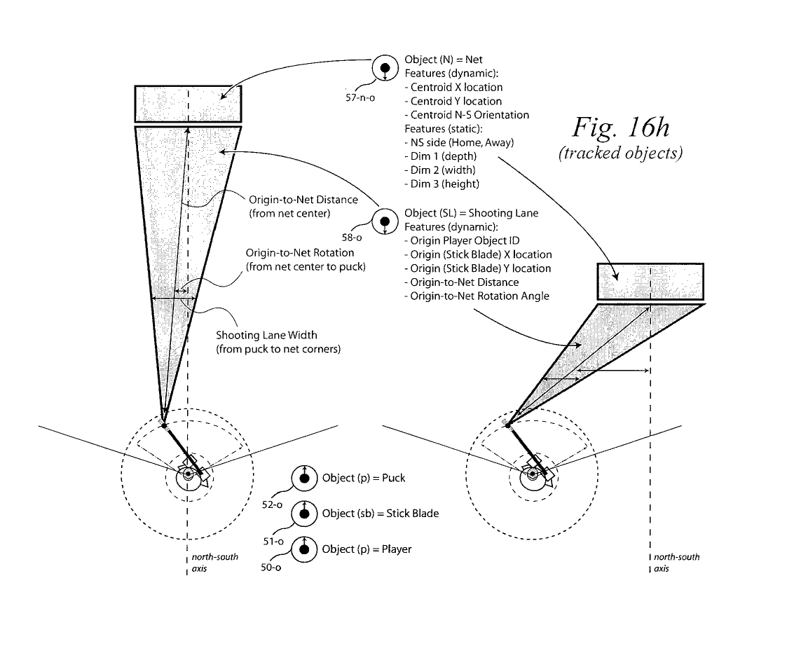

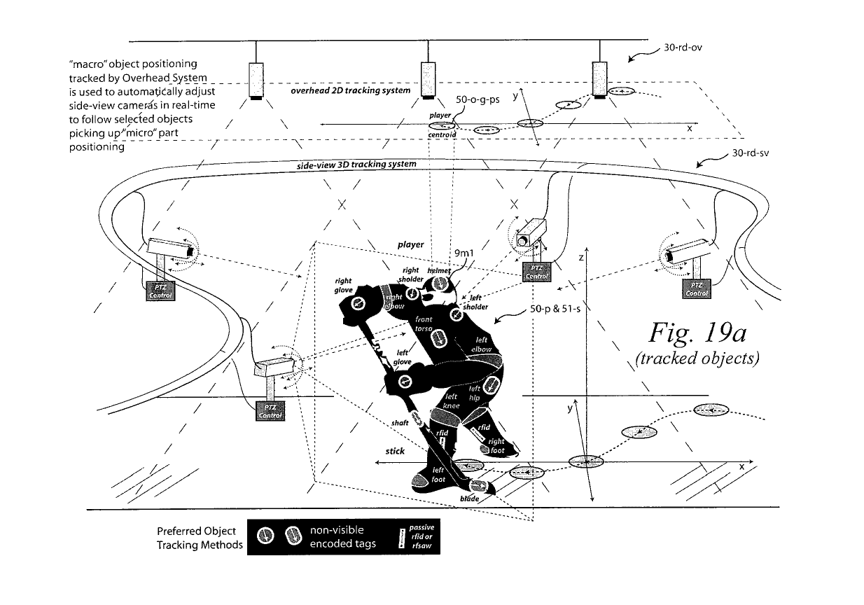

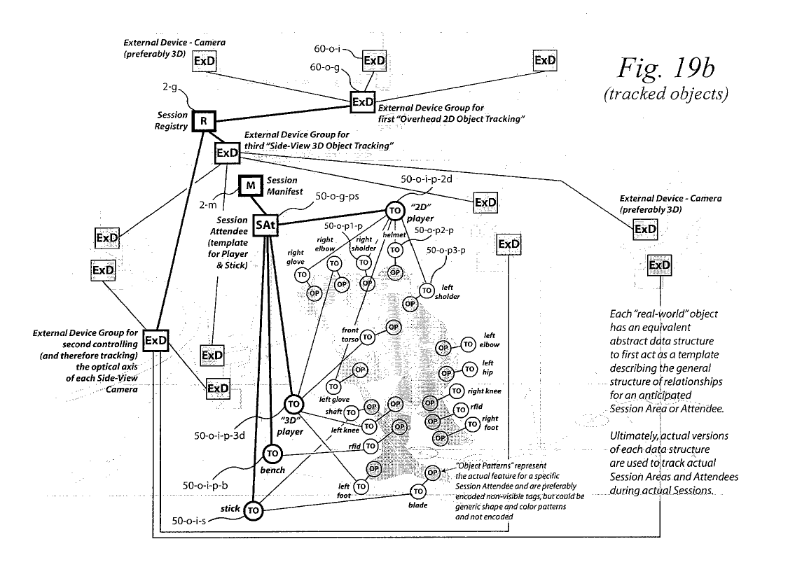

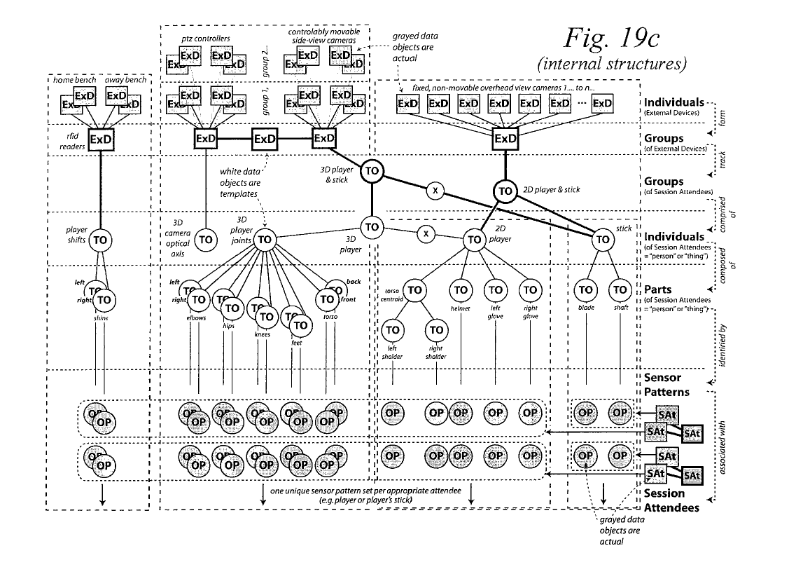

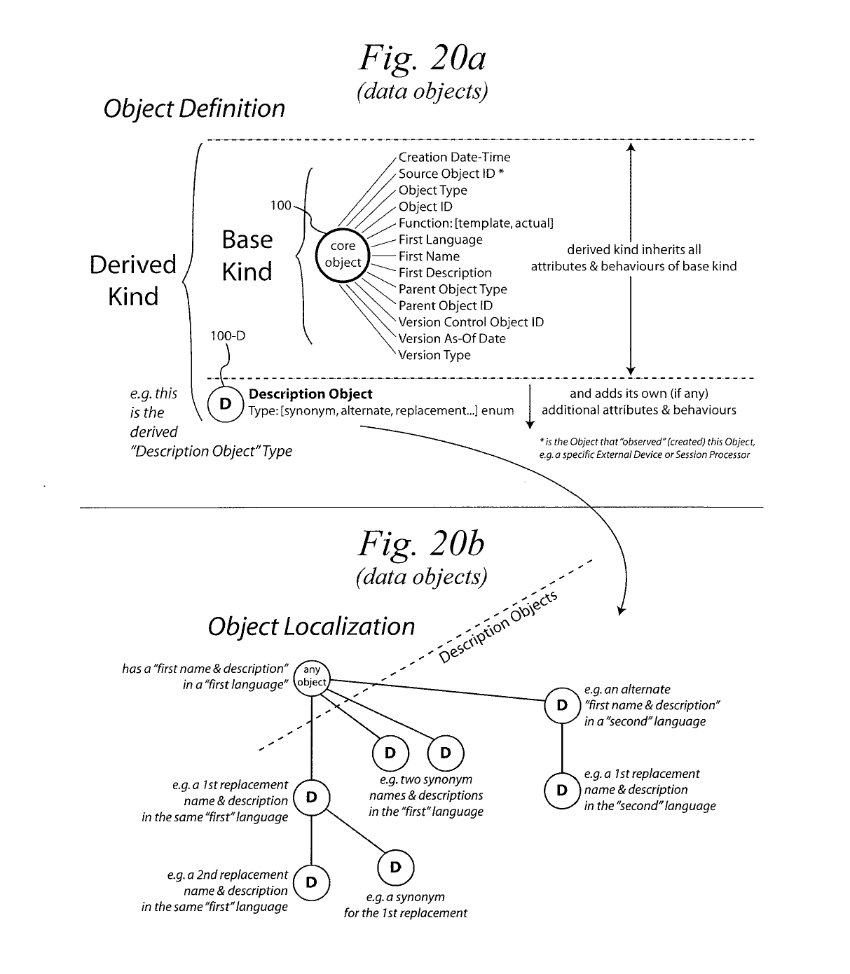

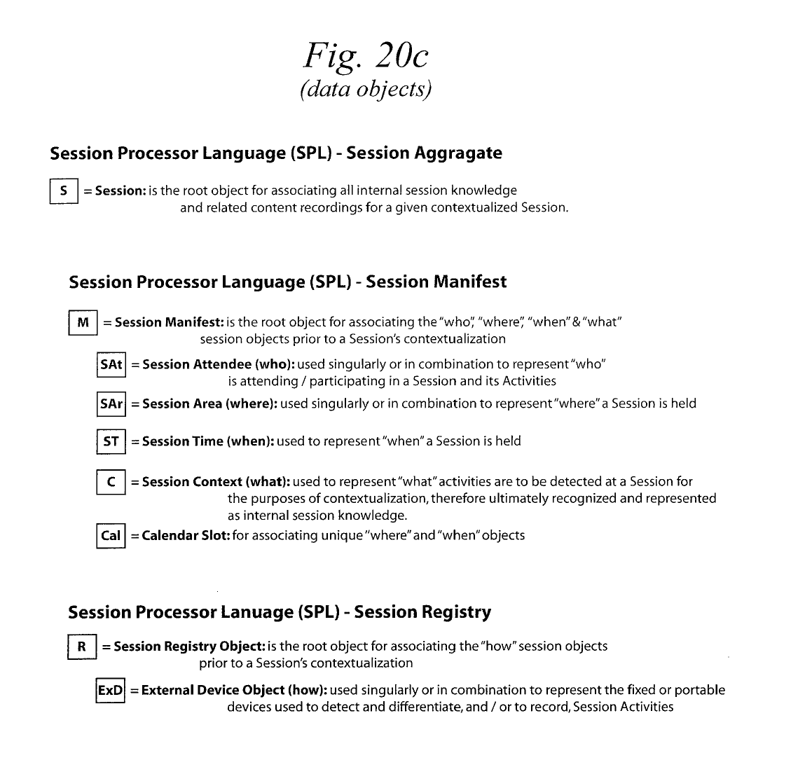

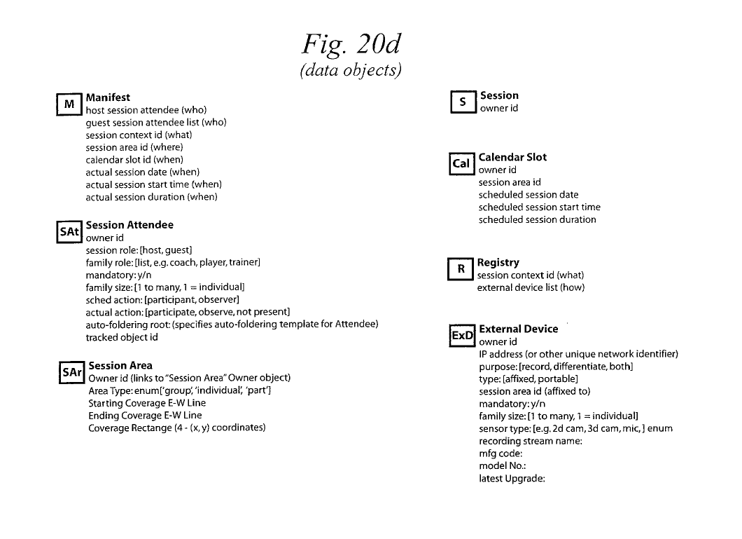

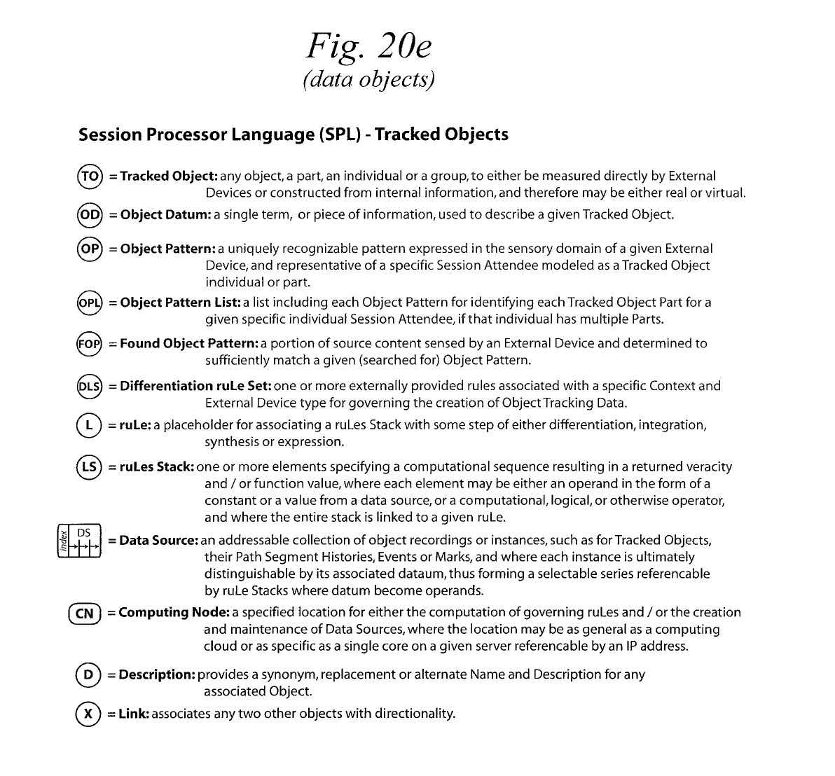

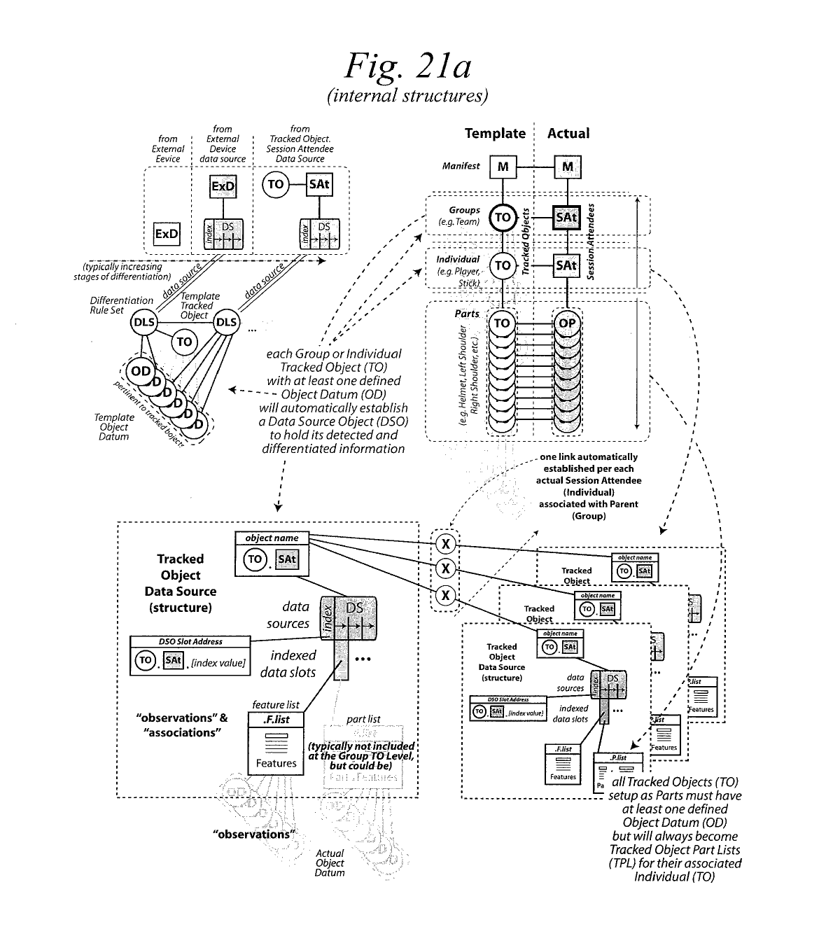

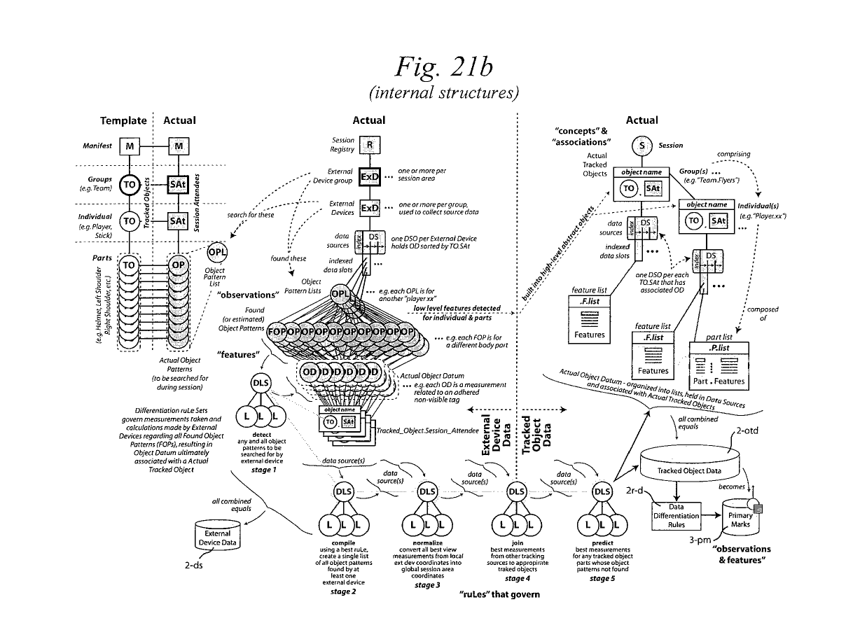

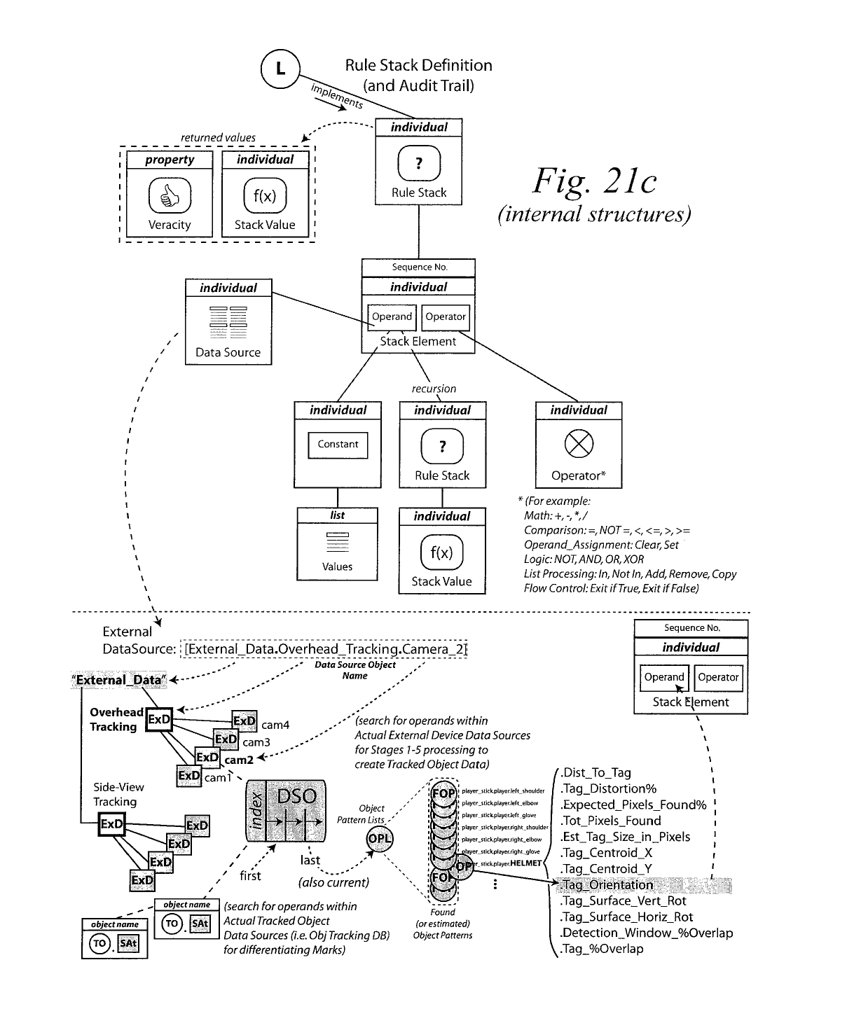

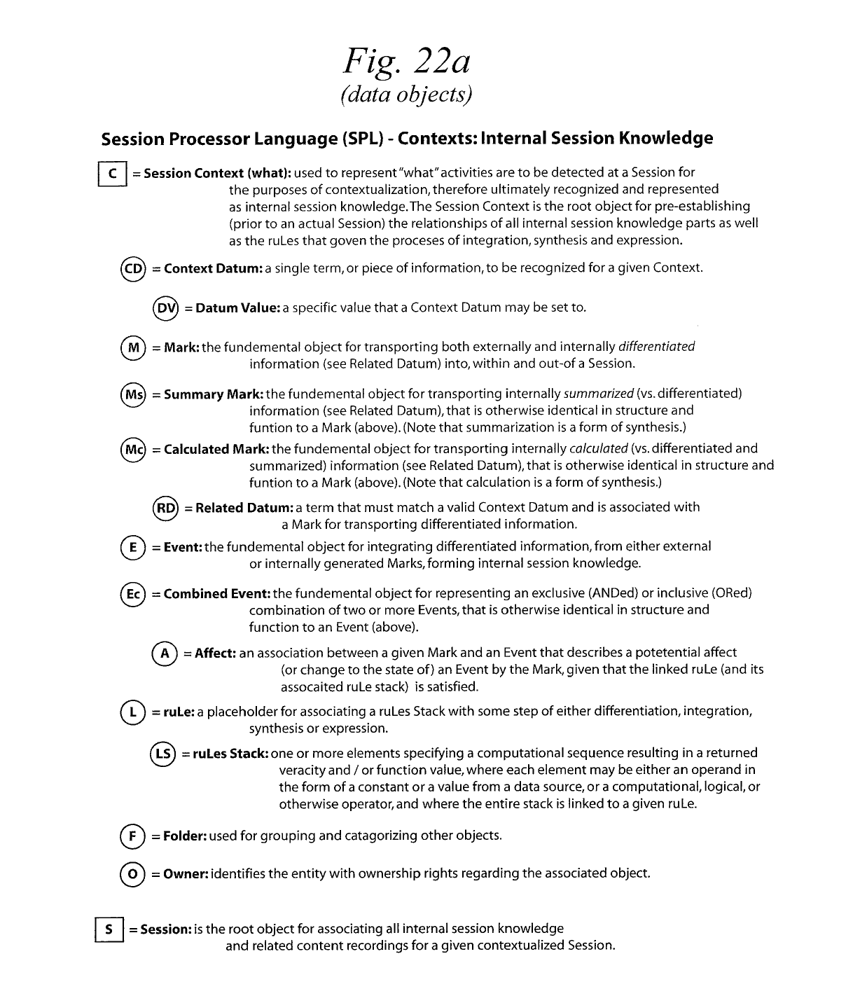

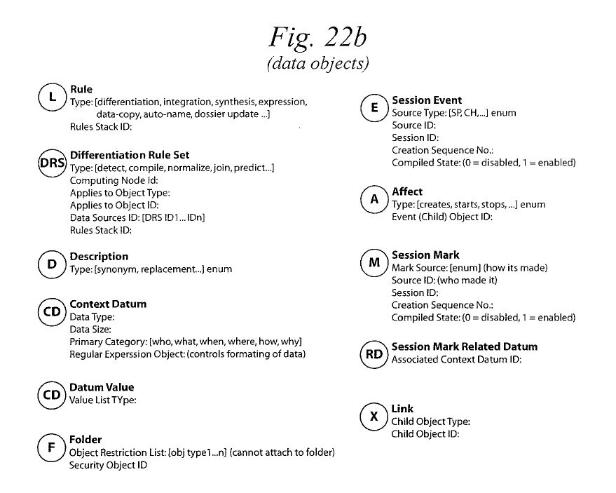

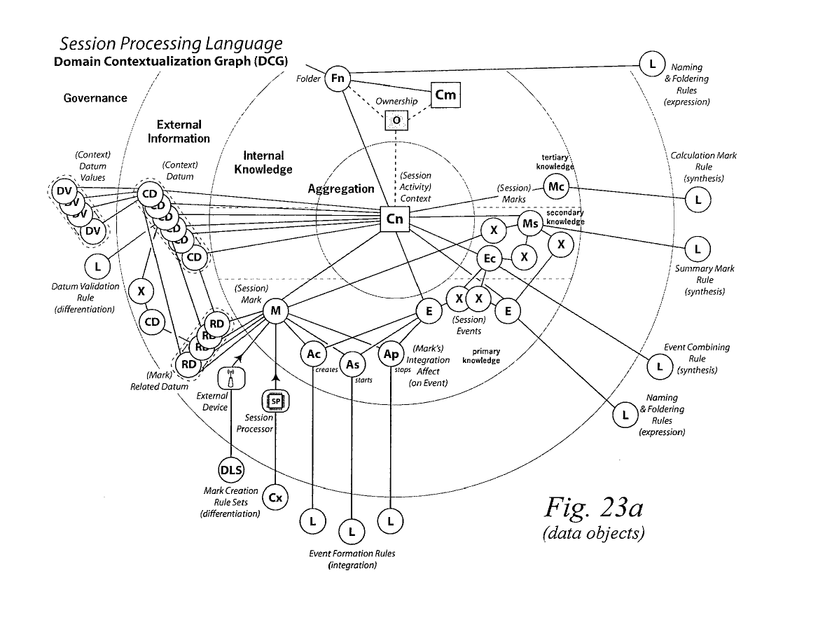

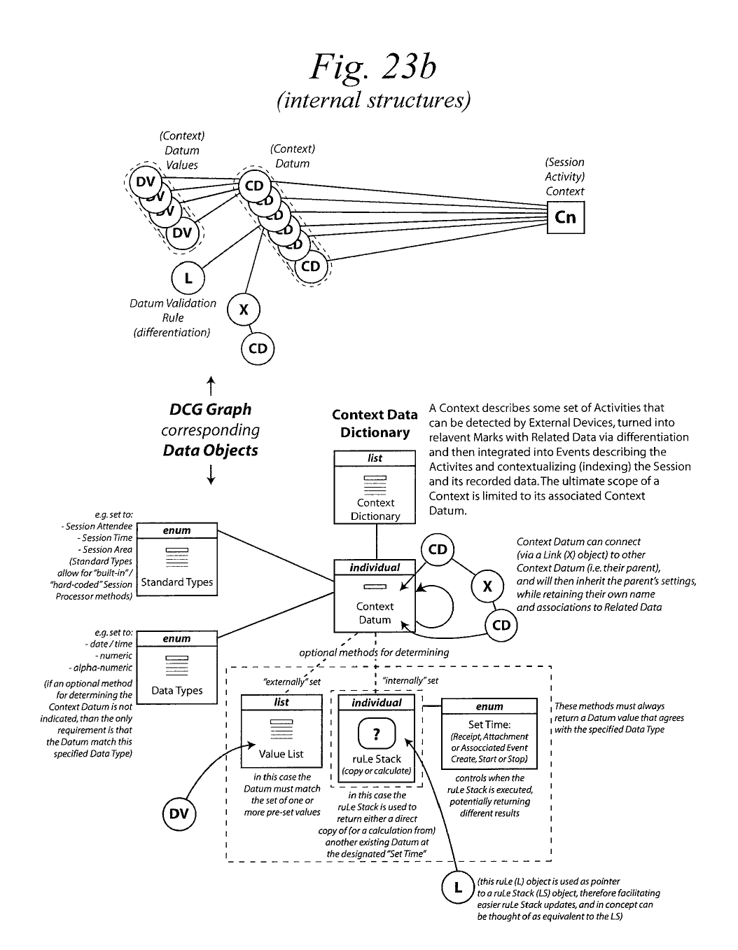

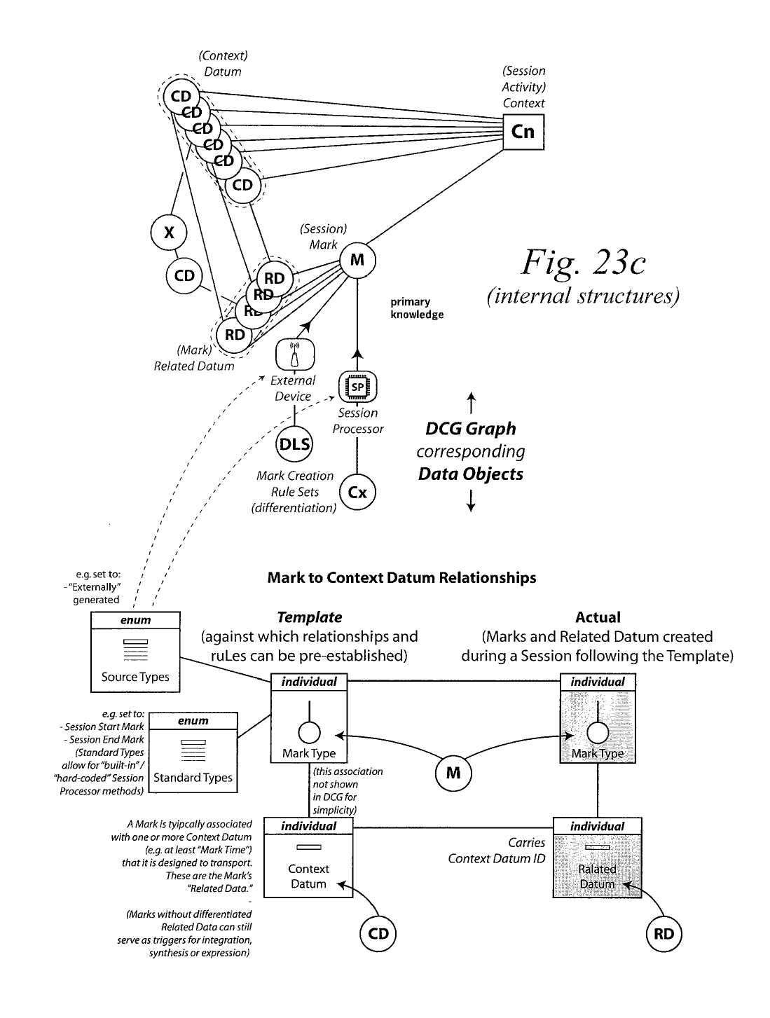

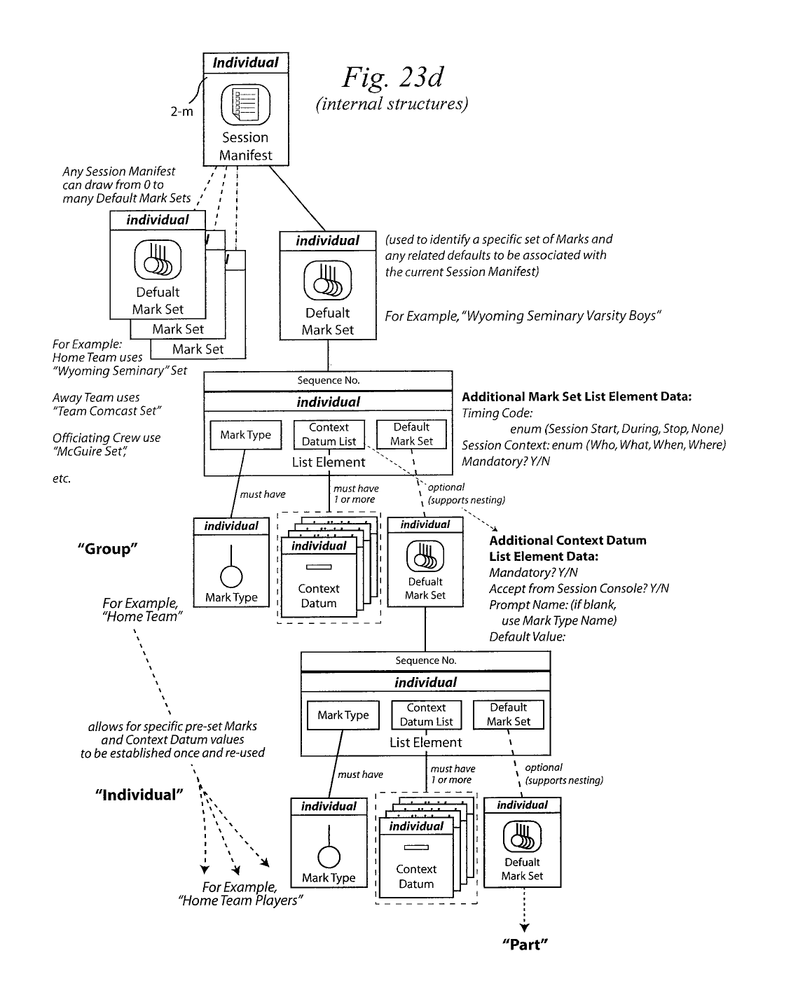

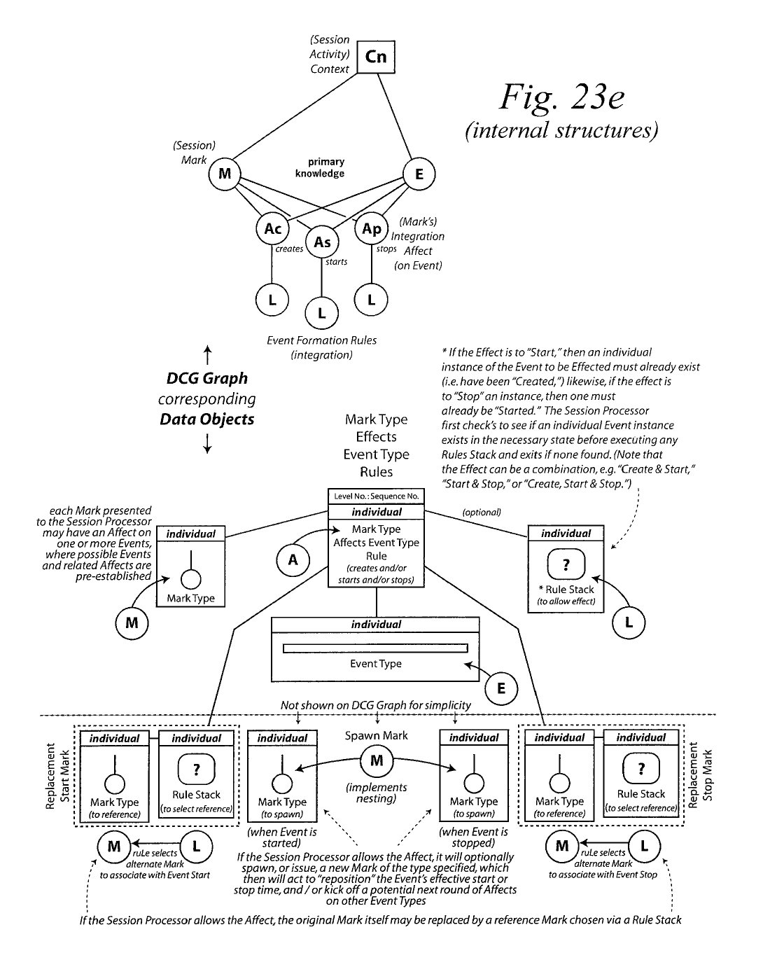

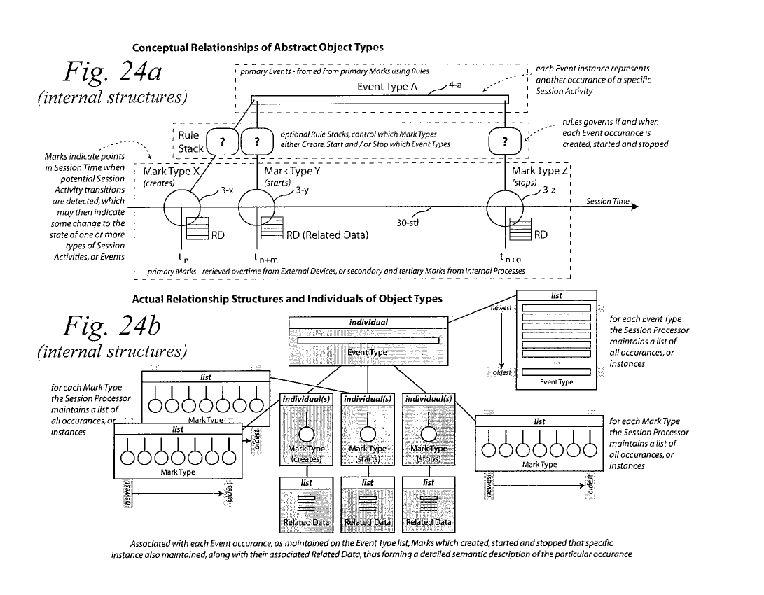

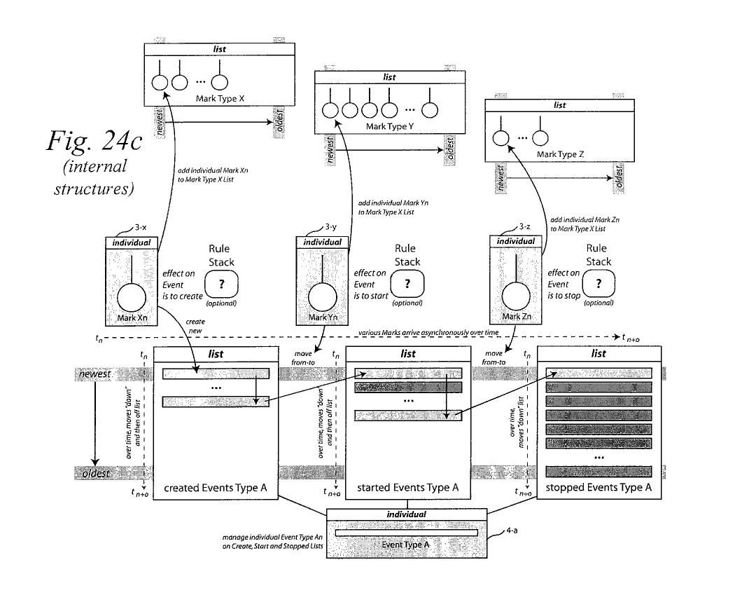

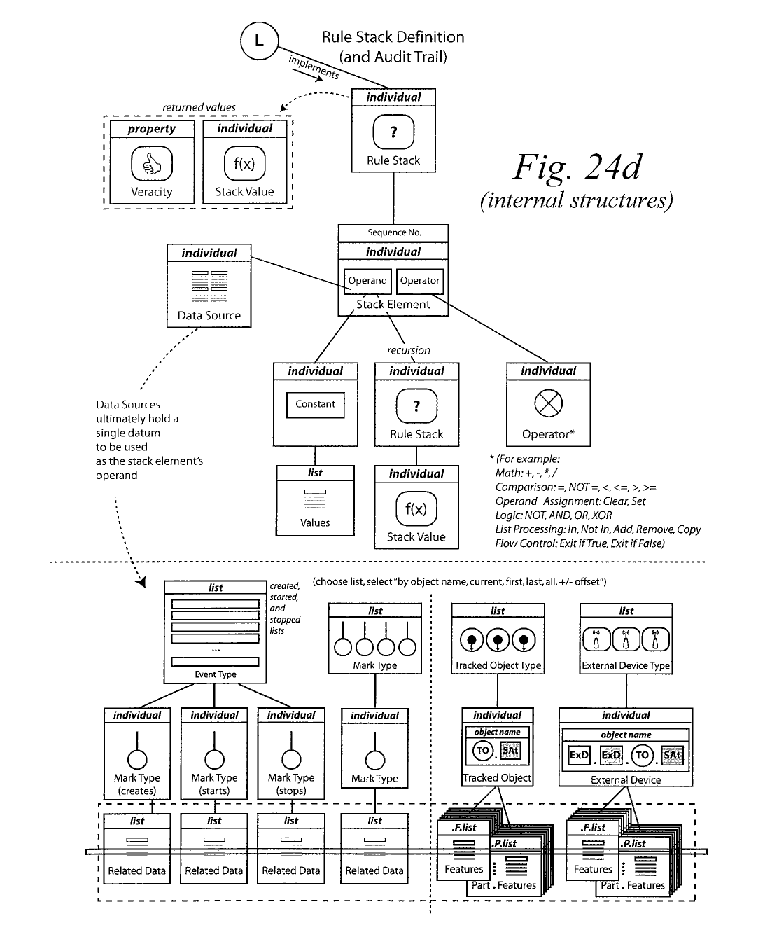

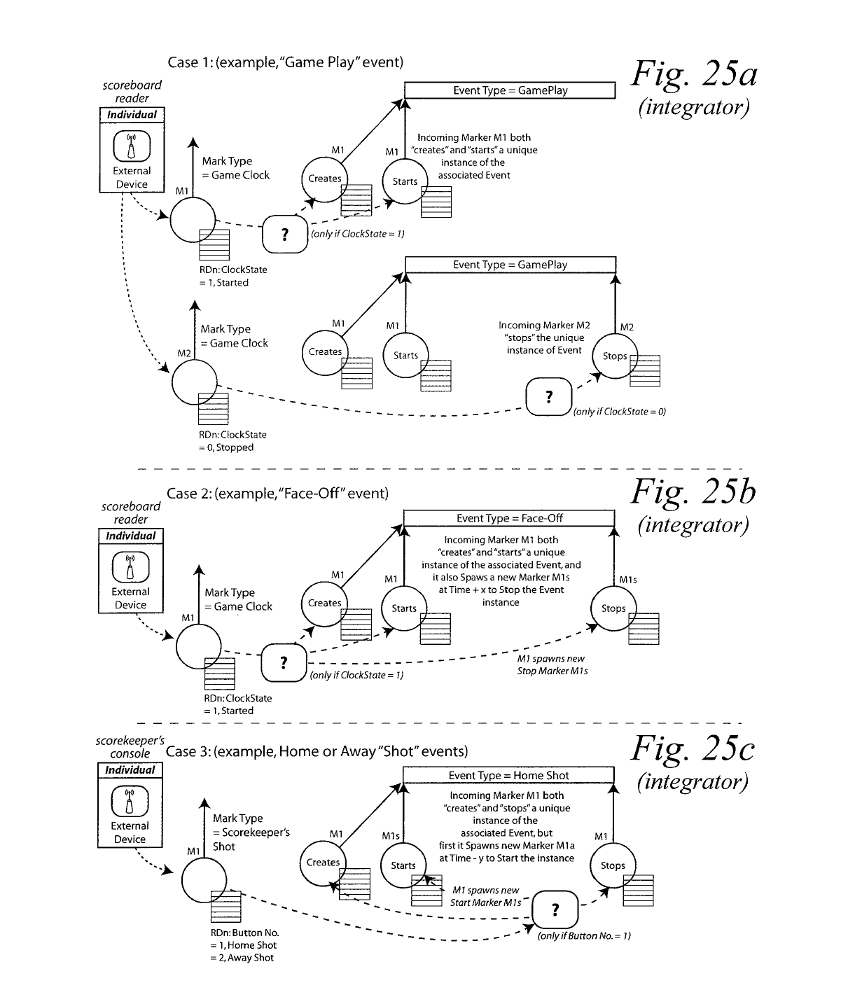

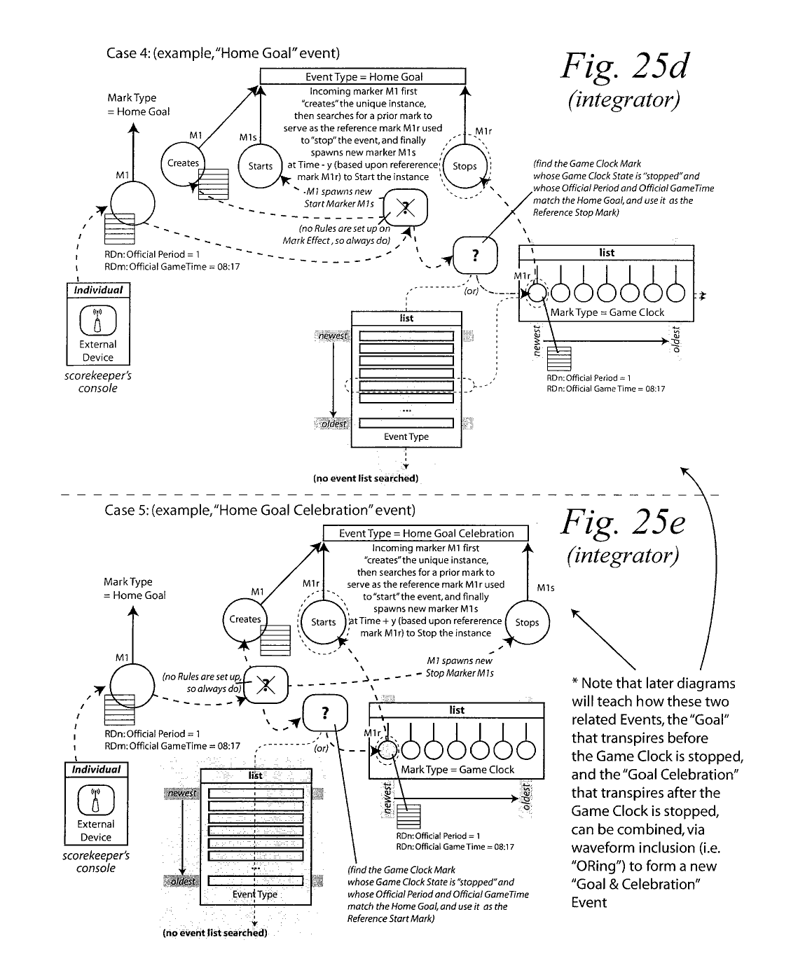

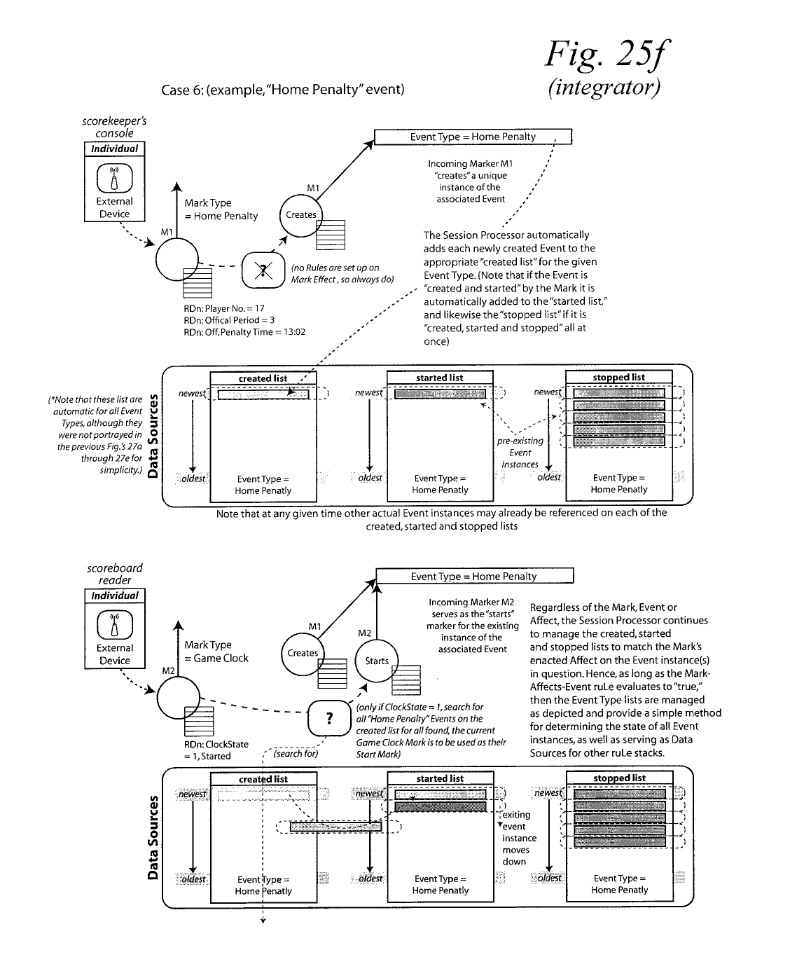

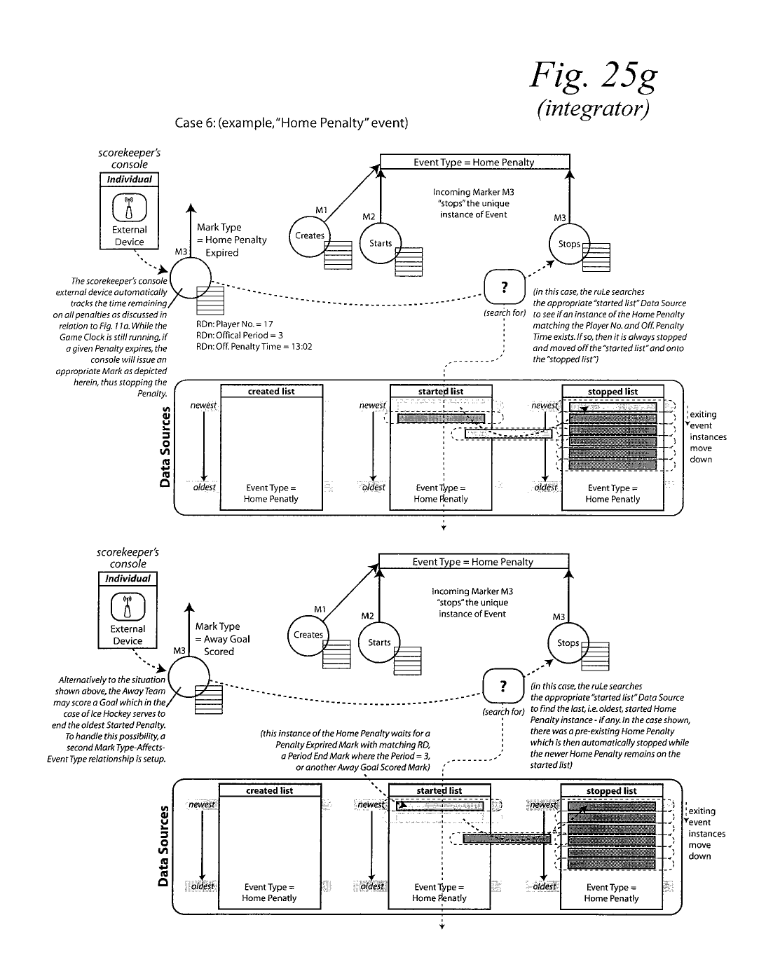

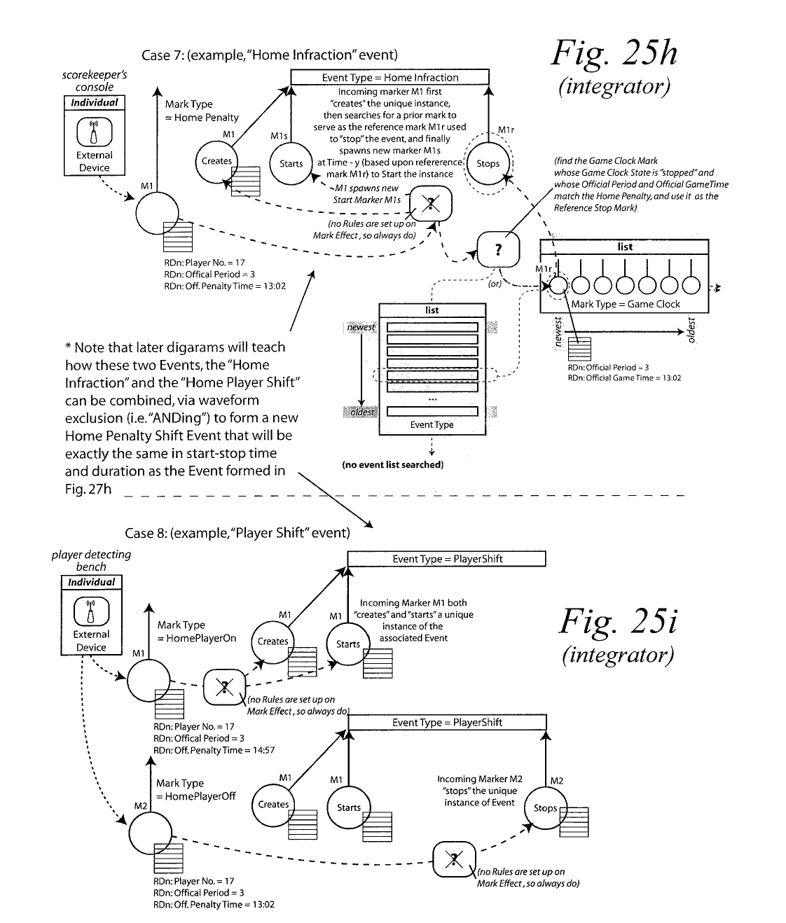

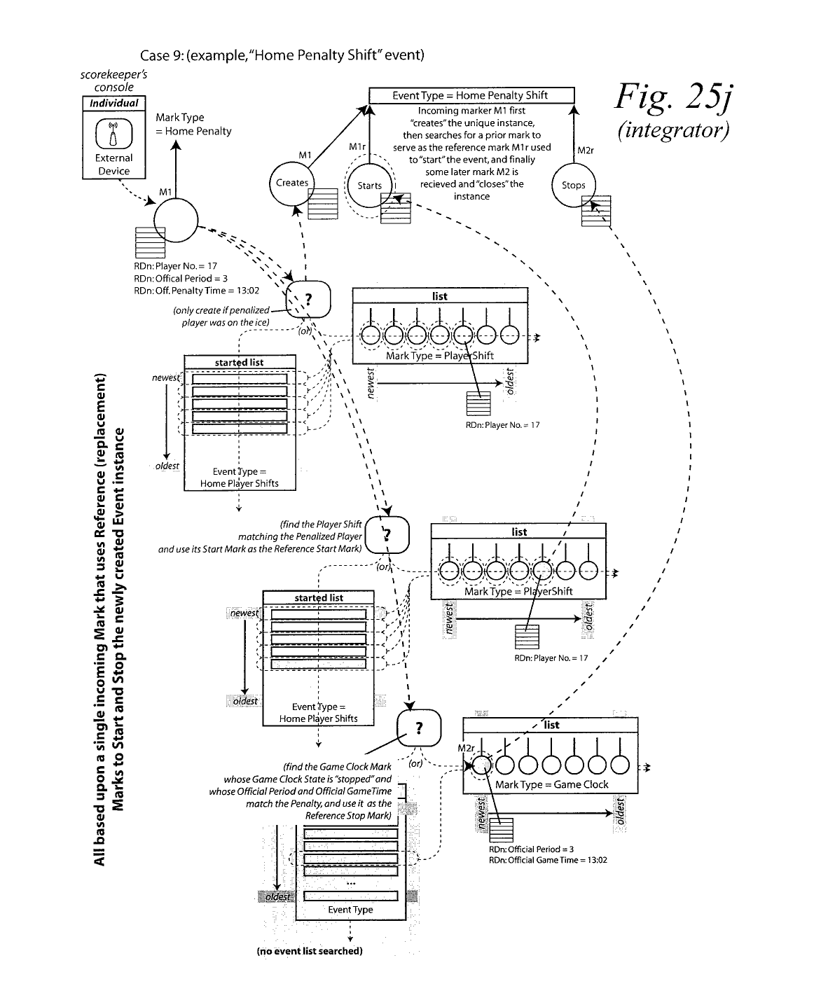

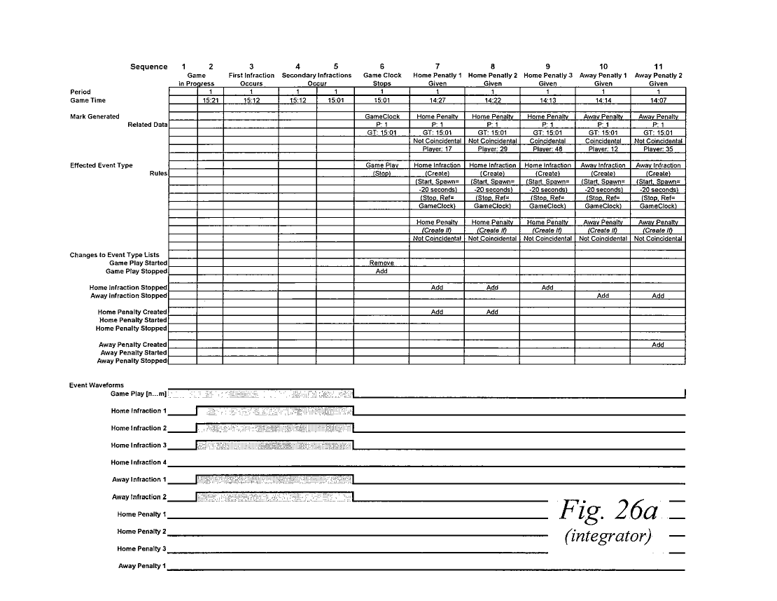

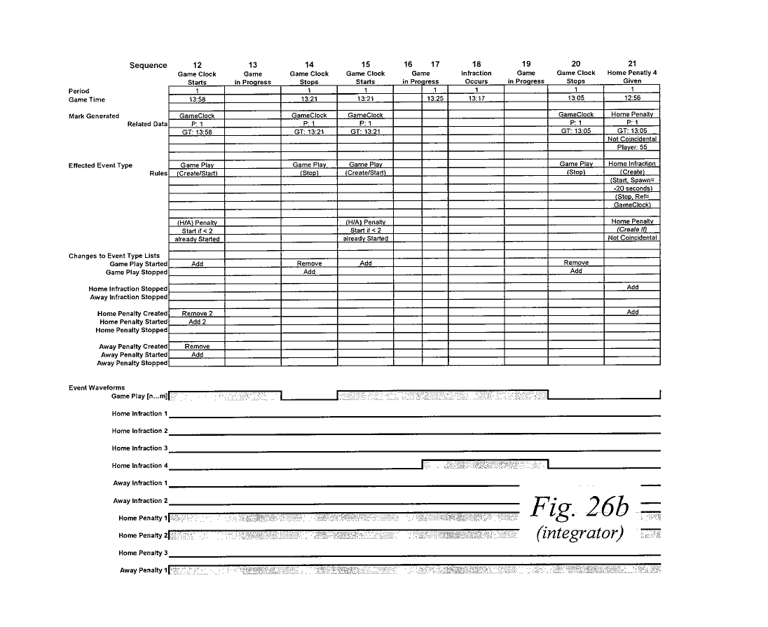

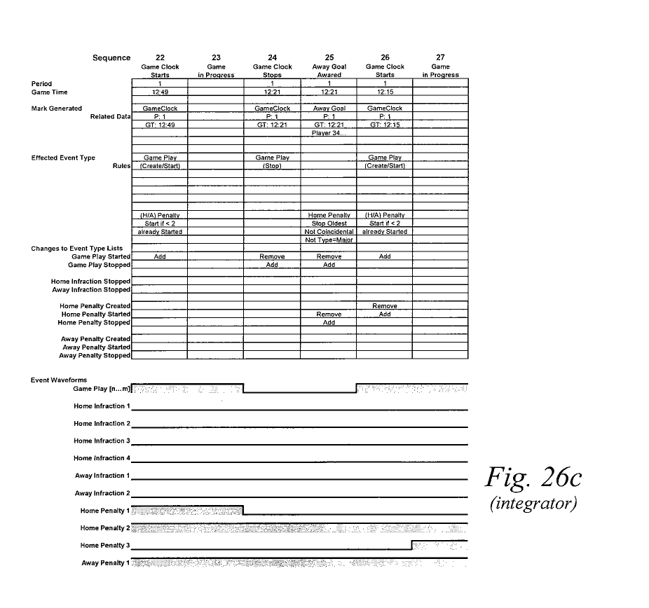

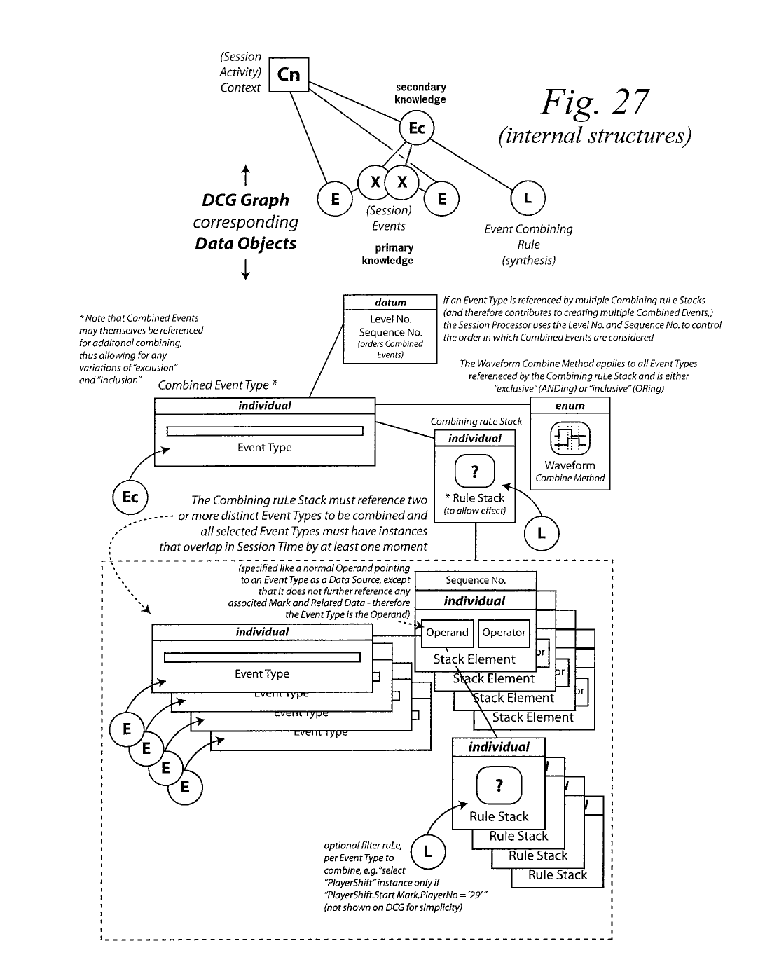

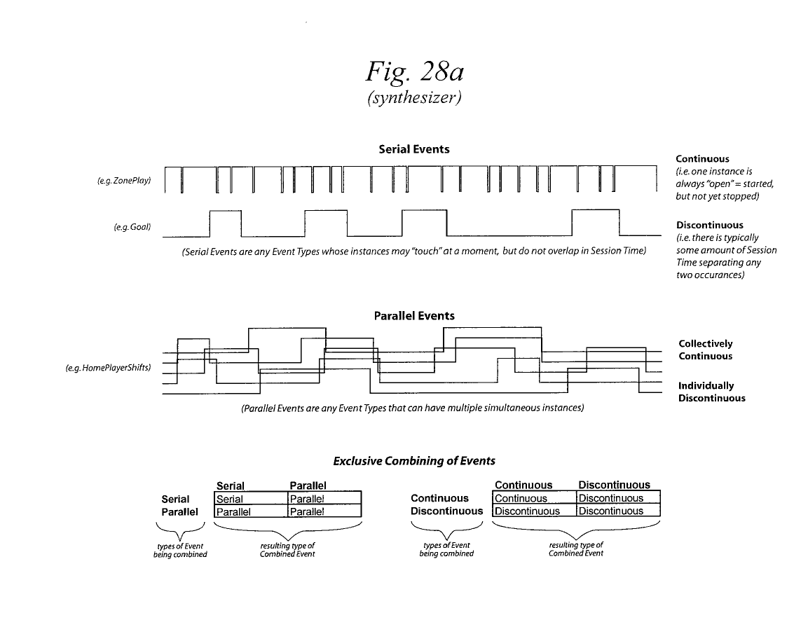

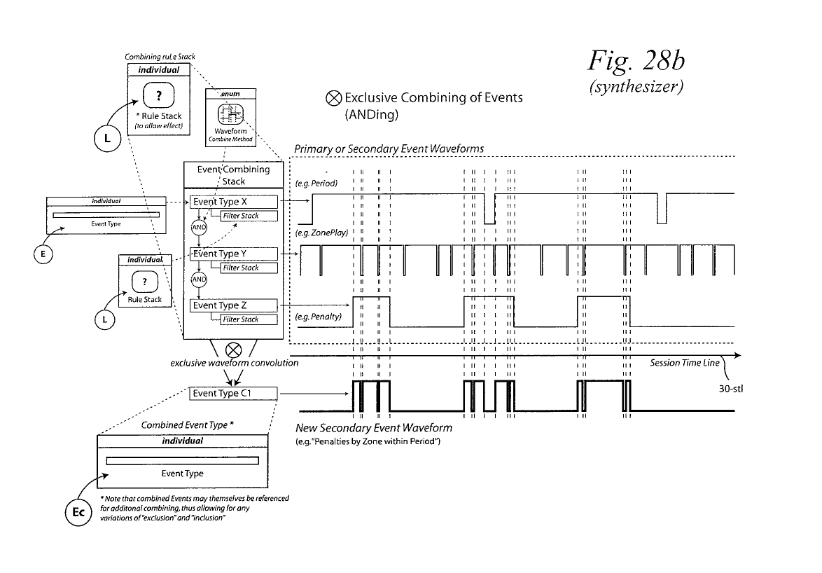

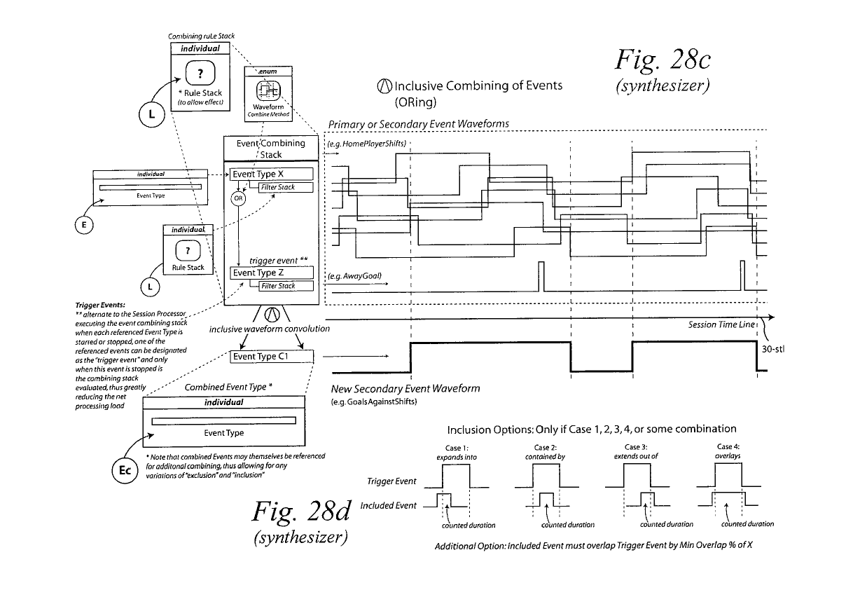

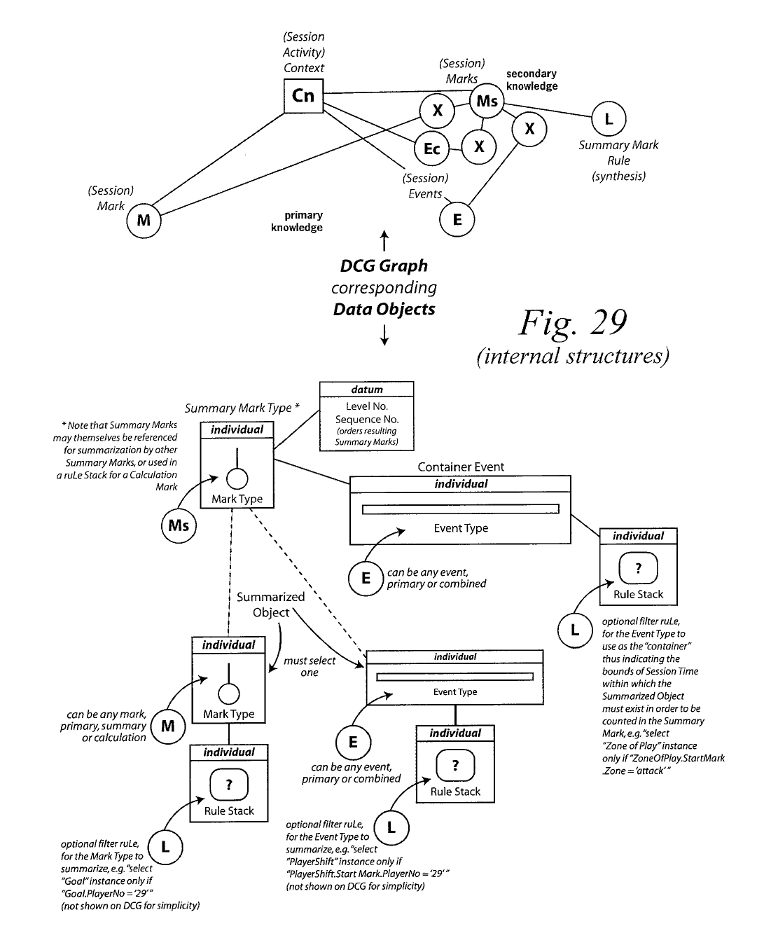

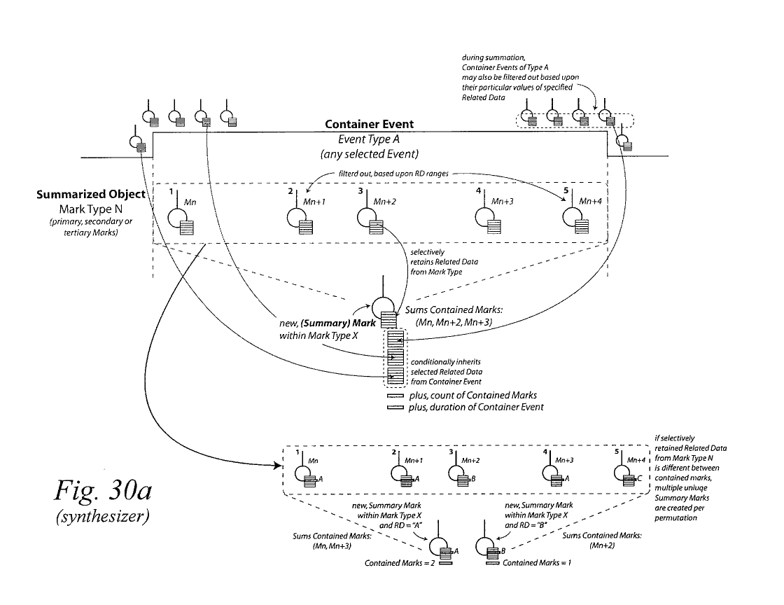

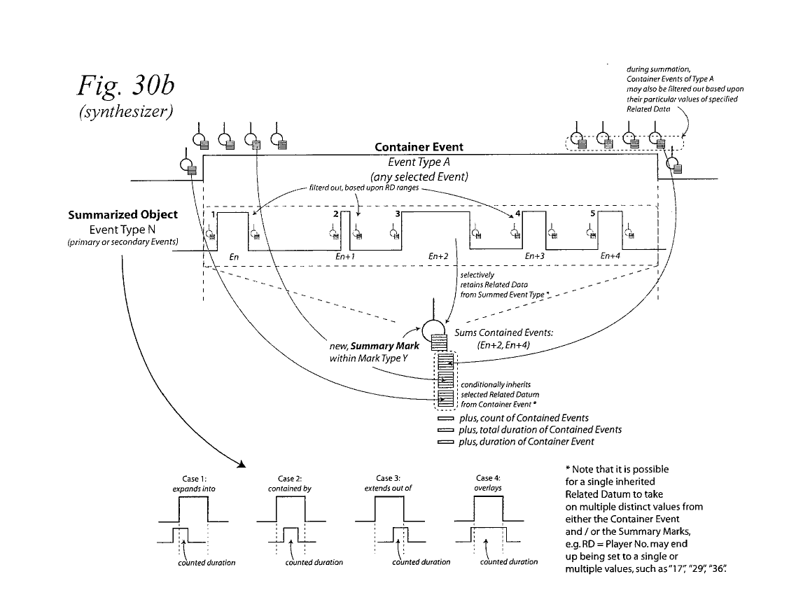

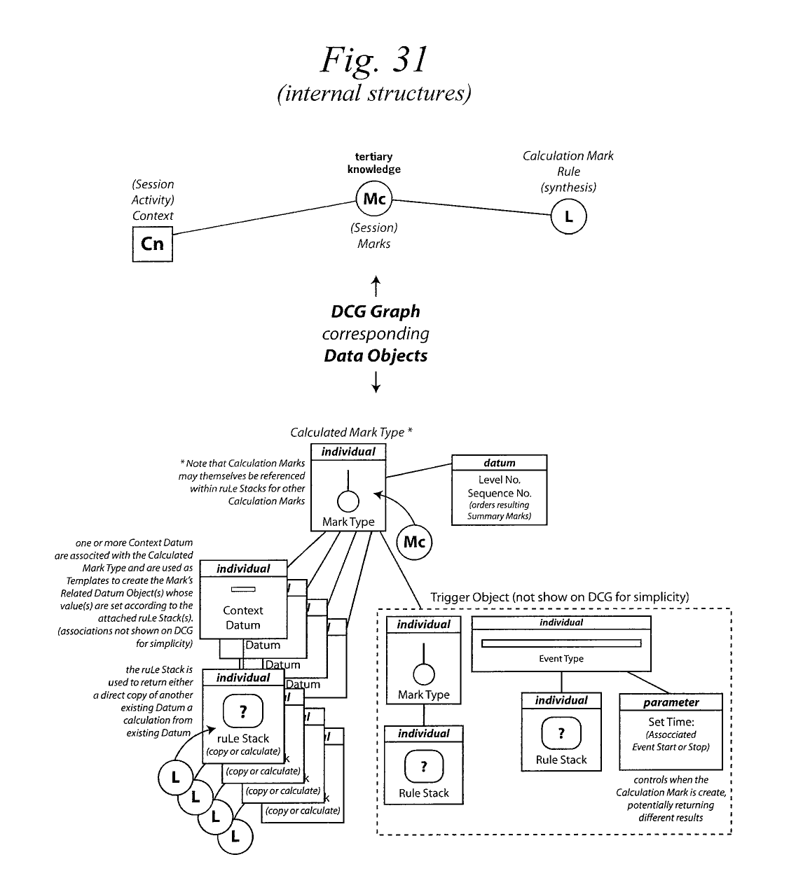

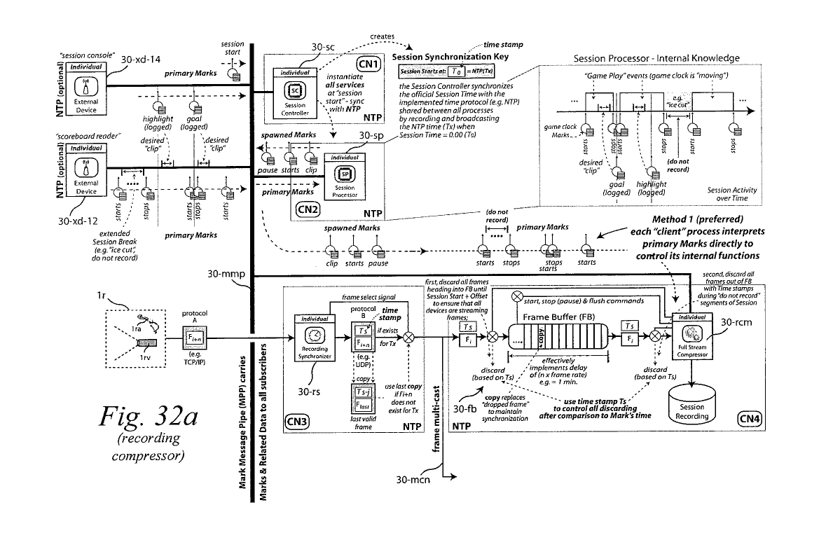

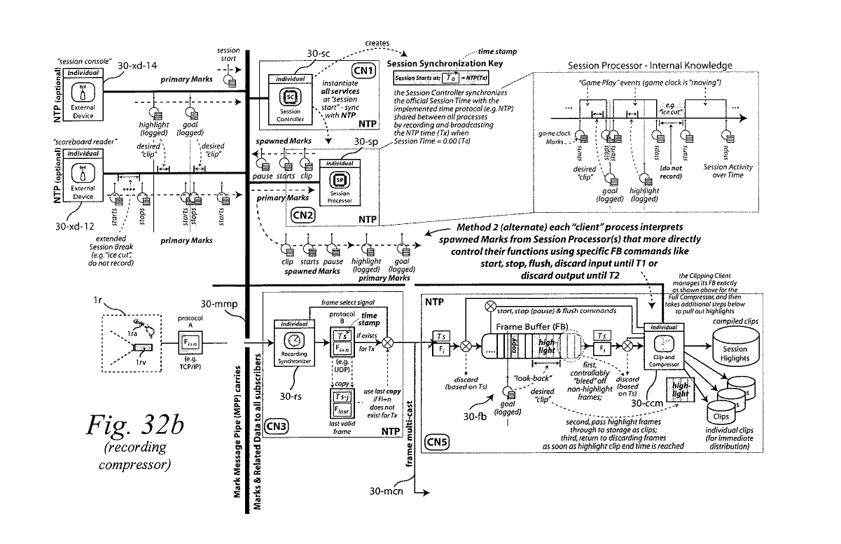

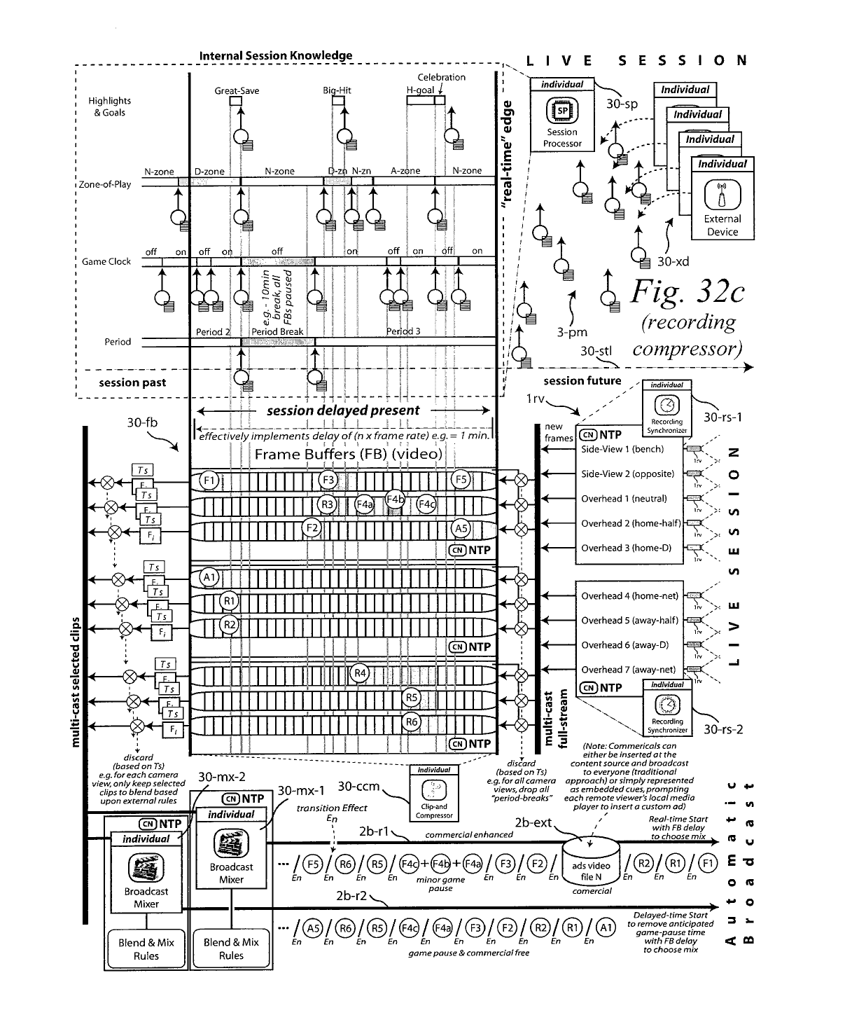

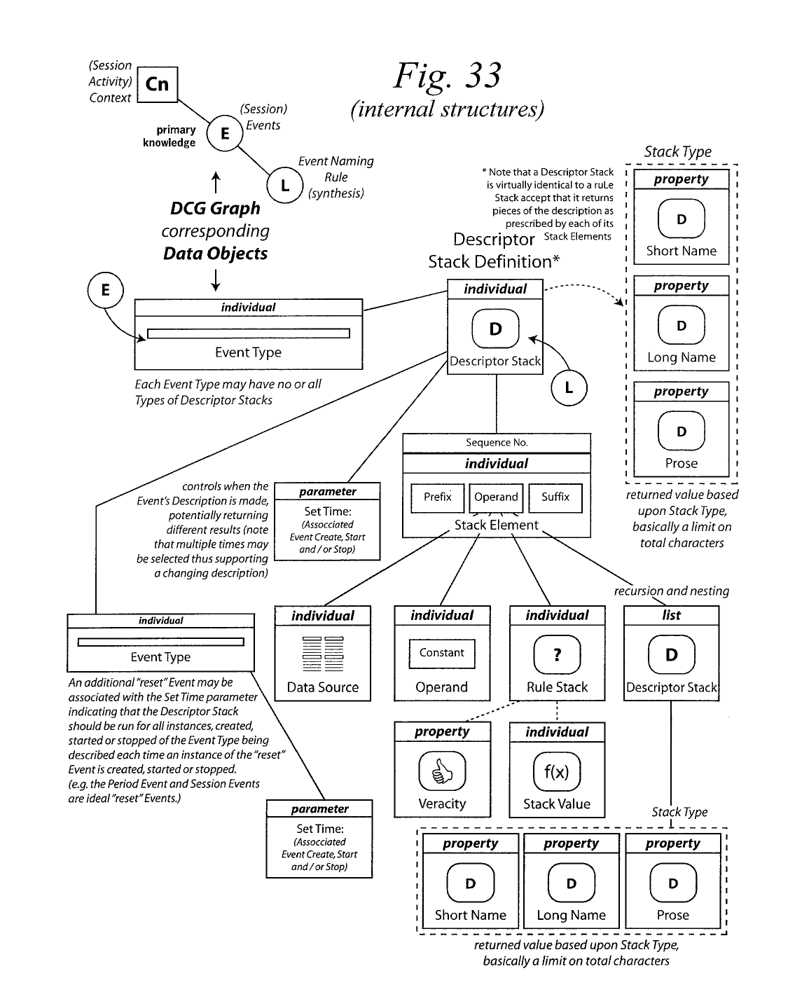

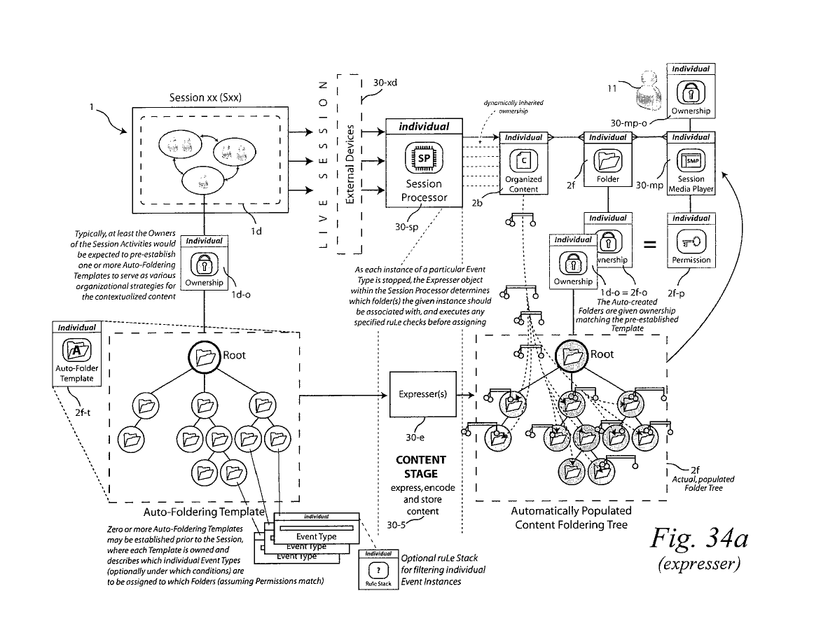

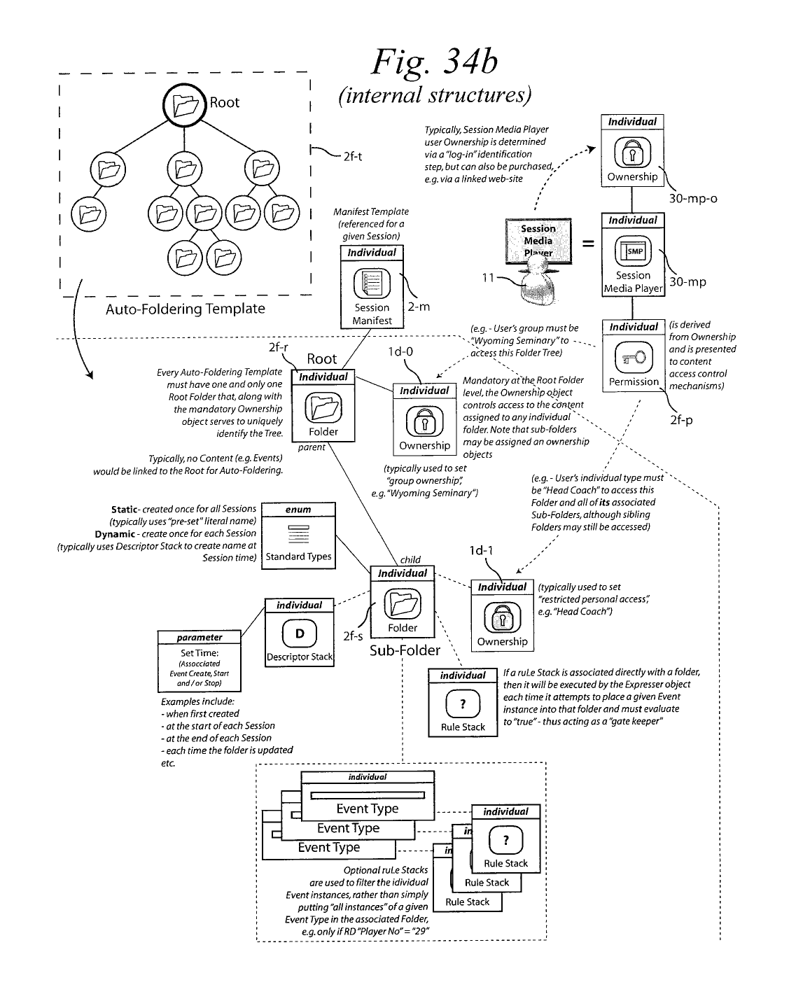

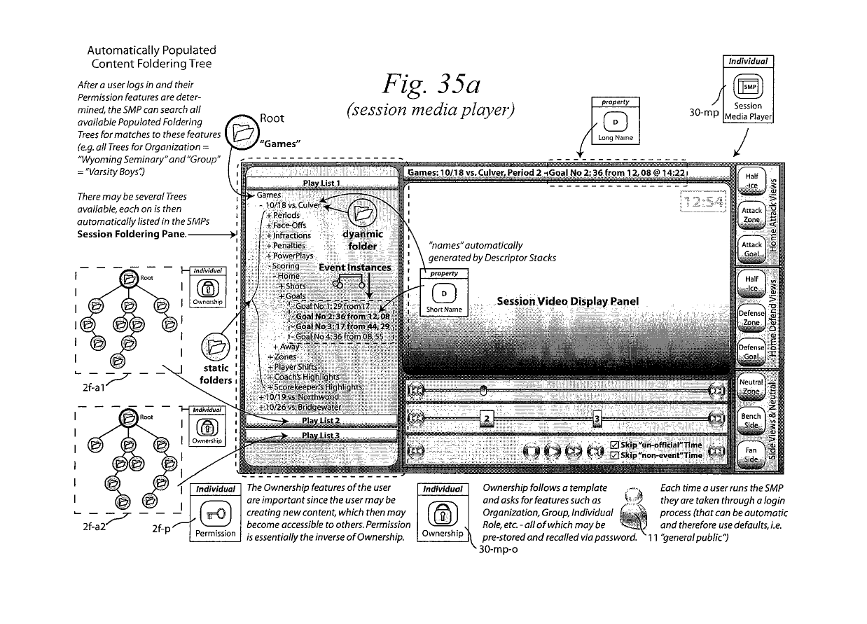

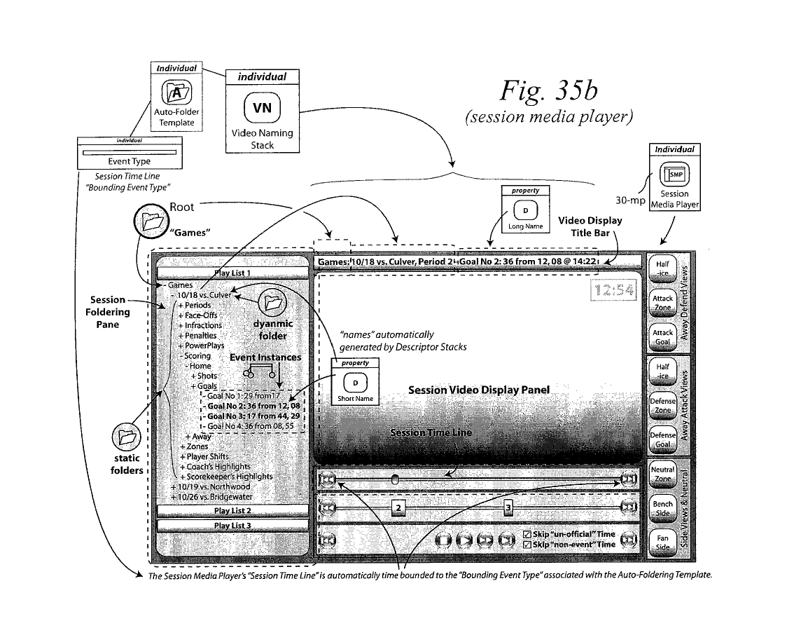

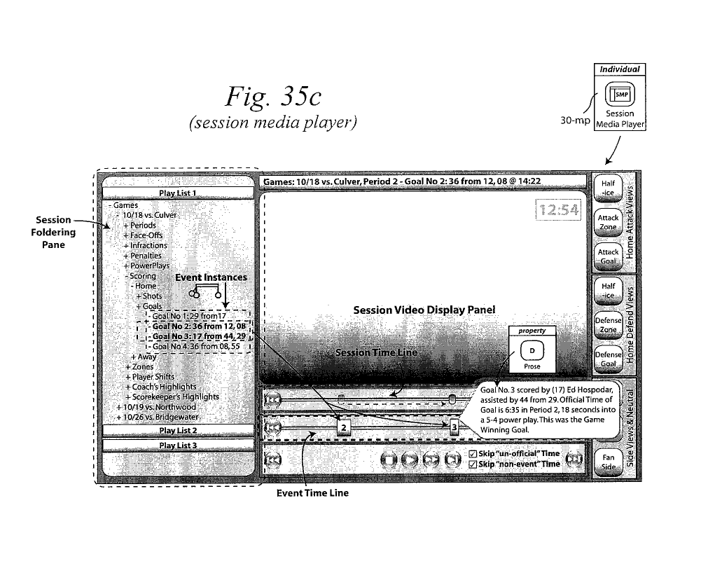

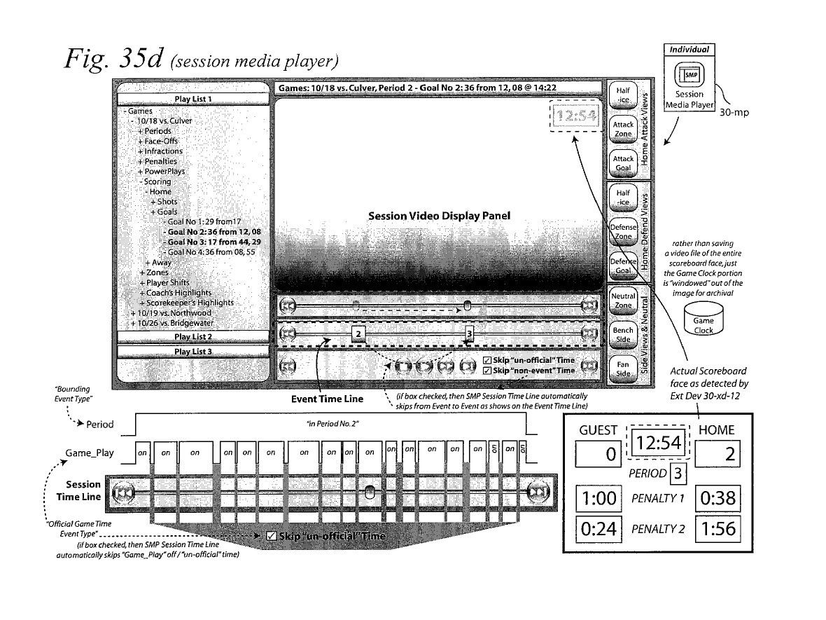

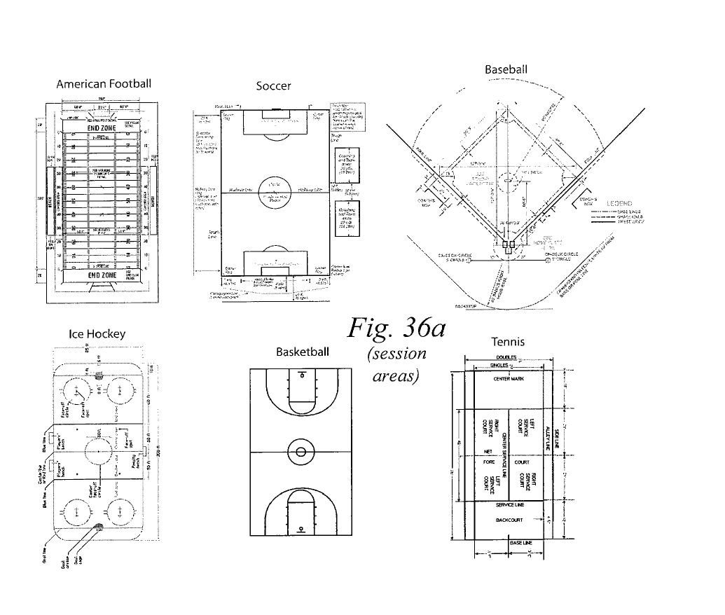

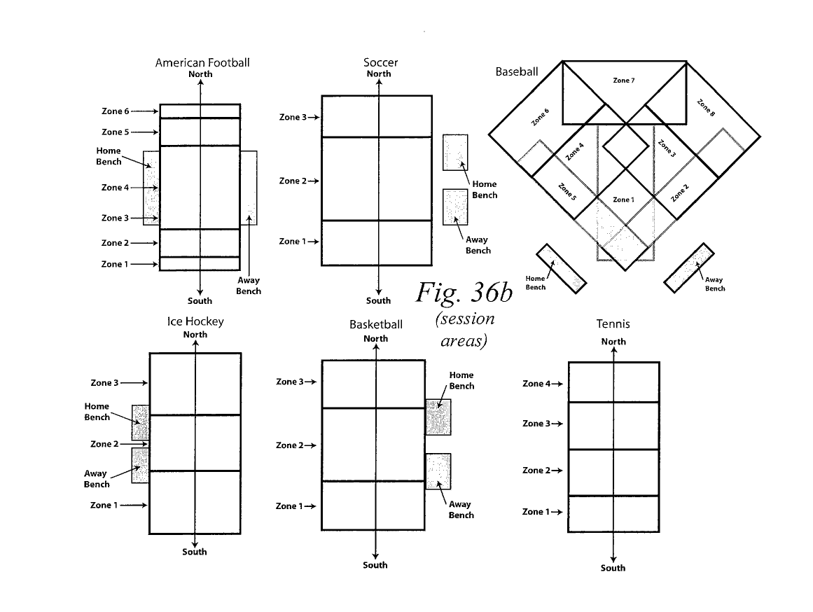

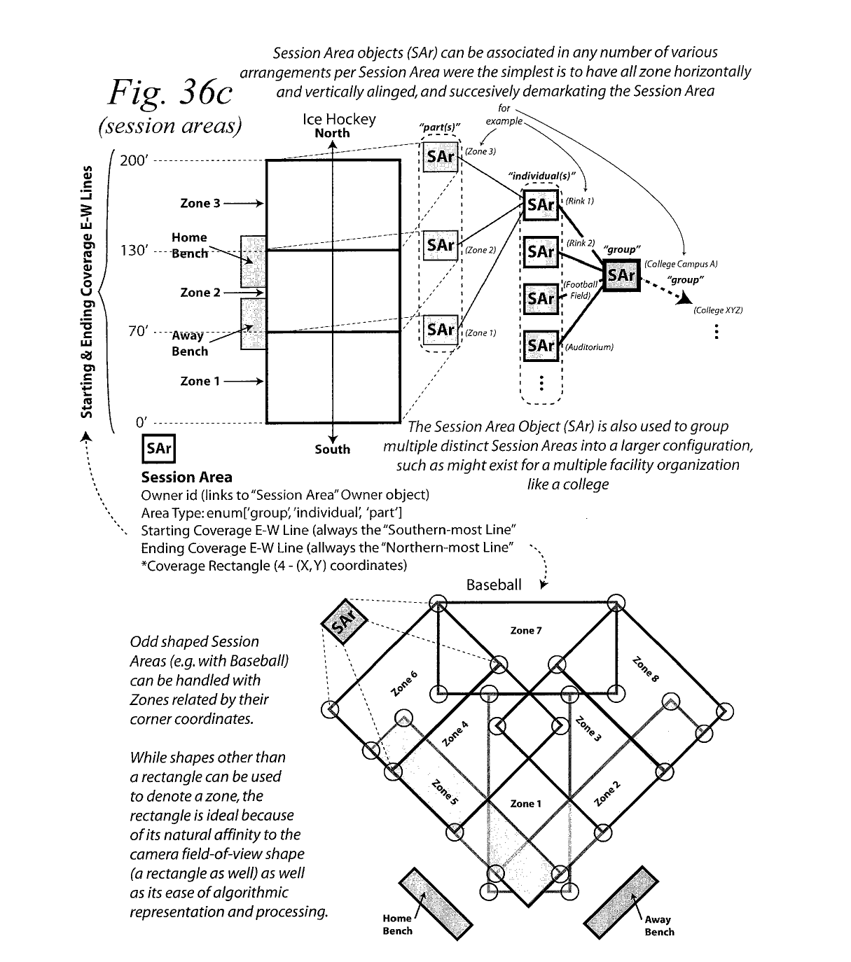

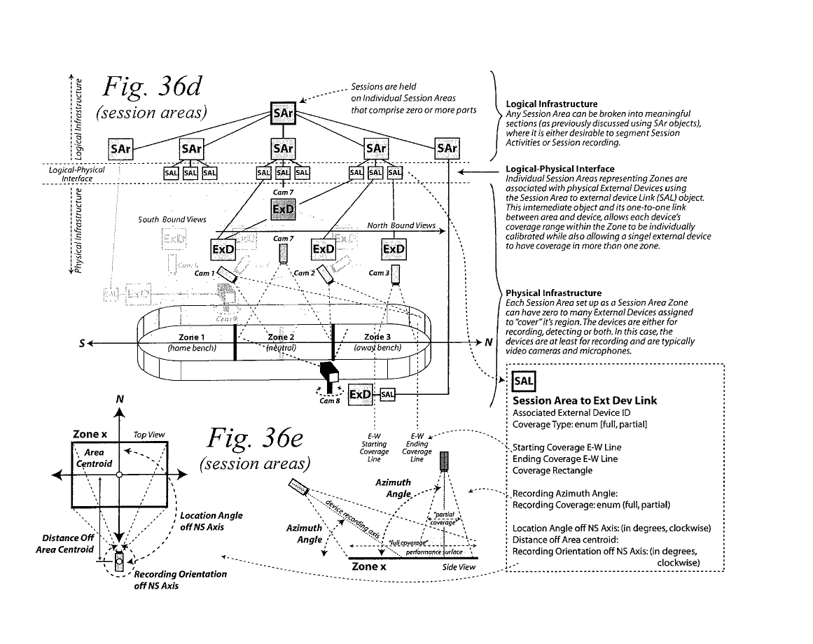

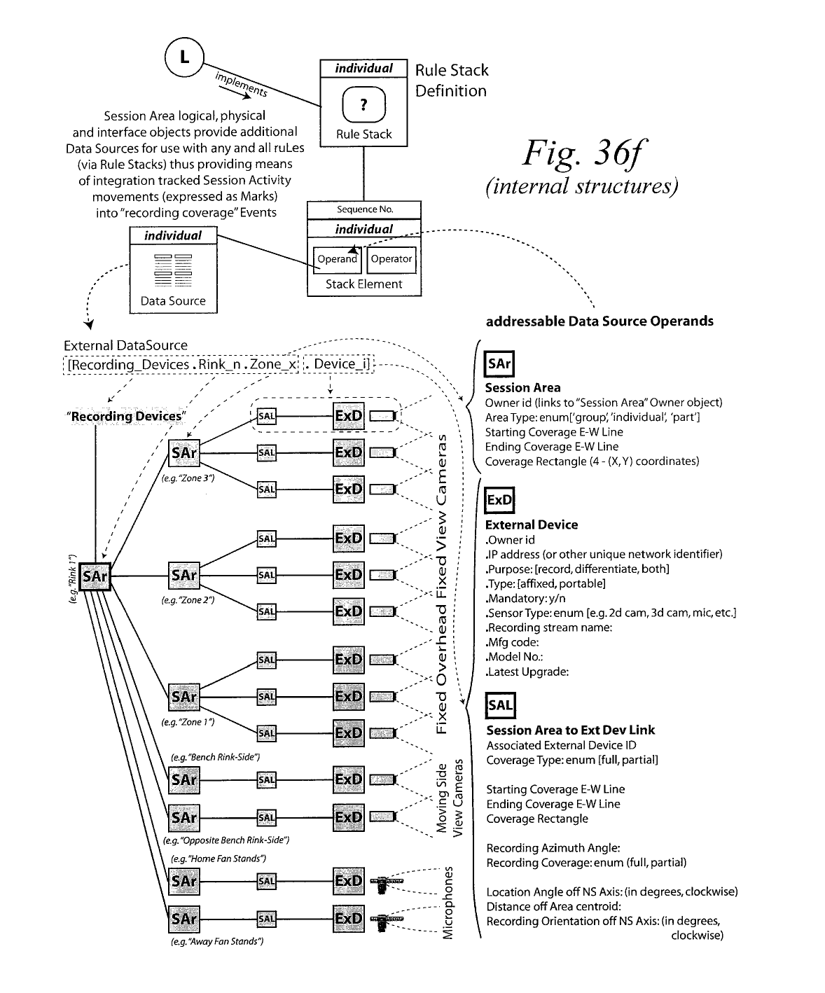

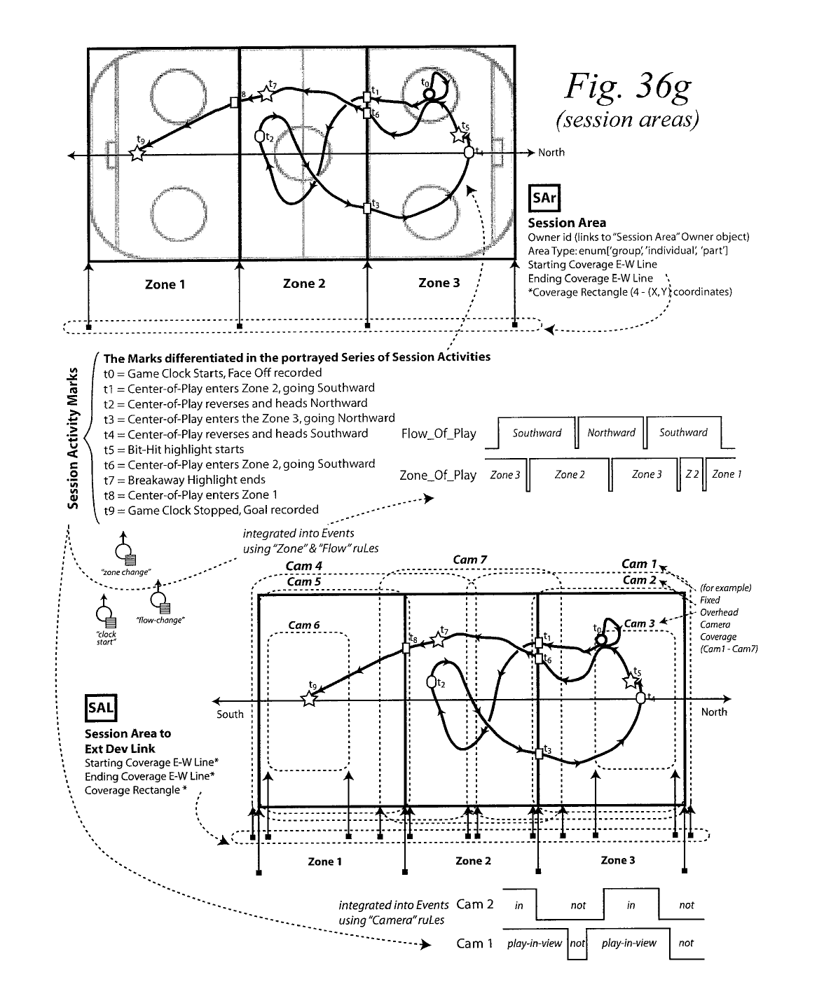

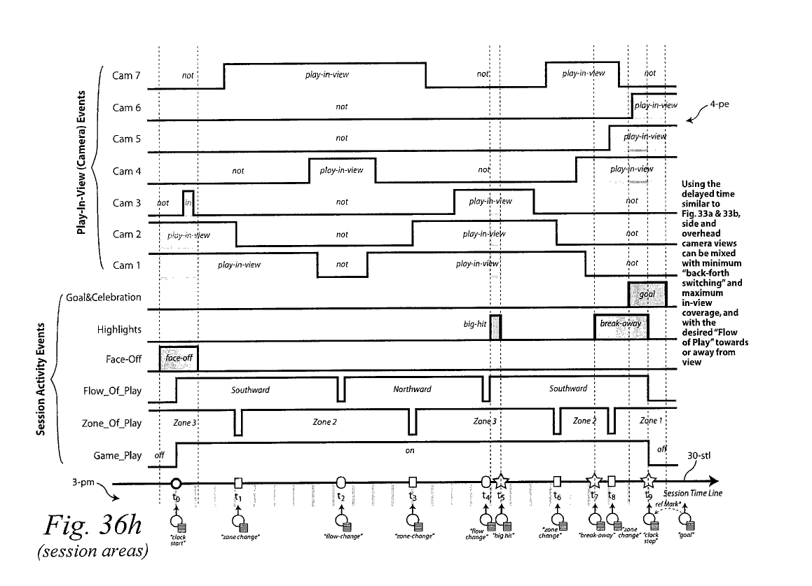

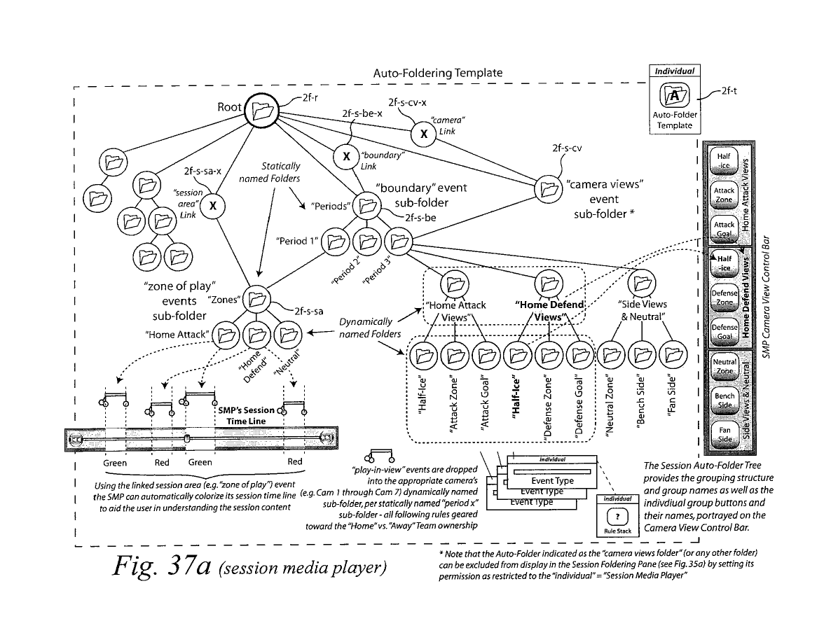

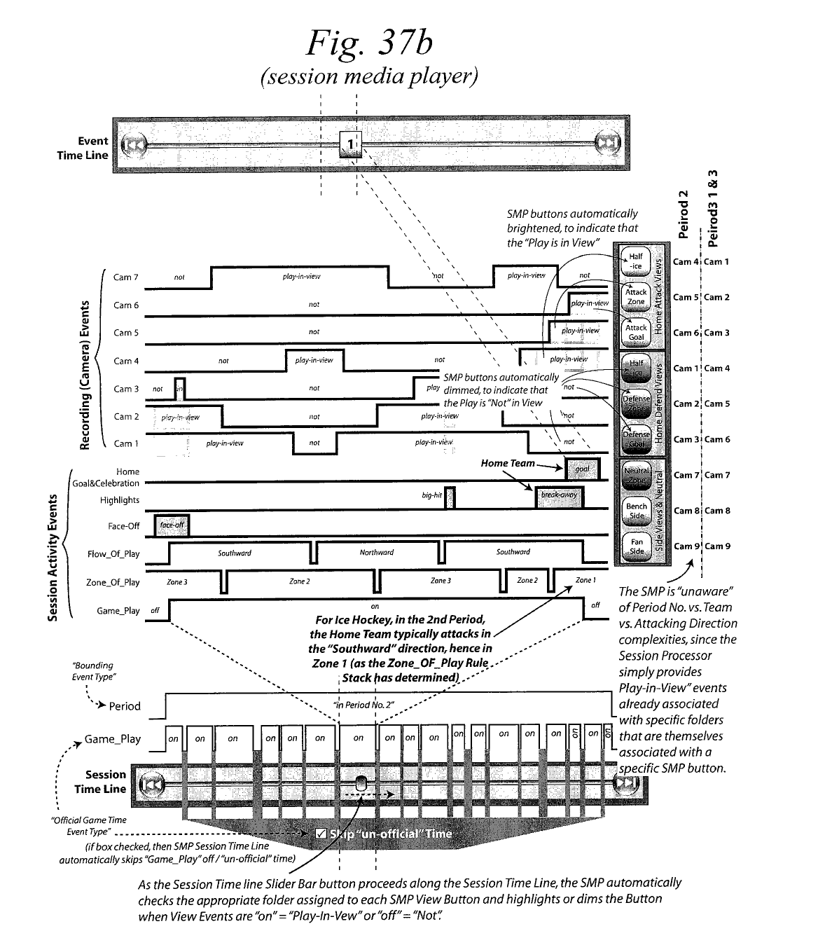

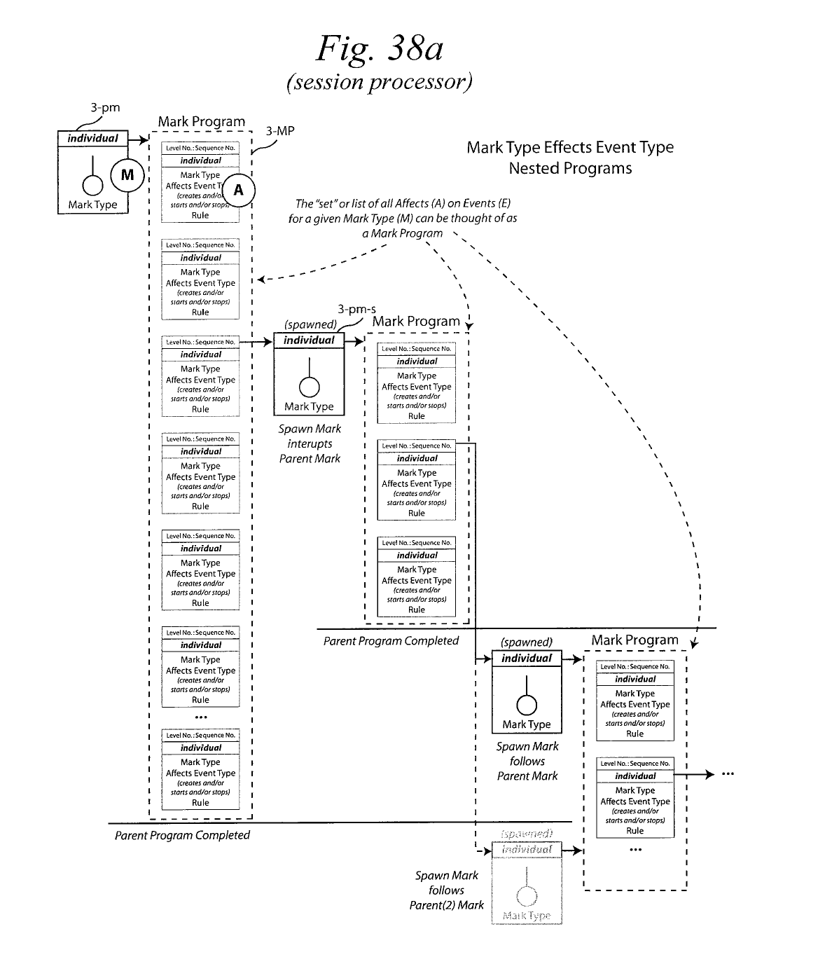

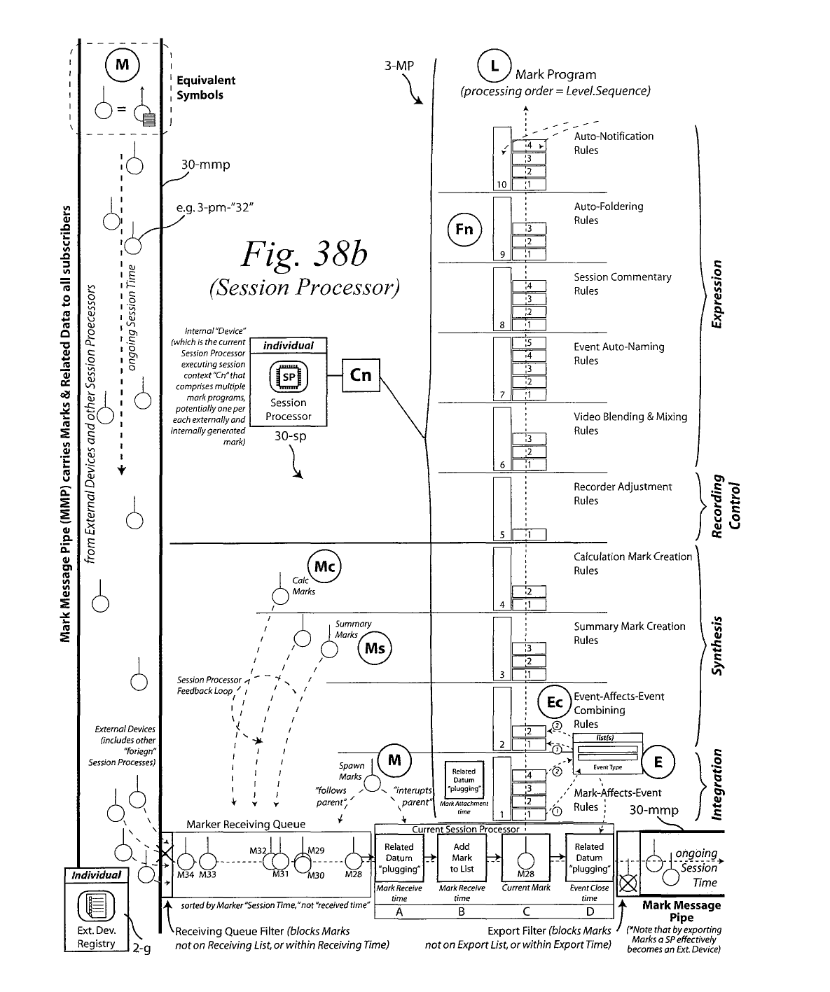

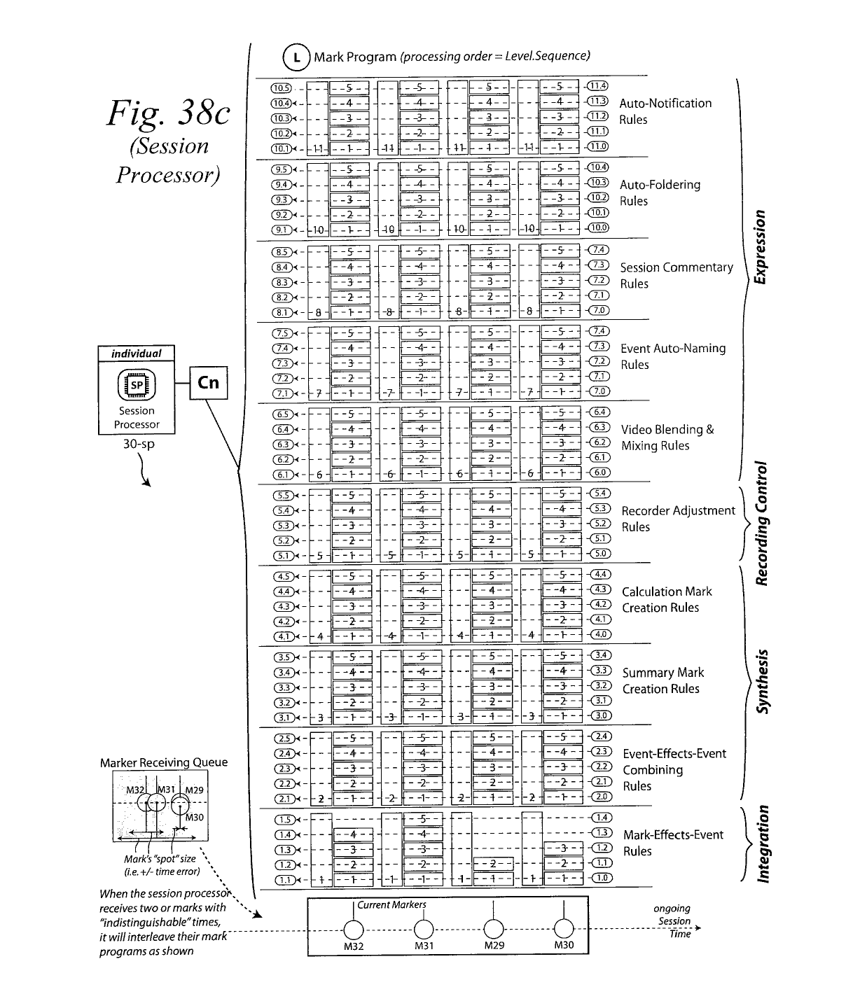

Each of the patent's various figures carries its appropriate category name (from the above list) in parenthesis just under its figure number. The following list provides all of the patent figures sorted in order within their appropriate category, forming a helpful index into the figures and specification.
“(system)” figures include:
   FIG. 1a through FIG. 7
   FIG. 12
“(external devices)” figures include:
   FIG. 8 through FIG. 11c
   FIG. 13a through FIG. 14
“(differentiation)” figures include:
   FIG. 15a through FIG. 15e
“(tracked objects)” figures include:
   FIG. 16a through FIG. 19b
“(data objects)” figures include:
   FIG. 20a through FIG. 20e
   FIG. 22a and FIG. 22b
“(internal structures”) figures include:
   FIG. 19c (in reference to the “tracked objects”)
   FIG. 21a through FIG. 21c (in reference to the “tracked objects”)
   FIG. 23a (in reference to the “Session Processing Language”)
   FIG. 23b (in reference to the “Context Data Dictionary”)
   FIG. 23c and FIG. 23d (in reference to the “differentiator”)
   FIG. 23e through FIG. 24d (in reference to the “integrator”)
   FIG. 27 (in reference to the “synthesizer”)
   FIG. 29 (in reference to the “synthesizer”)
   FIG. 31 (in reference to the “synthesizer”)
   FIG. 33 (in reference to the “expresser”)
   FIG. 34b (in reference to the “expresser”)
   FIG. 36f (in reference to “session areas”)
“(integrator)” figures include:
   FIG. 25a through FIG. 26c
“(synthesizer)” figures include:
   FIG. 28a through FIG. 28d
   FIG. 30a and FIG. 30b
“(recording compressor”) figures include:
   FIG. 32a through FIG. 32c
“(expresser)” figures include:
   FIG. 34a
“(session media player)” figures include:
   FIG. 35a through FIG. 35d
   FIG. 37a and FIG. 37b
“(session areas)” figures include:
   FIG. 36a through FIG. 36e
   FIG. 36g and FIG. 36h
“(session processor)” figures include:
   FIG. 38a through FIG. 38c

Given the state of the art in detectors, recorders, networks, both wired and wireless, time synchronization techniques for coordinating disparate data sources, computer systems, object oriented languages, data storage systems, compression algorithms and in general automated systems, it is possible to create the preferred system for automatically translating any disorganized content into contextualized, organized content following externalized rules.

### OBJECTS AND ADVANTAGES

Therefore, the present invention has at least the following objects and advantages:
1. the homogenization of otherwise disparate data streams created by various existing and novel apparatus, themselves built from differing core technologies, resulting in the formation of both a stream of universal normalized periodic object tracking data regarding the continuous session activities, as well as a stream of universal normalized aperiodic observation data regarding distinct human and/or machine observations of the session activities;
2. apparatus and methods controllable via external rules for differentiating the stream of periodic object tracking data into the stream of aperiodic observation data;
3. apparatus and methods controllable via external rules for integrating the stream of observations into content segments spanning some duration of session time and each representing some consistent session activity;
4. apparatus and methods controllable via external rules for synthesizing the stream of observations and their integrated content segments, via convolution, summarization and calculation into further observations and content segments;
5. apparatus and methods controllable via external rules for expressing descriptions about the observations and content segments and for organizing the segments into various foldering systems;
6. apparatus and methods controllable via external rules for directing the mixing and blending of session recordings in response to the ongoing creation of observations and segments;
7. apparatus for interactive use for recalling recording content via the foldered content segments tightly integrated with the observations and segments and further capable of recording additional user observations for feedback into the integration, synthesis and expression apparatus and methods, and
8. the establishment of a session processing language forming a session agnostic and universal marketplace tool for expressing all tracked object data, observation data, content segment data, foldering systems as well as external rules for governing all apparatus and methods for the integration, synthesis, expression, mixing and blending of session content.

As will be apparent to those familiar with the various marketplaces and technologies discussed herein, portions of the present invention are useful individually or in lesser combinations than the entire scope of the aforementioned objects and advantages. Furthermore, while the apparatus and methods are exemplified with respect to the sport of ice hockey, as will be obvious to the skilled reader, there are no restrictions on the application of the present teachings, whether to other sports, music, theatre, education, security, business, etc., and in general to any ongoing measurable activities, real, virtual, abstract, animate or inanimate, without limitation. Still further objects and advantages of the present invention will become apparent from a consideration of the drawings and ensuing description.

### DESCRIPTIONS OF THE DRAWINGS

(system) FIG. 1a and FIG. 1b are block diagrams describing the problem space at its most abstract level in order to define the minimum set of content language from which agnostic content contextualization can be taught.

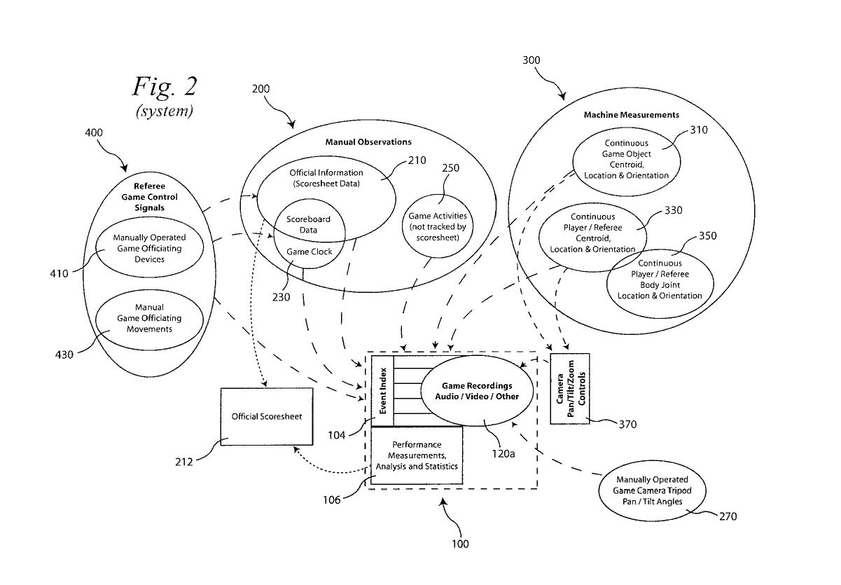

(system) FIG. 2 is a block diagram describing the problem space at a mid-level using a sporting event as an example in order to define the minimum set of sub-categories of content from which agnostic content contextualization can be taught.

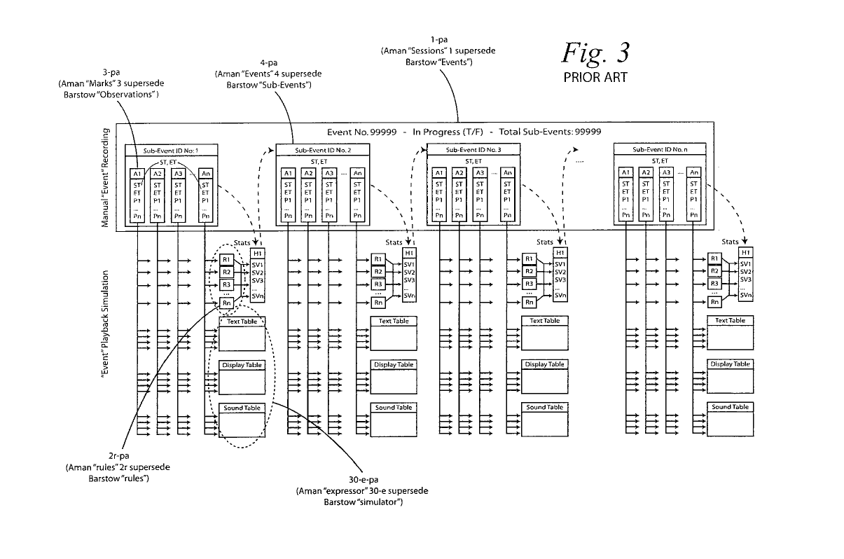

(system) FIG. 3 (prior art) is a block diagram drawn from U.S. Pat. No. 6,204,862 B1, as taught by Barstow et al., depicting a current approach to content contextualization structured around the sport of baseball.

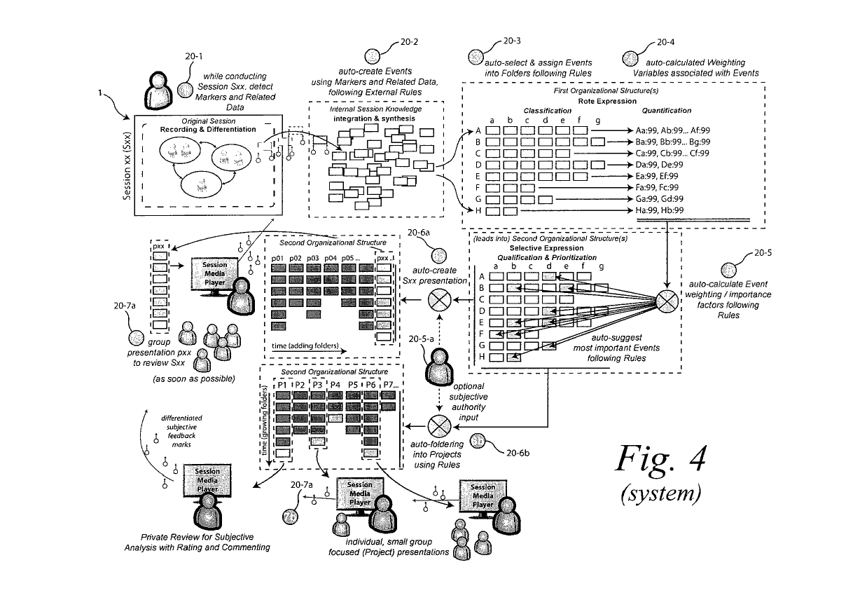

(system) FIG. 4 is a block diagram describing the solution space at its most abstract level in order to define the minimum set of contextualization language for use when teaching agnostic content contextualization.

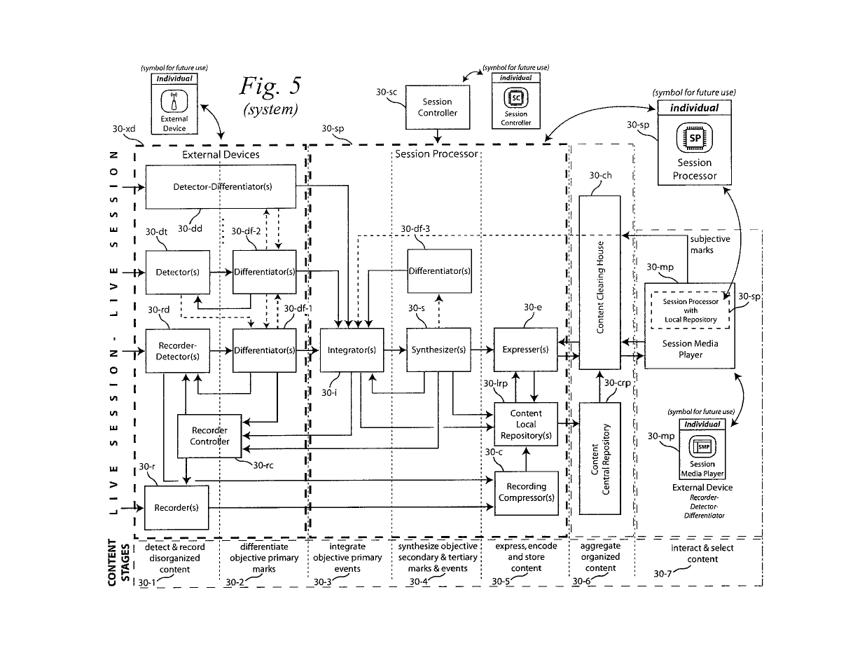

(system) FIG. 5 is a block diagram of the preferred invention from a task perspective, showing at the highest levels the various parts and their relationships necessary for agnostic content contextualization starting with a live session of disorganized content as input and ending with contextualized organized content that is interactively retrievable.

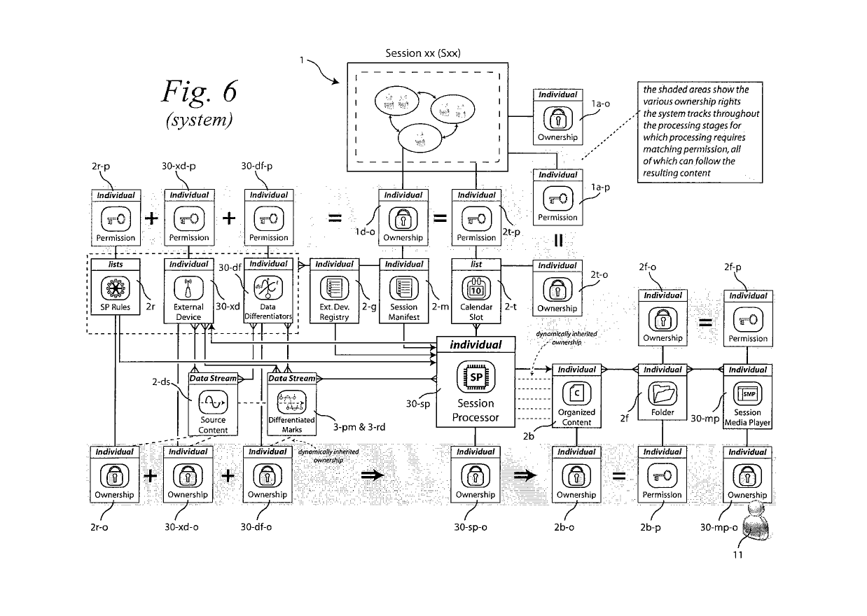

(system) FIG. 6 is a block diagram of the preferred invention from a content ownership perspective, showing at the highest levels the various parts and their relationships necessary for agnostic content contextualization starting with a live session of disorganized content as input and ending with contextualized organized content that is interactively retrievable.

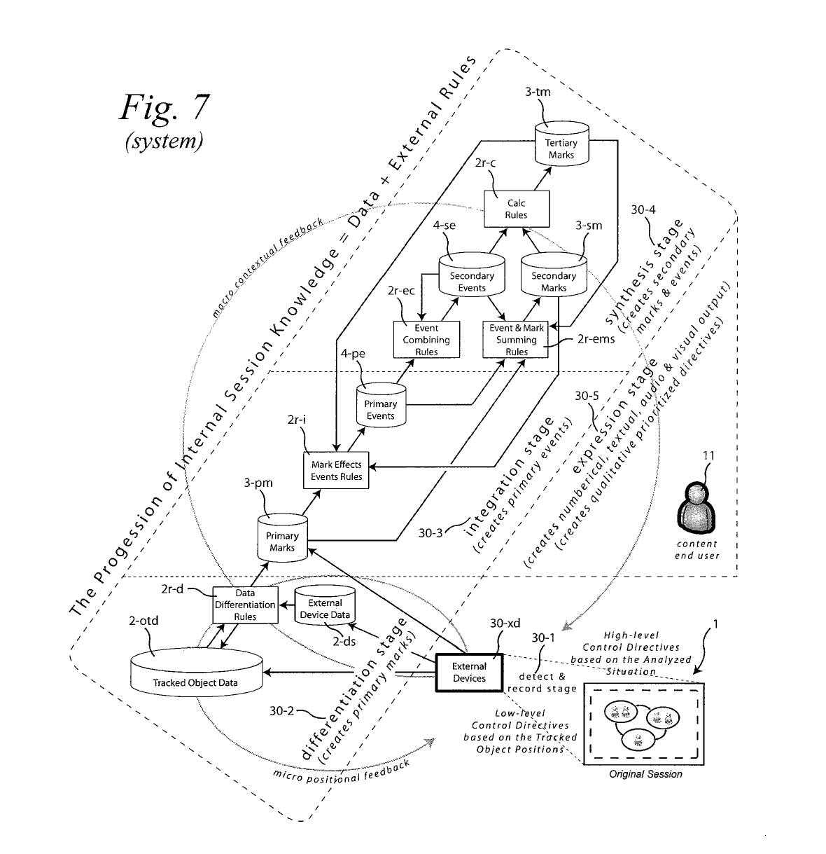

(system) FIG. 7 is a block diagram of the preferred invention from a data structure perspective, showing at the highest levels the various parts and their relationships necessary for agnostic content contextualization starting with a live session of disorganized content as input and ending with contextualized organized content that is interactively retrievable.

(external devices) FIG. 8 is a block diagram showing two fundamental alternative technologies for generating real-time movement data from a live session, namely machine vision and RF triangulation. Both types of movement tracking feed the same (normalized) tracked object database from which rules-based differentiation detects activity edges and creates marks along the session time line for subsequent integration into the event index.

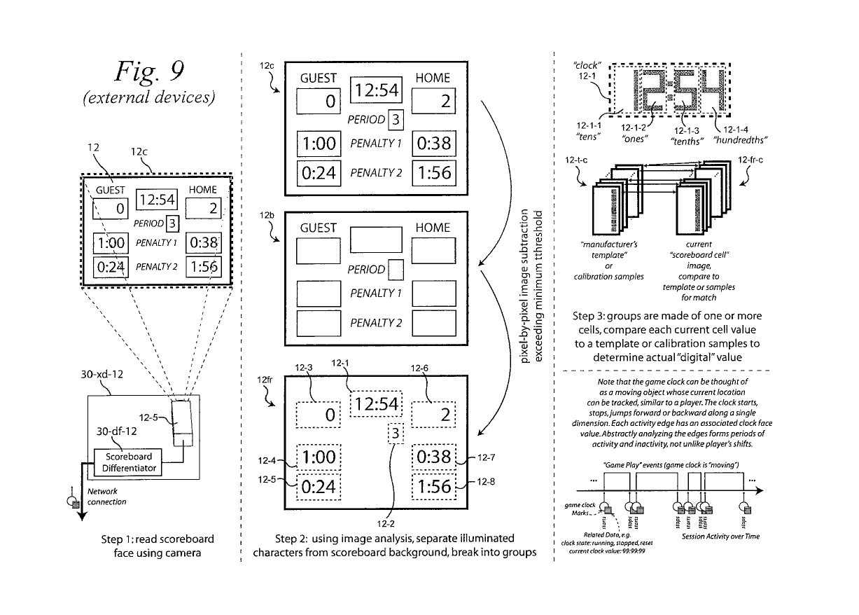

(external devices) FIG. 9 is a block diagram showing the preferred technology for detecting sporting scoreboard movements, namely machine vision. The scoreboard movement data is not stored as tracked object data, but rather directly differentiated using embedded logic that detects activity edges and creates marks along the session time line for subsequent integration into the event index.

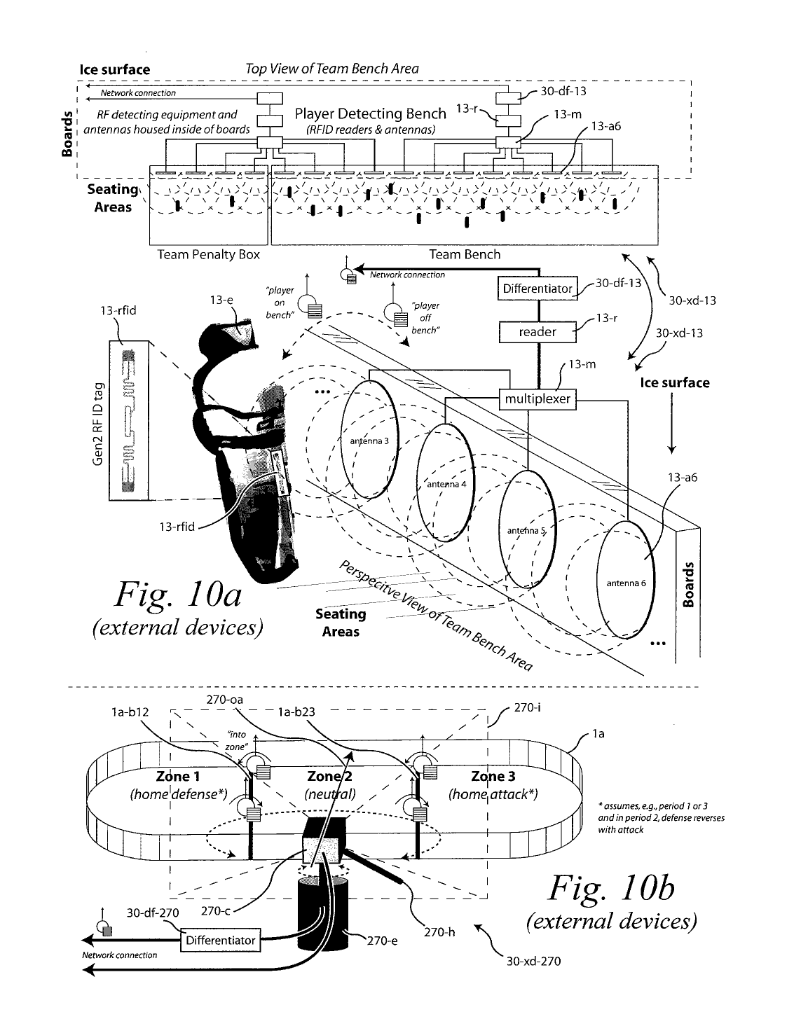

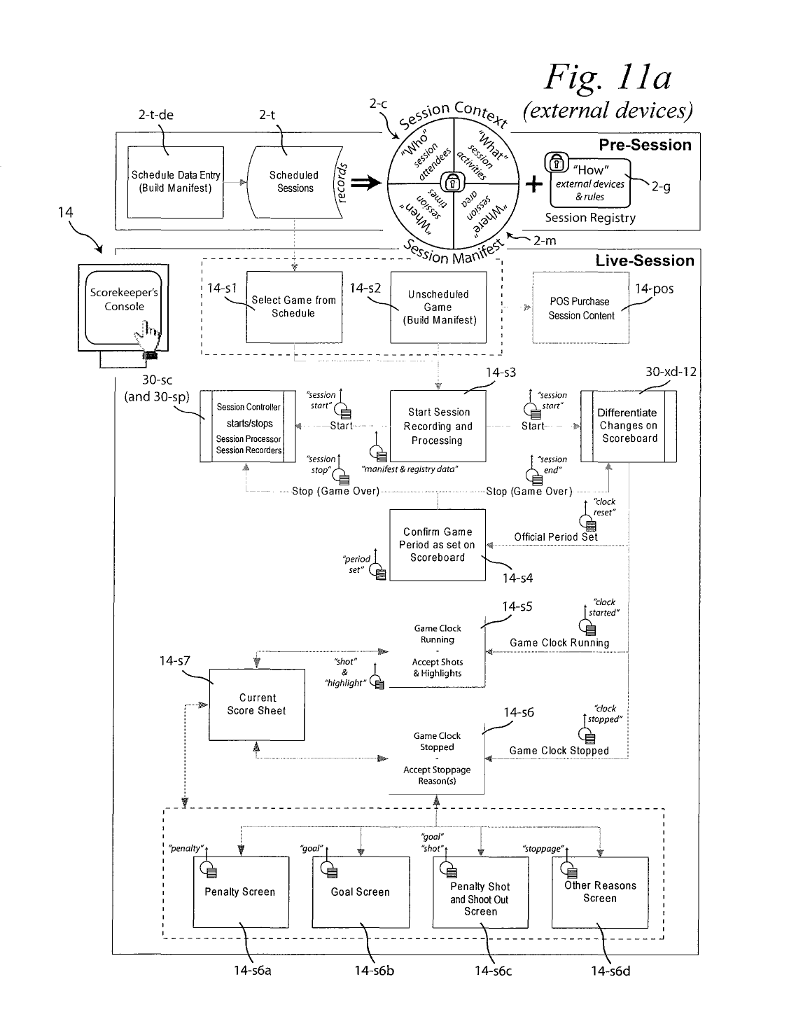

(external devices) FIG. 10a is a perspective drawing showing an example technology for detecting player presence movements on a team bench, namely passive RF. The player presence movement data is not stored as tracked object data, but rather directly differentiated using embedded logic that detects activity edges and creates marks along the session time line for subsequent integration into the event index.

(external devices) FIG. 10b is a perspective drawing showing an example technology for detecting center-of-activity movements, namely optical shaft encoders. The center-of-activity movement data is not stored as tracked object data, but rather directly differentiated using embedded logic that detects activity edges and creates marks along the session time line for subsequent integration into the event index.

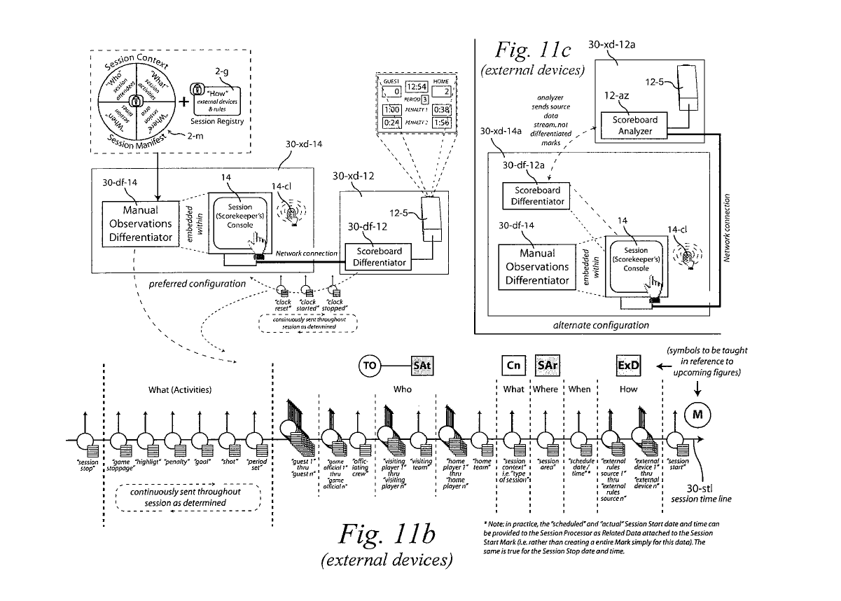

(external devices) FIG. 11a is a block diagram showing the preferred apparatus and methods for accepting manual session observations (e.g. scorekeeping data.) The manual session observation data is both subjective and aperiodic, unlike the objective periodic tracked object data, and it is differentiated using embedded logic that interacts directly with the manual observer and creates marks along the session time line for subsequent integration into the event index.

(external devices) FIG. 11b is a block diagram showing the scoreboard differentiator (from FIG. 9) providing data to the scorekeeper's console (from FIG. 11a.) The differentiated “clock started,” “stopped” and “reset” states are use to automatically select data entry screens on the scorekeeper's console. This figure also reviews the preferred normalized marks that are issued by the scorekeeper's console to the session processor.

(external devices) FIG. 11c is an alternate arrangement to FIG. 11b where the scoreboard differentiator is placed within the scorekeeper's console.

(system) FIG. 12 is an example configuration for the sport of ice hockey of a complete working system including recording cameras, a scoreboard differentiator, a scorekeeper's console, a player presence detecting bench, a center-of-activity detecting tripod and a server for receiving all differentiated object tracking data and marks and then using this to contextualize and organize the recorded content via the session processor.

(external devices) FIG. 13a is a perspective drawing showing an example technology for detecting referee movements including hand motions and whistle blows, namely MEMs. The referee movement data is not stored as tracked object data, but rather directly differentiated using embedded logic that detects activity edges and creates marks along the session time line for subsequent integration into the event index.

(external devices) FIG. 13b is a perspective drawing showing an example technology for detecting baseball umpire observations, namely a wireless clicker with readout. The umpire observation data is not stored as tracked object data, but rather directly differentiated using embedded logic that detects activity edges and creates marks along the session time line for subsequent integration into the event index.

(external devices) FIG. 13c is a perspective drawing showing an example technology for detecting baseball pitch speeds, namely a fixed, unattended radar gun. The pitch speed data is not stored as tracked object data, but rather directly differentiated using embedded logic that detects activity edges and creates marks along the session time line for subsequent integration into the event index.

(external devices) FIG. 14 is a block diagram showing the buildup from a simple external device that senses activity and outputs raw content, to a differentiating external device that additionally differentiates raw content using embedded logic and outputs marks, to programmable differentiating external device that inputs external differentiation rules to programmatically alter and control the detecting of activity edges within the raw content for issuing marks, to programmable differentiating external device with object tracking that additionally outputs periodic tracking data sampled from the raw content.

(differentiation) FIG. 15a is a graph showing single-feature fixed-threshold differentiation, where marks are issued as a single feature of an object varies overtime with respect to a fixed threshold.

(differentiation) FIG. 15b is a graph showing single-feature varying-threshold differentiation that further allows the threshold itself to vary over time based upon the value of a second feature from either the same or a different object, where marks are issued as a single feature of an object varies overtime with respect to a varying threshold.

(differentiation) FIG. 15c is a graph showing multi-feature varying threshold differentiation that further allows one thresholded feature to act as an activation range for a second thresholded feature, where marks are issued as the second feature crosses its threshold within the dynamic activation range.

(differentiation) FIG. 15d is similar to FIG. 15c and serves as a second example of multi-feature differentiation where both features using varying thresholds to create dynamic activation ranges that combine to trigger the issuing of marks.

(differentiation) FIG. 15e shows a four dimensional feature space, e.g. (x, y, z, t), which is broken into three two dimensional feature spaces, e.g. (x, t), (y, t) and (z, t), the result of which may all be differentiated individually.

(tracked objects) FIG. 16a is a top view diagram representing a real ice hockey player, their stick and a puck, showing their possible geometric representation within the present invention, based upon object features measured by external devices over the length of session time and stored as object tracking data.

(tracked objects) FIG. 16b is a top view diagram representing an abstract puck-player lane formed between a real player and real puck, showing its possible geometric representation within the present invention, based upon object features measured by external devices over the length of session time and stored as object tracking data.

(tracked objects) FIG. 16c is a top view diagram representing an abstract player-player lane formed between any two real players, showing its possible geometric representation within the present invention, based upon object features measured by external devices over the length of session time and stored as object tracking data.

(tracked objects) FIG. 16d is a top view diagram representing an abstract view of all player-player lanes available to a player with puck possession, where some lanes are determinably “in view” and other are not, showing their possible geometric representation within the present invention, based upon object features measured by external devices over the length of session time and stored as object tracking data.

(tracked objects) FIG. 16e is a top view diagram representing an abstract pinching lane formed between an opposing player and a player-player lane formed between two teammates, showing its possible geometric representation within the present invention, based upon object features measured by external devices over the length of session time and stored as object tracking data.

(tracked objects) FIG. 16f is a top view diagram representing an abstract view of all player-player lanes available to a player with puck possession, where some lanes are determinably “in view” and other are not, surrounded by opponent pinching lanes, showing their possible geometric representation within the present invention, based upon object features measured by external devices over the length of session time and stored as object tracking data.

(tracked objects) FIG. 16g is a top view diagram representing a real ice hockey rink, along with its normal distinctive features such as zone lines, goal lines, circles and face off dots, showing their possible geometric representation within the present invention, based upon object features measured by external devices over the length of session time and stored as object tracking data.

(tracked objects) FIG. 16h is a top view diagram representing an abstract shooting lane formed between a real player-puck and a real rink location, showing their possible geometric representation within the present invention, based upon object features measured by external devices over the length of session time and stored as object tracking data.

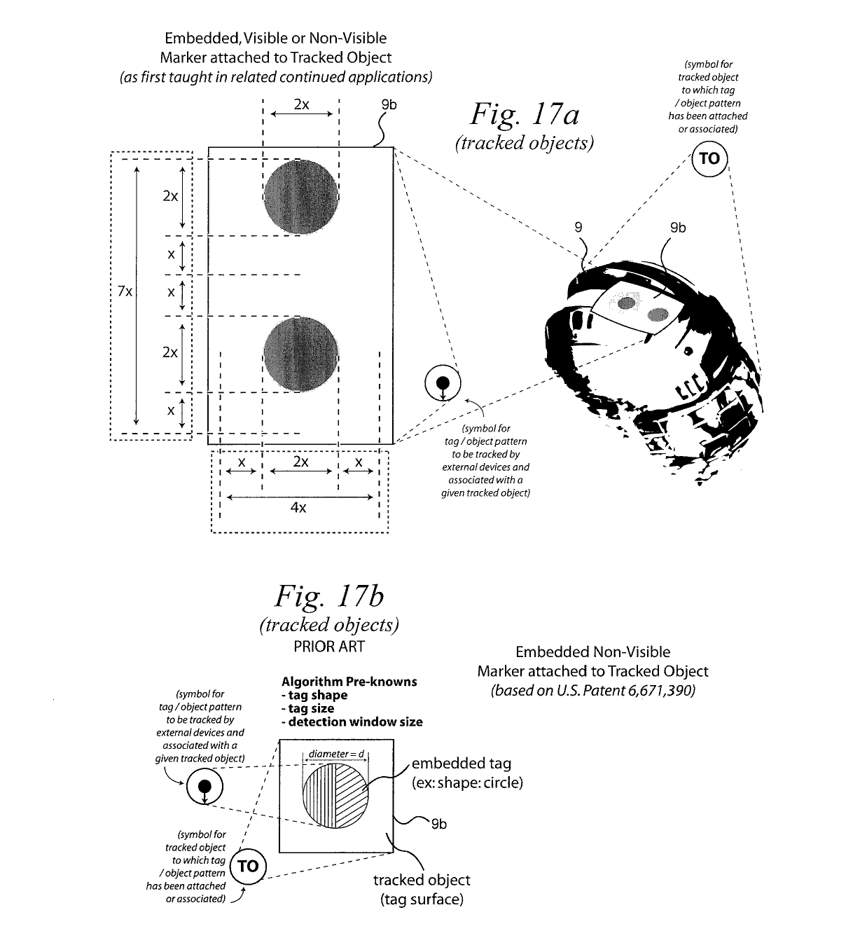

(tracked objects) FIG. 17a is a schematic diagram showing an arrangement for either a visible or non-visible marker to be embedded onto a surface of an object to be tracked, as first taught in prior applications by the present inventors. The marker is designed to provide three dimensional location and orientation using the appropriate three dimensional machine vision techniques, such as stereoscopic imaging.

(tracked objects) FIG. 17b is a schematic diagram of a proposed embedded, non-visible marker arrangement preferably made from compounds taught by Barbour in U.S. Pat. No. 6,671,390. This particular marker has the advantage a higher ID encoding within a smaller physical area especially because its operating technique is based upon differentiation of the spatial phase, rather than the frequency properties of the electromagnetic energy reflected of the marker.

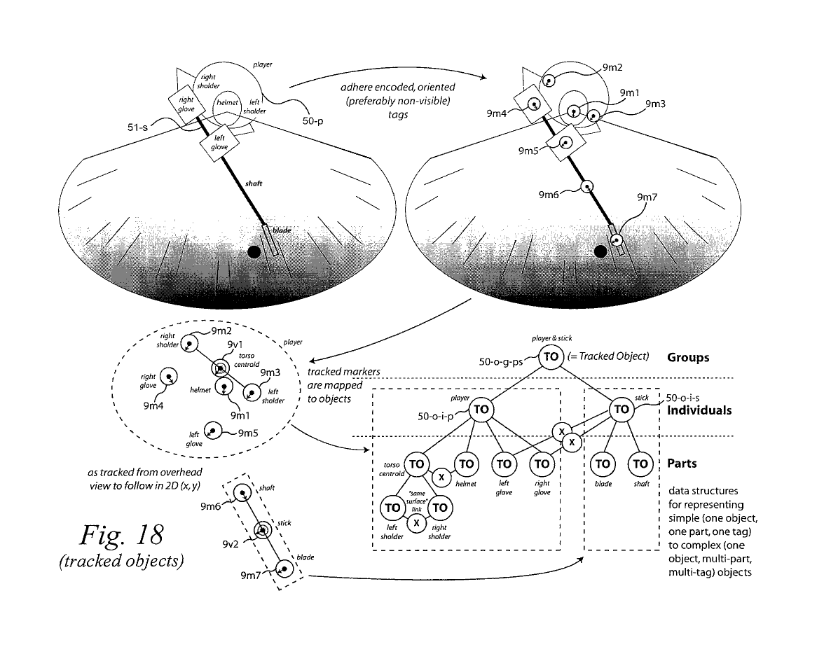

(tracked objects) FIG. 18 first includes a top view illustration showing an arrangement of non-visible markers embedded onto an ice hockey player for easiest detection from an overhead grid of cameras, and primarily for tracking in two dimensions. Below this, the physical arrangement of markers is shown translated into a node diagram for implementation in a normalized, abstracted object representation dataset.

(tracked objects) FIG. 19a expands upon FIG. 18 to show a perspective view of an ice hockey player were markers are additionally placed on key body joints that are further detected using controlled side-view cameras, thus expanding the object tracking data set to three dimensions.

(tracked objects) FIG. 19b shows the translation of the physical objects portrayed in FIG. 19a into a node diagram similar to that shown at the bottom of FIG. 18 and useful for creating a normalized, abstracted database for later object movement differentiation.

(tracked objects) FIG. 19c recasts the node diagram taught in FIG. 19b in a more structured view showing the cascading inter-relationships between individual external devices (e.g. cameras) that form groups (hubs,) whose information is then used to track groups of attendees, which are made up of individual attendees, who each comprise parts, where each part carries a uniquely identifying pattern responsive in some frequency domain (such as visible light, IR or RF.)

(data objects) FIG. 20a is a diagram introducing the present inventor's symbol for a Core Object along with the preferred set of minimal data. The core object serves as a base kind for all other objects taught in the present invention including for example tracked objects, marks, events, rule objects and the session itself. Also shown is the Description object, which like all other objects is derived from the base kind core object.

(data objects) FIG. 20b is a diagram teaching how the description object can be used to implement localization for any other type of object.

(data objects) FIG. 20c is a diagram introducing some key objects and terminology of a Session Processor Language (SPL), which is useable to express both the structure of the session content as well as the contextualization rules for content processing. Ultimately, all SPL objects represent either content (data) or rules (data.) The present figure teaches the upper tier objects including the Session Object itself at the highest level, and then also the “who,” “what” “where,” “when” and “how” objects.

(data objects) FIG. 20d is a diagram further describing the SPL objects introduced in FIG. 20c along with their preferred additional attributes (data) beyond that inherited from the base kind Core Object.

(data objects) FIG. 20e is a diagram introducing additional key objects and terminology of a Session Processor Language (SPL), focusing on tracked objects.

(internal structures) FIG. 21a is a node diagram that shows the association of key SPL objects introduced in FIG. 20a through 20e, especially as they are implemented to describe the structure of any activity based session in general, and then the session type of ice hockey in particular.

(internal structures) FIG. 21b expands upon FIG. 21a to show greater relational detail focusing on the transformation of observed tracked object datum, first associated with its capturing external device, into features of a session attendee tracked object; all accomplished under the control of differentiation rule sets that govern the steps of detecting, compiling, normalizing, joining and then predicting object datum.

(internal structures) FIG. 21c is a software block diagram showing the preferred implementation of external rules, in this cased used for differentiation. Fundamentally, the implementation draws from the postfix notation and uses a stack of elements to encode operations and operands.

(data objects) FIG. 22a is a diagram introducing additional key objects and terminology of a Session Processor Language (SPL), focusing on internal session knowledge.

(data objects) FIG. 22b is a diagram further describing the SPL objects introduced in FIG. 22a along with their preferred additional attributes (data) beyond that inherited from the base kind Core Object.

(internal structures) FIG. 23a is a node diagram showing a comprehensive high-level view of the main objects comprising the Session Processing Language (SPL) as they span the functions from Governance (external rules), to Information (sources of session content), to Knowledge (internal session knowledge), to Aggregation (session context and identity).

(internal structures) FIG. 23b is a combination node diagram with a corresponding block diagram detailing the context datum dictionary objects that are used to define all possible context datum that can be known about any conducted session governed by the aggregating session context.

(internal structures) FIG. 23c is a combination node diagram with a corresponding block diagram detailing the first object (a mark) of internal session knowledge and how it and its related datum associated with the context datum dictionary.

(internal structures) FIG. 23d is a block diagram detailing the session manifest as it relates to the default mark set to be used for describing especially the session attendees.

(internal structures) FIG. 23e is a combination node diagram with a corresponding block diagram detailing the relationship between the two internal information objects, namely the mark and the event, and specifically how the mark “affects” the event by creating, starting and stopping it.

(internal structures) FIG. 24a is a node diagram showing the associations between a create, start and stop mark and an event, each governed by a rule.

(internal structures) FIG. 24b is a node diagram showing that each of the two internal system knowledge objects, namely the mark and event, have corresponding list objects that track each instance of an actual occurrence received or instantiated during the processing of a session.

(internal structures) FIG. 24c is a node diagram showing how the event list of FIG. 24b has three views of created, started and stopped events, and how the effects of marks move any given event between these event list views.

(internal structures) FIG. 24d is a software block diagram repeating the preferred implementation of external rules first depicted in FIG. 21c with respect to differentiation. In this case, external rules are in relation to integration and as such the data source objects are internal session knowledge objects rather than tracked objects. The tope of FIG. 24d is identical in depiction and specification to 21c and represents a variation of postfix notation using a stack of elements to encode operations and operands.

(integrator) FIGS. 25a through 25j use the mark-to-event symbols and format especially shown in FIG. 24a to teach a series of nine cases, or examples, of how one or more marks issued by external device(s) create, start and stop different events. The specific examples are drawn from ice hockey, but in general teach the concepts of external rules based integration of marks into events, including the use of internally spawned marks and reference marks, both of which are used to alter the start and stop times of an event.

(integrator) FIG. 26a through 26c are a combination of table data and corresponding “event waveforms,” where each waveform is continuous over the session time and represents a single event type comprising zero or more event type instances. With respect to the waveform view of an event type, an event type instance is any continuous non-zero or “on” portion of the wave whose leading (or “start”) edge goes from 0 to 1, and whose trailing (or “stop”) edge goes from 1 to 0 (especially corresponding to FIGS. 24a through 24c.)

(internal structures) FIG. 27 is a combination node diagram with a corresponding block diagram detailing the relationship between two variations of the event object, namely the “primary” and “secondary” event, and specifically how two or more primary events (waveforms) are to be combined to form the secondary event (waveform).

(synthesizer) FIG. 28a is combination digital waveform diagram with accompanying table being used to introduce and define the terms of: serial vs. parallel events as well as continuous vs. discontinuous events.

(synthesizer) FIG. 28b is a diagram relating some of the event combining objects first taught in FIG. 27 with example input (primary) combining events and their resulting output (secondary) combined event, specifically for the “exclusive”/“ANDing” waveform convolution method.

(synthesizer) FIG. 28c is a diagram relating some of the event combining objects first taught in FIG. 27 with example input (primary) combining events and their resulting output (secondary) combined event, specifically for the “inclusive”/“ORing” waveform convolution method.

(synthesizer) FIG. 28d is a diagram teaching various options for determining if a non-triggering event is to be convolved (i.e. combined) with a triggering event for the “inclusive”/“ORing” waveform convolution method.

(internal structures) FIG. 29 is a combination node diagram with a corresponding block diagram detailing the relationship between the mark and event objects for specifying “secondary” (“summary”) marks.

(synthesizer) FIG. 30a is a block diagram depicting the summarization of marks (M) within a valid container (E) for the issuing of new secondary (summary) mark (Ms).

(synthesizer) FIG. 30b is a block diagram depicting the summarization of events (E) within a valid container (E).

(internal structures) FIG. 31 is a combination node diagram with a corresponding block diagram detailing the relationship between the mark and event objects for specifying “tertiary” (“calculation”) marks.

(recording compressor) FIGS. 32a and 32b are block diagrams depicting the concurrent flow of differentiated marks into the session processor, and image frames into a session recording synchronizer—frame buffer—compressor. The same differentiated marks that are integrated and synthesized by the session processor into new events and marks, are used as is or in combination with newly generated session processor events and marks to controllably direct the flow of image frames into and out of the frame buffer for mixing, blending clipping and compression.

(recording compressor) FIG. 32c is a block diagram that builds off of FIGS. 32a and 32b into order to add to the depiction of concurrent flow, multiple frame buffers as well as two concurrent broadcast mixes being output as concurrent external devices are capturing recordings and producing differentiated marks.

(internal structures) FIG. 33 is a combination node diagram with a corresponding block diagram detailing the relationship between an event and a special type of rule called a “descriptor,” or event naming rule, which is one aspect of event expression that covers the automatic naming and description of each actual event instance.

(expresser) FIG. 34a is a block diagram showing how internal session knowledge is automatically organized via dynamic association with foldering trees as governed by pre-established auto-foldering templates, the entire process of which includes the understanding of both content and folder tree ownership, thus supporting the subsequent controlled, permission based access to the organized, foldered content via the session media player.

(internal structures) FIG. 34b is a combination node diagram with a corresponding block diagram detailing the auto-foldering template object structure as well as its relationship to both the session manifest and the session media player.

(session media player) FIG. 35a is a block diagram showing a preferred screen layout for the session media player which allows a user to recall session content via the automatically populated foldering trees. This figure concentrates on the relationship between one or more foldering trees and the media player's session foldering pane.

(session media player) FIG. 35b continues the description of the session media player started in FIG. 35a, now with a focus on the media player's video display bar and session time line, that are both automatically driven by the selected foldering tree from the foldering pane.

(session media player) FIG. 35c continues the description of the session media player started in FIG. 35a and continued in 35b, now with a focus on the media player's event time line, that is automatically driven as the user moves about within a foldering tree, and also automatically integrates with both the video display bar and session time line.

(session media player) FIG. 35d continues the description of the session media, now in reference to the media player's event time line, focused on the individual event and its automatically generated “prose” description.

(session areas) FIG. 36a is a series of top-view architectural style diagrams showing six example session areas with respect to sporting events.

(session areas) FIG. 36b is a matching series of top-view block diagrams showing the six session areas of FIG. 36a, now sub-divided into the preferred “physical” video recording areas for both capturing useful video content (i.e. “good angles,”) and for collecting video for useful object tracking via machine vision/image analysis.

(session areas) FIG. 36c depicts the top-view block diagrams for two of the example sport session areas, along with the introduction of SPL objects logically representing each sub-area (similar to how FIG. 19b logically defined session attendee “sub-areas” or body joints with individual SPL objects.)

(session areas) FIG. 36d is a combination perspective view of one of the example session areas (specifically an ice hockey rink,) along with the structural layout of SPL objects holding its representation for the session processor. This figure is similar to a combination of FIGS. 19b and 19c and accomplishes the same purposes of teaching the “physical/logical” interface between the session area (vs. session attendees) and the SPL objects that carry its meaning.

(internal structures) FIG. 36f is a software block diagram expanding upon the external rules data sources discussed in relation to FIG. 24d. Specifically, examples are shown of how the logical SPL objects portrayed in FIG. 36d carry important relevant data for use by both the external devices and session processor when carrying out session activity differentiation, integration and synthesis.

(session areas) FIG. 36g is a top-view diagram of the example ice hockey session area focused on teaching how tracked session attendees are relatable to logically represented session sub-areas in order to automatically for useful differentiated events such as “flow-of-play,” “zone-of-play” and “play-in-view” (i.e. of a specific camera) events.

(session areas) FIG. 36h is a waveform diagram overlaying in parallel some various exemplary ice hockey events and preferred marks for integrating some of these, especially in relation to the session areas.

(session media player) FIG. 37a is a block diagram showing how an auto-foldering tree can be used to capture and organize the “play-in-view” of camera x events taught in FIGS. 36g and 36h. This folder tree can be related by folder name to the session media player for automatic correlation of the session time line to which cameras have activity in view.

(session media player) FIG. 37b is a block diagram expanding upon FIG. 37a to protray how the session media player uses “play-in-view” events to dynamically indicate which camera views include session activity at any given moment on the session time line.

(session processor) FIG. 38a is a block diagram showing how mark-affect-event objects are organized into lists by level and sequence (forming a “mark program”,) and which can effectively branch into new lists (mark programs,) via the issuing of the spawn mark.

(session processor) FIG. 38b is a block diagram depicting a mark program with its various levels corresponding to the stages of content processing, being implemented by a session processor in response to incoming marks via the mark message pipe, including the creation of primary and secondary events, secondary and tertiary marks as well as spawn marks.

(session processor) FIG. 38c is a block diagram building upon FIG. 38b and showing how multiple mark programs are processed in parallel when their corresponding marks are received at the same time, given the session time “spot size,” which accounts for potential plus-minus time error(s).

### SPECIFICATION

Referring to FIG. 1a, the present invention teaches that a unique session 1, e.g. session xx, is conducted with a session area 1a, within a session time frame 1b, by session attendees 1c, such as actor 1, actor 2, etc, where these actors conduct session activities 1d over the session time 1b. During session 1, one or more recording devices 1r such as microphones 1ra or cameras 1rv are preferably running to detect and record the attendees 1c conducting activities 1d initially in the form of disorganized session content 2a. Session area la can be any physical location such as a sporting venue, a classroom or a backyard. Session time frame 1b can be any successive time interval, where this is continuous, such as a sporting event, a class or a birthday party, or discontinuous, such as a sport team's season of games, or a semester of classes, or all of a family's birthday parties. Session attendees 1c can be human or non-human, animate or inanimate, hence including objects in sports such as the ball or a stick or in industrial settings such as machine. Session activities 1d can be any range possible, for example at the same session area 1a, at different session times 1b, the activities 1d could be a sporting event, a band competition or a high school graduation, all of which could have one or more of the same session attendees 1c. Disorganized content 2a must comprise at least one set of data, such as an audio stream from microphone 1ra, or video stream from camera 1rv, but is not otherwise restricted. Hence, the recorded information can be of any form not necessarily one designed for human interactions. And finally, sessions can be real or virtual (or some combination.) In real sessions, the area 1a and attendees 1c being recorded are real, such as a sporting event venue and sport team players. In a virtual session, the area 1a and attendees 1c being recorded are virtual, such as a multi-player video game event conducted on a gaming server with avatars controlled by either the gaming software or a participating game user.

Referring next to FIG. 1b, the present invention teaches that session activities over time are discernable as a series of various session events 4 whose start and stop times are identifiable by session marks 3. Session events 4 then serve as index 2i to content, thereby changing disorganized content 2a into organized content 2b.

Referring next to FIG. 2, the present invention teaches the specific example of a sporting event and the types of data present that ideally support both the disorganized content 2a as well as the index 2i. During the sporting event, it would be typical to expect at least one manually operated game camera 270 to be collecting audio and video game recordings 120a, at this point forming disorganized content 2a. What is desirable is a system capable of detecting or accepting at least the related information of manual observations 200, including official information (scoresheet data) 210, game clock scoreboard data 230 and other game activities (not tracked by scoresheet) 250, such as hits, turnovers, etc. in the sport of ice hockey. It is likewise desirable to detect or accept the related information of referee game control signals 400, including data from manually operated game officiating devices 410, such as an umpire's ball/strike/out clicker, and data representing manual game officiating movements 430, such as hand signals and penalty flags. The present invention addresses means for determining much of this information, some of which already exists in the market, others of which are novel. In addition to desirable information 200 and 400, the present inventor's prior applications already teach automatic machine measurements 300 capable of determining desirable information such as continuous game object(s) centroid location/orientation 310, continuous player/referee centroid location/orientation 330 as well as even more detailed continuous player/referee body joint location/orientation 350. As mentioned in these related applications, and to be repeated and updated herein, other inventors have already taught alternative ways of collecting some of this same data.

What is important is that the present invention teaches a universal protocol that allows information of these varied types, from potentially multiple detectors, to be first received and differentiated individually or in combination into marks 3, which then form a normalized single data stream for integration into events 4, ultimately forming event index 104; again, thereby automatically changing game recordings 120a from disorganized content 2a into organized content 2b. Also in prior related applications, the present inventor taught how machine measurements 300 where sufficient to automatically provide camera pan/tilt/zoom controls 370 thus obviating manually operating camera 270, and how these same machine measurements 300 could be combined with at least game clock data 230 to automatically determine performance, measurements, analysis and statistics 100 as well as producing the official scoresheet 212, especially if confirmed by collecting official scoresheet data 210.

Referring next to FIG. 3, there is depicted a representation of the data structures taught by Barstow et al. in U.S. Pat. No. 6,204,862 B1. There are several important deficiencies with respect to these teaching as related to the present invention. First, Barstrow teaches a fixed three tier structure for content organization, specifically, following his preferred example, an operator viewing a baseball game makes one or more action observations 3-pa that are associated by the observer into sub-events 4-pa, which are then automatically assembled by the system into event 1-pa database. (In loose comparison, the present inventors prefer marks 3 that supersede observations 3-pa, events 4 that supersede sub-events 4-pa and sessions 1 that supersede events 1-pa.) The present invention has no such three tier limit to the nesting and relating of session activities 1d. There are many improvements and differences with the present teaching that allow for more sophisticated session content organization such as unlimited event 4 nesting, something very necessary when comparing, for instance, the sport of ice hockey vs. baseball. One of the most important differences is the teaching of a mark 3 that represents the edge of a particular activity 1d, rather than some duration of activity. In this regard, marks 3 have a single time of mark associated with themselves, rather than a start and end time as conceived by Barstrow for observations 3-pa (all of which will be subsequently taught herein.) As will be understood by a careful reading of the present specification, marks 3 are “programmatically” combinable into joined events 4, where events 4 then have both a start and end time by virtue of their starting and ending marks 3. A careful reading of Barstrow will also make clear the limitation that observations 3-pa are rigid in their nature and not “programmatically” combinable based upon any external rules, but rather the logic for their resulting associations with sub-events is embedded within the system. Hence, observations 3-pa cannot be used to create new and different sub-events 4-pa that were not originally conceived by the manufacturer of the Barstrow system. In comparison, the present invention herein teaches a way that marks 3 may be combined into events 4 without limits caused by the underlying system; i.e. totally in response to externally created rules provided at some future point preferably by the open marketplace. As will also be seen, marks 3 may create, start, stop or associate with zero or more events 4, which are all join relationships not taught or available from Barstrow between observations 3-pa and sub-events 4-pa, thus ultimately allowing for a significantly richer semantic description of the session 1 (Barstow's event 1-pa.) There are many limitations to Barstow's teachings that among other things make his system structurally rigid (3 tiers only,) horizontally non-extensible (therefore within a single session type such as baseball, it is difficult to add new observations and new combinations of observations into new sub-events,) contextually non-portable (therefore the same deployed system cannot be dynamically reapplied to session activities outside the embedded rules domain, e.g. if baseball is embedded, the same system cannot be extended as is into football, ice hockey, plays, music, industry, etc.) non-customizable (regardless of extension, the embedded nature impedes user tailoring,) and locked to single organizational expression (i.e. that “one-embedded-way” only data structures, as opposed to potentially multiple independent contextualization and organization strategies for the same original data stream of marks 3, formed using multiple external rule sets from different authors.) Another significant drawback to Barstow's teachings are the lack of sufficient feedback loops which are highly useful for determining secondary organizational structures based upon qualifications and prioritizations of events 4 (to be discussed in relation to FIG. 4.) Furthermore, this lack of externalized rules effects more than just integration. For example, Barstow also teaches embedded rules 2r-pa for synthesis (what stats to collect,) as well as for his methods of expression 30-e-pa including text output, graphic display and sound output. Other drawbacks of Barstrow and therefore advantages of the present teachings will become apparent to those skilled in the necessary markets and technologies by a careful reading of the specification. Referring next to FIG. 4, there is depicted a series of method steps for the preferred system especially with respect to the second example discussed in the background of the present invention, which is in general to automatically segment recordings from a session 1 into various desired context, based upon relevant activity 1d information that is also the basis for statistical analysis, thereby creating organized content that is indexable by activities 1d and where the video segments correspond to individual statistics. As previously stated and will be apparent by the specification herein, the exact area 1a, time 1b, attendees 1c and nature of activities 1d of the session 1 are immaterial to the teachings of the present invention except in the case where the devices taught for detecting activity 1d edges to become marks 3 are specific to the type of activity 1d. In the present figure, there is no assumption regarding any of the properties of session 1, hence the specific session area 1a, the session time frame 1b, the session attendees 1c or their session activities 1d are immaterial.

Still referring to FIG. 4, in recording & differentiation step 1, 20-1 a session xx 1 is conducted and in at least one way recorded, typically using cameras 1rv and microphones 1ra to form disorganized content 2a (none of which is depicted but matches FIG. 1a and FIG. 1b.) Also in step 1, 20-1, activity detectors that may well include recording devices such as 1r are used to provide data streams that are differentiated to ascertain activity edges which are then normalized into marks 3. In integration & synthesis step 2, 20-2, this asynchronous stream of normalized marks 3 are then conditionally integrated and synthesized to form zero or more events 4, where each event 4 is a continuous segment of session time 1b corresponding to the duration of a specific activity 1d and where any one event 4 may partially, fully or not at all overlap any other event 4. In rote expression Step 3, 20-3, each event 4 is conditionally expressed into a first organizational structure (such as a first computer foldering system for archiving,) a process step of classification. In rote expression step 4, 20-4, which may occur at the same physical time or even before step 3, 20-3, synthesized data such as statistics and calculations are associated with any one or more single events 4, therefore providing further semantic description to their organized positions within the expressed structure. In selective expression step 5, 20-5, the sets of all possible events 4 placed in the first organizational structure are then conditionally qualified and prioritized, thus providing means for selecting those events 4 of highest value. Note that in practice, rote expression preferably tends to be broader and more inclusive of all events 4 (although not necessary,) while selective expression tends to narrow events 4 using external rules regarding automatically (objectively) determined quantification, qualification and prioritization semantics associated with each rote expressed event 4, and potentially further includes (subjective) indications from authority input 20-5-a.

Referring next to selective objective expression step 6a, 20-6a, the system automatically places events 4 into a second organizational structure (such as a second computer foldering system for presenting) using upon rules-based qualification and prioritization of each event 4's associated semantics (such as classification and quantification tags.) In variation, selective objective & subjective step 6b, 20-6b enhances step 6a, 20-6a by accepting optional subjective authority input to approve the placement of events 4 into a prioritized folding system ideal for presentation. Although not mandatory, step 6a, 20-6a is depicted as automatically creating entire new folders fully populated with relevant sets of events 4 to be later reviewed, e.g. in a group presentation step 20-7a, whereas step 6b, 20-6b is depicted as semi-automatically adding events 4 to pre-existing folders with preferably events 4 from prior relevant sessions 1, to then be reviewed for example in group or individualized presentations 20-7a. The exact combination of creating new fully populated folders of events 4 from a single session 1, such as depicted in step 6a, 20-6a, vs. adding to existing folders new events 4 from new sessions 1, such as depicted in step 6b, 20-6b, is immaterial, what is important is that using either fully automatic objective expression or semi-automatic objective-subjective expression, the present invention can be used to create sophisticated second organizational structures that are ongoing. Again, the first organizational structure is preferably more broadly inclusive of events 4 while the second organizational structure is more narrowly inclusive, implementing the concepts of classify and sort (first) and prioritize and select (second.) However, as will be understood by a careful reading of the present specification, the first organizational structure may also include a narrowing of the totality of events 4, especially when it is understood that apart from these organizational expressions, the preferred embodiment stores the interconnected mesh of all marks 3 and resulting events 4 individually, within type, as a core set of internal system knowledge that then becomes the foundation of all system expression. Furthermore, as will be understood by those skilled in the art, while the present inventors prefer using hierarchical trees which are presentable as foldering systems, the exact implementation of an expressed organizational structure is secondary to the core teachings herein. Other organizational structures exist but all incorporate the idea of maintaining individual event 4 identity, associating semantic values to each event 4, and then classifying, sorting, prioritizing and selecting events 4 based upon these values.

Furthermore, as will be understood from the teachings herein, the present invention is capable of maintaining a single set internal session knowledge comprising marks 3 and events 4 formed in step 20-2, along with their interconnected referential mesh, as will be understood by those skilled in the art of information systems and a careful reading of the entire specification. The present invention is further capable of creating any number of additional first organizational structures in steps 20-3 and 20-4 based upon the single internal session knowledge, each in response to either different integration & synthesis rule sets and/or different rote expression rule sets. The present invention is then also capable of creating any number of additional second organizational structures for each one or more first organizational structures in steps 20-5, 20-6a and 20-6b.

In summary with respect to FIG. 4, the present invention teaches the process steps of automatically collecting and determining (internal) session knowledge, in this case differentiated marks 3 and integrated and synthesized events 4, followed by expressing portions of this knowledge via the process steps of classifying, sorting, prioritizing and selecting, resulting in the formation of externalized sources of knowledge, such as a first and second organizational structure of folders with associated events 4. As will be understood by a careful reading of the remaining specification, any externalized sources of event 4 knowledge can be informed by more than one session 1, regardless of that's session's area 1a, time 1b, attendees 1c, or activities 1d, thus creating updatable knowledge repositories. Furthermore, the teachings herein will show how these repositories can be self-directed in terms of the session 1 knowledge that they accept and may then also follow additional integration, synthesis and expression rules to recursively compound events 4 and marks 3 and their associated semantics leading to larger and more sophisticated externalized organizational structures.

Referring next to FIG. 5, there is depicted a logical high-level task block diagram of the preferred invention sub-divided into a succession of seven content translation stages, namely: detect and record disorganized content 30-1, differentiate objective primary marks 30-2, integrate objective primary events 30-3, synthesize secondary and tertiary objective events & marks 30-4, express, encode and store content 30-5, aggregate content 30-6 and interact & select content 30-7. Detect and record stage 30-1 at least employs one or more recorders 30-r for receiving information from session 1 to be directly stored as disorganized content 2a. Stage 30-1 preferably also includes one or more detectors 30-dt that are capable of detecting, either automatically, semi-automatically or via operator input, one or more activities 1d. Note that it is possible, such as in the case of recording devices 1r, including both cameras 1rv and microphones 1ra, that a recording device 30-r may also serve as a detecting device 30-rt, thus combining into a recorder-detector 30-rd. For example the cameras 1rv provide images to be stored as disorganized content 2a that may also be computer analyzed as is well known in the art to potentially identify any number of image features, where such features are being detected and turned into a stream of data. The output data stream(s) from recorder(s) 30-r is directly received by recording compressor 30-c, whereas detected data stream(s) from detectors 30-dt or recorder-detector(s) 30-rd are directly received by differentiators 30-df-1 or 30-df-2. As will be further discussed in detail, with respect to content contextualization and organization, the differentiators follow external rules to monitor the states of incoming data streams looking for transitions across thresholds indicative of activity edges of greater important.

Still referring to FIG. 5, the differentiators such as 30-df-1 might also simply track the current states of a given data feature, states that are meaningful as control input to recorder controller 30-rc, thus forming a feedback loop for affecting recorder(s) 30-r and/or recorder-detector(s) 30-rd. For example, if the recorder 30-r or recorder-detector 30-rd is a camera capable of adjustment, such as but not limited to pan, tilt or zoom, than detecting the current states of all attendee 1c positions within the session area 1a within the time frame 1b is useful for performing any such positional changes, than controller 30-rc would be camera pan/tilt/zoom controls 370 (see FIG. 2.) The present inventors have addressed this core functionality in their prior applications including U.S. Pat. No. 6,567,116 B1 entitled MULTIPLE OBJECT TRACKING SYSTEM, U.S. Pat. No. 7,483,049 B2 entitled OPTIMIZATIONS FOR REAL-TIME 3D OBJECT TRACKING as well as PCT application US 05/13132 entitled AUTOMATIC EVENT VIDEOING, TRACKING AND CONTENT GENERATION SYSTEM. Among other things, the present invention teaches the management of this feedback loop following externalized rules conforming to a proposed standard, thus enhancing these prior teachings. Once abstracted and generalized, the present invention quickly extends and scales into numerous applications where for example feedback generated from one or more detector(s) 30-dt or recorder-detector(s) 30-rd may be used to turn on-off or otherwise adjust any number of possible controls for these same or other devices 30-dt or 30-rd; thus demonstrating a key benefit and advantage of the teachings herein. Additionally, as will be understood by those skilled in the art of automated systems, these block diagrams are conceptual and not intended to limit the present invention to specific configurations of processes steps within any computing node or device. Hence, the differentiator function may well be embedded in an external device also performing detection, such as detector-differentiator(s) 30-dd, or even potentially a recorder-detector-differentiator (not depicted.)

Referring still to FIG. 5, determine objective primary marks stage 30-2 ultimately differentiates one or more non-normal, disparate source data streams, into a single flow of normalized, packaged marks 3 representing various activities 1d state transitions, all controlled by external rules. This flow of primary marks 3 is received into a one or more integrator(s) 30-i, where each integrator 30-i uses external rules to conditionally combine various primary marks 3 into various primary events 4. As primary events 4 are created, started and stopped, the net information built up from stage 30-2 for determining marks 3 and stage 30-3 for determining events 4 create a mesh of marks 3 and events 4 as well as their referential connections, all of which is the subject of upcoming detailed teaching. The present invention teaches that these two fundamental objects, the mark 3 representing activity state transitions, and the event 4, representing continuous activity over threshold, are sufficient to form the basis of all session knowledge combinable into significantly contextualized and organized downstream content 2b. Marks 3 coming straight from devices 30-rd, 30-dt or 30-dd are considered to be primary, and likewise events 4 that are formed at least in part from a create, start or stop association with a primary mark 3, are primary. After primary marks 3 and primary events 4 are differentiated and integrated in stages 30-2 and 30-3, they may be further synthesized in stage 30-4 into secondary and tertiary, or combined objective marks 3, and secondary or combined objective events 4. Note that the present teachings intentionally refer to both primary, secondary and tertiary marks as simply marks 3 and primary and secondary events as simply events 4, because, except for their source, they are identical data structures and represent a key aspect of the present invention's recursive ability. In FIG. 5, stage 30-4 includes synthesizer(s) 30-i that follow external rules to conditionally create new events 4 from exclusive or inclusive combinations of other events 4. This combining function will be taught in greater detail later in the specification, suffice to say that conceptually events 4 can be viewed as digital on/off waveforms where the activity edges indicated by marks 3 cause the transition back and forth between the off (no activity) and on (yes activity) states. As digital waveforms, any event 4 can be combined with any other event 4 using both mathematical and logical operations, as will be apparent to those skilled in the arts of digital systems. The present inventors prefer to break these numerous possible operations into the overall concept of exclusion, a time narrowing operation, and inclusion, a time expanding operation. Briefly, in the exclusion operations events 4 are being combined to effectively limit any resulting secondary event 4 to a sub-set of activity time shared by two or more events 4. For example, player shift events 4 exclusively combined with power play events 4 result in narrower player shifts on (AND) power play events 4. In the inclusive operations, events 4 are being combined to effectively expand any resulting secondary event 4 to a super-set of activity time shared by two or more events 4. For example, player shift events 4 inclusively combined with goal against event 4 result in broader player shifts when (OR) goal against event 4. Combining events 4 is a major object and benefit of synthesizers 30-s. Another benefit is their ability to quantify marks 3 occurring within any events 4, where this quantification is represented as a summary mark 3. For example, shot marks 3 randomly occur throughout a typical hockey game. Man advantage events 4, such as even strength (when both teams have five skaters) and power plays (when one team has fewer skaters, in any combination, than the other) also randomly occur throughout a game. And finally, period events 4 periodically occur and are exclusively combinable with man advantage events 4 to create secondary man advantage by period events 4. It is desirable that synthesizer 30-s be able to count the number of a certain type of mark 3 within a certain type of event 4, all with the further ability to first filter either marks 3 or events 4 by any of their semantic features (all of which will be further discussed in more detail.) For example, synthesizer 30-s is capable of following external rules to total the number of shot marks 3 by exclusive man advantage by period events 4. Each summary is represented as new summary mark 3 that is available for feedback into integrator 30-i. Hence, synthesizer 30-s can also be viewed as a differentiator 30-df-3, depicted as a separate block on FIG. 5. As will be appreciated by those skilled in the art of content creation, the ability for these synthesized events 4 and marks 3 to be also fed back to recorder controller 30-sc provides significant value. For example, as session activity 1d continues, certain attendees lc will differentiate themselves based upon the accumulation of various activity edges (marks 3) and duration (event 4 time.) It is ideal that this differentiation might feedback to affect recording of disorganized content 2a, not just feed-forward to affect contextualization and organization of organized content 2b.

And finally, with respect to the quantification operations of synthesizer(s) 30-s, it is also ideal and herein taught that any one event 4 can be quantified with respect to any other event 4, similar to how marks 3 are counted within events 4. As will be subsequently taught in further detail, synthesizer 30-s is able to count both the number of occurrences of event 4 appearing in various overlap states with any other event 4, as well as the total time of overlap. As will be appreciated, the negative inverse of count and total time is also obtainable. A typical example of this use in ice hockey would be the determination of player shift events 4, both in count and time, on power play events 4.

Still referring to FIG. 5, as both primary and secondary marks 3 and events 4 are determined on an ongoing real-time basis within a session 1, it is desirable to express their existence. This expression is not limited in any way and ideally covers all forms of communication to external human and/or non-human based systems. For example, for human consumption, the expressions are ideally visual, auditory, tactile or essentially sensory. A preferred expression format is multi-media combining video, audio and overlaid graphical information. For non-human or machine consumption, the expression is ideally encoded information, either digital or analog. As will subsequently be taught in more detail, the preferred invention follows external rules for the creating and exporting of all external communications made by expresser(s) 30-e. In addition to real-time expression, it is also preferable that expresser(s) 30-e provide their information to internal content repository(s) 30-rp for combination with disorganized content 2b sourced by devices such as 30-r and 30-rd and potentially compressed by recorder compressor(s) 30-c. The resultant combination of differentiated, integrated, synthesized expressed content stored with disorganized content 2b in repository(s) 30-rp form the organized encoded content 1b of stage 30-5.

FIG. 5 depicts that the stages 30-3 through 30-5 are combinable into a minimum ideal set forming a sub-system for translating session 1 disorganized content 2a into organized content 2b, herein referred to as session processing, conducted by session processor 30-sp. Like each of its stages, 30-3 through 30-5, with each of their attendant parts, 30-i, 30-s, 30-e, 30-c and 30-rp, session processor 30-sp is virtual. As a virtual system, the actual functions embodied as portrayed, are expected to be performed across multiple computing platforms, essentially forming a real-time synchronized network of information processing. The present invention teaches that each stage is scalable because each part of each stage is virtual and may be performed in parallel with like copies of the same part running on separate systems. Alternatively, the present invention anticipates that rather than executing the session processor 30-sp on a generalized computer, it is embeddable into a content processing appliance perhaps containing a either an FPGA, micro-processor, ASIC or some other computing device.

Still referring to FIG. 5, while it is easier to see how source data is collected via a number of recorder(s) 30-r, recorder-detector(s) 30-rd, detector(s) 30-dt and detector-differentiator(s) 30-dd, collectively referred to as external devices 30-xd, it is also desirable and herein taught that their resulting differentiated streams of marks 3 may be processed in parallel by multiple integrator(s) 30-i and synthesizer(s) 30-s. While not depicted for simplicity, these parallel processing paths may remain separated all the way through parallel expresser(s) 30-e into one or more content repository(s) 30-rp, or alternatively, their resulting mark 3 and event 4 output streams may be joined in subsequent stages. For example, multiple synthesizers 30-e can feed a single expresser 30-e, thus allowing their synthesized content to be mixed for expression. Likewise, multiple integrator(s) 30-i can feed a single synthesizer 30-e, thus allowing their integrated content to be mixed for synthesis. What is typically expected and portrayed in FIG. 5, although by no means intended as a limit, are multiple parallel external devices 30-xd creating differentiated marks 3 across multiple computing devices, together outputting a single normalized data stream of marks 3 that are received into a single main computing server across a shared network. Typically, the main server has instantiated a single session processor 30-sp comprising a single integrator 30-i capable of processing all incoming marks 3 into events 4, as sufficiently close to real time as the applications demand. Downstream of the integrator 30-i is a path to a single synthesizer 30-s feeding multiple expressors 30-e (not depicted) which themselves place content into a single repository 30-rp.

Still referring to FIG. 5, it is anticipated that in practice, the equipment for implementing the present invention will be placed at a certain physical location that ideally performs multiple sessions of interest, therefore amortizing overall expenses—for instance, the equipment might be installed at a sporting, theatre or music venues with typically a single session area 1a shared by various session attendees 1c, each performing their various activities 1d at different times 1b. It is further anticipated that the present invention will be located at facilities with multiple session areas 1a, such as sporting complexes, business complexes and educational complexes. In such multiple session area venues, it may be preferable to share infrastructure thereby reducing system costs. In support of this goal, the present invention anticipates a multiplicity of portable external devices 30-xd connected via any form of local and wide area networks, directed by a single instance of a session controller 30-sc for all concurrent sessions, running on the main server or server cloud, as will be understood by those skilled in the art of network computing. This session controller 30-sc is responsible for instantiating and monitoring one or more session processors 30-sp running concurrently in order to process sessions 1 taking place at different session areas 1a at overlapping session times 1b.

Hence, the present invention is anticipated to be used by organizations controlling venues where attendees, typically people, congregate to conduct activities. Using the sport of ice hockey as a representative example, some venues have a single session area 1a, such as a professional arena. Other venues have multiple session areas 1a, such as a youth arena. For venues such as a high school, these facilities tend to have multiple session areas 1a including playing fields, auditoriums, stages and classrooms. Therefore, it will be understood by those skilled in the art that a normalized and extensible system, identical in internal structure and embedded task logic, controllable by externalized rules to adapt itself to any combinations of session areas 1a, times 1b, attendees 1c and activities 1d is preferred. It will also be understood that such a system is comprised of loosely coupled services such as the parts in stages 30-1 through 30-5 that can be spread across variable configurations of network and computing equipment necessary to handle all anticipated session processing loads, thus making for a highly scalable system.

Still referring to FIG. 5, the resulting organized content 1b created by a session processor 30-sp for a given session 1, is expected to be of high interest, both for the patrons of the venues and those not typically in session attendance. Therefore, expresser(s) 30-e preferably follow additional external rules directing them to provide their streams of expressions to other central repositories 30-crp housed on remote connected systems, such as shown in stage 30-6, for aggregating organized content. However, this push-model is less feasible when the target repository is not known. The present invention also specifies a reciprocal pull-model where expresser(s) 30-e simply provide their expressions to content clearing houses 30-ch that have wide area connectivity ideally including internet access. Such clearing houses 30-ch may then receive and hold owned requests for specific expressions complete with filters specifying desired combinations of any and all types of sessions 1, areas 1a, times 1b, attendees 1c, activities 1d and further specific marks 3 and events 4, all of which carry semantic descriptions linked to their data structures. Thus, the present invention teaches a system for creating contextualized organized content broken down into rich segments with normalized descriptors providing the basis for semantic based retrieval of remote information across the internet, commonly referred to as the semantic web.

And finally, still referring to FIG. 5, with respect to human content consumption the present invention teaches a new type of information retrieval device/program replacing the traditional media player. Depicted as session media player 30-mp, the preferred interactive retrieval tool not only processes the traditional video, audio and tightly coupled graphic overlays, it is capable of interpreting at least events 4 (as well as marks 3 where needed,) in organized expressed data structures (for example automatically populated folder systems) such as indicated in FIG. 4, that provide quantification, qualification and index into the desired context. Furthermore, session media player 30-mp is in concept and design a virtual session area 1a where the session attendee(s) 1c are the interactive viewer and the session time 1b is any time in which the interactive viewer works the player 30-mp to review desired content. As will be appreciated by those skilled in the art of information systems, this abstraction of a user-media-player interaction as a session 1, provides an ideal opportunity to use the virtual session processor technology described herein to collect additional meaningful content, both objective and subjective in nature. In this case, the session media player 30-mp program becomes a detector-differentiator 30-dd producing marks 3 as the user interacts with the various screen functions requesting and reviewing content events 4.

For example, for each button or tool actionable on the session media player 30-mp, marks 3 may be generated for each use along with content and media player configuration states as related semantic information. Such information is ideal for determining usage patterns providing opportunity for both post-time software improvements as well as real-time software reconfiguration. The session media player 30-mp ideally also provides marks 3 and events 4 describing objectively what content a given differentiated user accesses, in what order and for how long. As will be understood by those skilled in the art of software systems, embedding a session processor 30-sp into the session media player 30-mp in order to at least collect software usage data is extendible to many other types of software beyond the session media player 30-mp as herein described. Specifically, the present invention anticipates that a user working on a computer with any piece of software, such as a word processor, an internet browser or a spreadsheet, is conducting a session 1 such that it may be beneficial to embed a generic session processor 30-sp within this software in order to create indexed organized recordings of the user's activities for expression and internal feedback.

With respect to recording and contextualizing objective content from within any piece of user software in general, but now specifically within the session media player 30-mp, the embedded session processor 30-sp is capable of tracking user movements, both in general with respect to the media player 30-mp, as well as specific to a single viewed session 1. These user movements across the software user interface are abstractly comparable to session attendee 1c movements across a physical session area 1a. Hence, as taught in previous patents and applications from the present inventors, the ability to track physical movement, such as with athletes, is herein made equivalent to tracking the physical movements of software users (e.g. their mouse movements with and between software action points.) This movement of a software user is further differentiable as either movement throughout the software's user interface or movement within the software's content. This second type of user movement is even more readily comparable to athlete performance with respect to virtual gaming systems where the user is moving in a virtual space with other potential users connected through other user interfaces. The present invention anticipates that all of these real and virtual types of sessions are in abstract identical and therefore adaptable to the teachings herein specified, providing a major object and benefit; all that is needed is different real and virtual external devices 30-xd for detecting the real and virtual activities, conforming to the herein taught protocol for forming marks—from thereafter the remainder of the translation of content from disorganized to organized remains exactly the same, governed by different sets of external rules.

Still referring to FIG. 5 and now returning to session media player 30-mp, captured objective information might take on the less physical aspect of exact content retrieved in exact sequence, or the more physical aspect of buttons and software features used in exact sequence. Even more interesting, in respect to subjective information, the embedded session processor 30-sp be informed by the session media player 30-mp of both the user's relationship to the content, for example an activity instructor, activity performer or activity fan, as well as their reviewing context, for example critical analysis or enjoyment. (These distinctions are easily determinable as a part of either the initial program startup of player 30-mp and/or user logon, as will be understood by those skilled in the art of software.) Therefore, as each differentiated user interacts with content from a specific session 1, the session processor 30-sp embedded within the session media player 30-mp is configurable to allow for subjective feedback in any of several desired forms including direct comments input by the user, such as but not limited to text, graphic overlay or audio, describing any event 4, rating of any event 4, or indirectly commenting on any event 4 by implication of sequence and/or duration of access. All of these user activities may have important meaning and as such the session media player's 30-mp embedded session processor 30-sp performs the important task of communicating differentiated marks 3 and events 4 from each interactive viewer's media player session directly back to the central repository(s) 30-crp storing original session 1 content, or to content clearing houses 30-ch that allow such information to be widely accessible. It is even possible and preferred that such subjective marks 3 and event 4 fed back from session media player 30-mp, may cause additional integration, synthesis and expressions related to the original objective session content; a continual feed-forward from the session processor 30-sp to the session media player 30-mp and feed-backward from the session media 30-mp to the session processor 30-sp, without limits.

Referring next to FIG. 6, there is depicted a logical high-level data flow block diagram of the preferred invention showing four types of data entering session processor 30-sp, either causing or being output as organized content 2b; organized into a structure such as individual folder(s) 2-f for review by user(s) through interaction with session media player 30-mp. The only streaming input into session processor 30-sp is output by data differentiators 30-df and comprises differentiated content in the form of normalized marks and related data, 3-pm & 3-rd respectively. As previously discussed, differentiators 30-df accept source data streams 2-ds first detected and processed by external devices 30-xd. Also input at the start of each session 1 are externally sourced session processor rules 2-r that are used to direct all stages of content contextualization and organization including: initial detect and record stage 30-1, forming source data streams 2-ds, differentiation stage 30-2, forming differentiated marks 3-pm, as well as all session processor 30-sp stages 30-3, 30-4 and 30-5 covering integration, synthesis, expression, compression, forming organized content 2b, then aggregated in stage 30-6 into repository folders 2-f for review by person 11 in content selection and interaction stage 30-7. Like rules 2r, the other two remaining types of data enter the session processor 30-sp once at the beginning of a session 1. They are specifically the session manifest 2-m that minimally designates the session context including area 1a, time 1b, attendees 1c, activity (type) 1d, and the session registry 2-g that minimally designates the list of external devices 30-xd and data differentiators 30-df that together will be/are allowed to present differentiated data 3-p & 3-rd throughout the session 1. Note that the session processor uses manifest 2-m and registry 2-g to indicate which specific rules 2r from the set of all possible rules, should be input. (All of which will be taught subsequently in greater detail.) Still referring to FIG. 6, the present invention teaches that each of these data flow components may be owned and therefore cannot be used without sufficient permission. Ownership is primarily concerned with the identity of the controlling entity related to the data flow component. For instance, a session 1 may require the use of a facility, where the facility is owned by a first party having ownership 1a-o. The area(s) 1a in a facility may be pre-offered for rent by their owner (as is typical for youth ice hockey) to second parties who therefore have obtained facility area permission 1a-p matched to their time slot ownership 2t-o recorded in calendar 2-t. A third party with ownership of session activities 1d-o may then desire the use of session area 1a at a specific time 1b as recorded in calendar 2t, and therefore must obtain matching permission 2t-p. It is also possible that the external devices 30-xd resident at the facility area 1a are owned by forth parties different from either the owner of the facility 1a-o or the owner of the session activities 1d-o; hence external devices 30-xd have separate ownership 30-xd-o.

It is anticipated that external devices 30-xd may include embedded differentiator 30-df, or may pass their detected source data streams 2-ds to a physically separate differentiator 30-df. In either case, ownership 30-xd-o and 30-df-o may be the same, or introduce a fifth party. If different, activity ownership 1d-o must match differentiator permission 30-df-p in the same way it must match external device permission 30-xd-p. It is still further possible that external rules 2r, that in part govern external devices 30-xd, differentiators 30-df and otherwise session processor 30-sp, may be owned by sixth parties, with ownership 2r-o. Before session owner 1d-o may receive rules 2r and use of devices 30-xd, and differentiators 30-df, permission 2r-p, 30-xd-p and 30-df-p (respectively) must be obtained and match. Content in the form of differentiated data 3-pm & 3-rd produced using external devices 30-xd and differentiators 30-df, both governed by rules 2r, therefore inherits blended ownership derived from 2r-o, 30-xd-o and 30-df-o respectively, all of which is recorded in external device registry 2-g.

Still referring to FIG. 6, is still further possible that equipment providing the function of session processor 30-sp is owned by a seventh party, with ownership 30-sp-o. Regardless of all other transactions, session activities owner 1d-o must receive matching permission 30-sp-p for use of session processor 30-sp to record and create organized content 2b. Organized content 2b therefore dynamically inherits ownership 2b-o derived from session activity owner 1d-o, facility area owner 1a-o, time slot owner 2t-o, external rules owner(s) 2r-o, external devices owner 30-xd-o, data differentiator owner 30-df-o and session processor owner 30-sp. As will be discussed in further detail in the subsequent specification teaching expression, it is possible for the session processor 30-sp to automatically express variations of its internally developed knowledge into one or more organized structures, such as foldering system 2f, where each foldering system 2f has ownership 2f-o by potentially eighth parties. Therefore, foldering system 2f owner 2f-o must receive matching permission 2b-p from potentially all organized content owners 2b-o. Foldering system owners 2f-o may now grant permission to individual session media players 30-mp, whose ownership 30-mp-o has been purchased by organized content end user(s) 1u, a potentially ninth party.

As will be understood by a careful consideration of this ownership-permission teaching, in practice many lesser combinations of involved parties are possible. For instance, the present inventor anticipates that ownership of the session processor 30-sp-o may often match that of the external devices 30-xd-o, data differentiators 30-df-o and even potentially external rule ownership 2r-o. It is also anticipated that session activity ownership 1d-o may both match time slot ownership 2t-o and folder system ownership 1f-o, if not also session media player ownership 30-mp-o. And finally, in some cases facility area ownership 1a-o is expected to match session activity ownership 1d-o. However, the present invention prefers this detailed separation of ownership matching data, equipment and structures precisely so that multiple parties may participate in the formation of a marketplace for creating and consuming organized content 2b. It is still yet further anticipated that some ownership, especially rules 2r-o, will be owned by an open community of rules 2r developers focused on a particular context, and therefore free to use without permission 2r-p. All that is necessary is that each value added is accounted for in the resulting organized content 2b. While the exact structure and methods for creating this marketplace are not the subject of the present invention, it is assumed that those skilled in the art of information systems related especially to internet based economies will understand that ownership can be encoded and locked to either physical devices, embedded software or transmittable data sets and that permission can be purchased from owners especially via web-based interfaces; much of which is the subject of digital rights management. Once purchased, permissions can therefore be transmitted along with processing requests and data sets to therefore allow content creation and flow. While many variations of systems for accomplishing this accounting are possible and anticipated as obvious to those skilled in the art of information systems, the preferred invention includes a unique session id code per conducted session 1 to be associated with the data representing session manifest 2-m and external device registry 2-g and stored with resulting organized session content 2b. The manifest 2-m preferably records facility area ownership 1a-o, time slot ownership 2t-o; where the usage of such is purchased by session activity owner 1d-o (if they are not already either the facility or time slot owner.) During content creation, internal session data further maintains the relationship of session processor ownership 30-sp-o associated with all ownerships recorded in manifest 2-m and registry 2-r. It is further desirable that either manifest 2m or registry 2g record folder system ownership 2f-o, that will be recognized by content expressers 30-e within session processor 30-sp.

Still referring to FIG. 6, as will be appreciated, session processor 30p will then associate the unique session id code with all organized session content 2b stored in content repository 30-rp, or exported to central repository 30-crp or content clearing house 30-ch. By associating the unique session id code with all session organized content 2b, all related ownership may be determined by at least inquiry upon the associated manifest 2m and registry 2g. Such inquiry can be an embedded function of session media player 30-mp which has knowledge of media player user 1u, and may therefore conduct sales transaction from purchaser/user 1u to flow monies back to any and all entitled ownership as contractually agreed. It should be further noted that the present invention anticipates that any permission seeking ownership match may be the subject of a sales transaction, for any point of part of the overall value added processes, especially as described in FIG. 6. And finally it is noted that manifest 2m and registry 2g may be either separate or combined data structures without deviating from the teachings herein. All that is necessary is some system for recording and tracing ownership matched to purchasers of all services herein taught.

Also regarding FIG. 6's chosen depiction; the present inventors note that it is intentionally slanted towards the perceived best-use for the youth sports market. As such, it is assumed that the renters are attendees 1c who must receive permissions, and therefore pay all appropriate owners to have organized content 2b developed for them (while they may also receive downstream royalties for this same generated content.) If FIG. 6 was slanted towards the best-use for the professional sports market, then it might rather depict the host facility (owner of area 1a) that must receive permissions, including that of attendees 1c, in order to generate organized content 2b. Therefore, the teachings of the present invention should not be construed as limited to the exact configuration of relationships portrayed in FIG. 6, but rather to the concepts therein embodied and herein taught.

Referring next to FIG. 7, there is depicted the flow of internal data, including both content and rules, that together are herein designated as internal session knowledge. As previously introduced, while session 1 is conducted, one or more external devices 30-xd are used to create ongoing session source data 2-ds in detect and record stage 30-1. This session source data is then preferably analyzed to determine threshold crossings representing the beginnings and endings of distinct activities; essentially activity states changes; a process herein referred to as differentiation, as will subsequently be discussed in greater detail. This comparison of source data streams 2-ds to threshold functions (stage 30-2) may be built directly into the external device 30-xd such that the output of the device is a stream of differentiated, normalized marks 3, rather than source data 2-ds. For example, a clicker device uses electro-mechanical sensors to determine the moment a contact switch is closed; thus exceeding a minimum distance threshold. Rather than send a stream of distance measurements from the button to the contact sensor, the clicker external device 30-xd simply sends a signal when the button comes into contact with the sensor. As will be taught, the signal is the basis for a mark 3 and represents a differentiated data stream incorporated into the external device. More specifically, since this mark is coming directly from source data, FIG. 7 refers to these as primary marks 3-pm.

As will be understood by those skilled in the art, the signal coming from a device such as a clicker will minimally include a code representing unique id of the clicker and the button that was depressed (assuming the clicker has more than one button.) As will be further understood, this signal can then be converted into a data structure including a code for the type of mark, e.g. a “clicker mark,” the time the mark was received, and all related data, e.g. the unique clicker number and button number. All of this is discussed in more detail in a subsequent section of the present teachings. What is important to FIG. 7, is that external devices 30-xd may present information directly convertible to marks 3 without needing further differentiation.

Alternatively, some external devices 30-xd will provide on-going (undifferentiated) source data streams 2-ds representing one or more session activity 1d characteristics. For example, a microphone provides continuous measurement of ambient audible characteristics, including at least amplitude (sound levels) and frequency (pitch.) Another example of a preferred external device is an array of RF detectors capable of sensing the presence of low cost passive RFID antenna embedded in a sticker. As will be discussed in more detail later in the specification, such an array can be used to line the inside of a hockey team bench, where the projected detection field is combined from all antenna to form a corridor from approximately knee height to the ground running from the inside of the rink boards to the bench seats, all along the bench. Using this type of external device 30-xd, players would wear a low cost passive id sticker on the outside of their shin protectors, underneath their leg socks. When on the player bench, either of both stickers attached to the shin pad on either leg would be detected by the RF antenna array. While detected, the data stream from external device 30-xd is essentially the “on” or 1 state. When the player leaves the bench, usually for a shift of play, the RFID is no longer detected and the data stream turns to the “off” or 0 state. Using these types of external devices 30-xd, i.e. a microphone with a continuously variable data stream, or an RFID detector array with a two state data stream, the present invention teaches the differentiation of this data outside the physical external device 30-xd. Hence, the external device 30-xd outputs data stream 2-ds rather than signals leading directly to marks 3, or marks 3 themselves.

Referring still to FIG. 7, data stream 2-ds may then be received by an algorithm, or embedded task, of the present invention for differentiating any one or more streams 2-ds using data differentiation rules 2r-d. Again, the present invention teaches this as stage 30-2, differentiation of objective primary marks 3. As will be understood by those skilled in the art of computing systems, this algorithm may preferably be running on a small highly portable platform, with built in processing elements such as an FPGA, microprocessor or even ASIC, and thus even embeddable into external device 30-xd (as previously discussed,) or held in separate IP POE type devices. Conversely, the algorithm to differentiate incoming data streams 2-ds using externally developed data differentiation rules 2r-d may be implemented on the same computing platform that is used to further integrate and synthesize differentiated marks 3; presumably a general purpose computer. What is important is that external devices 30-xd may output data streams 2-ds (as opposed to primary marks 3) directly into the present system to be differentiated using externally generated and locally stored and executed data differentiation rules 2-rd. The result of this differentiation stage 30-2, as previously discussed, is marks 3; in FIG. 7 referred to as primary marks 3-pm because they come directly from the differentiation of a source data stream 2-ds.

Also referring to FIG. 7, external devices such as a machine vision tracking system (as taught by the present inventors in previous applications,) are capable of tracking the ongoing positional coordinates at least in two dimensions, output object tracking data 2-otd, rather than data streams 2-ds. The meaningful difference as taught herein is that data streams 2-ds are discarded after differentiation into primary marks 3-pm because there information is deemed unimportant beyond its threshold intersections (i.e. activity 1d edges.) However, some data such as the ongoing location of a player's centroid or the centroid of the game object (e.g. a puck in hockey,) is important beyond the differentiation into primary marks 3-pm. A simple example is the location of a given player during their player shift. This positional location data, or object tracking data 2-otd, can be differentiated in the longitudinal dimension to determine when a player enters and leaves a given zone of play (as first taught in prior applications of the present inventors.) Once differentiated using external developed data differentiation rules 2r-d unique primary marks 3-pm representing the time of zone entry and exit are passed into the system for integration and synthesis. However, the exact path of travel over time within each zone is still contained in object tracking data 2-otd and may provide future benefit and is preferably therefore stored and not discarded as is done with data streams 2-ds. As will be taught, object tracking data 2-otd forms micro positional feedback for immediate low-level adjustment and control of recording devices. For example, a video camera with controllable pan, tilt and zoom settings, is ideally continuously adjusted based upon the ongoing locations of one or more players and the game object, regardless of any differentiated threshold crossings (therefore primary marks 3-pm.) This particular teaching of automatic pan, tilt and zoom adjustment of movable cameras based upon tracked player and object location using machine vision is the subject of prior applications from the present lead inventor.

Still referring to FIG. 7, with respect to external devices 30-xd, what is most important is to see that they are capable of three basic types of output. First, they may output signals either equivalent to or directly convertible to primary marks 3-pm. Alternatively, external devices 30-xd may output data streams 2-ds or object tracking data 2-otd, for differentiation by the system into primary marks 3-pm using externally developed data differentiation rules 2r-d. Of these alternate output options, data streams 2-ds are discarded while object tracking data 2-otd is preferably stored as an additional source of information and potentially providing micro positional feedback to recording external devices 30-xd (to be discussed subsequently in further detail.) As will be understood by those skilled in the art, object tracking data 2-otd is not limited to physical objects such as players and a game object in a sporting contest. In that same sporting contest, the fan noise levels could be treated as either data streams 2-ds to be differentiated and discarded (regardless of whether or not they are also separately stored as recordings,) or they may be treated as an object, where in this case the moving object is for instance the volume level, and therefore the output stream is stored for later potential reference as object tracking data 2-otd while generating the same primary marks 3-pm as if it were treated as data streams 2-d. Another alternate example is virtual gaming players or objects that like their real analogies, may be tracked for storing as data 2-otd. Also depicted in FIG. 7, primary marks 3-pm, regardless of their source path, are now homogenous data objects following a preferred composition as will be discussed in further detail later in the specification. The benefit of this external data normalization is that any marks 3 are translatable into any events 4 following external integration rules 2r-i, where the translating application of integration stage 30-3 is therefore domain agnostic. As will be understood by those skilled in the art of information systems, removing domain rules 2r from the embedded application tasks provides significant advantages. While rules 2r are broadly defined to cover differentiation, integration, synthesis and various types of expression, the overall teaching remains consistent. For instance, the first translation of primary marks 3-pm into primary events 4-pm is a microcosm of the present teaching—that data-in plus rules-in are used by the agnostic computing tasks to produce data-out, thus creating a user programmable content contextualization and organization system. In the preferred invention, this set of agnostic tasks controlled by the integration rules 2r-i, represent the third stage (30-3) in the overall translation of disorganized content 2a into organized content 2b, and the first stage preferably within what is herein referred to as the session processor 30-sp.

Then next stage 30-4 within the session processor 30-sp is that of synthesis. Unlike integration 30-3, synthesis 30-4 has three distinct translation tasks. The first two are preferably executed prior to the third. Specifically, primary events 4-pe are combinable into secondary events 4-se following externalized event combining rules 2r-ec. As previously discussed and as will be subsequently taught in greater detail, events 4-pe can be modeled as digital waveforms that are either in the off-state (e.g. waveform equal's zero,) or the on-state (e.g. waveform equal's one.) When viewed as continuous waveforms, each transition from off, zero, to on, one, represents the leading edge of a detected session activity and conceptually the beginning of a single instance of a particular type of activity, referred herein to as an event type. Likewise, the waveform transition from on, one, back to off, zero, represents the trailing edge of that same instance of session activity. When viewed abstractly as on-off waveforms, any session activity is combinable with any one or more other activities. As will be understood by those skilled in the arts of digital waveforms, various types of combinations are possible and hereby considered a part of the present teaching. As will be taught, the present invention refers to the contractive process of ANDing waveforms to be an exclusive combining, while the expansive process of ORing waveforms to be an inclusive combining. Regardless, both processes can be exactly governed by external event combining rules 2r-ec for implementation by the appropriate agnostic task within session processor 30-sp.

The second task preferably executed prior to the third task is that of creating secondary marks 3-sm from primary events 4-pe, secondary events 4-se, primary marks 3-pe, secondary marks 3-sm, or tertiary marks 3-tm; all following event-mark summary rules 2r-ems. As will also be discussed in greater detail later in the present specification, secondary marks 3-sm can also be thought of as summarizing, or counting, the amount of occurrences and optionally time duration of one type of mark or event within a container event type. Reviewing the prior examples of these concepts, in a sport such as ice hockey, the container event could be the period event, which normally has three occurrences (non-zero waveform durations.) Within the session time demarked by the leading and trailing edges of these event type instances, any number of other event waveforms may be simultaneously on or off. Similarly, any number of other marks 3, including 3-pm, 3-sm and 3-tm, may be occurring on or within the instance. As will be understood by those skilled in the arts of statistics, these summarizations form import base information. As will also be shown, beyond statistics, these new summary marks 3-sm may be reprocessed by the session processor 30-sp in the exact same manner as primary marks 3-pm. This feedback loop is an extremely valuable tool for creating rich contextualization, expression and organizing indexes for content 2b.

Once created, primary marks 3-pm (link line not shown,) secondary marks 3-sm, primary events 4-pe (link line not shown,) and secondary events 4-se are further combinable into calculated tertiary marks 3-tm, using externalized calculation rules 2r-c. As will also be subsequently taught in greater detail, tertiary marks 3-tm differ from secondary marks 3-sm in purpose. Where secondary or summary marks 3-sm are meant to record a quantitative value within a contained duration of time, marks 3-tm are meant to represent real-time data curves, or multivariate waveforms distinct from the two-state event waveforms. At any given instant, the value of these calculation waveforms represent the statistical data at that time in a particular session 1 (e.g. the current score or possession time to shot ratio.) Overtime, the waveforms are expected to change value and as will be seen, the transition points of these digital waveforms are indicated by the tertiary marks 3-tm. The greater the number of events 4 and marks 3 considered in a the calculation rules 2r-c for a given tertiary mark 3-tm, the more frequently the waveform is modified. Regardless of their source, stage of creation, externally controlling rules or agnostic processing tasks, all marks 3-pm, 3-sm and 3-tm are identical in object structure. So likewise are events 4-pm and 4-sm. This enforcement of a single normalized object structure will be taught herein and is important to the one of the key objects of the present invention; namely, to create a universal content processing machine implementable as embedded algorithms in content appliances, programmable by users developing external rules on general computing platforms, and capable of functioning as IP POE devices. (As will be understood by those skilled in the art of network systems, IP stands for Internet protocol and is an industry standard for allowing various physical computing devices and platforms to remotely address each other and exchange data, while POE stands for power over Ethernet which allows these computing devices to draw sufficient power from the network signals, greatly simplifying physical installation.) Hence, while the preferred session processor 30-sp runs on a general computing platform networked to all external devices 30-xp and differentiators 30-df, and having direct access to local repository 30-lrp as well as wide area access to remote repository(s) 30-crp as well as clearing house(s) 30-ch, the preferred alternate embodiment is an embedded IP POE device similar to the preferred external devices 30-xd and differentiators 30-df. In such a fully embedded configuration, these three main devices are low cost, portable, remotely configurable, and highly scalable; thus providing solutions for the widest range of applications.

Furthermore, another significant advantage of the present invention is the simplicity of the underlying dynamically adjusted data objects. Fundamentally, there are only two: marks 3 and events 4. The present teachings support the processing of these two basic objects with only three other also simple static data objects: namely the session manifest 2-m, the registry 2-g and the context rules 2r. While there are further data constructs associated with each of these base data objects as will subsequently be taught in detail, it will be obvious to those skilled in the art of information systems that such an approach greatly simplifies the design of the internal session processor 30-sp tasks, greatly increases their reusability, and greatly extends their application benefits as new tasks designed for one application are immediately available for all others.

Still referring to FIG. 7, there are more basic data objects, especially for the various functions of content expression, a key value added function stage 30-4. As briefly depicted, expression of internal knowledge in the original form of marks 3 and events 4 can take on various content forms including, but not limited to: numerical, textual, audio and visual. While these formats of expressions are highly desirable for (but not limited to) human consumption, the session processor 30-sp can also express its internal knowledge as qualitative prioritized directives. Specifically, as shown in FIG. 7, there are two major feed-back loops from stages 30-2 through 30-4 back to 30-1 (detecting and recording.) The first loop was previously described and comes directly from differentiation stage 30-2 as micro-positional feedback. One preferred use of this loop is to automatically adjust the pan, tilt and zoom angles of one or more adjustable cameras as they at least record session 1 and possible also or only detect activities in session 1. Note that in addition to pan, tilt and zoom, the present invention anticipates being able to move the adjustable cameras along wires and tracks for an additional degree(s) of freedom. Therefore, the micro-positional feedback is desirably the shortest of the feedback loops as its adjustments are real-time continuous.

The second feedback loop comes preferably through either the integration stage 30-3, where events openings and closings are first “noticed,” or through the expression stage 30-5, where higher “value judgments” are available based upon increased internal knowledge. One preferred use of this loop is to automatically reassign, or switch the viewing target of a video camera off of some participant(s)/game object(s) and onto others. In direct analogy, the micro-positional feedback loop is akin to a cameraman's continuous adjustment of their single camera to follow the event activities based typically upon attendee movements, whereas the macro-positional feedback loop is akin to a producer directing the cameraman to change their target based upon session situations, or combinations of past and current events 4 and statistics (i.e. especially secondary and tertiary marks 30-sm and 30-tm respectively.) As will be understood by those skilled in various applications, this micro vs. macro control over detection and recording devices has significant value and is broadly applicable beyond sports and beyond video devices. For instance, with respect to video, security systems would also benefit from dynamic systems such as the present invention that can identify potential targets by following rules 2r that form events 4 from triggers (marks 3) so that idle or working cameras can be reassigned. Once reassigned, micro-positional feedback would then adjust these cameras until otherwise directed.

These types of macro and micro adjustments are expected to also have great value for the positioning of at least directional microphones such that the system's ability to record sound can be moved to appropriate locations within the session area 1a as the detected session activities 1d and rules 2r so direct. Many more uses of these types of feedback will be obvious to the skilled readers familiar with their given application space and preferred detection and recording devices. Still other uses will become apparent as the present invention is applied in practice, all of which is anticipated as the benefit of the abstract, agnostic nature of the present apparatus and methods.

Referring next to FIG. 8, there is shown a high level overview of stages 30-1 and 30-2 as they pertain to the session context of ice hockey. The first purpose of this figure is to show two alternate record and detect stage 30-1 apparatus for tracking detailed session activities 1d. More specifically, and in reference to FIG. 2, FIG. 8 depicts apparatus for making machine measurements 300 including: continuous game object(s) centroid, location & orientation 310, player and referee centroid, location & orientation 330 as well as continuous player and referee body join location & orientation 350. Two alternate apparatus for collecting machine measurements 300 are either vision based system 30-rd-c or rf based system 30-dt-rf. As will be seen, starting with either of these alternates, the present invention will create similar differentiated primary marks 3-pm and their attendant related data 3-rd; thus showing a first level of information normalization. Of the two approaches for detecting ongoing session activity 1d, especially for sporting events, the preferred external device 30-xd is a vision system 30-rd-c. Such vision systems have been prior taught in at least the present inventor's other patents and applications. With respect to the alternate RF apparatus, several examples of sports tracking systems exist in both the prior art and the marketplace, such as the system marketed by Trakus, Inc. of Massachusetts and taught in U.S. Pat. No. 6,204,813, or the technology being developed by Cairos Technologies AG of Munich, Germany. The Trakus system is currently be used to track horse racing and has seen limited use in ice hockey while the advertised uses of the Cairos Technologies system are to assistant referees in goal calling for soccer games. While there are significant advantages to using the preferred vision system 30-rd-c, both apparatus are capable of producing at least the ongoing centroid locations of the attendees is (players and referees,) if not in most cases also the equipment (sticks) and game object (the puck.) It should also be noted that other sports tracking apparatus have been both proposed and implemented. For the sport of ice hockey, one of the most notable examples we the Fox Puck based upon U.S. Pat. No. 5,912,700, which was based upon IR technology.

Referring still to FIG. 8, whether vision, RF, or even IR systems are used for tracking players and or the game objects, the net result is ideally and minimally a continuous stream of external devices signals, such as 30-xd-s that indicate player identity and at least the current 2D, or X, Y coordinates. Note that at this point, such signals 30-xd-s are preferably digital in nature and undeterminable as to their source external device, e.g. either 30-rd-c or 30-dt-rf. (This undeterminable nature is indicated in FIG. 8 by showing signals 30-xd-s coming from external devices 30-rd-c and the same signals 30-xd-s coming from devices 30-dt-rf.)

Still referring to FIG. 8, the second purpose of this drawing is to provide high-level examples of primary marks 3-pm along with related data 3-rd, as would be created by differentiation stage 30-2. A careful consideration of this figure provides an overview of a main goal and object of the present invention; namely to teach a standardized approach for determining and packaging complex detailed session activity 1d information, pertaining to any given session context, that is entirely abstracted so that the subsequent processing tasks that implement content contextualization need not have embedded awareness of any domain meaning. This packaged complex detailed information is in the form of primary marks 3-pm and related data 3-rd. Furthermore, the domain meaning is carried within rules 2r, and specifically 2r-d for differentiation stage 30-2, and therefore not embedded within session processing tasks.

Pausing for a moment from the detailed consideration of FIG. 8, the present inventors note that regardless of the detection apparatus, the minimal information of player and game object centroid location can provide significant contextualization opportunities, as first taught in the present inventor's PCT application US2007/019725, entitled SYSTEM AND METHODS FOR TRANSLATING SPORTS TRACKING DATA INTO STATISTICS AND PERFORMANCE MEASUREMENTS. In this application, it was shown that by knowing these two types of information, along with the current state of the game clock (i.e. running or stopped,) it is possible to determine the states of game object possession. These states include “free,” “in contention,” and “in possession,” where “in contention” can be further delineated as “under challenge.” It was also taught that knowing the states of possession flow is instrumental in creating a wealth of statistical and contextual information. As previously indicated, what is needed is a system for determining the prior taught statistical and contextual information in such as way that the types of detection apparatus, therefore the exact external devices 30-xd used, are immaterial. In other words, what is needed is a system for which a single set of externalized, domain specific differentiation rules 2r-d can be supplied to domain agnostic differentiator device 30-df to produces the same primary marks 3-pm and related data 3-rd, regardless of the source of the external devices signals 30-xd-s processed. Once differentiated, signals 30-xd-s become normalized primary marks 3 and related data 3-rd, which are then integrated and synthesized by session processor 30-sp into the preferred statistics, especially in the form of secondary (summary) marks 3-sm and tertiary (calculation) marks 3-tm; the entire process of which is also controlled by data source agnostic, domain specific rules 2r-i (for integration,) 2r-ec and 2r-ems (for synthesis) and 2r-c (for calculations.)

What is also needed is a system capable of relating these segmented activities and accompanying statistics in a universally applicable manner to any simultaneous recordings; thus an example of the contextualization that organizes content. In the case of human based sessions such as sporting events, theater, music concerts, classrooms, trade shows and conferences, etc., the preferable recordings include video and audio. By a careful reading of the present invention, those skilled in the necessary art of information systems will sufficiently understand how this content contextualization, and therefore interrelation of detected activities to activity recordings is accomplished.

Referring again to FIG. 8, no matter how the external device signals 30-xd-s are created, once differentiated using rules 2r-d, they are stored as object tracking data 2-otd, all of which will be subsequently discussed in more detail. Note that the present invention anticipates that several concurrent tracking apparatus, for several different tracked objects, both physical and virtual, may produce information desirable for simultaneous storage as object tracking data 2-otd. This is portrayed as additional data differentiators 30-df-2 and 30-df-3, where zero to many additional differentiators are possible. As was previously mentioned, one example of additional tracking information is the crowd noise level, which is detectable using microphones as external devices 30-xd, and can be differentiated into ongoing tracked noise levels associated with player movements all stored together in the object tracking database 3-otd.

Still referring to FIG. 8, any and all of the 30-xd-s signals coming into the object tracking database 2-otd, from any one or more external devices 30-xd, may be differentiated using rules 2r-d separately or in combination; all of which will be subsequently explained in greater detail. The net result of this differentiation stage 30-2 is the creation of normalized primary marks 3-pm and their related data 3-rd. Show to the right of object tracking data 2-otd is a table of information that might be producible from such data regarding concurrent player and game object positions relative to each other. As was taught in the present inventor's prior PCT application US2007/019725, knowing these relative positions along with the state of the game clock is sufficient for determining the cycles of possession flow; namely “receive control,” “exchange control,” and “relinquish control.” This information is determinable by both team and player within team. As the possession changes state from player to player, within and across teams, it will be understood by those skilled in the application of sports that these are very important activity edges defining events 4. What shall be taught subsequently in greater detail is how domain specific differentiation rules 2r-d can be used to establish the thresholds for determining the states of possession in a general way applicable to players as variables, independent of their identities. The player's identities may then be associated as related data 3-rd.

Furthermore, also as taught in PCT application US2007/019725, the current locations of the players and game objects are continuously relatable to the important boundaries defining the playing area of a sporting contest; e.g. in ice hockey the zones or the scoring area inside the goal net. Therefore, as players and the game objects move about their positions relative to the playing area create additional activity edges for defining events 4. Again, the present invention will show that domain specific differentiation rules 2-rd may be established that use fixed session area boundary coordinates as thresholds for comparing to the current player centroid location, thus providing a powerful and simple method for defining activities such as zone of play or scoring cell shot location. Referring again to FIG. 8, shown flowing to the right out of data differentiator(s) 30-df-1, are examples of primary marks 3-pm along with valuable related data 3-rd (above each mark) that is representative of the contextual information the present invention is designed to create, at least for the context of ice hockey. All of these marks 3-pm and related data 3-rd represent the flow of detected activities over session time line 30-stl that will subsequently be integrated and synthesized into internal session knowledge. Referring next to FIG. 9, there is shown teaching from the present inventor's U.S. application Ser. No. 11/899,488 entitled SYSTEM FOR RELATING SCOREBOARD INFORMATION WITH EVENT VIDEO that amongst other benefits taught the integration of the scoreboard clock with the recoding process. Hence, in reference to FIG. 2, the apparatus of FIG. 9 captures official game clock information 230. Step one includes using external device 30-xd-12 for differentiating scoreboard and game clock data 230 (see FIG. 2,) comprising camera 12-5 to capture ongoing current images 12c of a sporting scoreboard 12 for interpretation by scoreboard differentiator 30-df-12. In step 2, images 12c are compared within differentiator 30-df-12 to image background 12b pre-captured from the same scoreboard at the same position, while its clock face was turned off. As will be understood by those skilled in the art of image analysis, this subtraction of current pixels from background pixels, when compared to a threshold exceeding the expected image processing noise levels, readily yields a resulting foreground image 12f. As will also be understood, during a calibration step, the scoreboard 12 face may be separated into meaningful combinations, or groups, of characters, such as 12-1 through 12-8. Each group 12-1 through 12-8 may comprise one or more distinct characters or symbols. And finally, in step 3, as each ongoing image 12c of the scoreboard 12 is captured and segmented into foreground image 12f, differentiator 30-df-12 further divides each group into individual cells (or characters) such as the “clock” group 12-1 broken into the “tens” cell 12-1-1, the “ones” cell 12-1-2, the “tenths” cell 12-1-3 and the “hundredths” cell 12-1-4. Each individual cell such as 12-1-1 through 12-1-4 is then comparable to either a pre-known and registered manufacturer's template, or preferably a set of sample images taken during a calibration step; both herein referred to as 12-t-c. As will be understood by those skilled in the art of image analysis and object detection, via several well know techniques, current frame cell images 12-f-c are then used to search pre-known template or samples 12-t-c until a match is found. Of course, at times no match will be of high enough confidence, but as will also be understood, by increasing the sample rate (i.e. captured images frames 12c) and by employing logical analysis of the ongoing stream, these misreads can be rendered insignificant.

One of the advantages of the prior teachings was that it was shown how official information can be gathered from the existing scoreboard 12 system even if the manufacturer of that system blocked any ability to digitally interface. In practice, scoreboard manufacturers such as Daktronics, of S.D., have many various scoreboard 12 consoles capable of interfacing exclusively with their scoreboards and without a simple means for receiving output of their directives. Whether by commission or omission, at least the state of the game clock itself is so important that it is desirable to have alternate methods for determining this information. Ideally, cooperation with the console manufacturer allows this same clock face data to be gathered by simply connecting some form of network cable; in which case this prior taught solution is unnecessary. Still, there are many pre-existing scoreboard 12 consoles already in use that are not capable of such interface and as such the present inventor prefers having use of the techniques shown in FIG. 9. It is worth noting that with respect to the measurement of possession flow, determining the “on” equals “clock running” vs. “off” equals “clock stopped” states is one of the three minimally sufficient and necessary pieces of real-time information along with the current centroids of all players and the game object. All of this was first taught in the present inventor's prior PCT application US 2007/019725 entitled SYSTEM AND METHODS FOR TRANSLATING SPORTS TRACKING DATA INTO STATISTICS AND PERFORMANCE MEASUREMENTS.

Referring still to FIG. 9, what is additionally taught herein is the value of treating this sub-system as an external device comprising a detector-recorder in the form of a camera 12-5 with built in differentiator 30-df-12 capable of executing image analysis routines and outputting primary marks 3-pm that at least indicate “clock started,” “clock stopped” and “clock reset.” As will be appreciated, if the scoreboard 12 console does have a digital signal out that can be read into a computer, than using software on this computer a differentiator 30-df-12 can be created that will likewise the output aforementioned primary marks 3-pm. Thus, what is important for at least the session contexts of sports, where a scoreboard 12 is used for the official game time, is that this basic start/stop/reset information is packaged in the normalized form of a primary mark 3-pm plus related data 3-rd. As will also be understood, in this case related data 3-rd at least includes the clock face values (or time) when the mark 3-pm was detected and sent; hence the time on the clock when it was started, stopped or reset to. As will also be appreciated, any such differentiator 30-df-12 is also capable of reading other scoreboard character groups such as the game score or period. This ability provides an alternate way of determining official scoring information in the case where a session console (to be discussed in relation with FIG. 11a) cannot be employed. This information read off the scoreboard face can also be sent via normalized primary marks 3-pm and related data 3-rd.

As will be appreciated, the running clock face can be abstractly viewed as a moving object traveling along the single dimension of time (as opposed to a player traveling along the ice in two physical dimensions.) Viewed this way, clock face or official time is easily conformed to the event waveform with edges defined by the primary marks 3-pm for start of movement detected and conversely, stop of movement detected. In between these two marks 3-pm the event waveform is “on” and otherwise “off.” Since this state of clock face movement is directly relatable to session activity time line 30-stl, then as will be seen its event waveform is readily combinable with via either exclusion (ANDing) or inclusion (ORing) with any and all other integrated waveforms. All of which will be subsequently taught in more detail. And finally, as will also be understood, and is preferable, scoreboard differentiator 30-df-12 may itself filter the stream of primary marks 3-pm placed on the network by other external devices 30-xd. In so doing, it will recognize the session “start” and “end” marks 3-pm generated by the external device session console 30-xd-14 (to be discussed in relation to upcoming FIG. 11a, FIG. 11b and FIG. 11c) and therefore both commence and end its provision of scoreboard differentiated primary marks 3-pm.

Referring next to FIG. 10a, there is shown external device player detecting bench 30-xd-13 for differentiating which team players are currently sitting in the bench or penalty areas; information that is essentially a simplified variation of machine measurements 300 depicted in FIG. 2. With this information, it is then acceptably accurate to assume that any players (attendees 1c) known to be present at the game (session 1) that are not on the bench are in fact on the ice surface (session area 1a.) While the present inventor is aware of other apparatus for determining this information, including preferred vision systems as herein discussed and also taught in the present inventor's prior patents and applications, this RFID technology has some advantages. First, the RFID label 13-rfid provides simple and conclusive player identification and is inexpensive, passive and may easily be hidden; for instance by applying as a sticker to a part of the player's equipment such as shin pad 13-e. This placement is ideal since it does not affect the player, is easily covered by the player's shin pad sock, and ultimately positions the RFID label 13-rfid at a height coinciding with the boards directly in front of them as they sit on the team bench or penalty box.

Still referring to FIG. 10a, the typical boards at an ice hockey rink are hollow thus allowing a series of antennas (such as 13-a6) to be mounted just inside, nearest to the bench, so that their detection field radiates out towards the facing player's shins as they sit, stand or move. Sufficient antennas 13-a6 can be purchased from manufacturers such as Cushcraft. It is then possible to hook these antennas 13-a6 to a multiplexer 13-m such as provided by Skytek, out of Denver, Co. The multiplexer is then connected to a RFID reader 13-r, also supplied by Skytek. This combination allows the entire bench and penalty area to be scanned for the presence of team players. Besides the novel use of this apparatus more typically used in the retail or manufacturing industries, the present invention teaches that this is also an external device 30-xd. Data stream 2-ds from external device 30-xd-13 reader 13-r may then be passed directly to differentiator 30-df-13 for translation into normalized primary marks 3-pm. As will be easily understood by those skilled in the art of software, such as differentiator 30-df-13 can be made of software running on any networked computing device and all that is necessary is that it converts the “RFID found” signals into primary marks 3-pm matching the herein taught or equivalent protocol. As will also be understood, ultimately, differentiator 30-df-13 could even be embedded within reader 13-r, as it can be done generally with any existing technology already producing useful data streams 2-ds.

As will also be understood, and is preferable, player bench differentiator 30-df-13 may itself filter the stream of primary marks 3-pm placed on the network by other external devices 30-xd. In so doing, it will amongst other things recognize the session “start” and “end” marks 3-pm generated by the external device session console 30-xd-14 (to be discussed in relation to upcoming FIG. 11a, FIG. 11b and FIG. 11c) and therefore both commence and end its provision of player bench differentiated primary marks 3-pm. Also, following the session “start” mark 3-pm will be a series of “who” marks 3-pm (as will be shortly taught,) where some of these marks 3-pm will indicate through related data 3-rd that they are describing a “home” or “away” “player.” For each player's primary mark 3-pm, additional related data 3-rd will provide that player's “RFID label code” all of which comes from manifest 2-m to be differentiated by external device 30-xd-14 (again, to be taught subsequently in detail.)

Suffice it now to say that session console device 30-xd-14 is intended to initiate the session 1 and to differentiate the session manifest 2-m that includes session attendee 1c information which in the context of a sporting event such as ice hockey would include the list of players for each team. Hence, at the start of each session 1 for an ice hockey game, the player detecting bench 30-xd-13 is capable of receiving a list of players matched with their pre-known RFID labels 13-rfid. The player detecting bench may also receive game “clock started” and game “clock stopped” primary marks 3-pm from the scoreboard differentiating external device 30-xd-12. Using the combination of these different data streams, i.e. the externally differentiated player-to-rfid list and current clock states as well as the internally differentiated player presence on bench state, it is possible to generate individual primary marks 3-pm when each known player shows up (is on) or leaves (is off) their respective bench or penalty areas. The related data 3-rd for such marks would minimally include the player's identifying number (from the manifest, tied to the rfid,) if not also their name. As will also be understood by those skilled in the art, it is even more preferable that the manifest information simply include a player id along with a matching rfid and that ultimately this player id is the related data 3-rd that is provided with each “on/off bench” primary mark 3-pm. As will be shown, this player id is then recognizable to the session processor as a standard session data type indicative of an attendee 1c, thus allowing for automatic association with all other pre-know attendee 1c data, including in this example their jersey number and name.

It is also notable that other major sports follow the practice of segregating teams into distinct areas, often on different sidelines of the playing field. While the present inventor and others have taught systems and are building and marketing systems for tracking players throughout the entire field of play, the present teachings demonstrate the significant value in simply knowing that a given player is now “on the field,” or “having a shift.” This information is less expensive to collect therefore making useful systems for a wider range of the marketplace, especially including youth sports. As will be shown, knowing when an ice hockey player is on the ice for a shift is sufficient to segment the resulting game video so that a coach, player, parent or scout could quickly find and review the activities of that single player. As will also be shown, having this knowledge then allows other statics to be automatically determinable based upon that player's game time; all of which has great value. While the present invention specifies the use of passive rfid, other player-on-bench detecting technologies could be used.

For instance in the sport of soccer, Cairos Technologies, of Munich, Germany, uses an underground wire system to create a magnetic field that is capable of detection by an active sensor placed in the soccer ball. Once the sensor self-determines its own position using these magnetic fields, it can transmit this information along with a unique code via rf signal to a system for tracking the ball's position when around the goal. While such systems are being tested and may have limited success, they are costly to implement over the entire playing field, and for all practical purposes of little use to the youth outdoor soccer market. However, variations of this technology could be used to detect the simple presence of a youth athlete on the team bench area where the magnetic field generating wire could be built into the benches and therefore portable and simple to install. The wires could also be run through a matt that is spread along the team bench area (such as a layer of artificial turf) that would be simpler to install but perform the same basic function. What is most important is to see that this system from Cairos Technologies is capable of acting as an external device whose signals can become object tracking data stream 2-otd. Taking this approach, a differentiator 2-df may then follow external differentiation rules 2r-d designed by other parties to differentiate the stream into activity edges that are packaged as normalized primary marks 3-pm and related data 3-rd. By translating the custom data stream into a standard protocol the present invention allows data from such systems to be readily integrated and synthesized with other relevant data collection and recording devices. It is the combination of this information that will provide the highest value in contextualizing and organizing the session content.

If the matt approach as just mentioned is taken, then a system from ChampionChip of the Netherlands is already available and has the added advantage of using passive, low cost transponders. Used primarily in long running foot races, such as a marathon, the system includes a portable matt with a built in wire system capable of emitting a magnetic detection field. The system generating the magnetic field then detects the presence of the transponder and sufficiently energizes it so that a unique code may be transmitted. These mats are then placed strategically throughout the race course, such as at the beginning, middle and end are used to collect times at location be each runner. What is preferable about this solution is that it is low cost, easy to implement and passive. The present invention teaches the novel use of such systems as an alternate means for determining “player shifts” by laying the matt along the team bench and penalty areas. In fact, it is be preferable that the matt is made of artificial turf and permanently installed on the sidelines of a football or soccer field where the more expensive electronics is then easily ported between fields for use on a paid game-by-game basis. This solution is anticipated to also be acceptable for ice hockey as the bench and player areas are already lined with rubberized mats to protect the player's skates. Again, what is important is both the novel application of the existing technology to the new use of detecting player bench and penalty are presence as well as the incorporation of its data stream into a normalized protocols being established herein, making the integration of is valuable data significantly more accessible.

As will be understood by those skilled in the arts of both passive and active rf, microwave, magnetic and other electromagnetic, non-visible energies, these non-camera based solutions may have particular niches where their solutions are most desirable. Systems other than those discussed herein are both possible and exist. As already mentioned, Trakus of Boston, Mass., has developed an active microwave transmitter solution capable of tracking accurate positions over very large areas—however it is currently very expensive. Referring next to FIG. 10b, there is depicted a side view representation of manually operated session recording camera 270-c as it captures ongoing images 270-i of session area 1a (in this case portrayed as a hockey ice surface and boards.) Such images constitute all or a portion of game recordings 120a as depicted in FIG. 2, that are also a part of disorganized content 2a depicted first in FIG. 1. Note that like most playing areas of a sporting event, for ice hockey this session area 1a may have natural or desirable virtual boundaries such as 1a-b12 and 1a-b23. In hockey, these representative virtual boundaries break session area 1a into three zones, typically referred to as the defensive, neutral and attack zones. Especially at youth sporting events, it is not untypical to have a parent videoing the game from a perched position either holding the camera such as 270-c or having it rest on a tripod operated using handle 270-h. The present invention depicts the preferred use of a digital shaft encoder 270-e to determine the ongoing rotation of camera 270-c's field-of-view as it is rotated (panned) to follows the action. Shaft encoder 270-e then provides is ongoing data stream 2-ds of current angular positions to differentiator 30-df-270 while manually operated camera 270-c provides its ongoing video stream across the network to be digitally stored as raw disorganized content 2a. The ongoing angular positions of the field-of-view can be thought of as centered on optical axis 270-oa. Note that camera 270-c, encoder 270-e and differentiator 30-df-270 together form zone differentiating external device 30-xd-270.

Therefore, as will be understood by those skilled in the art of encoders and positioning systems, assuming that the camera remains in a fixed position, the current shaft rotation can be pre-calibrated to indicate when the optical axis 270-oa crosses a virtual boundary such as 1a-b12 and 1a-b23. As will be immediately appreciated, placing the camera 270-c nearer to the midpoint of session are 1a so that when pointing directly at area 1a its optical axis 270-oa is perpendicular to the central longitudinal axis of area 1a, and therefore also in this case parallel to boundaries 1a-b12 and 1a-b23, provides the most ideal data. As will also be understood, by tracking the back and forth movements of the manually operated camera, the encoder can additionally yield related data 3-rd including the direction of boundary crossing. Using this minimal information, as will be understood, four variations of primary marks 3-pm can be generated as the manual camera's optical axis 1rv-m-oa is moved to follow the session activities 1d. First, one primary mark 3-pm is generated as axis 1rv-m-oa crosses boundary 1a-b12 from the defensive zone1 into the neutral zone2, while a second is generated for the reverse movement. Third, a primary mark 3-pm is generated as axis 1rv-m-oa crosses boundary 1a-b12 from the neutral zone2 into the attack zone3, while a forth is generated for the reverse movement. As will be appreciated by a careful reading of the present invention, while there is some inaccuracy due to the logical assumption that the optical axis 270-oa crosses these boundaries 1a-b12 and 1a-b23 along the central longitudinal axis of area 1a, this information has many uses. In general it is a simple and cost effective way of tracking the current zones of play within a game and is especially helpful when combined with other detected information, e.g. the player shifts as already taught. Furthermore, when combined with information such as the state of the game clock, the location of the camera's optical axis 270-oa can be a rough indication of the location of a face-off which is valuable information for contextualization of content. Other innovative uses of information are also possible. For instance, differentiator 30-df-270 can be used to determine a “flow paused” event based upon the hovering in a single local range of the optical axis 270-oa. The differentiator 30-df-270 could also detect “rushes north” (i.e. from defensive to attack) vs. “rushes south” (i.e. from attack to defense) with all manner of variations, i.e. the action does not have to proceed the entire length of the session area 1a. This concept of a rush is especially useful when it is understood that there is another simple way of separately determining team possession events using inexpensive hand held clickers (as will be discussed especially in relation to upcoming FIG. 12.) Hence, while not known by differentiator 30-df-270, consecutive durations of team possession can be denoted by a stream of primary marks 3-pm provided from another external device, such as a hand held clicker, whereby session processor 30-sp can subsequently integrate this information with primary rush marks 3-pm from differentiator 30-df-270 to combine via integration rules 2r-i into, for example, “team attack” events.

What is important is to understand that valuable information is already being generated at many sessions 1 now being recorded with manual labor using fixed cameras that are panned back and forth to follow the session activities 1d. What is taught is to use one of several apparatus for determining the ongoing position of the manually operated camera's optical axis, and therefore also field-of-view. While the present invention prefers the use of digital shaft encoders, other technologies are equally suitable. For instance, it is also possible to use MEM based inclinometers to sense shaft rotation, such as sold by companies like Signal Quest of Lebanon, N.H. One drawback is that these devices are fundamentally gravity based and so the natural horizontal plane of camera rotation must be orthogonally translated into a vertical plane—thus engageable by gravitational forces. As will be understood by those familiar with mechanical transmissions, a simple and inexpensive solution is to attach a right angle gearbox to hold the rotation shaft of the camera 270-c. In this way horizontal panning motion of the optical axis 270-oa can be translated via the gearbox into a vertical rotation by inserting a second short shaft into the free opening of the gearbox onto which the inclinometer may be mounted. Thus the inclinometer's vertical rotations may be interpretable as optical axis 270-oa horizontal pan angles. This gearbox solution has the added benefit that a gear ratio can be built in that for instance turns the inclinometer at a 2 to 1 ratio with the optical axis 270-oa. Since in practice the camera 270-c is typically panned no more than 180 degrees, this will give a full sensing range of 360 degrees for the inclinometer's maximum angle detection. A second benefit of using MEM based inclinometers is that they can be built to detect rotation in two orthogonal axes. Hence, using this exactly described setup, if the base of the gearbox was free to tilt in the z-plane, then the same inclinometer can now sense optical axis 270-oa up-down movement as will be appreciated by those skilled in the art, thus increasing the precision of the boundary crossing assumptions. What is of next importance is to understand that regardless of the detection method, it is desirable that the stream of source data 2-ds be converted via differentiator 30-df-270 into the normalized stream of primary marks 3-pm with related data 3-rd so as to be readily integrated with other disparate information created by any number of additional external devices, either known or unknown to the makers of the now zone-detecting camera 270-c. It should also be further noted that as an external device 30-xd, this zone-detecting camera 1rv-m may output either data stream 2-ds or object tracking data 2-otd for differentiation by 30-df-270. Similar to the abstraction of the “moving game clock” to be like a moving person, except that the clock is limited to a single dimension, so also the optical axis 270-oa can be thought of as a moving object also along a single dimension, or with tilt sensing even along two dimensions, the same as the athletes.

Other variations of this concept are anticipated. First, using two separately located and manually operated cameras 1rv-m, the continuous intersection of their optical axes 270-oa can be jointly interpreted by a single differentiator 30-df-270 so as to gain a more precise “center-of-play” using the well known concepts of triangulation. At professional sporting events, there are often many fixed manually operated cameras 270-c capable of pan and tilt motion. The present invention teaches that by equipping these existing devices as herein taught with the appropriate angle sensing technology feeding one or more differentiator's 30-df-270, a new set of useful information including the ongoing center-of-play stored as object tracking data 2-otd, as well as current zones of play, flow pauses and team rushes are easily determinable and made available for integration and synthesis with other external data into even more meaningful contexts. And finally, the present invention here now also teaches that these same concepts are equally applicable for semi-automatic camera systems where the camera operator moves either a joy stick or touches a touch-panel to indicate the desired changes to camera 270-c pan and/or tilt angles. In this case, the data streams 2ds or 2-otd are then provided by the joy stick, touch panel or similar external devices 30-xd, but otherwise are equivalent in conceptual teaching to the preferred aforementioned apparatus.

And finally, as will also be understood, and is preferable, zone differentiating external device 30-xd-270 may itself filter the stream of primary marks 3-pm placed on the network by other external devices 30-xd. In so doing, it will recognize the session “start” and “end” marks 3-pm generated by the external device session console 30-xd-14 (to be discussed next in relation to FIG. 11a, FIG. 11b and FIG. 11c) and therefore both commence and end its provision of zone differentiated primary marks 3-pm.

Referring next to FIG. 11a, there is shown a data and screen sequence diagram of the preferred session console 14 for accepting official information 210 as well as some unofficial information (game activities) 250 not normally tracked on a scoresheet (see FIG. 2.) Therefore, session console 14 is acting as (has an embedded) recorder-differentiator 30-rd that captures manual observations 200 that are sent to session processor 30-sp as primary marks 3-pm with related data 3-rd and printable as official scoresheet 212 (see FIG. 2.) Console 14 is preferably implemented as a touch panel for operator simplicity, but as will be understood in the art of computing devices, this is not necessary as virtually any configuration computer, keyboard, mouse and monitor would also work sufficiently. As will be understood, this device could also be a portable hand held computer with touch interface and wireless connectivity, thus supporting the official scorekeeping practice for outdoor youth sports such as baseball, where the home team typically keeps the official score while sitting on the team bench.

Referring for a moment to a portion of upcoming FIG. 12, there is shown the preferred scorekeeper's station 14-ss (see bottom middle of drawing) that is also manual observation/session console differentiating external device 30-xd-14. As depicted, the preferred station 14-ss includes session console 14 with connected (via USB) wireless transceiver 14-tr capable of receiving signals from multiple uniquely identifiable hand held clickers 14-cl, each with multiple buttons. In the abstract, these wireless clickers 14-cl and their buttons simply become extensions of the session console 14 allowing for multiple operators to make simultaneous indications of official 210 and unofficial 250 game activates, and to make these indications at a significant distance from the scorekeeper's station 14-ss, say for instance from the team bench areas. Also preferably attached to scorekeeper's session console 14 is USB credit card reader and signature input 14-cc. The present invention teaches the idea of supplying patrons with a member's card containing at least their team identity code that can be swiped before a game (or any other type of session 1 to be conducted in that session area 1a, regardless of context and therefore activity 1d, e.g. game vs. practice,) thus providing a quicker means for initiating the session 1 recording. This same reader 14-cc is then usable to conduct a sales transaction, if for example either the home, away or both teams would like to purchase the recorded and organized content. The signature input pad on reader 14-cc can then alternatively be used to capture coach's and referee's signatures for inclusion with the manifest data 2-m. And finally, the preferred scorekeeper's station 14-ss includes connected (via USB) scorekeeper's lamp 14-l, that is capable of at least turning red and green in response to the actions of the scorekeeper and therefore the current state of data entry on the session console 14.

Switching back in reference to FIG. 11a, the session console 14 in abstract is meant to be used in place of traditional paper and pencil means for recording official game information. Towards this end, the general concepts herein taught are applicable at least to all sports for which this practice is in place. The present inventor is aware of prior art from Bishop, U.S. Pat. No. 6,984,176 B2 that specifies the use of touch input screens for gathering official scoresheet information, especially pertaining to ice hockey. The teachings and claims of Bishop are directed to the simple replacement of paper and pencil so that the information can be made readily available locally via network connections and remotely via the internet. These practices have been well established in other industries for quite some time predating Bishop's application. This prior art also teaches the use of a signature input to accept the referee and coach's signatures for inclusion with the official scoresheet data; again, an practice used routinely in other industries for collecting official signatures, for example with shipping companies such as UPS.

Beyond the teachings of Bishop, the present application addresses key opportunities for relating the scorekeeper's entered data in real-time sequence onto the session time line 30-stl (see FIG. 8) of the ongoing session 1, thus providing for a very important means of content contextualization. Hence, while the apparent goal of Bishop's patent was to produce an electronically transmittable scoresheet with web-postable statistics, the present teachings view each distinct entry of official information as real-time indications of session activities 1d, and therefore differentiable into primary marks 3-pm with related data 3-rd. As a by-product of the production of this stream of normalized differentiated official and unofficial manual game observations 200, both a physical and electronic scoresheet may be produced and transmitted via all the well-known methods established for many years, especially since the advent of the Internet. To best accomplish this coordination of official and unofficial data with the session activity 1d time line, the present invention teaches the novel integration of the scorekeeper's session console 14s with indications of the official game clock's 12 state; i.e. “running,” “stopped,” or “reset.” As will be seen, this information becomes very useful for automatically flipping to appropriate data entry screens for the scorekeeper. It also allows for the novel control of the scorekeeper's lamp 14-l helping to solve a persistent youth sports problem where the referee does not always wait sufficiently for the scorekeeper to finish recording their data before restarting the game. And finally, since the present invention turns the scorekeeper's session console 14 into a real-time manual observation device, it now becomes possible for the scorekeeper to make very simple but useful additional (subjective) observations such as, but not limited to:
Home breakaway started;
Home shot taken (official information);
Great save on Home breakaway;
Away breakaway started;
Away shot taken (official information);
Great save on Away breakaway;
Hit;
Last Hit was big Hit, and
(perhaps unfortunately) Fight.

These observations are simple to make by the scorekeeper with relatively good accuracy and have value both as statistics and as a means for indexing content, even to the point of the real-time clipping of video as electronically distributable highlights. As will be understood, the prior list is not the extent or limit of the data to be accepted by console 14, but rather indicative of novel information not typically included in the official scoresheet nor anticipated by Bishop in the teachings of U.S. Pat. No. 6,984,176 B2. Different sub-contexts, e.g. practice, game, tryout, clinic, etc., even within the same context, e.g. ice hockey, football, soccer, theatre, music concerts, etc., will justify their own manual observations 200, e.g. “official” and “unofficial” data, or rather their own necessary indications of real-time activities. The descriptions therefore presented in relation to FIG. 11a are to be carefully understood as indicative examples, and not a limitation of the present invention in any way, nor a limitation specifically of the session console 14. Both the present teachings in general and the session console 14 specifically have use for many session contexts well beyond sports and ice hockey.

In the broadest sense, console 14 represents a general class of external devices 30-xd that act as recorder-differentiators 30-rd during an ongoing session to accept and differentiate manually observed information. The functions of console 14 can be embedded into any type of computing device with any type of apparatus for operator input, especially including voice activation but also including hand/body signals detected by various means including those demonstrated by current gaming systems such as Wii, from Sony. What is important is that individual activity 1d observers, and not the attendees 1c, are given one or more external devices 30-xd-14 with appropriate input means for entering observed activity 1d edges in real-time, all aligned with the session activity time line 30-stl; where the observations are transmitted to the session processor 30-sp as normalized primary marks 3-pm with related data 3-rd. In a narrower sense, with respect to sporting events where official time is kept by an existing scoreboard 12 or similar system, then at least the clock states of “running,” “stopped,” and “reset” are taught as beneficial automatic input to external device 30-xd-14. While the preferred means is to receive this information directly from the scoreboard 12 system itself, such as with a networked digital signal, where this is not possible (because it is not a feature available from the scoreboard manufacturer,) then it is alternately preferred to use a machine vision system to read and differentiate this information off of the scoreboard display (see the previous discussion of external device 30-xd-12 in relation to FIG. 9). In additional to these taught uses and benefits of console 14 for gathering manual observations 200, other advantages will be obvious by a careful reading of the present invention, especially related to FIG. 11a, FIG. 11b and FIG. 12.

Briefly referring back to both FIG. 5 and FIG. 6, the present invention anticipates the need to track ownership of all value-added in the translation of disorganized content 2a into contextualized organized content 2b, such that each value-added piece can be exchanged in an open market under agreed terms between buyers and sellers, thereby supporting the concepts of purchasable permission to use. In recap, these value-added pieces include:
The session area 1a, which is owned;
Specific calendar time slots 2-t, giving exclusive use of the session area 1a for specific session times 1b, which are owned;
The performances of session attendees 1c doing session activities 1d, which are owned;
The external devices 30-xd, whether they are records 30-r, recorder-detectors 30-rd, detectors 30-d, differentiators 30-df, or detectors-differentiators 30-dd, which are owned;
The resulting disorganized content 2a, which is owned;
The resulting source data streams 2-ds, which are owned;
The resulting object tracking database 2-otd, which is owned;
The resulting streams of primary marks 3-pm and related data 3-rd, which are owned;
The session processor 30-sp and all its functioning parts, which is owned;
The integrated, synthesized, compressed and expressed organized content 2b, which is owned;
The local content repository 30-lrp, the central content repository 30-crp and the content clearing house 30-ch, which are all owned;
The organized foldering system 2f for reposting prior to interactive review, which is owned;
The session media player 30-mp for interactive, selective foldered content 2b review, which is owned, and
The external rules governing detection and record stage 30-1, differentiation stage 30-2, integration stage 30-3, synthesize stage 30-4, expression and encode stage 30-5, aggregation stage 30-6 and interact & select stage 30-7, which are all owned.

Any and all combinations of ownership are possible and anticipated between any and all combinations of value-added pieces as just reviewed. The market price for any particular owned value-added pieces is immaterial to the present invention and may be set at $0.00. Nor is it a requirement of the present invention that all proposed ownerships (and accompanying permissions) be tracked in order to stay within the present teachings. Likewise, additional ownerships in the future might be established, perhaps for example to individual attendees 1c, therefore apportioning session activity ownership 1d. What is herein taught is a system capable of tracking these or similar ownership pieces and providing built-in mechanisms for enforcing purchased permissions where demanded by the various value-added piece owners.

As also taught with respect FIG. 6, it is preferable to form both the session manifest 2-m and the external device registry 2-g before a given session 1 is processed. In recap, the session manifest 2-m records at least the following ownerships:
“Who”—the necessary session attendees 1c present, and
“What”—the session context bounding the recognizable activities 1d to be performed.
“Where”—the session area 1a being used;
“When”—the time slot within calendar 2-t being used, therefore the session time 1b;

In recap, the external device registry 2-g records at least the following ownerships:
“How”—the external devices 30-xd (30-rd, 30-d, 30-dd, 30-df) used to record and detect session activities 1d, and
“How”—the external rules 2r that govern the external devices 30-xd and session processor 30-sp.

As previously indicated, the preference of separating recorded ownerships related to the “who,” “what” “where,” “when” and “how” questions between the session manifest 2-m and registry 2-g is not necessary, other combinations are possible including a single set of data (e.g. all ownership is held in the manifest 2-m) or more than two data sets; as will be appreciated by those skilled in the art of information systems. What is most important is that preferably all, but at least some of these ownerships are recorded and tracked matched to the resulting organized content 2b.

Now returning to FIG. 11a, as will be furthermore understood by those familiar with running facilities where session areas 1a are typically rented, or at least used by various groups of attendees 1c, it is helpful to pre-establish a calendar of session time 1b slots 2-t. As will be understood by those skilled in the art of information systems, many variations of one or more software modules are possible for scheduling the use of a session area 1a, during session times 1b, by session attendees 1c, performing session activities 1d. What is herein further taught is the association of this information 1a, 1b, 1c and 1d as a session manifest 2-m. As will be seen, it is critical that manifest 2-m be in a normalized universally accessible format to flow forward into the creation of contextualized content 2b, and therefore also flowing on to all of the expressions of content 2b. As will also been seen and is herein taught, this combination of 1a, 1b, 1c and 1d form what is referred to as the session context 1c, specifying the “who” (attendees 1c,) “what” (activities 1d,) “where” (area 1a,) and “when” (time 1c.) It is also important to note that the present invention specifies the benefit of defining a normalized universally accessible session registry 2-g to also be associated with a given time slot 2t, and therefore also with the associated time slot session manifest 2-m. Registry 2-g specifies the “how” (external devices and rules.) As will be seen, session processor 30-sp may then prepare itself to accept or reject incoming streams of primary marks 3-pm based upon the associated external device sources, based upon whether or not they are officially logged in the session l's registry 2-g. It will be also be shown, and understood by those skilled in the art of information systems, that both external devices 30-xd and session processor 30-sp may automatically and dynamically retrieve appropriate external rules 2r, for each and every one of their executed stages 30-1 through 30-5, from a wide range of possible rule 2r sets ideally all available via the Internet. This retrieval will be based upon both the session context 2c, described by manifest 2m, as well as the devices scheduled to process the session 1, as described by the registry 2g; all of which will be subsequently described in more detail.

Referring still to FIG. 11a, it is ideal that calendar time slots 2-t for sessions 1 be scheduled “pre-session” using some embodiment of schedule data entry programs 2-t-de. Again, programs 2-t-de effectively at least build session manifest 2-m and registry 2-g, that may require appropriate payment transactions. As will be obvious to those skilled in the design of efficient data entry systems, since information in registry 2-g is unlikely to change (e.g. because the external devices are permanently housed at the session area 1a) at least for a given activity 1d, this information can be automatically defaulted for the chosen context 2-c based upon templates containing a model of that context's registry 2-g; thus making the registry transparent to the scheduling transaction. Once the calendar time slots 2t are established as scheduled sessions 2-t associated with manifest 2-m and registry 2-g, the session 1 may be conducted forthwith.

It is now especially noted that FIG. 11a is exemplary, and as such the session console 14 is being referred to as the scorekeeper's session console 14. As is made clear by the present teachings, the session 1 to be conducted is not limited to sporting events, especially those requiring a scorekeeper. In abstract, console 14 represents an interactive tool for one or more session observers to make manual observations 200 (see FIG. 2,) even where the event is not related to sports, or is not a sports game, but perhaps a practice. Therefore, as will be understood by a careful reading in relation to FIG. 11a, many of the overall concepts have value outside of the taught sports game example. For instance, at least the associating of the manifest 2-m and registry 2-g with the functions of the console 14, such that critical context 2c and ownership information may ultimately be differentiated into primary marks 3-pm for provision to the session processor 30-sp. While remainder of the description of FIG. 11a will be focused specifically on the sport of ice hockey, as will be appreciated, many of these same concepts are directly applicable to at least other sports, especially those with a game clock, official periods, scoring, referees, penalties, and desirable activity highlights. The present invention should therefore not be limited in scope to ice hockey or the exact functions of the screens and sub-screens depicted in relation to FIG. 11a. For instance, many sports have scorekeeper's, game officials and a scoreboards 12 potentially directed by a separate operator. In these cases, the coordination of the activities of the scoreboard operator, game officials and scorekeeper are greatly facilitated by the integration of the differentiated scoreboard 12 information (e.g. “clock running,” “clock stopped,” and “clock reset”) and session console 14. As will be discussed forthwith, this integration provides the means for automatically switching console 14 sub-screens to match the ongoing detected state of the session 1; for example, “game in play,” vs. “time out” or “between periods.” This integration also provides the means for signaling to the referees that the scorekeeper is “ready” or “not-ready” by appropriately changing the colors on lamp 14-l to for example green and red, respectively. And finally, it will also be appreciated that session console 14 is enhanced for many sporting situations by the integration of wireless clickers 14-cl that effectively provide remote buttons for making additional manual observations 200, either by the scorekeeper(s) remotely from console 14, or by other observers, including for sports team coaches and game officials.

Referring still to FIG. 11a, the scorekeeper ideally begins the recording and contextualization of session 1 by using screen 14-s1 to select the appropriate game from schedule 2t. As will be obvious to those familiar with software, many variations are possible. Since the console 14 is affixed to session area 1 (“where”) and can readily determine the date and time (“when”,) the simplest implementation of screen 14-s1 is to confirm the “host” attendee (“who”,) also assumed to be the owner of the session activities 1d if not also the session time slot 1b. Again, this confirmation is preferably done by swiping a membership card through reader 14-cc, but could also be accomplished in various other ways as will be understood, e.g. by accepting an attendee code. Once this confirmation of “who” is made, by looking at schedule 2t the preset indications of “what” session activities 1d are to be performed is easily recalled; e.g. game, practice, etc. As will be understood, screen 14-s1 should ideally allow the owning “host” to override the “what” session activities 1d; i.e. to switch from a game to a practice. In order to determine the “how” information, screen 14-s1 simply refers to the selected time slot in schedule 2t that records the associated registry 2-g. And finally, as will be easily understood by those familiar with software systems, in this example the “host” is a team, and therefore essentially a group representing a list of other “who”s, in this case the players and coaches. Once the team is identified by id, the list of associated player and coaches can be displayed on screen 14-s1 so that their status for the session is confirmed; e.g. in abstract, “present,” or “absent.”

In FIG. 11a, console 14 has a second introductory screen 14-s2 that may be used if the pending session 1 was not already scheduled pre-session and therefore listed in calendar 2t. Unlike the schedule data entry screen 2-t-de, the “where” (session area 1a) and “when” (session time 1b) questions do not need to be asked on screen 14-s2, since that are already know or determinable (respectively.) Furthermore, like screen 14-s1, if the operator has a member card, then 14-s2 will accept this as a means of identifying “who,” otherwise a code or similar software tool is used. All that is left is to prompt the operator of the “what” (session activities 1d) are to be performed and this can be easily presented as a list, group of buttons, etc. Once selected, the manifest 2-m may be created and an entry placed into the calendar 2t, if desired for record keeping (but not necessary for session processing.) Since the manifest 2-m also defines the session context 2-c, as previously mentioned, this information is sufficient to identify a template or model registry 2-g that can be copied becoming this session's registry 2-g.

As will be appreciated from a careful reading of the intent of the present teachings with respect to the session console 14, the first two screens 14-s1 and 14-s2 are necessary at the very least because they build the minimum manifest 2-m and registry 2-g that provide the information that the console's internal differentiator parses in order to generate a series of primary marks 3-pm and related data 3-rd in a normalized data protocol for transmission to the session processor 30-sp; all of which will be discussed in more detail with upcoming FIG. 11b. As will become more apparent with further reading, additional manifest information is preferable in the area of “who” is performing. Specifically, it is ideal to have recorded in the manifest at least one software object with id for each attendee 1c whose activities 1d are being sensed and tracked (but not necessarily recorded) by at least one external device 30-xd. So far, with respect to the present teaching example of the sport of ice hockey, all that has been discussed is the identification of the “host” team and all of its participants/players and coaches/attendees 1c. Obviously, it is also desirable, but not necessary, to know and track the “guest” team and its players. All of this will be discussed in more detail starting with FIG. 11b. At this point, what is most important is the concept of a standardized manifest 2-m that defines the session context 2-c, answers the “who,” “what,” “where,” and “when” questions that are key information for the contextualization of disorganized session content 2a. It is also important that there be the equivalent of a registry 2-g, dependent upon this context 2-c, that further defines “how” the session processor 30-sp should go about its contextualization stages 30-1 through 30-5; essentially, listen to this list of external devices 30-xd and follow these rules 2r.

Referring still to FIG. 11a, using the now selected or input session context 2-c, console 14c therefore knows the desired session activities 1d, and may hence enable the proper set of subsequent sub-screens. Apart for the explanation of the POS content purchase sub-screen 14-pos to be shortly discussed, all other sub-screens in FIG. 11a are particular to the sport of ice hockey, and in that, the activity 1d of a game. Still, while the apparatus and methods of the present invention with respect to a sports game in general, and ice hockey in particular, are an object of the present invention, as previously discussed, advantages will be seen by those skilled in various non-sporting applications—the benefits of which are anticipated and herein claimed. If the session activities 1d were either not sports or not ice hockey, the remaining sub-screens of FIG. 11a would be obviously modified to best accept the manual observations anticipated for those activities 1d, without departing from the teachings herein.

Still referring to FIG. 11a, during session startup, both screens 14-gs-c and 14-gs-b provide access to point-of-sale screen 14-pos. Since POS systems are well known in the art and since console 14 is already specified to have access to both a credit card reader 14 cc and a network preferably connected to the Internet, any obvious functionality can be contained within screen 14-pos to allow the purchase of organized content 2b to be created by the session processor 30-sp throughout and after the current session 1. What is of more interest to the present teachings are the definitions of what products the system herein is capable of producing, and therefore selling via POS screen 14-pos while at the session 1, or by some other similar screen accessible for example at a kiosk in the facility housing session area 1a or via a web-site page, all as is well understood in the art of business systems. By understanding the nature of the useful products intended for production by the present invention, the apparatus, methods and overall objects will be more readily understood.

Briefly leaving FIG. 11a, as will be recognized by those familiar with youth sports and by a careful reading of the entire application, many possible variations of organized session content 2b are possible for sale, fundamentally including, but not limited to the following four categories:
A. Indexed full-recordings spanning the entire session:
   typically for the practitioners, typically for detailed study;
B. Blended, mixed, and indexed part-recordings, spanning the entire session:
   typically for the deeply interested fans, typically for full session review;
C. Blended, mixed, and indexed part-recordings, only including portions, or “highlights” of the entire session:
   typically for the interested fans, typically for quick post-session review;
D. Real-time session activity notifications, only including portions, including ongoing summaries and “highlights” throughout the entire session:
   typically for the deeply interested fans, typically for immediate and quick notice.

As will be understood, these four categories of information represent a successive narrowing of content to serve different marketplace needs and different distribution mediums. For instance, category A represents “all content.” For example, all recorded video, audio and detected events 4 in various expression, with related contextual information. This would also naturally include any formats of such content, but especially the playlist index synchronized to the recordings interactively selectable for consumption using session media player 30-mp. Category B represents a programmatically (i.e. external rules 2r) chosen subset of all information blended into an informative representation of the entire session, potentially programmatically (i.e. external rules 2r) mixed with advertisements and then also indexed, where the resulting content is preferably consumable in a traditional family setting such as a living room, as opposed to the also possible session media player 30-mp running for instance on a personal computer. Note that category A is already available to the marketplace and used mostly at the professional sports levels where the video and audio are separately captured and operators index these recordings either manually or semi-automatically, typically post-session. Category B is also available to the marketplace as a sporting event broadcast created typically by a crew assigned to videoing as well as a production manager assigned to blending and mixing.

It is further advantageous that a automatic content processing system be able to create category C, a further subset of A and B only including key activities 1d (e.g. a breakaway, goal scored, great save, big hit, etc.) As will be seen, the granularity of session content contextualization and therefore both opportunities for indexing and analysis as well as the creation of category C highlights, is highly dependent upon the number and type of external devices 30-xd used to detect session activities 1d. The present invention is forward looking in its expectation that more and better devices 30-xd will continually be developed by the open market and therefore provides what is needed, namely protocols to allow these anticipated new activity detections to be seamlessly integrated with now existing external devices 30-xd without any major overhaul of data structures and hence completely backwards compatible. And finally, category D represents the minimal automatic notifications of important session activities 1d to be transmitted to selected recipients ideally while the session 1 is in progress. Such notifications would at least include (for the present example): game started between host and visitor at location, goals scored for team by player, periods ended with scores and game ended with scores. As will be understood by a careful reading of the entire application, the only limitations to the contextualization of disorganized content 2a, and therefore any of the categories A, B, C or D, is that of the external devices 30-xd used as well as the external rules 2r implemented. Therefore, the specific examples of content should be seen as representative and illustrative, but not as limiting to the present teachings which by object and design are purposefully abstracted from actual session context 1c.

Referring again to FIG. 11a, any of the content creatable due to the combinations of external devices 30-xd and rules 2r available to the session processor 30-sp, may be purchased either before, at the time of, or after session 1 is conducted, where the functions of screen 14-pos are considered obvious to those familiar with point-of-sale systems. Once the selected or entered session manifest 2-m and registry 2-g are confirmed by the operator in screen 14-cf-1, console 14 then communicates, preferably via network messages, the primary “session started” mark 3-pm. Once received, session controller 30-sc (see FIG. 5) instantiates new, or invokes running session processor 30-sp to begin its contextualization of session 1. One of the key purposes of session controller 30-sc is to monitor the ongoing state of session processor 30-sp with the understanding that processor 30-sp may become unstable, either caught in an ambiguous rule 2r or otherwise interrupted by faulty internal task logic alone or in combination with faulty external rules 2r. Therefore, what is needed is a fail-safe design where an independent session controller 30-sc is capable of instantiating additional session processors 30-sp to take over the ongoing contextualization of session 1 should the existing processor 30-sp stall or fail. While such a fail-over system is expected to cause momentary delays in processing (that can be recovered as the session 1 continues,) by monitoring the flow of current primary marks 3-pm, one for which a session processor stalled or failed, controller 30-sc can selectively choose to disregard and log the failed mark 3-pm, thus restarting the session 1's contextualization with the last known successful state of context. Newly instantiated session processor 30-sp-fo will pick up with the last known successful session state and then process all new marks 3-pm following the now failed and skipped mark 3-pm. All of which will be taught subsequently in greater detail.

It is also herein noted that his ability of the session controller 30-sc to identify potentially errant session states in combination with next marks 3-pm and attending rules 2r is a key advantage of the present teachings. For instance, it provides the session controller 30-sc with the ability to automatically communicate this relevant information to a support staff remote of the session area 1a for ultimately understanding and correcting the unforeseen problem. As will also be taught, once the problem, presumably either embedded within session processor 30-sp's abstract task functions, contained in external domain rules, or contained in transmitted mark 3-pm and related data 3-rd, the present invention is capable of reprocessing the entire session 1 including the originally failed mark 3-pm with different post-fact corrected results. This ability highlights the value of session registry 2-g that specifically identifies exactly with external devices 30-xd and external rules 2r were used for the session's contextualization. Note that session processor controller 30-sc will also therefore update the registry 2-g with the exact version of itself, the session processor 30-sp and all other key system modules.

Returning now to FIG. 11a, the culmination of operator inputs into either sub-screens 14-s1 or 14-s2 is the invoking of the start session recording and processing screen 14-s3. Screen 14-s3 has two primary functions after gaining operator “yes” confirmation to its “start session recording—yes/no” question. The first task is generic to all session 1 applications, while the second is specific to all scoreboard based sporting applications. Namely, task one is to inform secession controller 30-sc that a session 1 has been properly requested and should be commenced. This communication is by the sending of appropriate “session start” primary mark 3-pm and related data 3-rd. As will be understood by those skilled in the art of distributed system design, session controller 30-sc is ideally a service class running somewhere on the network. Controller 30-sc then responds by either instantiating or invoking a session processor 30-sp to carry out contextualization stages 30-2 through 30-5 for the current session 1. Controller 30-sc will then also instantiate or invoke all other related recording classes and otherwise start all external devices 30-xd for creating differentiated session 1 primary marks 3-pm and related data 3-rd. As will be understood, recording classes will ideally include additional network services for receiving, synchronizing to session time line 30-stl and recording video and audio source data streams 2-ds from IP cameras and microphones. Recording classes may also include additional network services for buffering live video and audio for temporary storage while session processor 30-sp executes in response to the ongoing session marks 3-pm it receives. As will be shown, session processor 30-sp may then communicate highlight clipping requests to these additional network services that have buffered the live recordings. All of which is the subject of subsequent teachings herein.

Now referencing both FIG. 11a and FIG. 11b, there is shown console differentiator 30-df-14, embedded within session console 14, together forming external device 30-xd-14 for differentiating manual observations 200. The larger responsibility of differentiator 30-xd-14 is to create and send all primary marks 3-pm and related data 3-rd for all manual observations 200. After console 14 sub-screen 14-s3 invokes differentiator 30-df-14 to send the “session start” mark 3-pm, its second task is to then again invoke differentiator 30-df-14, this time to differentiate manifest 2-m and registry 2-g. As shown in FIG. 11b, differentiator 30-xd-14 is a computer algorithm that upon command is capable of parsing data 2-m and 2-r, that collectively define the “who,” “what,” “where,” “when,” and “how” descriptions of the current session 1 into primary session marks 3-pm and related data 3-rd for example including:

Preferably sent first after the “session start” mark:
“How”—“external device 1” thru “external device n” marks;
“How”—“external rules source 1” thru “external rules source n” marks; Preferably sent next, after the “How” marks:
“When”—“schedule date/time” mark;
“Where”—“session area” mark;
“What” (type of activity)—“session type” mark;
“Who”—“home team” mark;
“Who”—“home player 1” thru “home player n” marks;
“Who”—“visiting team” mark;
“Who”—“visiting player 1” thru “home player n” marks;
“Who”—“officiating crew” mark;
“Who”—“game official 1” thru “game official n” marks;
“Who”—“guest 1” thru “guest n” marks;

As will be appreciated, these are exemplary marks whose actual descriptions, or names (e.g. “home team” mark) are immaterial. What is important is that the session console 14 includes differentiator 30-df-14 capable of parsing some digital format of manifest 2-m and registry 2-g and transmitting all critical information in a standardized protocol that is being followed by all external devices 30-xd; guaranteeing that all information input to session processor 30-sp be uniformly interpretable, and both forward and backward compatible. (Again, the critical information taught herein indicates session area 1a, time 1b, attendees 1c and activities 1d that together form the session context 2-c, as well as the list of external devices 30-xd that will be differentiating the session 1 and the external rules 2r that are to govern all contextualization stages 30-1 through at least 30-5, run on the external devices 30-xd and session processor 30-sp.)

For other session contexts 2-c, especially outside of ice hockey or sports (e.g. a classroom,) or even within ice hockey (e.g. a practice,) the actual marks sent by the console 14 are anticipated to be different. For other applications, including an ice hockey practice, it is also anticipated that the console 14 software might be running on a smaller portable device, such as a PDA, or may be voice activated with a blue tooth headset feeding a cell phone running a version of the session console 14 with differentiator 30-df-14.

Also shown in FIG. 11b is scoreboard differentiating external device 30-xd-12 that feeds its detected marks, e.g. “clock reset,” “clock started” and “clock stopped” over the network. Once on the network, any external device 30-xd is ideally capable of receiving and responding to these marks, but especially console 14. Session console 14 as will be discussed in returning to FIG. 11a, uses at least the changing game clock state to automatically switch between various sub-screens thereby assisting the operator. Also, console 14 ideally uses the combination of the game clock state as differentiated by 30-df-12 as well as the current data entry status per individual sub-screens on console 14 to operate console lamp 14-l. Hence, the present invention teaches the benefits of a tight integration between the manual observations differentiating external device 30-xd-14 and the scoreboard differentiating external device 30-xd-12. In this regard, hence the tight and useful interaction of any and all external devices 30-xd, as previously indicated for prior discussed external devices, it should also be understood that it is preferable that all external devices 30-xd be capable of filtering the stream of primary marks 3-pm placed on the network by all other external devices 30-xd. In so doing, at least each device 30-xd will recognize the session “start” and “end” marks 3-pm generated by the external device session console 30-xd-14 and therefore both commence and end the provision of their particular differentiated primary marks 3-pm and related data 3-rd. This particular feature is preferably included (although not mandatory) within all herein discussed external devices 30-xd as well as all potential external devices 30-xd as will be imagined by the marketplace, and therefore will not necessarily be further mentioned.

Referring next to FIG. 11c, there is shown an alternate configuration between the two aforementioned external devices, namely 30-xd-14 and 30-xd-12. As will be understood by those skilled in the art of information systems, especially in a networked computing environment, the new differentiator 30-df component taught in the present invention need not be physically embedded within a given external device, such as 30-xd-12. FIG. 11c teaches an alternate arrangement where the scoreboard differentiator 30-df-12a is embedded within the software of console 14 along with existing differentiator 30-df-14, thus forming alternative external device 30-xd-14a. This arrangement is both illustrative of the flexible, extensible design herein taught and presents some practical benefits for the specific interaction between the console 14 and scoreboard 12 (for instance a somewhat simpler back-forth communication.) In this alternative design, external device 30-xd-12a is no longer a differentiator, and as earlier discussed this means that its output is now considered source data stream 2-ds. (It is no longer a differentiator, even though it may still partially or fully recognize scoreboard 12 “motion”/activity edges, precisely because it does not communicate these activity edges as marks 3 with related data 3-rd.) Regardless, as will be appreciated, current scoreboard images 12c must still be analyzed for changes and as such scoreboard reading camera 12-g now feeds its images to scoreboard analyzer 12-az. The functions of analyzer 12-az should be very familiar to those skilled in the art of image analysis (see FIG. 9,) and would be very close to identical to those executed within the preferred differentiator 30-df-12; especially if the encapsulation of communicated activity edges into marks 3 is not considered. This alternate design of FIG. 11c then helps to demonstrate the differences between source data streams 2-ds, coming from more traditional device analyzers such as 12-az, and primary mark 3 and related data 3-rd streams coming from the herein taught differentiators, such as 30-df-12. Note however that analyzer 12-az presents a more frequent, synchronous stream of data, e.g. one dataset per image frame, versus differentiator 30-df-12 that gives a much less frequent, asynchronous stream. While 30-df-12's stream of marks 3 requires considerably less network bandwidth, it also looses information that is critical for forming object tracking database 2-obt.

Still referring to both FIG. 11a and FIG. 11b, as will be appreciated by those skilled in the art of network messaging and communication, and as will be discussed in greater detail with respect to FIG. 14, external devices such as 30-xd-12 are capable of picking up marks 3-pm being generated by other external devices, such as 30-xd-14; this is a key teaching of the present invention. Hence, when sub-screen 14-s3 invokes embedded differentiator 30-df-14 to sends primary “start session” mark 3-pm to session controller 30-sc, this alone can suffice to initiate the functioning of networked scoreboard reading external device 30-xd-12. In reciprocal, once started, external device 30-xd-12 need merely output detected primary marks 3-pm with related data 3-rd and not be concerned or even aware of session console 14. Sub-process 14-p1 of console 14 is then responsible for continuously monitoring network mark 3-pm traffic to selectively receive and process scoreboard related marks 3-pm from external device 30-xd-12.

Once notified, as will be understood, external device 30-xd-12 may then start to supply marks 3-pm and related data 3-rd in real-time as the face of scoreboard 12 changes in response to the operation of the scoreboard console. (As first discussed in relation to FIG. 9 and depicted again in FIG. 11b.) Since scoreboard related marks 3-pm are present on the network as they are being sent to the session processor 30-sp, they may be picked up by the session console 14 as valuable information as will be discussed shortly. Again, such marks preferably include with respect to the game clock: “clock reset,” “clock started,” and “clock stopped.”

Referring now again exclusively to FIG. 11a, the session 1 is started, session controller 30-sc has been notified and has started session processor 30-sp, the manifest 2-m and registry 2-g have been differentiated by manual observation differentiator 30-df-14, and scoreboard differentiating external device 30-xd-12 has picked up the session's “start” mark 3 and is now differentiating at least the game clock of scoreboard 12. While the scorekeeper may now operate the session console 14, preferably only the current score sheet sub-screen 14-s7 is displayed and usable. At this point the score sheet is also empty and the scorekeeper's lamp 14-l is turned off. The state of console 14 will now be automatically changed based upon three primary game clock differentiations. First, as is typical the time on the game clock of the scoreboard 12 will be controllably reset by via a scoreboard console. It is usually reset to a some introductory warm-up time, e.g. in youth sports five minutes. When scoreboard external device 30-xd-12 detects this change, it send “clock reset” mark 3 with related data 3-rd that ideally includes the new detected game clock value, for instance “5:00.” Session console 14 will receive and respond to this “clock reset” mark 3-pm by invoking confirm game period as set on scoreboard sub-screen 14-s4. This sub-screen will provide the operator with the ability to confirm the console 14's own internal logic which, as will be understood for those familiar with the patterns of a youth hockey game, easily determines that most likely a warm up “period” is being entered. (For instance, based upon the known know session context 2-c, it is determinable via ancillary lookup tables that a full period is typically 12, 15, 17, 20 or 25 minutes, based upon the competition level and type of game. Once confirmed, sub-screen 14-s4 invokes differentiator 30-df-14 to issue a “period set” mark 3-pm with related data 3-rd of at least “period=warm-ups,” after which the scorekeeper is returned to the score sheet sub-screen 14-7.

Eventually, warm-ups will expire causing a “clock stopped” message that will automatically turn the scorekeeper's lamp 14-l to red, thus indicating that control is now at the scorekeeper's station. Typically, the scoreboard console is then used to reset the scoreboard 12 game clock to a full period time, e.g. “17:00” thus causing an additional “clock reset” mark 3-pm, this time with related data including the clock value of “17:00.” Now period confirm sub-screen 4-s4 is presented on console 14 with a default of “starting period 1” plus appropriate additional options. Once confirmed, a sub-screen 14-s4 invokes differentiator 30-df-14 to issue the “period set” mark 3-pm with related data 3-rd including the “period=1,” after which the scorekeeper is returned to the score sheet sub-screen 14-7 and scorekeeper's lamp 14-l is turned green to indicate that the referee is free to start game play. Once game play is started, typically a button on the scoreboard console is depressed sending a signal to the scoreboard and the game clock begins to count. This movement is immediately differentiated by external device 30-xd-12 into a “clock started,” which then in turn is immediately received by session console 14 which invokes game clock running sub-screen 14-s5 whose purpose is to minimally record shots by team—the only function typically performed by the scorekeeper during the game action (traditionally marking the printed score sheet.) At this same time, the scorekeeper's lamp 14-l is turned off.

As will be appreciated by those skilled in the art of software systems and especially those with touch panel interfaces, such as kiosks, there are many ways of implementing each of the sub-screens of console 14, all of which are considered obvious and not the subject of the present invention. On sub-screen 14-s5, what is new is the inclusion of additional input devices, in this case buttons, that allow the scorekeeper to enter “non-official” manual observations of game activities 250 (see FIG. 2.) The preferred buttons are for indicating:
The start of a “breakaway,” (two buttons, one for each team);
That a “great save” was just made, (two buttons, one for each team);
The a “hit” just happened, (one button, i.e. no attempt to award credit for hit);
That the last hit was a “big hit,” (one button, i.e. no attempt to award credit for hit);

Hence, in response to console 14's operator, sub-screen 14-s5 invokes differentiator 30-df-14 to create primary marks 3 and related data 3-rd, for instance as follows:
“home breakaway,” or “away breakaway”;
“home shot,” or “away shot”;
“home great save,” or “away great save”;
“hit,” and
“big hit.”

These particular observations are exemplary, and should not be considered as a limitation on the present invention; other buttons for observing other ice hockey activities could have been added without deviating from the present teachings (nor do any of these particular buttons need to be present.) Furthermore, the present invention teaches this functionality as hardware configuration independent, as input means independent, and as context/activity type independent. What is taught is that this manual observation entry device 30-xd-14, is capable of differentiating into normalized marks 3 and related data 3-rd, any and all provided for observations of the console 14 operator(s), including but not limited to those accepted via touch panel 14, attached wireless clickers 14-cl as well as other well known apparatus such as speech input. These marks may represent official or un-official observations, they may be considered objective or subjective in nature; all of which is considered within the scope of the present invention.

Still referencing FIG. 11a, three preferred uses of wireless clickers 14-cl are taught. First, clickers 14-cl may be individually assigned and associated with one or more coaches on either or both teams. As will be understood by those familiar with X10 automation systems, such clickers 14-cl transmit in their wireless “button pushed” signal both a uniquely identifying code for the clicker itself, and also a code indicating the button pushed (if more than one button is provided.) The present invention teaches that clickers 14-cl be assigned to specific coaches who then register their clicker 14-cl device with session registry 2-g prior to the session 1. During this process, as will be understood by those familiar with software systems, it is possible for the coach to choose between various available mark 3-pm types, or to create a new mark 3-pm type, to be associated with each given clicker 14-cl button. In operation during a given session 1, a coach may then press their clicker 14-cl button 1 which in turn sends unique source signal 2-ds through the USB wireless transceiver attached to console 14 to be received and differentiated by embedded 30-df-14. This differentiation process would then use registry 2-g information to translate each individual coach's button presses into their desired primary mark 3-pm. Hence, the head coach may desire to send a “bad play” primary mark 3-pm when pressing their button one while an assistant defensive coach pressing their button one has indicated that this should be differentiated as “failed clear.”

As second preferred use of clicker 14-cl is as a team possession indicator. Hence, during session 1, at least one clicker 14-cl is given to an operator who for instance presses button one when they observe that the home team has puck (game object) possession and presses button two when the away team has possession. Such information is easy to obtain and has significant value—short of a full player tracking system that has been taught by the present inventor using machine vision and is available in other methods such as RF from Trakus; both systems of which are significantly more expensive than additional clicker 14-cl. Furthermore, for the youth marketplace, the accuracy of the observers “team possession” marks 3-pm as clicked through session 1 need not be perfect to have significant uses. As will be understood, each alternate click is the activity 1d edge that closes one team's possession and opens the other. For a face-off, where neither team has possession, the first recorded click after the “clock started” primary mark 3-pm is differentiated by 30-xd-12, will indicate the winner of the face-off, also very useful information. Furthermore, as will be understood by those familiar with digital waveforms, this simple set of “team possession” marks 3-pm will provide two waveforms. These waveforms may then be exclusively and inclusively combined with any other wave forms creating very useful secondary events 4-se, as will be discussed further. Examples include “team possession on power plays,” or “team possession by zone,” or “player shift team possession.”

The third preferred use of clicker 14-cl is as an inexpensive video editing tool to be given to an observer for indicating when fun or exciting moments have just happened. For instance, in youth sports, a single clicker 14-cl could be given to a parent who watches the game and presses button one for a “big hit,” button two for a “great save,” button three for a “fight,” button four for a “great goal,” etc. Or, alternatively, this observer could register their clicker 14-cl into external device registry 2-g so that button one meant “3 second highlight,” and button two meant “10 second highlight,” etc. It is even envisioned that for some applications, multiple observers using individual clicker's 14-cl, each “pre-programmed” with the same button-to-mark relationships could essentially form a polling system, where the consistency of their observations is used to by rules 2r when determining if events 4 should either be created and or once created, how they should be classified, quantified, prioritized or otherwise expressed.

From these three examples, which will be well understood by those familiar with youth sports to be both simple to implement and useful, the reader will see that the present invention teaches a flexible system for allowing multiple remote observers, via wireless clickers 14-cl, to create source data streams 2-ds to be differentiated by manual observation differentiator 30-xd-14. Furthermore, the reader will see that the ability for each clicker 14-cl to have its button-to-mark relationships pre-defined in registry 2-m is highly valuable and has many applications and uses beyond these three specific examples, and beyond ice hockey and sports; all of which is considered within the scope of the present invention.

Again referencing FIG. 11a, eventually, while game play is continuing, the game officials will typically stop game play using their whistle and possibly a hand signal. Once observed at the scorekeeper's station 14ss, a button is pressed on the scoreboard console causing the game clock to stop counting. When this happens, scoreboard device 30-xd-12 immediately differentiates the scoreboard change and sends the “clock stopped” mark 3-pm, which then is turn is also picked up by console 14 that immediately invokes game clock stopped sub-screen 14-s6. At this same time, console 14 turns on scorekeeper's lamp 14-l causing it to be red in color, thus indicating that game control is now at the scorekeeper's station 14-ss. For the example of an ice hockey game, there are several well understood reasons that game play may be stopped, which are all immaterial to the present invention as other sports will have other reasons, some similar, some not. With respect to ice hockey, these reasons are themselves handled by four sub-screens 14-s6a, 14-s6b, 14-s6c and 14-s6d for indicating penalties, goals, a penalty shot with results and other reasons for the game stoppage, respectively. Other sports are expected to need similar sub-screens, at least for penalties and scoring, if not also other game stoppage reasons. Some of the screens, which ideally use touch buttons for indications of observed activity, may rather have their respective buttons on the game clock running sub-screen 14-s5.

For instance, in the sport of basketball, scoring happens during game play without interruption. In this case, the present invention would teach the addition of “home basket” and “away basket” buttons to sub-screen 14-s5. Note that also for basketball, the “home shot” and “away shot” are preferably kept as manual observation buttons, thus providing information on the basket to shots taken percentage. Similarly, basketball also has highlight activities including “breakaways,” “hits,” “big hits,” and “great shot blocks” (roughly equivalent to “great saves.” Because the speed of basketball is slower, it is anticipated that console(s) 14 for recording manual observations might also record “turnovers”/“steals” and “great baskets.” Again, what is important is that manual observations are collectable on one or more external devices, herein called consoles(s) 14, which can be of any typical hardware and connectivity configuration. At least one of these console(s) 14 will be considered the main scorekeeper's console 14 that officially starts and stops the session 1 recording and contextualization process. As previously eluded to, any given console 14 may accept simultaneous input from one or more observers; for instance where the first observer is using the physical embodiment of console 14 (e.g. a wireless pc tablet with touch input,) and other connected observers are using second detached means, such as clickers 14-cl or even voice activated microphones; all of which can be thought of as the equivalent of indicator buttons, marking a point in time when an observation was made, and at least indicating the type of activity 1d observed. Referring still to FIG. 11a, the typical reasons for game stoppages will be handled by the other reasons sub-screen 14-s6d, and for hockey would include things like:
“icing”;
“off-sides”;
“goalie cover-up”;
“time-out”;
“injury,” and
“net off moorings.”

All of these differentiations and others similar thereto, can be made with respect to each team, e.g. “home icing” versus “away icing.” There are other types of stoppages not necessarily or easily attributable to a given team, especially at the youth level, such as but not limited to:
“broken glass”;
“puck out-of-play,” and
“scorekeeper.”

On occasion, teams will also score goals which for ice hockey preferable creates either a “home goal” or “away goal” primary mark 3-pm, with related data 3-rd at least including:
time of goal;
scored by player number;
assist1 by player number;
assist2 by player number, and
type of goal (i.e. “even strength,” “power play,” or “short-handed.”)

As will be appreciated, other sports would require similar marks 3-pm, but may also benefit by different types of related data 3-rd. What should be obvious is that just as the only marks 3-pm than can be sent to the session processor 30-sp are for activity edges that can be detected by some external device 30-xd, whether it is fully-automatic, i.e. a machine observation 300, or semi-automatic observations like the location of play information determinable from manually operated game camera tripod 270, or manual observations 200, such as made by a scorekeeper, the associated related data 3-rd must come from this same source of information. The present invention does teach several novel methods for determining useful primary marks 3-pm and valuable related data 3-rd. For instance, the examples of FIG. 9, FIG. 10a, FIG. 10b, FIG. 11a, FIG. 11b., FIG. 12, FIG. 13a, FIG. 13b, and FIG. 13c. Within each of these figures there is shown useful activity edge information and related data, all of which will be appreciated by those skilled in the various potential applications, especially sports, most especially ice hockey.

While the present invention does seek to claim these specific new device teachings for determining new and useful combinations of activity information, the larger teaching is of a system for differentiating these herein specific examples as well as all potential existing and yet to be invented external differentiating devices, into a standard minimal protocol leading to maximum opportunities for the integration, synthesis and expression of the detected information, thus forming useful, contextualized, indexed, organized content 2b. Content that is more readily distributable because it has associated in a universally standard way semantic descriptions formed ultimately by the combinations of the information detected by the various external devices and packaged in the primary marks 3-pm and related data 3-rd. It is not the purpose of the present teachings to show all possible apparatus and methods for finding the many potential activity edges for the many potential applications. The present invention is a continuation in part of some applications from the present inventor that do concentrate on new external devices, many of which prefer vision systems, but not all. It is important to understand that the present invention expects to receive information from various existing technologies developed and being developed for the detection of interesting activities, in either the real or virtual worlds. What these existing devices currently lack is at least the ability to provide normalized differentiations, especially those targeted to activity edge detection.

The present invention is using the examples of the sport of ice hockey precisely because it has sophisticated interconnected activities that are detectable, or at least becoming more detectable in all of the aforementioned general ways; again most especially fully automatically by machines (300,) but also semi-automatically by devices monitoring human observations (270,) or by input devices accepting verbatim human observations (200.) Because of the popularity and economics of sports, in addition to its complexities, many technologists are striving to create new devices for tracking activities (which is not to be construed as the same as determining activity edges)—although no systems are yet teaching the herein disclosed ideas of a generic abstract externally programmable (i.e. via rules 2) set of external devices 30-xd and session processor 30-sp. Furthermore, the present invention recognizes that as of yet there is no single approach to creating internet shareable content that follows a standardized set of protocols that will greatly facility structured, token based content retrieval, also referred to as the semantic web. As taught herein, these tokens will be both descriptive of context and activity as well as source and ownership. This last teaching, provides and enables useful methods for tracing detailed interwoven ownership from source all the way to individual consumption (e.g. by user 11 on session media player 30-mp who has purchase permission 2f-p to view content in folders 2f.) For all of these stated reasons, the functions of the console 14 and its various parts are to be seen as both individually novel and as abstractly representative of a larger function (i.e. the collection and differentiation of manual observations 200,) that itself is a part of a still yet larger machine, that of the session automated recording together with rules based indexing, analysis and expression of content.

Referring again to FIG. 11a, during a stoppage, the scorekeeper may invoke penalty sub-screen 14-s6a to enter one or more penalties per team, to be preferably sent as “home penalty,” or “away penalty” marks 3-pm with at least some if not all of the following related data 3-rd:
penalty on player no.;
served by player no.;
type of penalty;
penalty time, and
additional penalty (e.g. the player was given a game misconduct.)

As already discussed, this related data is also exemplary and not to be construed as limiting the current teachings. And finally, with respect to either a penalty shot or shootout (which are actually conducted when game play is stopped,) the sub-screen 14-s6c ideally allows the operator to indicate who the player is, to push a button at the moment the player starts to move towards the net (i.e. “shot started,”) and then to push either of two buttons after their attempt; specifically “shot,” or “goal.” It will be obvious to those skilled in the application of hockey scorekeeping that some of this information is kept. What is considered additionally novel over current scorekeeping systems is the ability to differentiate with separate marks 3-pm both the beginning of the penalty/shoot out shot and its end. These marks 3-pm are then useful for creating shot and goal events 4 thus indexing this activity 1d for content types A), i.e. full recordings, and B) i.e. partial blended and mixed recordings, and also facilitating its expression as either content types C), i.e. “highlights” or D), i.e. notifications.

Still referring to FIG. 11a, while game play is stopped and the scorekeeper is still entering information/observations through any of sub-screens 14-s6a through 14-s6d, the scorekeeper's lamp remains on and red. Once the scorekeeper has finished entering data they press a “done” or similar button on console 14a which immediately causes differentiator 30-df-14 to be invoked appropriately to send primary marks 3 and related data 3-rd. Also, lamp 14-l is switched from red to green, thus indicating that the scorekeeper has completed their tasks and the referee is free to start the game. Again, once the game is started and the clock begins to count, the differentiated scoreboard mark 3-pm indicating “clock running” will be picked up by console 14 which then turns off lamp 14-l. While the clock continues to count, the scorekeeper is repositioned to the game clock running screen 14-s5 for entering game in play observations. At any time, the scorekeeper can invoke current score sheet sub-screen 14-s7 where the now see the same information they would typically find on the hand written score sheet. From this sub-screen 14-s7, the scorekeeper can select any given goal or penalty and recall the appropriate sub-screen in order to edit the information. Upon completion of such edit, new marks 3-pm and related data 3-rd are sent to session processor 30-sp and will update existing events following rules 2r.

As will be discussed at a later point with respect to the basic object types of the present inventions, and especially in relation to marks 3 and related data 3-rd, the present inventor is aware of tradeoffs between the granularity of the mark 3 type and related data 3-rd kept versus the complexity of the attending rules 2r. As will become more apparent, and for example, at least the goals penalties and goals differentiated 30-df-14 invoked by console 14 could be of either two formats as follows:
1. Two distinct mark 3-pm types, one being “home xxx” vs. “away xxx” plus any related data 3-rd. (This is the aforementioned example.)
2. One mark 3-pm type, i.e. “xxx” plus any related data 3-rd, especially including “Team=Home” or “Team=Away.”

As will become more apparent with a careful reading of remaining patent, each distinct mark type requires its own set of rules for at least integration upon receipt into session processor 30-sp. In this regard, it might seem that the second approach simplifies the development of rules 2r, i.e. there is only one set of rules that handle all penalties and goals (for example.) However, as will be seen and taught, this will necessarily add complication to the implemented rule 2r's rule stack. This complexity is presented to both the rules developer and the session processor 30-sp. While the present inventor prefers the first approach of separate marks 3-pm for these type situations, in the larger teaching of the present invention, this facts and tradeoffs of this choice are intentional and represent a feature, and not a limitation. Both implementations are possible and stay within the teachings herein specified and claimed.

Referring next to FIG. 12, there is shown a preferred configuration of external devices 30-xd capable of differentiation essentially as taught thus far, all fitted to an ice hockey rink. While it will be shown that this system is fully functional, it is not to be construed as a limitation on the present invention. Variations are possible most especially in regards to the chosen external devices 30-xd without deviating from the essential teachings. The fact that variations are possible is one key object of the present teachings—as already pointed out, the exact configuration of external devices is intentionally variable. FIG. 12 will serve as an example of how one type of session activity 1d, for of a single context can be captured for both recording and contextualization therefore creating organized content 2b. With relation to FIG. 12, there is shown session area 1a-1 to be an ice sheet. Also depicted is ice sheet scoreboard 12 typically operated by a scoreboard console (that is not depicted and immaterial.) Furthermore, there are home and away player benches and penalty areas, and as often found in youth ice hockey, a place for the scorekeeper in between the benches. The present invention first adds to the environment session processing & recording server 30-s-svr that preferably is maintained in some office area outside of the actual rink. As will be understood, server 30-s-svr can be a single system, a blade server, multiple systems with a highly connected backplane or any number of configurations now or in the future available. The actual computing platform chosen is immaterial to the present invention, although as will be seen, what is material is the highly service-oriented design allowing for the separation of the pieces and parts of each stage of content processing to be run in parallel and spread across multiple connected computing platforms, all of which will be discussed subsequently in greater detail. For the purposes of FIG. 12, it is sufficient to think of server 30-s-svr as running and storing the data for at least session controller 30-sc, each instantiation of session processors 30-sp, all recording and compression services 30-c as well as the resulting local content repository 30-lrp. Still referring to FIG. 12, because of the volume of information to be recorded & processed by server 30-s-svr, it is ideally connected to the rink via a fiber optic cable run through multi-port sheet hub 30-s-h into preferably Giga-Ethernet caballing that makes the final connections to each external device 30-xd. It is important to note that the purpose of FIG. 12 is to help create a higher-level image of how various external devices 30-xd can combine with the session processing equipment and software to create a customized useful system. Once fully understood, FIG. 12 becomes exemplary of all types of session areas 1a and potential activities 1d not simply and ice rink and ice hockey respectively. It is not the purpose of FIG. 12 to explain the functioning of any external devices in detail or how they interact over time. Most of the apparatus and methods of external devices 30-xd portrayed have already been discussed in relation to prior figures as well as how they interact, if they interact. One main point here and object of the present invention is that each external device 30-xp becomes in a sense “plug-and-play” to the system. If it is added to the session area 1a for capturing session activities 1d all that is necessary is that it issues marks 3-pm with related data 3-rd that are pre-registered to the session processing components, as will be subsequently described in greater detail. After this, which other external devices 30-xd use this information is irrelevant to the functioning of the issuing external device 30-xd. If one external device 30-xd requires information from another devices 30-xd, or the session processor 30-sp, it will filter the network traffic of primary marks 3-pm and related data 3-rd accordingly. For external device 30-xd creating primary marks 3-pm and related data 3-rd, the necessary rules 2r informing the embedded or external differentiators 30-df and the session processor 30-sp as to how processing should proceed must be available, or the marks 3-pm will be ignored by 30-df and 30-sp.

Therefore, FIG. 12 shows the connection of the following external devices 30-xd, namely:
1) Session console differentiator 30-xd-14;
   a. (starts and stops session 1, session processor 30-sp and all other external devices 30-xd)
2) Scoreboard differentiator 30-xd-12;
3) Home player bench differentiator 30-xd-13-h;
4) Away player bench differentiator 30-xd-13-a;
5) Zone differentiators 30-xd-270 and 30-xd-15;

As is portrayed and will be understood, all of these listed external devices place their differentiated primary marks 3-pm on the shared network to be accessed by any other external devices 30-xd and ultimately processed by session processor 30-sp running on session server 30-s-svr. In addition to these activity differentiating external devices, FIG. 12 shows two types of recorder-detector 30-rd only external devices 30-xd, namely overhead views external device 30-rd-ov and side views external device 30-rd-sv. The present inventor prefers using multiple fixed, non-movable overhead IP POE HD cameras with on-board MJPEG compression, as will be understood by those skilled in the art of security camera systems that are preferably arranged to form a single continuous, contiguous view of session area 1a-1. Beyond simply capturing video for recording and playback, and as taught in prior patents and applications by the present invention, these overhead cameras may have their image streams analyzed in order to create an ongoing database of tracked objects, 2-otb. As prior, this tracking database may then be used to automatically and in real-time determine at least the pan, tilt and zoom adjustments of one or more side view cameras attached for instance to pan, tilt and zoom controls 370 (see FIG. 2,) that take directives from recorder controller 30-rc.

In this case, external device 30-xd-ov output their source data stream 2-ds as a continuous flow of image frames throughout session 1. These image frames are then analyzed using object tracking techniques that are both prior taught by the present inventor and well understood by those skilled in the art of machine vision. This analyzer is preferably a software routine running on session server 30-srv as an independent service invoked by session controller 30-sc, one per camera. The present invention herein further teaches that this analyzer class be enhanced to also become a rules 2r based differentiator 30-df, the essentials of which will be subsequently disused in detail. If an object tracking differentiator 30-df is added, than recorder detector external devices 30-xd-ov now becomes player tracking differentiator external devices 30-xd-ov. Either configuration works in the present invention. For instance if external device 30-xd-ov does not differentiate player movement within session area 1a, then the object tracking database 2-otd will not exist and there is no requisite information to feed recorder controller 30-rc, which in turn then cannot send pan, tilt and zoom adjustments to pan, tilt and zoom controls 370, upon which a side view camera is attached. In this alternative case, the present inventor prefers using a well known semi-automatic camera device such as a joy stick (not shown) or a cameraman's touch panel 30-xd-15.

As will be well understood, either the joystick or touch panel 30-xd-15 accepts operator directives to typically pan or tilt the controlled side view camera. The present invention herein teaches that such standard techniques be augmented to move beyond their primary function of adjusting a side view camera to also become zone differentiators 30-df. Similar in concept to the teachings in reference to FIG. 10b, as will be understood by those familiar with security systems, the operator controls that move the side view cameras optical axis can be considered a source data stream 2-ds which is readily differentiated into the current zone location of the camera's center-of-view. Hence, whether using overhead player tracking external device 30-xd-ov, or either of side view zone detecting external devices 30-xd-15 or 30-xd-270, the net result is at least the flow of “into zone” primary marks 3-pm and related data 3-rd, if not also “flow paused” and “team rush” primary marks 3-pm, as discussed in relation to FIG. 10b.

Referring next to FIG. 13a, FIG. 13b and FIG. 13c, there are shown additional exemplary external devices including referee's observation differentiator 30-xd-16, umpire's observation differentiator 30-xd-17 and manual observer's object speed differentiator 30-xd-18. There are two main purposes for these figures. The first is to further teach the advantages of the present inventions contextualization scalability, the reason for normalizing source data streams 2-ds into primary mark streams 2-pm and related data 2-rd. As will be obvious to those familiar with sports in general, the additional information collectable by these three exemplary devices by themselves have some limited usefulness. However, by creating a system where their data is easily combinable as and with primary mark streams 2-pm from other independent external devices 30-xd, the foundation is in place to create a significant set of domain specific contextualization decisions. As will be understood by those skilled in the art of information systems, normalizing these data streams has significant value on its own, apart from how the information is then processed for contextualization, or any other uses for that matter. The majority of the present teachings thus far have concentrated on the overall apparatus and methods (i.e. the figures labeled as “system”) as well as the first stage 30-1 for detecting & recording disorganized content. Understanding this stage 30-1 requires understanding the purposes, apparatus and methods that are collectively herein referred to as external devices 30-xd (see the figures labeled as “external devices”.) A critical aspect of these teachings is the addition of the differentiator 30-df to the traditional forms of external devices for collecting source data streams 2-ds, thus converting these streams 2-ds into mark streams 3-pm.

The second main purpose of for these figures is to teach these exact devices for their own sake. It will be understood that they have value individually, for their source data streams 2-ds alone, regardless of their differentiation into mark 3-pm streams. In these regards, now referring exclusively to FIG. 13a, there is shown a referee observations differentiating external device 30-xd-16, for creating primary marks 3-pm and related data 3-rd corresponding to referee game control signals 400 (see FIG. 2.) This particular device 30-xd-16 is a variation of the teachings of the present inventors as disclosed in prior PCT application serial number US 2005/013132 entitled AUTOMATIC EVENT VIDEOING, TRACKING AND CONTENT GENERATION SYSTEM (see FIG. 20 of this application.) This prior design of the signal detecting referee's had several advantages over prior art. For instance, it used air flow throughout the chamber of the whistle to sense activation (i.e. whistle blow) rather than using the detection of the resulting frequency limited sound waves. With the prior art, given ambient sound waves, the chances for interference where significant. Furthermore, it was difficult to know exactly which referee blew the whistle, especially if two were close to each other. Using a simple air flow detection apparatus overcame these prior limitations. External device 30-xd-16 teaches two main advantages. The first, is adds a differentiator 30-xd-16 so that detected whistle blown signals 2-ds are translated into normalized primary mark 3-pm and related data 3-rd. This advantage is considered an applicable teaching regardless of the underlying whistle blown detection apparatus, i.e. based on sound waves or air flow. The second advantage is that its underlying apparatus as will be shortly discussed is straightforward to implement given the current state of the art in MEM devices, as will be understood by those skilled in the art.

Still referring to FIG. 13a, there is attached to whistle 16 a vibration sensor MEM device that are commonly available in the marketplace. One such supplier of the types of vibration sensors than can be specifically tuned to a select range of vibration frequencies is Signal Quest of N.H. It is possible to attach or embed one of their vibration sensors into the shell of the whistle in such a way that with a sufficient degree of accuracy the sensor will transmit a signal only when the whistle is blown. As will be understood by those familiar with detection systems especially for human behavior, the range of vibrations necessary to detect is broadened due at least to the inconsistencies of the referee (e.g. the strength or duration of their whistle blow,) in addition to the inconsistencies of whistle construction, especially including the chamber size, acoustical characteristics and wall thickness. In order to allow for a broader range of threshold acceptance, the present inventor prefers adding a second inclinometer sensor 16-t-1, also a MEM device sold by Signal Quest as well as others. As will be understood by those familiar with such devices and with the normal whistle blowing techniques of a referee, it is possible to first detect if the whistle is oriented in a longitudinally parallel position with respect to the ground surface, i.e. the whistle is being help level so that it can be properly placed in the mouth of a referee that is standing erect and therefore orthogonal to the ground surface. This second set of information in combination with the first signal will provide greater accuracy, as will be understood by those skilled in the art.

Still referring to FIG. 13a, it is herein taught to add a second inclinometer 16-t-2 as a third data collector; this time attached to referee 11-r's wrist of the arm they would typically use to signal an infraction or that stoppage of play is imminent. Note that this arm is typically not the arm that would hold whistle 16. Operationally, the preference is to use the inclinometer to detect if the referee's hand is raised for instance above the horizontal (90 degrees,) above a 135 degree rotation off of the ground surface or 170 degrees or more rotated off the ground, i.e. within 10% of fully perpendicular to the ground surface. These three signals would provide a high level of accuracy that a referee's 11-r hand was raised. At least in the sport of ice hockey, this knowledge, especially transmitted as marks 3-pm with related data 3-rd (such as the referee's number/id,) has significant value. Note that in ice hockey, after spotting an infraction (i.e. a penalize-able activity 1d performed by one or more attendees 1c,) the practice is for the observing referee to immediate raise their hand and wait for the offending team to gain possession of the puck, after which they will blow their whistle 16. The time between the actual raising of their hand, after they have observed the infraction, until they blow their whistle 16 is therefore a variable. By detecting when their infraction indication, which is really marking the end of the activity 1d—i.e. the penalize-able activity, the session processor 30-sp can create a more accurate infraction event 4 because its ending time is more exactly known and assuming that the beginning of the infraction was X seconds prior is reasonable. (All of which will be taught as a specific example in relation to the discussion of integration.) Beyond providing a more accurate indication of the end of an infraction activity 1d, therefore leading to more accurate indexing of a resulting infraction event 4, there are other reasons that a referee, at least in ice hockey, will first raise their hand before blowing their whistle 16; such as to indicate an “icing” or “delayed off-sides.” In any case, once their hand is raised, the potential for their whistle to be blown, while not a 100% is significantly higher. Therefore, having this information to combine with the signals generated by whistle 16 increases the overall differentiating accuracy of external device 30-xd-16—all of which will be well understood by those skilled in the art of electronic and digital system design. Beyond therefore creating a new set of primary marks 3-pm and related data 3-rd, such as “infraction” and “whistle blown” for use during session 1 integration and contextualization, it is understood that especially the whistle blown primary mark 3-pm, or even its source data stream 2-ds, can be used to stop the game clock of scoreboard 12, which has many advantages that will be well understood by those skilled in the sport of ice hockey. Using data stream 2-ds, this functionality has been described at least in the present inventor's prior application that taught the air-flow detecting referee's whistle. And finally, the present inventor prefers that signals generated by MEMs 16-v, 16-t-1 and 16-t-2 be first received via wired connection and differentiated by device 30-df-16 prior to wireless transmission as marks 3-pm and related data 3-rd. Referring next to FIG. 13b, there is shown umpire's observation differentiating external device 30-xd-17. As will be familiar to those in the sport of baseball and softball, it is customary for at least the home plate umpire of a game to use prior art mechanical umpire's clicker 17-a. Clicker 17-a is used to record the umpire's observations of pitched balls and strikes, as well as total team outs per inning. The present invention teaches the value of using a wireless device essentially similar to clickers 14-cl of FIG. 11a and FIG. 12, here now referred to as umpire's clicker 17-b. As was previously taught, the present invention allows the clicker 17-b owner to register their external device 30-xd-17 and in the process map their device's buttons to desired marks 3-pm. Therefore, as clicker 17-b is operated for instance, differentiator 30-df-17 uses source data stream 2-ds and registry 2-g external device map to create and send “strike,” “ball,” “out,” and “undo,” primary marks 3-pm and related data 3-rd when buttons “S,” “B,” “O,” and “U,” are pressed respectively. As will be understood, especially in relation to the teachings of FIG. 11a, differentiator 30-df-17 is preferably a standard algorithm operating on a computing device, and in this case the device is preferably a session console 14. Hence, in the sport of baseball and softball at least as practiced at the youth level, the envisioned console is very similar to design and purposes to that taught for ice hockey in FIG. 11a and FIG. 12. As will be understood by those familiar with these sporting applications, the envisioned baseball/softball console might be a portable tablet with a wireless network connection and USB hubs so that it can receive information both from the umpire's clicker 17-b and the baseball/softball scoreboard (similar to 12.) While not specifically taught in detail, it will be understood that the arrangements envisioned especially in relation to FIG. 13b are beneficial and fall within the scope of the present invention.

Referring next to FIG. 13c, there is shown object speed differentiating external device 30-xd-18. Radar guns such as prior art 18-a are well known. For the sport of baseball, they are typically operated by an individual sitting behind home plate who recognizes the situation (i.e. the game is in play and the pitcher is about to throw their next pitch) and so they hold up the radar gun 18-a and take an object speed measurement of the pitched ball. As will be appreciated, this level of labor is difficult to afford at the youth level and is otherwise tedious. What is needed is a way to automatically collect the object speed information and to integrate this with other simultaneous knowledge that will differentiate the entire set of information into an in-game pitch-by-pitch database. The present invention teaches the housing of new portable radar gun 18-b inside of detachable housing 18-b-h that may be affixed to permanent mount 18-b-m. Ideally, permanent mount 18-b-m stays in place for instance attached to the batting cage of a baseball (or softball) diamond, located so that when attached, housing 18-b-h holding gun 18-b is sufficiently located to pick up good object speed measurements for the anticipated pitches. As will be understood, gun 18-b is preferably IP and also POE, but in any case is connectable to object speed differentiator 30-df-18. Once in place, connected and powered, gun 18-b will start transmitting all detected object speeds (perhaps over a minimum threshold of velocity.) The source signals 2-ds from gun 18-b are differentiated by 30-df-18 into primary “object speed” marks 3-pm with related data 3-rd including the detected speed. This information is then available over the connected network to be integrated with all other marks 3-pm from all other external devices 30-xd in use during the session. As can be seen, by itself this information would be difficult to interpret but especially in combination with umpire's observation differentiating external device 30-xd-17, and further with the use of a manual observation differentiating external device similar to 30-xd-14, to be used by at least the scorekeeper if not also the coach's (using clickers 14-cl.)

In general FIG. 13a and FIG. 13b address the differentiation of referee game control signals 400 while FIG. 13c addresses the differentiation of game object speed machine measurements 300. A careful reader will see how the systematic application of various existing and future sensing technologies can be leveraged by adopting the herein taught differentiation protocols for establishing a normalized, activity edge “centered” primary marks 3-pm and related data 3-rd.

Referring now to FIG. 14, there is shown a block diagram sufficient for representing various configurations of external devices 30-xd first taught in relation to FIG. 5, specifically including recorder 30-r, recorder-detector 30-rd, detector 30-dt, differentiator 30-df (shown as two alternates, 30-df-a and 30-df-b,) and finally recorder-detector-differentiator 30-rdd. As will be understood, each of these devices can function individually, many of which already exist in the marketplace. It is the combination with differentiators 30-df-a and 30-df-b that begins to touch upon the novel teaching herein presented. Starting first with simple recorder 30-rd, this is well known in the art and typically comprises one or more source data capture sensor(s) 30-cs for receiving information from the ambient environment. For the present invention, such sensors 30-cs preferably include image sensors for capturing video and microphones for capturing audio. Other sensors such as MEMs are part of a larger class of transducers that are also of interest. In recorder 30-rd, sensors capture and provide internal measured signal streams that are usually received by some first process 30-1p for preparing the first measured signals to be output as source data stream 1 via data output port A (ideally IP) 30-do-A. For the purposes of the present invention, what separates recorder 30-rd is that source data stream_1, 30-do-1, has two primary characteristics, both of which are good for recording continuous session activity 1d. First, its frequency typically matches the capture rate of internal signals as measured by sensor 30-cs, thus recorder 30-rd ideally provides “raw” session source data at a period rate. And second, there is little to no filtering or interpretation of captured signals; i.e. no “detection.”

The second type of external device 30-xd used by the present invention is detector 30-dt. Detector 30-dt also comprises capture sensor(s) 30-cs as well as first process 30-1p to convert the internal source measured signals into a prepared source data stream 1. However, rather than output this stream 1 via port A 30-do-A, detector 30-dt typically performs some type of a detection or interpretation in second process 30-2p. The resulting output of 30-2p is a meta data stream that is often sporadic and is output as source data stream_2, 30-do-2. Once such example of detector 30-dt from the present example are referee hand raise detecting MEM tilt sensor 16-t and referee whistle blow detecting MEM vibration sensor 16-v. As will be understood, both of these devices have sensor 30-cs for transforming gravitational pull and vibration into measured source signals as well as a first processor for providing these in some acceptable output format. However, rather than outputting a continuous periodic stream_1 of hand tilt or whistle vibration measurements, 30-dt rather uses a second process 30-2p (typically externally adjustable) to filter these internal signals into sporadic meta data output via port 30-do-B. The result is the desired minimal information of moments when the referee's hand is raised over a programmed inclination and the times when his whistle is both raised and blown, neither of which represents “raw” source data, but rather is detected and interpreted. However, as will also be understood, the output meta data as stream_2 30-do-2 is not differentiated into normalized primary marks 3-pm and related data 3-rd. Still referring to FIG. 14, it is typical to find in the marketplace various external devices 30-xd that combine recorder 30-r and detector 30-dt into recorder-detector 30-rd. For example, such an external device would be a security camera that provides both a periodic stream of images (i.e. 30-do-1) and possibly sporadic motion detection meta data (i.e. 30-do-2.) Again, as will be understood by a careful reading of the present teachings, recorder-detector 30-rd does not provide differentiated data 3-pm and 3-rd. Given that recorders 30-r, detectors 30-dt and recorder-detectors 30-rd are prevalent in the market and provide potentially useful source data 1 or interpreted source data 2, collectively source data stream 2-ds (see FIG. 6 and FIG. 7) but all lack a normalized differentiated primary marks 3-pm and related data 3-rd, the present invention teaches the creation of a new class of external devices, namely differentiators 30-df.

Referring still to FIG. 14, there are herein envisioned two basic types of differentiators 30-df. The first, simple non-rules based differentiator 30-df-a has external data input port C, 30-di-C that is preferably (but not limited to) IP in nature (the reasons for which will be obvious to those skilled in the art of networked systems.) Input port 30-di-C is capable of receiving either or both of source data streams 1 or 2 as would be first output by either recorder 30-r, detector 30-dt or recorder-detector 30-rd. Either or both of streams 1 or 2 are then received into third process 30-3p for differentiation into primary marks 3-pm and possibly related data 3-rd, which is then output on port D, 30-do-D. As will be understood, if input to differentiator 30-df-a is only source data stream 1, 30-do-1, such as from an un-filtered security camera, than third process 30-3p might perform identical tasks to second process 30-2p (for example motion detection,) but rather than outputting non-normalized meta data signals as stream 2, 30-do-2, it would output “hard-differentiated” signals as stream 3-pm & 3-rd. In this case, “hard-differentiated” is meant to be similar in concept to “hard-coded,” a familiar term to those in the art of software systems. Hence, in many situations, such as the referee observation differentiating external device 30-xd-16, the signals being detected are simplistic in nature and therefore best processed by embedded, non-programmable logic. Also portrayed in FIG. 14 is a variation of simple non-rules based differentiator 30-df-a that is included or embedded into any of external devices 30-r, 30-dt or 30-rd. All that is needed is to replace input port 30-di-C (for receiving external data,) with internal input port 30-di-Ci; otherwise, the teachings are identical.

However, the present inventor prefers a second type of external rules programmable differentiator 30-df-b that is like non-programmable 30-df-a in that it can be embedded into external devices 30-r, 30-dt and 30-rd (therefore requiring internal port 30-di-Ci.) In order to receive external differentiation rules 2r-d, differentiator 30-df-b must have external (preferably IP) data input port C, 30-di-C; regardless of whether or not it is ultimately included or embedded into any external devices 30-r, 30-dt or 30-rd. Also required in differentiator 30-df-b is forth process 30-4p computing element capable of receiving and implementing differentiation rules 2r-d (all of which will be explained subsequently in greater detail.) Forth process element 30-4p must also receive input of either or both source data streams 1 and 2, collectively 2-ds, as will be obvious since these data streams contain electronic representations of the source activities 1d to be differentiated. While the exact teachings of the rules 2r-d and how they cause the forth processing element 30-4p are to be taught subsequently in respect to other figures, the resulting differentiated primary 3-pm and related data 3-rd are at least now referable to as “soft-differentiated” signals; again, where “soft” is understood by those familiar with software systems to represent the idea of changeable, or programmable.

Referring still to FIG. 14, the present invention anticipates that any number of obvious combinations of recorders, detectors and differentiators may be embedded together following the general patterns taught herein. As will be understood, for the purposes of the accomplishment of stage 30-1 to detect & record disorganized content and stage 30-2 to differentiate objective primary marks, the exact configuration of the individual components of FIG. 14 are immaterial. Hence, there may be three physical devices, one recorder 30r that outputs to a second device in detector 30dt, after which either or both output to a third physically separate differentiator 30-df-a or 30-df-b; or, conversely, all of these functions may be embedded into a single external device 30-xd, that is either non-programmable (because it implements differentiator 30-df-a,) or programmable, because it implements differentiator 30-df-b.)

Furthermore, as will be obvious to those skilled in the art of information systems, the differentiator 30-df may reside on the same computing system as the session processor 30-sp, hence the session server 30-svr. All that is required is that the third process “hard-differentiation” or the forth process for “soft-differentiation” have access to the necessary source data stream 2-ds and in the later case, differentiation rules 2r-d. Still, beyond the larger picture of the need for external devices 30-xd that provide many and various source data in an normalized protocol such as primary marks 3-pm and related data 3-rd, those skilled in the art of embedded source signal analyzers will appreciate that the teachings herein for a differentiator, and especially a rules based differentiator, have applicability outside of their use as a means of providing data to a session processor 30-sp or its logical equivalents. Therefore, the present invention is neither to be limited in scope to require a specific combination of elements for recording, detecting and differentiating, nor is it to be limited by requiring that “programmable” differentiation be followed necessarily by “programmable” integration, synthesis and/or expression.

Before moving on to the remainder of the specification, especially in reference to the figures starting with FIG. 15a which teaches the automatic differentiation of machine sensed content, and moving forward through the figures teaching the integration and synthesis of these differentiations, it is best to understand that the present inventors' focus is now on the contextualization of content mostly using machine measurements 300 (see FIG. 2) as opposed to referee signals 400 and manual observations 200 (that were discussed especially in relation to FIGS. 11a and 11b.) In the broadest view, for any given session 1 there will only be three types of sensed information as follows:
1) Observations and content sensed by people alone;
2) Observations and content sensed by people with machine assists, and
3) Observations and content sensed by machines alone.

Other systems now exist such as the teachings of Barstow (U.S. Pat. No. 5,671,347) for capturing observations made by people (e.g. what batter is now at the plate,) and/or people-machine combinations (e.g. what was the speed of the last pitch.) While the present invention teaches expansive new apparatus and methods to enrich the contextualization of content collected in these same ways, the teaching herein and especially from here forward, address the more difficult problem of creating an automatic system capable of addressing machine sensed content. Therefore, with a careful reading of the remaining specification, the reader will see that there is a significant amount of apparatus detail that would not be necessary if only to integrate and synthesis people or people-machine observations. Simply put, due to the limitations of human observation (even when machine assisted,) the observation (data) rates will tend to be sporadic and aperiodic. This is precisely why the teachings for Barstow for instance, have already been applied to Major League Baseball but as of yet not applied to any of the other major team sport such as ice hockey, basketball or football. Because of the high structure and low speed of baseball, human based observations are sufficient for creating a meaningful data stream. This is not to say that the other major sports cannot stream meaningful human observations, it is merely meant to point out that contextualizing the action of an amorphous, high speed sport such as ice hockey requires significant data sampling that can only be performed by machines. This in turn means that any universal system for contextualizing any type of session context, must address high volume, micro detailed machine data. And this in turn is why the next major portion of the specification is very involved, precisely to teach how machine observations can be differentiated, integrated, synthesized, expressed and aggregated, side-by-side with human observations. As the careful reader will see, there are many individual novel concepts relating to the processing of machine observations that are equally beneficial and novel for human observations, and that by removing some additional teachings meant primarily for machine observations, the overall processing taught herein could be simplified. Therefore the present invention must be addressed both as its novel whole and in its novel parts, where some novel parts may be individually useable, or in smaller combinations, without straying from the teachings herein.

Referring next to FIG. 15a, there is shown a graph depicting the differentiation of a single feature(a) 40-f of a single object(r) 40-o that varies over time with respect to a fixed threshold (t) 45-t. At the broadest levels, within a session 1 of live activity 1d, the single object(r) 40-o can be real (e.g. a puck, player center or joint, the game clock face, the crowd noise etc.,) or virtual/abstract, (e.g. a passing lane formed by two players or the center-of-activity.) The object 40-o must have at least one feature such as 40-f which can take on at least two distinct values, or states. Most objects 40-o will have many features such as 40-f. Any object's 40-o activity 1d can be differentiated by comparing at least one of that object's features 40-f to some value such as a fixed threshold 45-t. For instance, a moving puck has at least three features including its x, y and z locations. If the puck's 40-o x location feature 40-f is assumed to represent its position along the longitudinal axis of the ice sheet/session area 1a, then it is useful to compare this feature's value over time against the fixed x locations of each zone (as will be understood by those familiar with the sport of ice hockey.) Therefore, each zone location can be considered a single fixed threshold 40-t. As the puck's 40-o x dimension 40-f crosses over a zone's fixed x value 45-t, the crossing will trigger the issuance of a primary mark 3-pm1 through 3-pm3 at the time of the crossing with respect to the session time line 30-stl.

Referring next to FIG. 15b, single fixed threshold 45-t is replaced by feature 41-f on object(s) 41-o such that primary marks 3-pm1 through 3-pm3 are issued when the two varying waveforms cross, as will be understood by those familiar with mathematical functions. For example, if object(r) 40-o was a sprinter on a track and feature 40-f was that sprinter's distance from the starting line, and similarly object(s) 41-o was a second sprinter, than marks 3-pm1 through 3-pm3 would represent lead changes between them. Referring next to FIG. 15c, rather than comparing threshold 45-t directly to an object feature such as 40-f or 41-f, it is compared to some mathematical function applied dynamically to the two feature values at the same time (t) on the session time line 30-stl. For instance, the mathematical function could be subtraction expressed as an absolute value, thus showing how “close” the two values 40-f and 41-f are to each other. The threshold 45-t may then be used to define a dynamic activation range, e.g. when two object features are within a minimum closeness to each other, then this “true” value can be applied to a second differentiation such as taught in FIG. 15b. In this case as depicted, such application would obviate the issuing of marks 3-pm1 and 3-pm3 since these are determined to occur at times (t) on the session time line 30-stl that are not within the dynamic activation range. Note that the graphs in FIGS. 15a through upcoming 15f, including current FIG. 15c are meant to be representative and especially the feature value curves over time may not be continuous (or smooth) as portrayed. Some objects, such as the game clock, may have features such as the clock face that take on only two value, e.g. “started”/running and “stopped.” The graph for this function will be discontinuous and vary for instance between 1=started and 0=stopped. Hence, the function will not be continuous as portrayed in the graphs of FIGS. 15a through 15f, all of which will be very familiar to those skilled in the art of mathematical algorithms. Furthermore, as will also be understood, the exact mathematical function to be dynamically applied to any two (or more) feature values to establish an activation range is immaterial to the novel teachings herein. While FIG. 15c teaches subtraction to measure “closeness” as a very useful example, other mathematical formulas are possible and considered within the teachings of the present specification. What is important is that either one or more features plus a constant, or two or more features, are combinable via some calculation that translates their input waveforms into an output waveform that itself may be thresholded or may serve as a threshold for other feature(s,) or may be viewed as determining “activation ranges” to limit the issuing of primary marks 3-pm triggered by other feature(s) crossing thresholds.

Referring next to FIG. 15d, there is shown the same activation range determination taught in FIG. 15c with respect to objects 40-o and 41-o and their features 40-f1 and 41-f1 respectively (upper graph,) but where the second two features, namely 40-f2 and 41-f2 are being compared via some mathematical function (in this case subtraction followed by thresholding against a constant) to also first form an activation range. Thus, in this example, two distinct sets of activation ranges are being created and then compared along the session time line 30-stl, thereby triggering primary marks, such as 3-pm2 and 3-pm3, when the two activation ranges align in some logical fashion; in this figure the upper graph activation range indicates that the two features are within value g1 of each other whereas the lower graph activation range indicates that the two features are at least value g2 away from each other. As will be appreciated by those skilled in mathematics, the main difference between FIG. 15d and FIG. 15c is that the introduction of the constant g2 to act as a threshold for the mathematically combined features 40-f2 and 41-f2. In FIG. 15c, features 40-f2 and 41-f2 where simply compared for equality as a means of determining their intersection, which in turn represents the “activity edges.” As will be further understood, the objects represented in the upper graphs and the lower graphs do not need to be the same. In fact, the differentiation process can draw from any single feature on any single tracked object to be combined in any mathematical way with any other feature(s) or constant(s) to create a unique threshold dynamically changing along the session time line 30-stl for direct comparison—or again, to create activation ranges to enable or obviate the issuing of primary marks based upon other feature comparisons. Because of the first step of normalizing all sensed object tracking data, these features may or may not be measured by the same external device (i.e. technology type,) and may or may not be associated with the same objects—all of which is considered novel to the present invention.

Referring next to FIG. 15e, there is shown a typical four dimensional space Or Location=f(x,y,z,t) (upper graph) for tracking an object 40-o's feature(s), where for example, that space is physical including length (x), width(y) and height(z) location measurements with respect the session area 1a and over session time 1b forming a time series data set along session time line 30-stl. As will be appreciated, this type of space-time object feature tracking provides very important information especially when the type of session 1 is sports. However, when making differentiation rules, it is often more convenient to work in two dimensional functions as represented in FIGS. 15a through 15d. The present figure shows how the single four dimensional space can be first represented as three two dimensional spaces, namely x=f(t), y=f(t) and z=f(t); all of which is well understood by those familiar with mathematical functions.

In summary, regarding differentiation stage 30-2 (from FIG. 5,) and in reference to FIGS. 15a through 15d, the most important understanding being taught is the value of normalizing object tracking data for programmatic differentiation over time, where the differentiation is expressed as normalized primary marks 3-pm. For instance, session 1 activities 1d can be thought of as comprising one or more real or abstract objects, each of which comprise one or more features, each of which can take on two or more values. Each object's features may be sensed by a different type of external device/technology, e.g. machine vision, RF, IR, MEMs, etc. The present invention teaches that for key objects whose feature values are continually changing, it is first beneficial to follow a protocol to normalize all sensed data into a uniform dataset, as will be understood by those familiar with software systems. As will be discussed later in the specification, the present inventors have a preference for the data structures to be used to represent the tracked object feature values over time—or “tracked object database.” However, these suggested data structures are also representative and not meant to limit the present invention in any way. As will be understood by those skilled in the art of software systems, other data structures for representing unique objects with unique features that have a time series of values are possible.

What is important to note and novel to the present invention, is that by bringing together disparate data measurements representing multiple features from multiple objects into a single normalized data structure/protocol, this allows for the establishment of a “universal, agnostic” software based differentiator task that accepts as input these same one or more object features as well as static thresholds (constants) for simple and complex comparison. FIGS. 15a through 15d are directed to ways of making these feature comparisons. As will be understood, there are other multi-variate mathematical functions and/or algorithmic methods that could be implemented in addition to those taught. While the present inventors teach these specific functions and methods as sufficient for significant object tracking differentiation, they are not meant to limit the application in any way.

Again, what is considered to be most novel to the present invention is that all activities 1d conducted by all attendees 1c be detectable via some technology (e.g. machine vision, RF, IR, MEMs, etc.,) for sampling on a periodic basis preferably (but not necessarily) synchronized with the recording devices, where the sample values are organized by a tracked object and feature. Each sample then becomes a specific value recorded in a series by session time, thus creating a session-time-aligned dataset of all detectable session activities 1d. Once all activities are sampled via some technology, normalized into a single data format and synchronized by a session time line, then they may be differentiated mathematically, for example as taught in FIGS. 15a through 15d. It is further considered novel that activities 1d are taught to have “edges” where their states go through a transition from one side of a static or dynamic threshold to another. Each crossing of a threshold (edge) is then represented by a primary mark 3-pm carrying related data regarding the object(s) and feature(s) at that moment in the session time. It is also considered novel to recognize that some features in static or dynamic comparison create “activation ranges” in which the movement of other features on other objects become interesting and therefore issue primary marks 3-pm. It is still further novel that these primary marks 3-pm and their related data are themselves expressed in a common or normalized data format whether derived from the differentiations of referee signals 400, manual observations 200 or machine measurements 300, whether or not this differentiation is “hard-coded” or programmable via external rules, or whether or not the differentiator task itself is embedded in the device or performed by a second computing device not physically connected. And finally, it is considered novel that this differentiation may be programmatically controlled via external rules so that the external devices with capability for differentiation could alter their determinations based upon the external differentiation rules as pertinent to the session 1 context, i.e. the type of session such a ice hockey game, football game, concert, play, etc. Thus, the same physical external devices could issue different primary marks 3-pm based upon the session context which specifies the use of different external rules—all of which is to be further taught herein. Referring next to FIG. 16a, for the exemplary context of ice hockey, there is shown a critical set of real data (content) ideally sensed via machine measurements 300, normalized into object tracking data and subsequently differentiated, integrated and synthesized along with other captured and sensed referee signals 400 and manual observations 200, into the index 2i for organized content 2b. Specifically, this information includes the time series of location and orientation data for the player centroids 50-o, stick blade centroids 51-o and puck centroids 52-o. Both the present inventors and several others have taught various methods for obtaining this type of information on a continuous basis throughout the session 1 activities 1d. While the present inventors continue to prefer player and game object tracking solutions based upon machine vision, other technologies (such as RF for the players and IR for the puck) have been successfully demonstrated. While it is not the primary purpose of the present invention to teach the best way and/or novel ways of determining this particular data, upcoming figures will add new details for the use of machine vision. This should not be construed in any way as limiting the present invention whose purpose and novel teachings include the abstraction and normalization of data such that its fundamental sensing and tracking technology is immaterial to its downstream differentiation, integration and synthesis. Therefore, the goal if the present figure and the remaining figures up to FIG. 16h, is to show how these three pieces of real measurable data can be used to support the useful construction of several abstract objects; which themselves are then available for the programmatic, rules-based contextualization of content.

Still referring to FIG. 16a, in the upper left corner of the figure is shown the present inventors' preferred symbol for describing a tracked object 50. At least for each real tracked object, it is preferable to measure the (x, y, z) location of the object relative to the session area 1a throughout the session time 1b. It is often further desirable to know that real object's orientation, or rotation with respect to the session area 1a, the measurement of which is highly dependent upon the technology employed. (Given that abstract objects can be compounded from these real objects as will be subsequently taught, these abstract objects also naturally tend to inherit this same location and orientation data.) The present invention is not intended to in any way be limited to requiring all of these (x, y, z) locations and orientation measurements per any or every real object in order to be useful. Furthermore, other measureable data (such as object identity, color, size, etc.) and calculable data such as velocity, acceleration, work, etc. are of obvious value and considered included in the present teachings. (Note that other example features are listed on the figure with their corresponding object.) With this minimal measured data of player 50-p centroid 50-o, stick 51-sb blade centroid 51-o and puck 52 centroid 52-o, combined with the state of the game clock (i.e. running or stopped) as reviewed in FIG. 9, all of an ice hockey's possession cycle is programmatically determinable, as prior taught by the present inventors in PCT application US 2007/019725 entitled SYSTEM AND METHODS FOR TRANSLATING SPORTS TRACKING DATA INTO STATISTICS AND PERFORMANCE MEASUREMENTS. In this regard, player 50-p radius 50-p-r1 and area of influence 50-p-r2 can be dynamically calculated and tracked therefore becoming either features of player object 50-o or their own objects as is preferable to the differentiation strategies being employed, but immaterial to the present teachings. Furthermore, as was prior taught by the present inventors, continually determining the puck object's 52-o distance from the various player objects 50-o, indicates if it is within their area of influence 50-p-r2, a critical factor in determining puck (or game object) possession. (Alternately, the stick blade radius 51-sb-r, similarly determinable by a variable radius and defining the blade's area of influence, may be used in place of, or in combination with, player radius 50-p-r1 for determining game object possession.)

Referring next to FIG. 16b, there is shown the formation of a new abstract object, namely puck lane 53-o that is compounded from at least real puck object 52-o and real player object 50-o, and preferably also real stick blade object 51-o. As will be obvious to those skilled in the art of software systems, the association of base objects to form new derived objects lends to the inheritance of the base objects' features, thus becoming attributes of the derived object. Furthermore, new derived object features may be calculated using the base object features in some mathematical combination—all of which is obvious to those skilled in the art of software systems and mathematics. (See FIG. 16b for example new features per derived puck lane object 53-o.) What is important for the present invention is to see how, in these FIGS. 16b through 16h, useful abstract objects can be compounded. The present invention is specifically teaching how this method of first tracking real object(s)-feature(s) to form an object tracking database in a normalized data structure, can be usefully extended to the creation and tracking of abstract object(s)-feature(s), the net total of which deepen the richness of all subsequent content contextualization. What was needed and what is herein considered novel and specifically taught, is a structured and normalized set of datum and protocols that enable the formation of universal, session agnostic software tasks for implementing the differentiation, integration, synthesis, and expression of session activities 1d into organized index 2i for any and all recorded organized content 2b. In addition to the novelty of the data architecture, protocols and implemented task methods, the present inventors also consider its teachings for the abstract objects described in FIGS. 16b through 16h, (e.g. puck lane 53-o) to also be novel.

Referring next to FIG. 16c, new abstract object passing lane 54-o may be compounded from real player objects 50-o, and preferably also real stick blade object 51-o. Important new features are also depicted for passing lane object 54-o as show associated with its object symbol in FIG. 16c.

Referring next to FIG. 16d, new abstract object team passing lanes 55-o can be further compounded from abstract object passing lanes 53-o1 through 53-o, all with respect to real player object 50-o determined to have possession of real puck object 52-o. What is especially important in FIG. 16d is the teaching of how the abstraction of objects can continue indefinitely as needed, created more and more powerful constructs with highly leveraged features in part derived and or calculated from all inherited features. The importance of this understanding is a key motivation for the teachings herein of agnostic data structures for normalization and compounded any object from any type of session. The net result of this approach is a systematic method for symbolically representing and analyzing and describing session 1 activities 1d forming normalized content 2b. Referring next to FIG. 16e, new abstract object pinching lane 56-o may be compounded from real player objects 50-o, abstract lane object 53-o, (and preferably also real stick blade object 51-o.) Important new features are also depicted for pinching lane object 56-o as show associated with its object symbol in FIG. 16e. What is additionally important if FIG. 16e is the teaching of how abstract object may also be formed as a combination of both real and other abstract objects.

Referring next to FIG. 16f, prior abstract object team passing lanes 55-o (as first taught in FIG. 16d) can be further expanded to also include pinching lanes 56-o1 through 56-o5. What is especially important in FIG. 16d is the teaching of how the abstracted objects can have various feature sets independent of their core identity. Hence, the present invention teaches apparatus and methods where some external rule sets for the differentiation of tracked real and abstract data may varying because of the granularity of either the measurable real objects, or the compounded abstract objects. As will be shown, this leads to the possibility of the present invention contextualizing the same type of session 1, e.g. the sport of ice hockey, differently for a youth game vs. a professional game, simply by varying the levels of abstracted objects and therefore external rules built to differentiate them—all of which is both considered novel to the present invention and will be understood by those both skilled in the art of software systems and familiar with the contextualization and analysis needs of youth through professional sports.

Referring next to FIG. 16g, there is shown a top view of a real ice hockey surface with its typical markings such as zone lines, goal lines, circles and face-off dots, as will be recognizable and familiar to those skilled in the sport of ice hockey. Furthermore, other abstract markings are shown include the scoring web first taught in prior applications by the present inventors. What is most important to note in FIG. 16g is that fixed physical objects can be stored as tracked objects, even though their pre-session measured features will not change throughout the session activities 1d. In the present figure, example fixed objects include net object 57-n-o, face-off circle object 57-f-o, line of play object 57-1-0 and area of play object 57-a-o. (Note that these objects are representative and preferred, but other fixed objects are possible and hence the present invention is not to be limited to these portrayed constructs, especially in consideration that other sporting and non-sporting session activities 1d will also take place in session areas 1a that have specific measurable and constant area markings of relevance, which are different but anticipated herein.) What is further important and novel to the present teachings is to include these measurements in the potential of tracked objects and features datasets (even though they do not change value within and during the session time 1b,) so that any derived differentiation rules may access their features especially for the thresholding of the moving tracked object(s) and feature(s) representing the session attendees 1c as they perform activities 1d. Note that FIG. 16g includes example useful features to maintain with objects 57-n-o, 57-f-o, 57-l-o and 57-a-o, as will be obvious to those skilled in the art of ice hockey.

Referring next to FIG. 16h, new abstract object shooting lane 58-o may be compounded from real moving objects including player 50-0, stick blade 51-o and puck 52-o and real fixed object net 57-n-o. Important new features are also depicted for shooting lane object 58-o as show associated with its object symbol in FIG. 16h.

Referring next to FIG. 17a, there is shown a schematic diagram of an arrangement for either a visible or non-visible marker 9b to be embedded onto a surface of an object to be tracked, such as a player helmet 9. Note that this particular arrangement was first taught by the present inventors in related application US 2007/019725 (see FIG. 5c of related application,) which itself draws upon prior teachings beginning with U.S. Pat. No. 6,567,116 B1 filed Nov. 20, 1998, also from the present inventors. Based upon the chosen marking compounds, marker 9b can be made to be either visible or non-visible (or at least not visually apparent,) to the human eye. Ideally, marker 9b is detected using an appropriate vision system capable of determining three dimensional locations and orientations, such as but not limited to the system taught by the present inventors in prior related applications that included a grid of fixed position overhead tracking system camera(s), not capable of pan, tilt or zoom, whose collected object tracking data is used to automatically direct the pan, tilt or zoom of one or more fixed-position but movable side-view cameras(s). As will be understood by those skilled in the art of vision systems, other arrangements are possible. Note however that in the past, existing systems for tracking the complex movements of humans in a fixed session area 1a tended to use markers of a single reflected frequency range (visible or non-visible, typically near IR) and of a single shape, circular. The present inventors have suggested and implemented in practice other arrangements, especially as shown in PCT Application PCT/US2005/013132 (see FIG. 6f of related application.)

An additional value to the arrangements such as shown in FIG. 17a is that each marker carries its own unique code, limited of course to the number of frequency (color) or amplitude (intensity or grayscale if monochromatic) combinations fit into the marker space (all as previously taught in the related applications.) Each marker may then be attached to some object (such as attendee 1c) or part of an object (e.g. attendee's 1c various body joints) to be tracked by the vision system viewing the session 1 activities 1d. For instance, for the sport of ice hockey, it is minimally preferable to attached at least one marker 9b to the helmet 9 of each player, thereby providing a centroid location and orientation of that player, now recorded by the present invention as a unique “tracked object,” with a time series of normalized data for differentiation associated with the player's ID as encoded into the marker 9b, where the data at least includes the location and orientation of the marker 9b as detected over session time 1c.

Referring next to FIG. 17b, there is shown a schematic diagram of the preferred embedded, non-visible marker 9m that can be used as helmet sticker 9b or placed on various surfaces of both the attendees 1c and their equipment (especially in the case where the type of session 1 is a sporting event.) The marker itself is prior art first taught by Barbour in U.S. Pat. No. 6,671,390 and is made from a nano-compound that can affect the spatial phase of incident electromagnetic energy without significant altering of frequency and amplitude (e.g. via absorption.) Furthermore, the compound can be affixed to the desired surface with physical directionality. The current practice implemented by Barbour is to use one vertical alignment as the base of the symbol with the second alignment adjusted, for example, at between 1 to 180 degrees offset from parallel with this base—thus resulting in a very compact implementation of a marker with 180 unique codes, more than enough to individually identify players in a team sporting event. The present inventors see no reason to alter this strategy are making no claims with respect to the specific compound or the teachings of Barbour. However, the use of any non-visible marker for the purposes being discussed herein, was already addressed in claims issued to the present inventors with respect to U.S. Pat. No. 6,567,116 B1.

Now referring to FIG. 18, there is illustrated a representation of the top view of an ice hockey player 50-p where non-visible markers 9m1 through 9m7 are embedded onto the player 50-p and stick 51-s. The placement of these markers is chosen to be most easily viewed by a grid of cameras positioned overhead, (all of which has been prior taught by the present inventors in the various related applications.) The physical markers 9 ml through 9m7 are then shown in their physical-world arrangement with the depiction of player 50-p removed. The idea of a “virtual marker” is then introduced as 9v1, formed as the average between locations 9m2 (right shoulder) and 9m3 (left shoulder), and 9v2, formed as the average between locations 9m6 (top of stick shaft) and 9m7 (blade of stick.) And finally, all real and virtual markers are shown as a node diagram representing a single instance of a tracked object group of “player & stick” 50-o-g-ps, which is comprised of individual tracked objects of “player” 50-o-i-p and “stick” 51-o-i-s. Each individual object “player” and “stick” comprises additional part objects; all of which will be understood by those skilled in the art of object oriented programming and software design.

Still referring to FIG. 18, what is most important to note is the introduction of a normalized and abstract method for representing attendees 1c and their performance objects. For instance, as portrayed in FIG. 18 in the lower right hand corner, one possible configuration of tracked objects representing attendees 1c for an ice hockey game would include:
1) “player & stick” tracked group object 50-o-g-ps;
   a. associated with “player” tracked individual object 50-o-i-p;
      i. associated with part objects such as “torso centroid,” “helmet,” “left glove” and “right glove,” etc.
   b. associated with “stick” tracked individual object 50-o-i-s;
      i. associated with part objects such as “blade” and “shaft”

As will be understood by those familiar with node software structures, various nodes from differing branches can share links, thus allowing the association of the individual stick object 50-o-i-s with both the “player & stick” 50-o-g-ps (“above it,” or its “parent” on the tree,) and the “left glove” and “right glove” part objects of its “sibling” “player” individual—all as will be well understood by those familiar with database structures. It will also be clearly understood by those familiar with software systems, that this type of object tracking abstraction and normalization is desirable so that the application tasks (such as differentiation, integration and synthesis) can be made operable in a way that is universal to all types of sessions 1; and not just different sports such as ice hockey or football, but also including for instance music, theatre, etc. To accomplish this goal, the present inventors teach the use of external devices to sense 30-xd to capture session attendee 1c performance activities 1d for immediate representation as nodes in a multi-dimensional tree, where each node carries relevant associated data the carries that nodes unique description. Therefore, the universal tracked object node can be used to represent virtually any detectable real object (such as player 50-p or for instance, their right glove.) The nodes can also be used to represent estimated objects, such as depicted by virtual markers 9v1 and 9v2 that are a mathematical combination of their respective real markers 9m2, 9m3, 9m6 and 9m7.

Once the external devices 30-xd (using their various base technologies both as taught herein and as anticipated and obvious to those skilled in the art of sensors and transducers) detect physical attributes on attendees 1c, then this ongoing data can be used to create the normalized tracked object database necessary to best describe session activities 1d. Specifically, with respect to sporting events and tracking players, the present inventors prefer to “mark” each player and/or player joint to be tracked, where the markers operate in either the visible or IR spectrums detectable via lower-cost machine vision cameras (shown in FIGS. 17a and 17b,) or operate in the RF spectrum, detectable via lower cost RF readers. However, this is not necessary, as there are some machine vision systems from manufacturer's such as Organic Motion of New York, N.Y., that use marker-less techniques to create a three dimensional body model—where this body model would then be used to populate the tracked object database as taught herein. What is considered to be further unique concerning the present invention is that while it is usual for a manufacturer such as Organic Motion, to create an ongoing database of player joint data, what is not being done is to ensure that this database is abstracted and usable for every type of session activity 1d data, for ice hockey including but not limited to:
Game clock face movements;
Referee official hand signal and whistle blow movements;
Player and game object movements, and
Crowd physical and noise movements.

What is further uniquely taught herein is that these same tracked object data structures are used to represent the physical external device apparatus as well as session area 1a, as will all be further taught forthwith. This broad normalization of data elements is critical for forming a universal, agnostic database for rules based session processing through the stages of differentiation 30-2, integration 30-3, synthesis 30-4, expression 30-5 and aggregation 30-6, all as first taught with respect to FIG. 5, regardless of session type 1, attendee 1c and activity 1d.

Referring next to FIG. 19a, there is illustrated a perspective view of an ice hockey player 50-p and stick 51-s where non-visible markers such as 9m1 have been affixed to various body joints and player stick as desired for best 3-D body modeling (see FIG. 18 for example locations.) Referring also to FIG. 12, there is shown external device 30-rd-ov comprising a grid of individual cameras for capturing substantially overhead views and external device 30-rd-sv comprising one or more PTZ capable side view cameras for following individual players in order to capture additional perspective views. As has been prior taught in the related applications, the overhead views captured from external device 30-rd-ov can be analyzed in real-time to form an ongoing database of at least player 50-p centroids, detectable as the location of markers such as 9m1, or simply as the center of mass of the detected shape if no markers are being used, as will be understood by those skilled in the art of machine vision. What is herein further taught is that determined player 50-p centroids, regardless of their method for determination (hence even including alternate active RF methods, passive RF SAW methods, etc.,) are stored in a universal data format taught by the present inventors as a tracked group object “player & stick” 50-o-g-ps (where additional important details of this data structure will be expanded upon in regard to subsequent figures.)

Still referring to FIG. 19a, the granularity of tracked object data collected by overhead grid 30-rd-ov is highly dependent upon the extent of player 50-p marking, or the abilities of the markerless tracking software. For instance, using only helmet sticker/marking 9m is sufficient to create tracking data for group player & stick object 50-o-g-ps. Furthermore, as will be understood by those familiar with machine vision and as has been taught by the present inventor in prior related patents, even without helmet sticker 9m, especially using grid 30-rd-ov that is substantially overhead of the session area 1a, it is possible to do markerless shape tracking to come up with object 50-o-g-ps ongoing locations. However, the present inventors prefer to associate a full 3-D body model with tracked group object 50-o-g-ps, which is best facilitated by affixing additional markers 9m on various joints of the player 50-p and their equipment. However, as has been prior taught, the placement of any additional markers 9m may make them difficult to physically image using the overhead grid 30-rd-ov. Given this limitation, at least the player & stick centroid object 50-o-g-ps provides enough on-going data to automatically direct one or more side view cameras 30-rd-sv for perspective imaging of the player 50-p (and therefore any markers placed on their person.) Again, while these concepts have been fully taught in prior related applications from the present inventors, what is new and to be illustrated in FIG. 19b, is that both the data collection devices comprising 30-rd-ov and 30-rd-sv, as well as the individual marker and non-marker created tracked object information, are all to be considered as tracked objects, thus forming a universal agnostic data structure ideal for creating the processing tasks first discussed in relation to FIG. 5.

Referring next to FIG. 19b, there is depicted the one-to-one correlation with the physical devices (such as 30-rd-ov and 30-rd-sv) used to both capture session activities 1d, as well as the individuals and parts of the session attendees 1c, and their representative tracked objects. Specifically, and for example, there is shown:
1) 60-o-i, which is the tracked object representing an individual camera acting as an external device in either the overhead tracking grid 30-rd-ov or the side view configuration 30-rd-sv;
2) 60-o-g, which is the tracked group object representing either the entire overhead tracking grid 30-rd-ov, or some portion of the grid, or a group of one or more side view cameras 30-rd-sv, and therefore as will be seen associates with individual cameras such as 60-o-i;
3) 2-g, which is the object representing the Session. Registry as first discussed in relation to FIG. 11a that is used to ultimately associate and describe the hierarchy of all external devices (and the differentiation rule sets) being used to record and/or detect session activities 1d;
4) 2-m, which is the object representing the Session Manifest as first discussed in relation to FIG. 11a that is used (amongst other things) to ultimately associate and describe the hierarchy of all session attendees 1c being tracked for their session activities 1d, along with the unique “patterns” (if any) to be associated with individual object parts for detection via various technologies embedded in the various external devices;
5) 50-o-g-ps, which is a preferred tracked object for ice hockey representing a session attendee 1c group, in this case comprising at least a player 50-p and their stick 51-s;
6) 50-o-i-p-2d, which is a preferred individual tracked object representing individual player 50-p for associating the “2-D” detectable parts;
   a. 50-o-p1-p, 50-o-p2-p, 50-o-p3-p, which are example preferred individual 2-D parts for describing a player 50-p by tracking their helmet, right shoulder and left shoulder, respectively;
      i. associated “OP” (Object Pattern) data, which is an optional piece of data to be associated with any given object part that describes the unique marker patterns to be placed on player part (such as 50-o-p1-p, 50-o-p2-p and 50-o-p3-p) to simplify the detection and tracking of that particular chosen body locations;
      ii. (Note that Objects Patterns (OP) associate the unique code of the marker in a format relevant to the particular technology being used for detection. For example, in FIG. 19b the detecting external devices 30-xd in overhead object tracking grid 30-rd-ov are cameras, therefore the OP could well be expressed as a bitmap in JPEG format, or some vector drawing, or a numerical representation if the pattern is a bar code or similar. If the detecting external device was something different, perhaps like the passive RF player detecting bench taught in FIG. 10a, then the OP would most likely be the unique RF id code of the sticker being placed on that player's shin pads.)
7) 50-o-i-p-3d, which is a preferred individual tracked object representing individual player 50-p for associating the “3-D” detectable parts;
   a. FIG. 19b shows associated tracked part objects with associated (OP)s similar to those taught for the “2-D” player
8) 50-o-i-p-b, which is a preferred individual tracked object representing individual player 50-p for associating the “RF bench” detectable parts;
   a. FIG. 19b shows associated tracked part objects with associated (OP)s similar to those taught for the “2-D” player
9) 50-o-i-s, which is a preferred individual tracked object representing individual stick 51-s for associating the detectable parts;
   a. FIG. 19b shows associated tracked part objects with associated (OP)s similar to those taught for the “2-D” player.

With respect to FIG. 19b, what is most important to understand and considered novel to the present invention is the mapping between both the external devices 30-xd (groups and individuals) and the attendees 1c (groups, individuals and parts) such that there is a single normalized and abstract data construct for associating both initial data (known prior to session time frame 1b) and session activity 1d tracked data, (detected by the external devices 30-xd during session time frame 1b.) As will be understood by those skilled in the art of software systems, the present invention should not be limited to a single representation of this data since many variations are possible. For instance, the external device 30-xd representations could be in a separate dataset from the session attendee 1c representations. The present inventors only prefer that there is an established universal format, or protocol, for designating new individual external devices 30-xd, which may then be grouped together. As will be later shown, having this universal format allows developer's of the differentiation rule sets that parse the external devices 30-xd data streams to work independently by referring to abstract nodes which may be later associated to the real external devices 30-xd even as late as the beginning of session time 1b. This approach is critical to allowing various external devices 30-xd, produced by various manufactures and based upon various technologies to be pre-organized into a data structure for a given type of session 1, where the data structure describes how the devices are related and what session attendee 1c groups, individuals and parts they are assigned to track. This pre-establish abstract view is then broadly applicable to any same type of session 1 running on different session areas 1a and/or at different session times 1b.

And finally with respect to FIG. 19b, the present invention should also not be limited to a single representation format for the session attendee 1c objects. The present inventors only prefer that there is an established universal format, or protocol, for designating new individual session attendees 1c, which may be groups (such as teams and player & stick,) or individuals (such as player or stick,) with parts (such as helmet, shoulder, glove, blade, etc.) As will be later shown, having this universal format allows developer's of the differentiation rule sets that parse the external devices 30-xd data streams to work independently by referring to abstract nodes which may be later associated to the real session attendees 1c even as late as the beginning of session time 1b. This approach is critical to allowing the pre-establishment and evolution of abstract complex rule sets that are broadly applicable to any same type of session 1 running on different session areas 1a and/or at different session times 1b.

Referring next to FIG. 19c, in comparison to FIG. 19b, all of the same abstract nodes representing real external devices 30-xd groups and individuals as well as session attendee 1c groups, individuals, parts and patterns is shown independently of the physical objects. This representation not only emphasizes the universal, abstract nature of the present teachings, it also helps the reader visualize the cascading hierarchy of inter-relationships between the individual external devices 30-xd that do the session activity 1d tracking, and the associated inter-related cascading descriptions of the session attendees lc to which tracked object data in time series format is to be associated (as discussed with respect to subsequent figures.)

Referring next to FIG. 20a, there is shown the preferred circular symbol for the base kind Core Object 100, as will be understood by those familiar with the art of object oriented software design. Also depicted associated with Core Object 100 is the minimal set of attributes preferred by the present inventors, as follows:
“Creation Date-Time”:
   The date and time the object was instantiated into the database;
“Source Object ID”:
   Indicates the observing object that created the instantiated object and is providing either one time or ongoing information, either before, during or after the session (e.g. the unique ID of an individual or external device group object, if the created object is being tracked);
“Object Type”:
   As will be further taught, this indicates the role of the object in the entire system, e.g. “Session Manifest,” “Session Attendee,” “External Rule,” etc.;
“Object ID”:
   Is preferably a globally unique identifier for the instantiate object;
“Function: [template, actual]”:
   Indicates if the instantiated object is a “template,” i.e. acting as structure, or is an “actual” object, i.e. real content unique to the session being contextualized;
“First Language”:
   Holds a code indicating the human language (e.g. English, German, French, etc.) used for the First Name and First Description attributes;
“First Name”:
   Personalizes the object within the context of the type of session it has been created for;
“First Description”:
   A longer description of the object;
“Parent Object Type”:
   The role of the main object to which this object is attached/associated in the session data structure (note that an object can be linked to additional parents, siblings and children using a Link Object to be subsequently taught);
“Parent Object ID”:
   The globally unique identifier of the template or actual object to which this instantiated object is first associated;
“Version Control Object ID”:
   The globally unique identifier of a Version Object assigned to this instantiated object, especially if the instantiated object is to act as a “template” vs. “actual session data,” and therefore defines structure versus content;
“Version As-Of Date”:
   The date the instantiated object was associated with the Version Object;
“Version Type”:
   To be later discussed, especially in relation to FIG. 39c. Still referring to FIG. 20a, there is also shown a Description Object 100-D, which has been derived from the base kind Core Object, as will be understood by those familiar with Object Oriented Programming practices. As a derived object, it inherits all of the aforementioned attributes of the base kind, and then additionally adds unique attributes of:
“Type”:
   Which can be set to “synonym” [0 . . . n], “alternate” [0 . . . n], or replacement [0 . . . n].

Referring next to FIG. 20b, the present inventors teach how to use the Description object to enrich the First Name (e.g. “Player” and First Description carried on the object itself, both of which are in the First Language (e.g. “English”.) Since each Description object inherits the attributes of the base kind, it will inherit a First Language that can be in the same language of the parent object (e.g. “English”) or a different language (e.g. “French.)
If the language is the same then the Description should be either a “synonym” or a “replacement,” for example as follows:
Synonym for Player, e.g. “Teammate,” to optionally be used (in addition to “Player”) for describing the parent object in either the SPL (Session Processor Language) Dictionary, if the parent is a template object and therefore used during the formation of external rules, or for describing the parent object during the “expression of content” stage 30-5 of session processing, if the parent is an actual object, i.e. created and described content;
Replacement for Player, e.g. “Contestant,” to always be used instead (instead of “Player”) for describing the parent object in either the SPL Dictionary (if the parent is a template object,) or the expressed content stage 30-5, (if the parent is an actual object.)

Still referring to FIG. 20b, the Description object can also be used to achieve what is referred to as “localization” with respect to software systems. Localization refers to the ability of a software system or data to be presented in various human languages (local to the user.) The present invention anticipates that both the structure and external rules used to govern the contextualization of a given type of session, which collectively make up the SPL (Session Processor Language,) will be shared and exchanged globally. Furthermore, session context created in one local (e.g. the United States,) may be viewed or consumed in another remote local (e.g. Japan.) The present invention herein teaches how both the SPL and expressed content can be equally amended and consumed regardless of the local language spoken. In order to provide an “alternate” language word or token, the Description object simply needs to be attached to its parent, and then be assigned its own First Language (e.g. “French”) that is different from the parent (e.g. “English.) The Description Object must also be set to an alternate, and then for example it could be given a First Name of “Joueur” (the French language equivalent of “player.”) Referring next to FIG. 20c, there are shown some of the key objects and terminology collectively referred to as the Session Processor Language (SPL). All of the symbols introduced represent objects (also known as “classes”) as will be well understood by those especially familiar with OOP languages and techniques. The goal of the SPL is to define a highly tailored, robust yet minimal set of objects for describing both the session content (data) itself, as well as the external rules (data) for processing this content. The key objects and terms in the language are taught over several diagrams, were figures with new terms are typically followed by figures with the most important attributes (also known as “properties”) for the key objects, and then figures that described how these key objects function, essentially their methods, or tasks—as will be understood by those familiar with OOP. As will be obvious to those skilled in the art of software systems, there are many programming languages and object description styles within the OOP's world. There are also even more non-OOP programming languages and data schematic techniques. Therefore, the present invention should not be limited to the means and techniques used to describe its software structures and tasks.

Referring still to FIG. 20c, the key SPL objects taught are as follows:
1) “Session”: the root object
   a. “Session Manifest”: associates the “who,” “where,” “when,” and “what” objects
      i. “Session Attendee”: “who” is the content about
      ii. “Session Area”: “where” is the content taken from
      iii. “Session Time”: “when” was the content generated
      iv. “Session Context”: “what” is the content activity
      v. “Calendar Slot”: “where” and “when” combination tool
   b. “Session Registry”:
      i. “External Device”: “how” was the session observed

As will be understood by those skilled in the art of software systems, individual variations in what objects and their data structures are actually employed, whether or not they are fully object oriented or some approximation is immaterial. What is important is that they encapsulate the abstract notions of a session 1, performed in session area 1a, at session time 1b, by session attendees 1c, doing session activities 1d to be recorded into disorganized content 2a, where the differentiated, integrated, synthesized activities 1d are expressed as content index 2i thereby creating organized content 2b. However, while variation data structures and object encapsulations and naming are possible, the present inventors are herein teaching that there is a fundamental set of information, specifically answering the “who,” “where,” “when,” “what” and “how” questions, that must be included in order to create a universal, abstract and robust automatic system for contextualizing any content. (It should be noted however that with respect to the “how” question, the present inventors mean “how the source content was collected,” rather than “how the attendees accomplished a particular activity feat.” While the former “how” is objectively determinable as are the answers to the other “who,” “where,” “when,” and “what” questions, the later “how” is considered by the present inventors to be a subjective induction or deduction based upon observed session activity 1d, and is not included or a goal of the present teachings.)

Referring next to FIG. 20d, next to each of several of the objects defined in FIG. 20c there is shown the present inventors preferred attributes for each object. While the present inventors teach and prefer the objects and their listed attributes, no specific object or attribute is meant to be limiting in any way, but rather exemplary. With this understanding of sufficiency over necessity, the attributes listed in FIG. 20d are left as self-explanatory to those both skilled in the art of software systems and sports, especially ice hockey, and therefore no additional description is here now provided in the body of the specification.

Referring next to FIG. 20e, there are shown some additional key objects and terminology of the Session Processor Language (SPL), in general concerning “tracked objects.” These objects describe both session content (data) and external rules (data) and their descriptions as provided in the figure are considered sufficient by themselves without further elaboration at this point within the specification. As will be understood by those skilled in the art of software systems, individual variations in what objects and their data structures are actually employed, whether or not they are fully object oriented or some approximation is immaterial. What is important is that they encapsulate the abstract notions of objects that move; where the objects are either real (e.g. people, equipment, game objects,) virtual (e.g. avatars in a video game,) and/or abstract (i.e. conceptual combinations of real or virtual objects, e.g. a player-player forming an abstract “passing lane”.) The objects may be individuals with parts that move, or may be groups formed from individuals that move. The movement is either physical (e.g. in terms of the three dimensions and time,) or conceptual, in terms of a movement between two or more potential values (e.g. the loudness of crowd noise.) It is further important that the objects have the ability to represent patterns (unique to the domain of the sensing technology,) that can be “searched for” by the external devices 30-xd in order to recognize, or help recognize, an individual or its parts as it is moving. It is also important to have data sources where tracked object movements can be stored in association with either or both the external device 30-xd that “found” the object, or the session attendee (“who”) the object is, or is a part of. And finally, what is important is to have a universal structure for storing external rules, or formulas, describing the processing of content, where a formula must be able to describe any type of mathematical or logical operation performed on any captured tracked object data source.

Referring next to FIG. 21a, there is shown an interlinked set of node diagrams teaching the key concepts necessary for defining the structure of the tracked objects to be associated with a given session 1 (using the sport of ice hockey as an example.) Specifically, in reference to the upper right hand corner of FIG. 21a, these concepts are depicted, implied and here now emphasized:
1) Any given object can function as either a template object (which defines structure before the session 1 is conducted, and to which external rules are referenced) or an actual object (which is actual content from an actual session 1);
2) All session attendees 1c are first created as abstract templates and associated with the session manifest [M]:
   a. For example, in the sport of ice hockey, a “Team” (TO) would be set up as parent group and attached to the manifest [M]. Attached to the Team (TO) could be another “Player & Stick” group (TO) or simply an individual “Player” (TO) or “Stick” (TO). Attached to each individual Player (TO) or Stick (TO) would then be “part” (TO)'s that would necessarily depend upon the type of external devices 30-xd and their detection capabilities to be used in a particular session;
   b. (As will be obvious by way of a careful consideration of the present teachings, it is possible to set up a structure that may only be partially detectable during a given session 1 because the session does not have the requisite external devices associated with its “how” session registry [R], whereas other session 1 may capture actual data objects for all of the defined structure. This flexibility of design allows for external rules to be created that are only implemented by the session processor 30-sp if the necessary actual objects are detectable relating to the template objects referred to by a given external rule. This in turn allows a more comprehensive external rule set to service multiple levels of session contextualization, only dependent upon the ability to “observe” activity via external devices 30-xd.)
3) External Devices 30-xd track parts, rather than individuals which are comprised of tracked parts, or groups, which are comprised of individuals:
   a. If an individual only has 1 part (e.g. a player is only tracked by the body centroid,) than that part, i.e. the body centroid (TO) must be defined and preferably has an associated object pattern (OP) detectable by some external device 30-xd;
      i. For example, the (OP) could a representation, or various representations of a player's jersey number which is used by a machine vision system to match up and compare against current images captured during a live session, such as that a match-up of the (OP) reveals the identity and potential location of the (TO). Or, the (OP) could be an RF code used by either a passive or active RF triangulation system, such that the match-up of a triangulated signal (OP) reveals the identity and potential location of the (TO);
   b. Associated with the template object for each part (TO), is ultimately an actual object pattern (OP) that describes how a given type of external device 30-xd could “recognize” that particular part (TO) for a given individual (actual) session attendee [SAt] (e.g. “Sidney Crosby”), where the individual [SAt] is attached to a group (actual) session attendee [SAt] (e.g. “Away_Team.Pittsburgh_Penguins”);

Still referring to FIG. 21a, prior to capturing and contextualizing a session 1 of a specific type (e.g. ice hockey,) it is necessary to use the SPL to establish a template manifest [M] with associated template groups (TO) (e.g. Team) and template individuals (TO) (e.g. Player) with template parts (TO) (e.g. helmet, left shoulder, right shoulder.) In relation to FIGS. 11a and 11b, and as will be understood by those familiar with software systems, once a sufficient template is built to generically, or abstractly describe all attendees 1c to be (optionally or required) present at a given session 1, an “actual” list of attendees may be captured following the template, which for the sport of ice hockey would represent the home and away team rosters of players as well as potentially the officiating crew list of game officials.

Now referring to the upper left hand corner of FIG. 21a, there is shown a broad view of the data structures supportive of first the detect disorganized content stage 30-1 followed by the differentiate objective primary marks stage 30-2, with respect to a single (TO) representing any and all (TO)'s. A detailed understanding of the present teachings is as follows:
1) Any given (TO), whether a group, individual or part, whether real or virtual, must have both identity and a lifetime, minimum attributes that are carried with each object as derived from the base kind Core Object;
2) Most (TO) will have additional information that is important to observe or determine (where observations are made by people, machines or people machine combinations and collectively taught as external devices 30-xd, while determined information is a subsequent process carried out upon the observations preferably as a result of the application of external rules):
   a. Each piece of additional information, or individual attribute, is represented as the template object called an Object Datum (OD) which is first associated to the Session's Dictionary of information and then further associated to typically one-to-many (TO)'s;
3) Differentiation is the process step of sorting through a large amount of detected content to observe and determine the desired (OD)s with respect to their associated (TO)s, and is inherently associated with the translation from a live session into actionable data, the input to the “black box” as described in the SUMMARY OF THE PRESENT INVENTION
   a. Once a desired interrelated structure of (TO)'s with their individual associated (OD)s is established in template form, for an automatic system it is necessary to pre-establish which external devices 30-xd are designated to gather which (OD) for which (TO)s;
   b. As shown in the upper left corner of FIG. 21a, template external devices [ExD] can be pre-established prior to an actual session 1 in the same way that template (TO)s and (OD)s can be per-established. Once this is done, then Differentiation ruLe Set objects (DLS) can be defined in association between the [ExD] groups and individuals the sense and detect information and the (TO) and (OD) about which the information is to be tracked;
   c. Ultimately, before a session 1 can be conducted, an actual registry [R] must be associated with the given session 1's template registry [R] so that the actual external devices [ExD] can be associated with the template external devices [ExD]. Likewise, an actual manifest [M] must be associated with the template [M] so that (amongst other things) actual session attendees [SAt] can be associated with their template tracked objects (TO)s. After these associations are made, then differentiation rule sets (DLS) are actionable;
   d. However, what is then necessary is that the system automatically create actual indexed Data Sources [i|DS] at the time of session 1 capture to store all object datum (OD) first observed and determined per actual external devices [ExD] and then associated with the appropriate actual session attendee [SAt], where the translations from raw sensed data into the aforementioned observed and determined (OD) are ideally, but not necessarily fully controlled by the differentiation rule sets (DLS) (i.e. as will be understood the differentiation may also be “hard-coded” into the external device and therefore not programmable, albeit perhaps adjustable via external parameters and the like);

Referring still to FIG. 21a, but now to the lower left corner of the figure, there is seen a dotted outline enclosing an indexed data sources [i|DS] and providing more detail regarding the present inventors preferred software implementation. Specifically:
1) Each data sources [i|DS] is a self contained, encapsulated object that is associable to a template-tracked-object-to-actual-session-attendee-object (TO)-[SAt] combination object. As previously described, this connection is made automatically by the system by the time the session 1 commences and as a part of instantiating the new data sources [i|DS] for receiving differentiated external device [ExD] observations and determinations;
2) Each data sources [i|DS] contains a repeatable indexed data slot for storing actual external device [ExD] output (OD)s. The (OD)s captured and stored per (TO), per data slot are complied for convenience as a Feature List object [.F.list];
3) The index for a given data source [i|DS] is ideally, but not necessarily, synchronized with all other data source indexes and ultimately with the beat of recorded data, e.g. 30 images per second of video;
   a. As will be understood, indexes can be periodic or aperiodic as well as synchronized or not with all other indexes or recorded materials without straying from the teachings of the present invention. In fact, the approach herein taught is considered a novel way of relating these disparate indices (and their inherent data samples) via a translation from the index value to a universal, relative session time line 30-stl, expressed in the extent of a session timeframe 1b. Hence, if any given data slot of tracked object features is not captured simultaneous or in period with any other data slot, it is still relatable as will be further taught via its recorded Creation Date and Time attribute as inherited from the based kind object;
      i. As will be understood by those skilled in the art of information systems, at least two possible techniques can be used for synchronizing the Creation Date and Time of all actual objects created during a given session 1. The first method, preferred by the present inventors, is that the Creation Date and Time is the universal, absolute “wall-clock” date and time. What is then further preferred is that associated with the actual manifest object [M] is the actual session date, time and duration (see FIG. 20d), which can then be applied to translate the absolute “wall-clock” time into relative “session-time” as will be understood by those familiar with software systems;

And finally, still referring to FIG. 21a but now directed to the lower right hand corner of the figure, it is shown that any given (TO) can be connected to any other given (TO) via a link object (X). The use of a link object (X) is only necessary when a group, individual or part tracked object (TO) needs to be associated with more than its parent tracked object (which is an inherited attribute available to all objects) or any of its children (that point to the (TO) via their respective parent tracked object attributes)—all of which will be well understood by those familiar with OOP techniques.

Therefore, in summary what is taught via FIG. 21a is how template configurations of tracked object (TO) groups, individuals and parts are associated via a template manifest [M] to actual session attendee [SAt] groups or individuals associated to an actual manifest [M]. Coincident with pre-establishing the template manifest [M] with template tracked object (TO) inter-relationships, it is also necessary to pre-establish a template registry [R] indicating the types of template external devices [ExD] that will be available to observe a given session 1. After all of these templates are created, it is then possible to additionally pre-establish differentiation rule sets (DLS) to govern actual [ExD] as they observe the live session 1. At the time a session 1 is captured, the external devices [ExD] then store their attendant embedded or external rules-based observations and determinations in the appropriate indexed data sources [i|DS] associated with actual external devices [ExD] and/or actual tracked object session attendees (TO)-[SAt]. All observations and determinations are saved as object datum (OD) associated with a given indexed data slot on the appropriate indexed data source [i|DS], were a combination of object datum within a single data slot form that index values feature list [.F.list].

Referring next to FIG. 21b, the data structures and inter-relationships of the objects shown in FIG. 21a are further detailed, with special attention paid to the processes steps associated with differentiation including: detection, compilation, normalization, joining and predicting. Specifically, starting on the left hand side of FIG. 21b, there is copied the template vs. actual hierarchy of session attendees 1 to be tracked by external devices 30-xd. In brief, tracked object (TO) groups, individuals and parts can be nested into virtually any configuration to describe the individual session attendees 1c (such as a player,) any of their parts (such as helmets, body centroids, joints, etc.,) any of their equipment (such as their stick,) any of their equipments parts (such as shaft and blade,) the game object (such as the puck,) and any groupings of individuals including player & stick, home team, offensive line 1, etc. As will be appreciated by those skilled in the art of software systems, the present teachings provide software apparatus and method for pre-establishing every structural aspect of an session, abstracted as the session area 1a, session time 1b, session attendees 1c and session activities 1d. Pre-establishing this structure in a universal protocol, normalized across all session types, uniquely provides the foundation for creating a single system capable of contextualizing any detectable content, whether real or virtual. Once pre-established, as will be further taught, external rules can be created for the differentiation 30-2, integration 30-3, synthesis 30-4, expression 30-5 and aggregation 30-6 of disorganized content 2a into indexed 2i organized content 2b, for interactive self-directed retrieval via session media player 30-mp (or similar device/software tool.)

As will be further taught, at the highest level the tracked object (TO) hierarchy is preferably attached to a template session manifest [M] which itself is attached to a template session [S]. Note that the session context id attribute (which indicates “what” kind of activity is to be conducted,) is associated with the manifest [M] template, rather than the session [S] template. This technique allows a single session template [S] to remain very broad having the potential to associate with one or more manifest templates [M]. In practice, this would allow a session template [S] to represent “ice hockey” in total, with different manifest templates [M] for a “tryout,” “clinic,” “camp,” “practice,” “game,” etc. This particular choice of where the session context (“what”) id should be associated in the hierarchical template defining the structural aspects of an abstract session, is immaterial and easily moved without departing from the novel teachings herein. What is of greater importance are the teachings that:
any and all sessions comprise only “who,” “where,” “when,” “what” and “how” dimensions;
these dimensions must be pre-established in some template form that is easily reconstruct able to fit any possible combinations in order to form a universal protocol, or “session processing language”, and
by pre-establishing these template structures, rules can also be pre-established expressing their execution against abstract template objects that are only associated to actual objects at the time of session processing via connection of the template registry [R] and manifest [M] with the actual registry [R] and manifest [M].

As will be understood, many of the detailed teachings (such as where to associate the session context “what” id) are provided as exemplary, and are therefore considered sufficient and preferred, but not necessary in their details where obvious changes can be made by anyone skilled in the necessary underlying arts, such as software systems in general and object oriented programming in particular.

Still referring to FIG. 21b, the object patterns (OP) associated with each part (TO) are themselves accessible as a group object referred to as the object pattern list (OPL). Moving directly to the right in the figure, the actual session registry [R] hierarchy is depicted starting with an external device group [ExD] (e.g. “overhead tracking camera grid”,) linked to individual external devices [ExD] (e.g. “overhead camera x”,) linked to that devices indexed data source [i|DS], where each filled indexed data slot is linked to any and all object pattern lists (OPL) associated with any found object pattern (FOP). Hence, for any given data source [i|DS] slot, the only object pattern lists (OPL) that need be associated are those for which at least one object pattern (OP) was detected as a found object pattern (FOP). As a practical example for the ice hockey, the overhead tracking grid group [ExD] may comprise eight to sixty or more individual cameras [ExD], depending upon the grouping strategy and needs for overall image resolution, as will be obvious to those familiar with machine vision. Ideally assuming that all individual overhead cameras [ExD] are capturing images at a synchronized 30 frames per second, then as each frame is analyzed (differentiated to “detect” object patterns (OP)) zero or more of the total object patterns (OP) pre-established within the actual manifest template [M] may be detected, thus becoming found object patterns (FOP). Therefore, while each individual camera [ExD] will have its own data source [i|DS] with one slot for each time period of data sampling (e.g. per each 1/30^{th} of a second,) it is only necessary to associate an individual (OPL) with any individual camera [ExD] data source [i|DS] data slot if at least some part (TO), of a session attendee [SAt], corresponding to an object pattern (OP) can be detected in that camera's current image frame.

(As a note, the present inventors prefer having an actual data structure that will store the found object pattern (FOP) which may only match one of the possible object patterns (OP) by some percentage less than 100%, as will be appreciated by those familiar with analog-to-digital and pattern recognition systems, regardless of the underlying technology and electromagnetic energy employed. Saving the actual found object pattern (FOP) allows for the possibility to reconsider any rule-based decision that is deemed so critical that the typically accepted recognition confidence, say 80%, is not acceptable.)

Still referring to FIG. 21b, it can therefore be seen that the “detection” stage 1 of differentiation begins with the parsing of the sensed energy emitted by the live session 1, in search of pre-establish object part (TO) patterns (OP). For camera based sensing solutions, this means performing image analysis to find probably matches to any of the pre-established object patterns (OP). In practice, the present inventors prefer and expect that this initial aspect of the “detection” stage 1 will be accomplished via embedded, vs. external rules based algorithms—especially due to their complexity and need for optimum execution speed. (However, as technology and algorithms naturally progress, the present invention fully anticipates that even this initial pattern recognition step of parsing some form of sensed energy to find a pre-known object pattern, will become expressible in a general way using external rules thus allowing the sensing device to be “programmable” or field “teachable” as new types and variations of patterns are dynamically discovered by the system itself, especially as a result of further integration and synthesis.) As will be appreciated, at any given moment not all possible object patterns (OP) defined in the actual [M] will be detected. Hence, as will be seen, the final stage 5 is one of “prediction,” where critical object datum (OD) are estimated based upon what found object patterns (FOP)s do exist and what the history of (FOP)s indicates.

After an individual or group of external devices [ExD] detect/find one or more object patterns (FOP), they may also record other key data regarding that found object pattern (FOP) or the object (TO) to which it is associated. For example, if the [ExD] is an overhead camera or grid, and the found object patterns (FOP) are visible or non-visible markers such as taught in relation to FIGS. 17a and 17b, then the additional information would at preferably include:
location with respect to the session area 1a surface, at least expressed as X (lengthwise) and Y (width) locations with respect to the parallel plane of the surface, if not also (Z) height off surface;
orientation with respect to the session area 1a surface, for instance as a 0 to 360 degree rotation about a central north-south axis, preferably defined along the X (lengthwise) surface dimension, and
any encoded identity information, again as taught in FIGS. 17a and 17b.

As will be well understood by those familiar with the underlying detecting technologies, in this exampled cameras and machine vision, other important measurements are possible including, but not limited to found object pattern size and shape, to the neighboring image pixel color (e.g. indicating the team of the player on which the object pattern was found,) etc. What is most important to note for the purposes of the present invention, is that automatic machines may continually parse electromagnetic energy emitted by the session attendees 1c as they perform activities 1d in a session 1. This energy may be emitted or reflected (and even fluoresced,) it may take the form of UV, visible light, non-visible light such as IR, RF, or lower frequency audio waves, etc. The technology chosen must match the desired energy to be sensed. It may also be desirable to sense chemical, vibrational, gravitational or thermal energy, etc.—these are all valid examples of session content to be observed for contextualization. For attendees and their parts to be recognized in any energy format, there needs to be a pre-established pattern to be used as a template for matching and detecting. Once detected, especially based upon the form of energy and the requisite detecting technology, many other pieces of significant related data are measurable and may be associated with the part (TO) along with the found object pattern (FOP) without deviating, straying from or expanding the teachings of the present invention. All of this is taught as stage 1 “detect” in FIG. 21b.

Still referring to FIG. 21b, also in stage 1, as this datum is detected and initially stored per external device [ExD] data source [i|DS], it is also associated with the individual tracked object session attendee (TO). [SAt] for which the object pattern (OP) was ultimately associated. While this stage 1, as will all stages 1 through 5 shown, are preferably controlled via a set of external differentiation rules (DLS), this detect stage may often be executed with embedded logic because of its extreme complexity. For example, creating a universal image analysis algorithm that could switch external rules (DLS) to start looking for knot patterns on the surface of wood crossing a camera view at high speeds during an industrial shift session 1, as opposed to finding non-visible nano-compound markings applied to an athlete's jersey and visible during a sporting contest session 1, is outside of the scope of the present invention. However, once the “customized” algorithms hard coded into the external devices perform this initial “detect” stage 1, the object datum (OD) associated to (TO).(SA) can be universally processed using external differentiation rules (DLS), which is both the preference of the present inventors (although not necessary,) and one of the key novel teachings of the present invention.

Still referring to FIG. 21b, after stage 1 detection it may often be necessary to perform stage 2 compilation. What is important to see here, is that often the collection of session activity 1d will require the use of many similar external devices [ExD] covering different or overlapping areas of an expansive session area 1a. This is certainly the case with ice hockey and other sports, depending upon the energy to be sensed. For instance, if the energy is emitted RF, then the number of sensing external devices [ExD] (i.e. transceivers) will have more to do with emitted signal strength and ambient reflection patterns, whereas if the energy is visible light, then the number of sensing external devices [ExD] (i.e. cameras) will have more to do with the necessary minimal pixel resolution per session area and ambient obstructions. What is important to note is that in both of these cases, in fact it is necessary to detect the same object pattern (OP) on more than one external device [ExD]—this at the very least supports both RF and visible light triangulation for the confirmation of location, if not also orientation. Therefore, since a found object pattern (FOP) and its associated object datum (OD) for a given (TO).[SAt] may exist in multiple external device [ExD] data sources [i|DS], it becomes necessary to compile a single list of (FOP)s for the given (TO).[SAt]. While the details of these rules are immaterial (whereas the data structures for forming differentiation rule sets (DLS) will later be taught,) in general it will be understood that were multiple equivalent datum exist, some form of “best fit” calculation, or averaging, is sufficient for compile stage 2. Also, as previously noted, for the calculation of X, Y and Z location, it will be necessary to have two independent and physically separate (FOP) measurements—as will be well understood by those familiar with various local positioning systems.

Still referring to FIG. 21b, after compiling in stage 2 the “best” or average (OD) for a given (TO).[SAt], it may also be necessary to translate some form of the information from a measurement relative to the detecting [ExD] into a global measurement based upon the entire session area 1a (or session volume, as the case may be)—which is referred to as normalization stage 3. As will be appreciated by those skilled in the art of software systems, this local-to-global measurement transformation is not unusual in automatic measurement systems. What is novel is the teaching of it as a “programmable” stage in a series of stages for differentiating sensed content, especially using external rule sets (DLS). However, as will also be understood, is may be just as desirable to perform this normalization stage 3 prior to the compilation stage 2, or even at the same time. For that matter, normalization may not be necessary and could be skipped, or could be combined with detection stage 1, with or without also combing compile stage 2; hence, any combination including at least the detection of (FOP)s with their related object datum (OD), and possibly also the compiling and normalizing of the same, is possible, whether it is performed as three distinct stages or one fully combined stage is immaterial to the present teachings. Where a single external device [ExD] senses and detects sufficiently across the entire session area 1a, then at least the compilation stage is unnecessary, and maybe also the normalization stage, because for instance the measurements are already global.

Also referring to FIG. 21b, the next stage 4 of processing is to join information from other tracking sources to the same (TO).[SAt]. For example, the overhead tracking grid 30-rd-ov in FIG. 12 and FIG. 19a is ideal for collecting (OP) that can be detected via visible images from cameras oriented over the marked players 5p. Alternately, some markings such as those that would be added to a player 5p's ankle joints, might only be detectable from side view cameras such as included in [ExD] 30-rd-sv. And finally, passive RFID sticker 13-rfid first taught in FIG. 10a, may only be detectable by RF enabled team bench [ExD] 30-xd-13. As the reader can appreciate, all of this data may be important for describing the same tracked session attendee (TO).[SAt] and therefore must at some point be joined together, shown as stage 4, again preferably accomplished via external rule sets (DLS). As with stages 2 and 3, stage 4 may either not be necessary or may be accomplished in a different sequence or in combination with other differentiation stages without departing from the novel teachings herein.

Still referring to FIG. 21b, after completing some or all of the stages 1 through 4 as taught, the final stage is to predict missing (OD) because of non-detected object patterns (OP) during any given data slot time. Furthermore, it should be noted that the present inventors delineate a change from external device oriented differentiation rule sets (DLS) that perform stages 1 through 4, to tracked object (TO) differentiation rule sets (DLS) that perform stage 5, predict. The main difference is that where detection is always related to the capturing [ExD], if compilation, normalization and joining are necessary, they too must reference data held in a data source [i|DS] associated with an [ExD]. However, as a result of these first 4 stages, the (FOP) may become much less relevant to carry forward and only the related (OD) is then associated to (TO).[SAt]. In practice, and as will be understood by those familiar with software systems in general and OOP in particular, this “point of delineation” of when (OD) is less about the sensing [ExD] and more about the (TO).[SAt] is blurred since the associations are being made between the two right from the beginning in stage 1, as mandated by the associations between the manifest [M] and registry [R] templates. Suffice it to say that now viewing the rightmost portion of FIG. 21b, the goal of the overall “detect disorganized content 30-1” processing stage, first discussed in relation to FIG. 5, is to create a database associated at the root level with an actual session object [S], which has the same hierarchy of associated (TO).[SAt] groups, individuals and parts as described in the manifest [M] template, and contains periodic and aperiodic detected and determined (OD) held in indexed data sources [i|DS] associated to this hierarchy—the collection of which is herein referred to as the “tracked object data” 2-otd.

And finally, referring to the lower right hand corner of FIG. 21b, there is shown that a next set of tracked object data differentiation rules 2r-d that can be universally applied to any tracked object data 2-otd to create primary marks 3-pm (representing important activity 1d“edges”) for later integration—all as will be further discussed herein.

Referring next to FIG. 21c, there is shown a block diagram of the preferred implementation of the external rule (L) object introduced in FIG. 20e. As also taught in FIG. 20e, a differentiation rule set (DLS) is simply the collection of multiple external rules (L) that are attached via their parent object ID (as will be well understood by those skilled in the art of OOP.) Note that one significant benefit of the preferred implementation is that individual external rule (L) objects may be created and attached to one or more differentiation rule sets (DLS) creating the opportunity for the re-use of individual external rules. Starting at the top of FIG. 21c, there is seen the root ruLe object (L) that aggregates an entire, single external rule. (As will be understood, every object discussed in the present application is assumed to be derived from the base kind core object and therefore inherits its base attributes. And so for the sake of brevity, the present inventors will make little additional reference to the base kind core object and instead assume that all base attributes belong to each object herein taught, along with any additional attributes added specifically to the derived object.) Attached to the root rule object (L) is a individual rule stack object whose symbol as taught in FIG. 20e is (LS). The rule stack object (LS) has two attached returned value objects, namely a Veracity Property Object that indicates if the execution of the given rule (L) results in either a “true” or “false” conclusion. Also attached to the rule stack (LS) is a Stack Value Object that provides a returned value, either recalled or calculated via the execution of the rule (L). Note that a Stack Value Object may be used by another rule (L), thereby allowing for a powerful nesting of rules (L). Still referring to FIG. 21c, attached to each rule stack (LS) there are individual stack elements that are ordered in the execution via a sequence number. Each stack element may be either an operand or operator. If the stack element is an operator, then an individual operator object will be attached to the individual stack element, where the operator object itself carries a code indicating to the session processor 30-sp (that executes rules (L)) what type of mathematical or logical operation, etc. is to be performed. As will be further understood by those familiar with OOP, the actual method for implementing the desired operation could be held either in the session processor 30-sp, in which case the operator object acts as a simple pointer, or the method could be held on the operator object itself, in which case the session processor 30-sp then uses the operator object's method for execution. Both techniques have value, are sufficient and are considered within the scope of the present invention.

There are three basic choices for referencing an operand in an individual stack element, as will be well understood by those familiar with software programming. The simplest operand is an individual constant object that can be attached to the stack element. In this case, the present inventors prefer that the actual constant value be carried with the constant object, therefore allowing for easy reuse of pre-established constant values (with their attendant names, descriptions and limitations.) For the simplicity of the algorithm for executing the rule stack object, the present inventors prefer allowing a list of constant values object to be attached to the individual constant itself, where if attached the list overrides any value found on the constant object. As will be appreciated, although not necessary for any novel aspect of the present invention, having a list of constants can prove useful for implementing a “found in list” “yes or no” operation. For example, in the sport of ice hockey, a constant object could be established called “Line 1,” referring to the first line of forwards on a hockey team (as will be well understood by those familiar with ice hockey.) This “Line 1” constant object could then be a placeholder object, rather than carrying the actual value for execution by the session processor 30-sp. Using this approach, at the time of session 1 live processing, a unique list of constant values can be attached to the individual constant, reflecting the actual session attendee 1c objects. For instance, this list of constant values could be the player jersey numbers or names of the first line of a given team, which would obviously change from team to team. As will be understood, this and similar advantages herein taught are overall representative of the externalization and flexibility of the present teachings that especially allow a single set of rule objects (L) to be created that can be executed for any session of the same type (including session activity 1d,) regardless of the session area 1a, time 1b or attendees 1c. Still referring to FIG. 21c, rather than a fixed constant value, a data source object can be attached to the stack element, the returned value of which becomes the operand. Hence, the data source object is used to uniquely “point to” or “address” information held in an indexed data source [i|DS]. As was previously taught especially in FIGS. 21a and 21b, in order to reference a indexed data source [i|DS], all that is necessary is for the individual data source object attached to the stack element to include the following attributes:
1) Indexed Data Source [i|DS] Object Type:
   a. Either external device [ExD] or tracked object—session attendee (TO).[SAt];
   b. (Note that other Data Source Object Types will be taught in reference to upcoming figures especially in regard to the processes of integration and synthesis).
2) Indexed Data Source [i|DS] Object ID:
   a. Either a [ExD] group or individual object that has an attached [i|DS], examples include:
      i. The [ExD] group object representing the entire 2D and 3D machine vision based player tracking system, i.e. both the overhead tracking grid and the side-view cameras, (a combined dataset which is populated for instance during the “join” stage 4 of differentiation);
      ii. The [ExD] group object representing the 2D machine vision based player tracking system, i.e. the overhead tracking grid, (a combined dataset which is populated for instance during the “compile” stage 2, or “normalization” stage 3 of differentiation);
      iii. The [ExD] individual object representing a single source of 2D machine vision based player tracking data, i.e. a single camera in the overhead tracking grid, (a single dataset which is populated for instance during the “detect” stage 1 of differentiation);
   b. Either a (TO).[SAt] group or individual object that has an attached [i|DS], examples include:
      i. The (TO).[SAt] group object representing the entire “home team”;
      ii. The (TO).[SAt] group object representing a “player & stick”;
      iii. The (TO).[SAt] individual object representing a “player”, or
      iv. The (T0).[SAt] part object representing the “player helmet”.
3) Index value for accessing the Indexed Data Source [i|DS], examples include:
   a. A number 1 to n;
      i. A range from j to k, where both j and k are >=1 and <=n;
   b. A code referring to the “currently populated, or just populated” index slot, or
      i. A range from “current”—x, to “current”.

As will be understood by those skilled in the art of software systems in general and OOP in particular, after specifying the [i|DS] Object Type, [i|DS] Object ID and Index Values, the system can return the requested indexed data slot object along with all associated objects which are held on the feature lists [.F.list] and parts lists [.P.list] and ultimately contain object datum (OD) associated with a tracked object—session attendee (TO).[SAt]. As will be further obvious from a careful reading of the specification, if the Object Type of the data source is already a specific tracked object—session attendee (TO).[SAt], then any returned feature list [.F.list] or parts list [.P.list] from a given indexed data slot will naturally be only for that (TO).[SAt], or one of its associated descendent (TO).[SAt]. It should also be understood that while the present inventors prefer an implementation predicated on OOP techniques, various other solutions for implementing external rules are possible and perhaps even more desirable given the state of current or future computer software and/or hardware technologies.

Regardless of the software implementation, what is herein considered most important is the teaching of a systematic means for making the present system “agnostic” of at least the “who” for, “where,” and “when” the session 1 is being conducted, as well as “how” (the content data is collected.) (The careful reader should understand that the external rules themselves will naturally be built around “what” type of session activity 1d is to be conducted, for example as ice hockey vs. a music concert.) Even so, using the herein taught approach, many generic “activity” rules are possible that would be applicable across several “what” session activities 1d—for instance rules could be created to measure athlete movements that are equally applicable to all sports as long as the data collected per athlete is universal and normalized.)

Accomplishing this goal of “agnostic” session processing has two key requirements beginning with the normalization of data collected by any current or future external device capable of sensing session activity 1d. However, a universal protocol for input content normalization is not sufficient. What is also of critical importance is the normalization of the content processing rules; hence the establishment of a universal protocol and format for expressing how this first captured and normalized content is to be operated upon (i.e. differentiated, integrated, synthesized, expressed and aggregated,) where the processing rules can be freely exchanged amongst the marketplace without necessarily needing to know details of actual session areas 1a, times 1b, attendees 1c or even to some extent activities 1d. To accomplish the goal of the normalization of processing rules (beyond the normalization of content data,) what is needed and herein taught, is some implementation of the “external rule”—very much akin to a user entered formula that is associated with a “cell object” in a “work sheet object” in a “spread sheet object,” all of which are exchangeable in an open market regardless of the executing spread sheet.

Having said this, the present inventors prefer using the herein taught rule (L) object and all of its aggregated child objects. Hence, the ability to create any number of individual and/or nested rules (L), comprising a rule stack (LS) of one or more stack elements, where each element can be either be virtually an operator of any known current or future type (including mathematical and logical,) and where any stack element via a data source object can point to any information detected or determined via differentiation (either held in association with an external device or in the tracked object—session attendee,) or ultimately from any integrated or synthesized data structure (as will be further taught,) is sufficient for accomplishing the goal of normalized, externalized, content processing rules. And finally, as will be further understood by those more familiar with digital computing hardware beyond the general processor (CPU), at least including FPGAs and ASICs, the choice of implementing that external rules in a postfix “stack” configuration lends itself very well to the possibility of creating a new dedicated, hardware specific “session processor” that can only (but most efficiently) process universal, normalized session data using universal, normalized external rules.

And finally with respect to FIG. 21c, there is also shown a third possible operand, specifically the attachment of another individual child rule stack to the existing parent rule stack. As will be obvious to those skilled in the art of software systems, this allows for a very sophisticated nesting of rule stack elements, akin to the ideas of callable sub-routines in the structured programming environment. As will also be understood, this allows for the possibility of recursive rule stacks which call themselves, for instance to loop through data sources until conditions are met that end the recursion. While a nuance of the present design, the careful reader will note the choice of the present inventors to use a rule stack (LS) object to aggregate child stack elements, as opposed to simply aggregating the child stack elements to the rule (L) object itself. This is preferred since it allows the rule (L) objects to be easily pre-established without a rule stack (LS) in order to create an overall rules structure, and then to also have their rule stacks (LS) removed without effecting this structure, and further allows a single rule stack (LS) to attach to multiple rules (L)—however, it is not necessary as the alternate suggestion will also work. Referring next to FIG. 22a, there are shown some additional key objects and terminology of the Session Processor Language (SPL), in general concerning “internal session knowledge.” These objects describe both session content (data) and external rules (data) and their descriptions as provided in the figure are considered sufficient by themselves without further elaboration at this point within the specification. As will be understood by those skilled in the art of software systems, individual variations in what objects and their data structures are actually employed, whether or not they are fully object oriented or some approximation is immaterial. What is important is that they encapsulate the abstract notions of observations made about session activity (i.e. the objects that are moving in a session.) These observations “mark” an instant on the session time line where there is some fundamental shift in object behavior exceeding a simple or complex threshold. (The determination of these marks is herein taught as differentiation.) It is also necessary to represent “events” of consistent behavior by object(s), where the edges of the behavior, i.e. where the behavior starts and stops is defined by the observed “marks.” (The determination of these events is herein taught as integration.) It is also important to support related data to a “mark” that is measured or known with any given observation. It is also important to represent and process how existing events can combine into new events, and/or how observations (marks) can be aggregated and counted (statistics) within events (the combination and determination of which is herein taught as synthesis.)

As with tracked objects, any description of internal session knowledge (regarding the observation marks and events pertaining to the tracked objects) should preferably include a universal structure for storing external rules, or formulas, describing the processing of this content, where a formula must be able to describe any type of mathematical or logical operation performed on observation mark or event.

Referring next to FIG. 22b, next to each of several of the objects defined in FIG. 22a there is shown the present inventors preferred attributes for each object. While the present inventors teach and prefer the objects and their listed attributes, no specific object or attribute is meant to be limiting in any way, but rather exemplary. With this understanding of sufficiency over necessity, the attributes listed in FIG. 22b are left as self-explanatory to those both skilled in the art of software systems and sports, especially ice hockey, and therefore no additional description is here now provided in the body of the specification.

Referring next to FIG. 23a, there is shown a node diagram of main objects comprising what is collectively herein termed the Session Processing Language (SPL). This node diagram is referred to as the “Domain Contextualization Graph” (DCG) because of its broader view of the entire contextualization infrastructure. In this case, “domain” refers to the “scope of content and rules” that apply for a given session context, or “scope of session activity.” For example, when the session processor 30-sp is enabled to contextualize the session activity of an ice hockey game, or a play, or an educational class, the DCG holds and what the session processor can ultimately “know” and “express,” the internal session knowledge, and how it goes about sensing and translating session activity 1d to then be converted into this knowledge. More specifically, the DCG is a high level view of the objects representing the inner parts of the “black box” discussed in the summary of the invention. These objects, or “machine parts,” each provide important structure for creating the novel benefits of the present invention. The objects themselves are placed into the following four categories:
1) Governance:
   a. These are objects whose attributes (also known as “properties”,) serve to limit or direct the internal workings of the external devices 30-xd and session processor 30-sp as they capture and transform disorganized content 2a through the stages of detect & record 30-1, differentiate primary marks 30-2, integrate primary events 30-3, synthesize secondary & tertiary marks & events, express 30-4, as well as encode and store (organized) content 30-5;
   b. There are only two basic objects included in Governance:
      i. (L)—RuLes: which control all content transformations (see FIG. 7):
         1. Differentiation rules used in sets (DLS) by external devices 30-xd to detect, compile, normalize, join and predict live session 1 data into tracked object data 2-otd (see also FIG. 21b);
         2. Differentiation rules 2-rd used by external devices 30-xd, or by a differentiator 30-df, to parse the tracked object data 2-otd into primary marks 3-pm;
         3. Integration rules 2r-I used to create primary events 4-pe from primary, secondary and tertiary marks 3-pm, 3-sm, 3-tm respectively;
         4. Synthesis rules including 2r-ec for combining events into secondary events 4-se, and 2r-ems for summing events and marks into secondary (summary) marks 3-sm;
         5. Calculation rules 2r-c for creating tertiary (calculation) marks 3-tm, and
         6. Naming and Foldering rules for cataloguing and tagging events 4-pe and 4-se;
      ii. (DV)—Datum Values:
         1. Data validation values acting as constants and referred to in rules (L);
2) External Information:
   a. There are two objects included in Information that serve to generate input to the “black” box, either in the form of disorganized content (recordings) 2a, tracked object data 2-otd or primary marks 3-pm, which respectively could loosely be considered “recorded (full) data,” “tracked (sampled) data” and “filtered (thresholded) data,” and where the “filtered (thresholded) data” of primary marks 3-pm is the fundamental input to the session processor 30-sp to become the content (vs. rules) aspect of the internal session “Knowledge”;
   i. [ExD] External devices 30-xd (which can be either an individual or a group) for interfacing directly with a live session 1 in order to differentiate primary marks 3-pm;
   ii. {SP} Any session processor 30-sp for outputting any of its primary 3-pm or secondary 3-sm marks to become primary marks 3-pm into the receiving session processor, thereby supporting both session processor nesting and recursion;
   b. In addition to these two input generating objects, there are an additional two objects serving as the “template” for, and the “actual” data that is, the input, including:
      i. (CD) Context Datum holding a description (template) of any and all possible individual pieces of information than can either be detected or determined by external devices 30-xd or generated by session processor 30-sp. Collectively, (CD) Context Datum form the “data dictionary” of allowed information for any given session context to be processed;
      ii. (RD) Related Datum which is the (actual) individual pieces of information detected and determined by the external devices 30-xd and associated with primary marks 3-pm, or generated by session processor 30-sp and further associated with marks or events;
         1. Note that every piece of (RD) Related Datum is mapped (or associated) to its description (template) (CD) context Datum;
3) Internal Knowledge:
   a. There are two objects that represent the internal session knowledge as follows:
      i. (M) Marks, which are structurally identical whether they are classified as “primary” 3-pm, “secondary” 3-sm and “tertiary” 3-tm. Marks (M) represent boundary's of session activity 1d behavior, hence where a given activity aspect starts or stops. Marks (M) have a distinct session time “marking” the behavior change along the session time line 30-stl. Marks (M) also typically (but not necessarily) include one or more pieces of information, or Related Datum (RD);
      ii. (E) Events, which are structurally identical whether they are classified as “primary” 4-pe or “secondary” 4-se (also called “combined” events.) Events (E) represent consecutive time of repeated session activity 1d behavior over the detection threshold that “started” the event (E), and over the threshold that “stops” the event (E);
   b. At this point it is worth reiterating that session activity is not limited to real objects, but also pertains to virtual and abstract objects. Furthermore, real objects that “move” are not limited to people, or even organism vs. machines. To the extent that that a machine (such as a game clock in a sporting event) or inorganic object, such as a hockey stick, moves, then it's “behavior” can be marked into events. And finally, movement should not be restricted to the physical dimensions of length, width and height (with respect to the session area 1a,) but rather is meant to include the transition over time of any measured datum that can take on, or occupy, more than one distinct value of any type—i.e. the datum moves through the value type from distinct value to distinct value;
   c. In addition to the two knowledge objects of a (M) mark and an (E) event, there is also additional knowledge contained in the understanding of how various (M) marks and (E) events related to each other. To express this knowledge, there are only two types of objects as follows:
      i. (X) link objects, which provide for any number of additional connections between any one object (the child, or parent) to another (the parent, or child) beyond the built-in connection provided to all objects via the Core Object (base kind) attributes of: Parent Object Type and Parent Object ID;
      ii. (A) affect links, which are specifically used to establish the type of association a given (M) mark has to its related (E) event. The valid (A) affects are for the (M) mark (i.e. change in behavior) to “create,” “start” or “stop” the (E) event (i.e. duration of consistent behavior over threshold);
   d. And finally, within the Information, or internal session knowledge, there are two objects used for organizing the segmented (E) event behavior as follows:
      i. (F) folder objects, which provide an unlimited nesting hierarchy for forming organization, and to which any one or more (E) event can be associated. Note that any one (E) event can be associated with zero to many organizational (F) folders, and that the “decision” to associate an (E) event is made by the session processor 30-sp under external rules governing expression (L) at the behavior change times of “create,” “start” and “stop”;
      ii. (0) ownership objects, which carry information the specifically tracks the all content ownership identities as taught in relation to FIG. 6, including who owned the:
         1. Session area 1a;
         2. Session time 1b;
         3. Session attendees 1c;
         4. Session attendee activities 1d;
         5. External devices 30-xd;
         6. Differentiation Rule Sets used by external devices 30-xd;
         7. Session processor 30-sp;
         8. Integration, Synthesis and Expression Rules used by session processor 30-sp;
         9. Folders (F) into which the session content is to be expressed, and
         10. Session Media Player which provides access to the folders (F);
4) Aggregation:
   a. There is only one object used to aggregate either internal session knowledge, comprising external rules and session content, or expressed content, as follows:
      i. (C) context objects, which are structurally identical whether they are classified as:
         1. [Cn] “session context” which is the current context governing the running session processor, where the context is roughly equivalent to the type of activity (e.g. a sporting, theatre, classroom, etc. session.) While not necessary, the present inventors prefer a minimum three level classification system for delineating session activities, including:
         a. Category of activity, e.g. sports, theatre, music, educational, etc.
         i. Sub-Category of activity, e.g. ice hockey, football, baseball are all sports;
         b. Level of activity, e.g. professional, college, high school, recreational, etc., and
         c. Type of activity, e.g. game, practice, tryout, camp, etc.
         d. Note that the present inventors consider the Category—Sub-category to be a single distinction designed to denote the broadest view of the activity, for which there may be one or more narrow activities which are the “Type.” It should also be noted that there is no necessary order to the three classifications, as they can be rearranged to change the “view” (i.e. “list order”) of all possible session context activities;
         2. (Cx) “session context” which is any other sub-context being used by a nested or recursive session processor to prior or concurrently generate behavior change marks (M) for the current session 1 (being governed by context [Cn].) Note that both [Cn] and (Cx) are interchangeable and only reflect the nesting order of session processing, and that both n and x are the same variable used to uniquely identify a context, hence the “session contexts ID” or name;
         3. [Cm] “session folder context” which is used to segregate and uniquely identify various foldering hierarchies specifically to be used as templates for the expressions of content based upon a given session context [Cx]. Note that this provides for the opportunity to have multiple expression foldering hierarchies for a given session context, e.g. “home team” vs. “away team” vs. “scout”, etc.;
      ii. And finally, also note that ownership (O) can, and is expected to be, related to [Cn], (Cx) and [Cm].

Referring next to FIG. 23b there is shown in the upper half of the figure, the portion of the Domain Contextualization Graph first taught in FIG. 23a that corresponds to the scope of the allowed session information, (CD) context datum, and the rules (L) and datum values (DV) that govern its acceptance. As will be understood by those familiar with software systems, in order to establish and automatic system for inputting, processing and outputting content, it is desirable to create a definition of all possible pieces of information, i.e. “session words,” “content tokens,” etc., that define the actual “session language” to be used by the system. As will also be understood, this session language will vary based upon the session context [Cn], especially including the type of session activity 1d, but also including the types of session attendees 1c and even the session area 1a and session time 1b, to a lesser but important extent.

Upon closer consideration, it will also be seen that while this session language will change, especially based upon the activity 1d, e.g. the language of ice hockey is much different that the language of a theatre play, in many cases there can be significant overlap of session language between various session contexts [Cn]. Keeping in mind that the present inventors sufficiently define session context [Cn] to include: [(category), (sub-category)].[level].[type]. Two example session contexts [Cn] with a session language expected to have a very high correspondence would be: [(sport), (ice hockey)].[professional].[game] and [(sport), (ice hockey)].[youth].[practice]. Two other examples with moderate overlap would be: [(sport), (ice hockey)].[professional].[game] and [(sport), (soccer)].[youth].[game]. For these reasons, the present inventors teach the nested association of the definition of session information (i.e. (CD) context datum,) any of its limiting datum values (DV) and its validation rules (L), to a given context aggregator such as [Cn]. This allows for partial session language to be defined once, e.g. the language of athletic motion, and assigned to its own unique session context aggregator, e.g. [C-GUIDy] (where GUID is an acronym for global identifier, as will be understood by those familiar with software programming languages.) In addition to this, a separate aggregator [C-GUIDz] could be used to establish the session language of ice hockey attendees, as opposed to aggregator [C-GUIDr] for defining soccer attendees. With each partial session language first established, they may then be joined by a higher level session context aggregator [Cn], e.g. joining the language of athletic motion and ice hockey attendees.

This aspect of the present invention, i.e. nested aggregating of session information (CD)-(RD), (DV) and (L), is equally applied to the definition of all other rules (L), internal session knowledge (M) marks and (E) events, as well as expression folders (F). Furthermore, the present inventors consider this to be a fundamental and necessary apparatus for allowing the efficient development, exchange and melding of the session processing language (SPL) by the open marketplace, were any number of individuals or entities can define their own session languages and contextualization rules, to any desired level of fullness matching their expertise, for various session activates 1d, attendees 1c and areas 1a. These may then be placed in an open and free exchange or be bought and sold with ownership for aggregation in any number of simply and complex nesting relationships. As will be further understood by a careful reading of the present teachings, this arrangement of apparatus, providing simple yet highly reconfigurable session language and contextualization rules, uniquely allows for the universal normalization of the any and all types of session contextualization by automatic machines—the net result of which opens the opportunity for a loosely coupled world-wide network of autonomous session processing machines, following universally agreed upon standard languages and contextualization rules and outputting for Internet based consumption normalized parsed session content, which is supportive of what it referred to as the “semantic web,” or “web 3.0.”

As will be further understood by a careful reading, the present invention supports multiple session processors 30-sp working in parallel or series, with or without collaborative nested aggregation and its attendant sharing of internal session knowledge and rules. This in turn implies that any session may be contextualized in as many ways as the marketplace desires and economically supports. For instance, each professional sports game could be contextualized three different ways simultaneously using three separate session processors 30-sp all receiving input from the same external devices 30-xd; where for example the three ways would be for the league (NHL,) the team and the fans. As will be further understood, while each session processor 30-sp would be referencing a different root session context [Cn], these roots which are aggregating the session language and contextualization rules, could share sub-nodes and as such be nearly identical except for expression (F) folders, or some levels of contextualization details—i.e. fans may not care about nearly as many (E) events being tracked as the coaching staff. All of these types of aforementioned features are lacking from the present systems and prohibiting the universal, efficient and market collaborative contextualization of session content, thereby greatly inhibiting the sharing and searching of the results of any and all types of sessions, whatever they may be.

Still referring to FIG. 23b, the top of the figure shows a session context aggregator [Cn] attached to which is any number of context datum (CD), where each data describes a single word of the session language (in a chosen first human language, with the possibility of localization to other human languages via the (D) description objects as earlier taught with respect to FIG. 20b.) Each (CD) may or may not have an associated rule (L) for its acceptance during a session, or one or more datum values (DV) for limiting its range—all of which has been prior discussed and will be understood by those familiar especially with software systems supporting external data definitions.

With respect to the lower half of FIG. 23b, there is shown the corresponding block diagram of class for implementing the abstract objects represented in upper half of FIG. 23b, all of which will be familiar to those skilled in OOP. First note that a context dictionary class is preferred for associating and allowing external views into the context datum (CD) associated with the given session context [Cn]. Also note that for any given (CD) there are the following preferred object classes, namely:
Standard Types:
   This enumeration is meant to be universal across all session languages and is used to indicate whether a given word, context datum (CD) is applicable to the “who,” “what” “where,” “when” aspects of the session, i.e. the (CD) describes an aspect of the session attendee 1c, session activity 1d, session area 1a or session time 1b;
   (Note that the “how” question is left off only because it is herein being applied to the external devices 30-xd, which is “how” the session is to be captured. Otherwise, as will be understood by those familiar with more complex artificial intelligence systems, understanding the “how” or “why” human accomplishments, i.e. session activities 1d, are achieved is a significant challenge requiring inductive and deductive reasoning systems—all of which is outside of the scope of the present invention. Having said this, the present invention is considered to be very supportive of such reasoning systems because of its universal and consistent representation of session content upon which further reasoning algorithms can be built);
Data Types:
   These are the classifications of data very familiar to software programmers, such as date, time, numeric, alpha-numeric, picture, sound, blob, etc., and are important for information processing as will be understood by those of necessary software skills;
Value List:
   This object was fully explained with reference to FIG. 21c and provides for a pre-known list of distinct values that any given context datum (CD) may be restricted to matching;
Rule Stack:
   The rules stack (LS) allows the session processor 30-sp to perform any type of calculations on any pieces of existing internal session knowledge, at the indicated “set time” (see below) for plugging the associated (CD).
   For example, a differentiator 30-df, or an external device 30-xd with built in differentiation, may transmit a primary mark 3-pm (M) at a given moment with several related datum (RD) (to be discussed in more detail with respect to upcoming FIG. 23c.) It may be assumed that most often the (RD) comes from the differentiation of measured object tracking data 2-otd, or for instance, from captured manual observations, such as with the umpire's clicker taught in FIG. 13b. However, as will be understood, there are times when the (RD) related datum to be associated with a (M) mark is not “from” the session activity 1, but rather “from” the state of the session 1, i.e. the internal session knowledge, at the “set time” of the (E) event being described by the (M) mark. For example, with respect to ice hockey, when a (M) mark is issued by a differentiator indicative of a “player shift” start or stop, then it is assumable that the (M) marks related datum (RD) will include “team,” “player number,” etc.—precisely because this is information captured in the tracked object database 2-otd used for differentiation. However, an additional (RD) could be added to the (M) for example called “Period” or “Score Differential.” This information could then be captured either at the start or stop of the player's shift (E) event (or at both the start and stop, if two (RD) are set up per (CD) with different “set times.”) Furthermore, note that the “Period” information needs to only be “looked up” via a rules stack (LS) and returned as a value where as the “Score Differential” will require looking up both operands, e.g. each team's current score, and performing a subtraction operation, all as can be accomplished via the postfix rules stack as will be understood by those skilled in the art of computer architectures.
Rule Stack Set Time:
   This enumeration is a settable parameter that indicates to the session processor when a particular mark (M) related datum (RD), associated with a distinct (CD), is to be “set” to the value indicated by the associated rule stack (LS). The choices preferably include:
      Time of (M) receipt by the session processor 30-sp;
      Time of (M) attachment to an event (E) by processor 30-sp (which will be further discussed in relation to subsequent figures);
      Time of (M) association with an event (E) create, start or stop.

Referring next to FIG. 23c there is shown in the upper half of the figure, the portion of the Domain Contextualization Graph first taught in FIG. 23a that corresponds to the scope of the allowed session information (i.e. context datum (CD) as taught in relation to FIG. 23b) in association with the first of the two internal session knowledge objects; namely the (M) mark, used to denote a change in, or state of, a given session attendee's is activity 1d. (As mentioned previously, note that the attendee 1c and their behavior 1d can be real, virtual or abstract.) As will be understood by those familiar with software systems, the data input to a system must be “understood” by that system at some level. In the present invention, all data input into the session processor comes in the normalized form of a (M) mark (activity observation, thresholded data) along with any one or more pieces of additional observation or measurement, collectively called “related datum” (RD). Each related datum (RD) must correspond to one and only one (CD) (not withstanding that (CD) can be linked as described in FIG. 23a.) In one sense, if the sum of all potential context datum (CD), collectively listed as the context dictionary, is what “can be known” about a session 1, then the sum of all related datum (RD) is what “is known” about a session 1. Obviously, the set of unique (RD) can be less than or equal to the set of unique (CD), but it cannot exceed that set or there would be an unidentified “word” concerning a session 1. As is also obvious and will be further addressed in relation to coming figures, the sum of all (RD) by itself, without organization, would effectively be meaningless. Still referring to FIG. 23c, the first way of organizing related datum (RD) is in relation to the mark (M). For example, in ice hockey the related datum (RD) could be of name “duration,” of standard type session time, of data type time, of value “1 minute, 14 seconds.” By itself this datum carries little meaning. However, it could be associated with a mark (M) of name “penalty,” or a mark (M) of name “player shift,” in which case it has gained more meaning. Since each (M) as a derived object also has a creation date-time (see FIG. 20a,) which is directly translatable to the session time line 30-stl, then this additional attribute of the mark (M) gives the (RD) even further meaning. If the mark (M) were to have other related datum (RD) with names such as “period,” “player number,” etc., than the original “duration” (RD) starts to take on significant context value. Furthermore, as will be taught, when the mark (M) itself is integrated by the session processor, and for instance used to “start” or “stop” either a “penalty” or “player shift” event (E) respectively, then the related datum (RD) is fully associated, first with the mark (M) and then through the mark (M) in association with zero or more events (E)—where then its name, value and other attributes, along with its associations to the two information objects, are extremely meaningful “contextualized” content.

Still referring to the top of FIG. 23c, the external device 30-xd using a differentiation rule set (DLS), and/or an another session processor 30-sp using a different session context (Cx), are the sources of marks (M) and their related datum (RD). As can be appreciated by a careful reading, context datum (CD) are clearly templates objects, pre-defining what datum are allowed, where (RD) are clearly actual objects, created at the time of session processing. However, as will also be appreciated and in reference to the lower half of FIG. 23c, marks (M) can be either templates or actual. They can be instantiated prior to the session by a contextualization developer using the SPL to define the session information and internal session knowledge, i.e. (CD), (DV), (M), (E), (F) and (L) objects, in which case the (M)s are serving as templates and their “function” attribute (see FIG. 20a) is set accordingly. Pre-establishing a template mark (M) allows associations to be made between the (M) and the context datum (CD) that the mark source will provide as input to the session processing (note that these association lines are not portrayed in FIG. 23a or 23c for simplicity and clarity.) Pre-establishing template marks (M) also allows rules (L) to be pre-established defining the aspects of differentiation, integration, synthesis and expression that may involve the given mark. Marks (M) can also be instantiated during a session, becoming a critical part of the actual session knowledge—in which case they are created by external devices 30-xp or another session processor 30-sp and transferred via some protocol (e.g. network messaging) to the session processor 30-sp, which then stores and processes them. However, as implied in FIG. 23c by the enum “source types” class associated with an individual mark “type” or template, the current session processor 30-sp itself, processing context [Cn], is also able to internally instantiate its own marks (M), as will be later taught in greater detail. Hence, the “source type” of a template mark (M) is either internal, or external.

And finally, still in reference to the lower half of FIG. 23c, template marks (M) also have a standard type (similar to context datum (CD),) but in this case with values including:
Session Start Mark:
   As discussed in relation to FIG. 5, the present inventors prefer a manager-worker service model where an “always-on” manager service called a session controller 30-sc is waiting on a network and accessible via messaging by manually operated externals devices such as the scorekeeper's console 14, taught especially in relation to FIG. 11a. When a person using console 14 initiates a new session, (e.g. with respect to ice hockey, a practice, game, tryout, etc.,) then a request message is sent to the session controller 30-sc asking that a session processor 30-sp be instantiated to service the session 1. Once the session processor 30-sp is successfully instantiated and named, it will communicate its unique identity back to the session console 14, either directly or via the session controller 30-sc. Since console 14 has access to the session registry 2-g, it may then work independently or with the session controller 30-sc to inform all other external devices 30-xd in registry 2-g that a session 1 is about to begin of context [Cn] and that all differentiated marks (M) should be sent to the identified session processor 30-sp. After these initial functions are performed, the console 14 sends the “session start mark” (M) to the identified session processor 30-sp. This special mark (M) is then recognized by the session processor 30-sp, which begins the entire contextualization processes.
   Note that other software apparatus and interaction methods are possible to accomplish the aforementioned establishment of a session processor 30-sp and start of the contextualization of a session 1. The teaching above should therefore be considered as preferences and not mandatory, as sufficient but not necessary. For instance, the console 14 could instantiate its own session processor 30-sp without needing an intermediary session controller 30-sc. Conversely, some sessions 1 may preferably be started and stopped automatically without any human interaction, in which case some external device other than console 14 should be communicating with session controller 30-sc, or its functional equivalent. As will be understood by those skilled in the art of software systems, the teachings and functions of the present invention are separate from the actual software implementations and may be implemented with alternate apparatus arrangements without departing from the novelty and claims of the present invention. However, the actual software apparatus herein taught is also efficient and purposeful in itself, and therefore is also considered novel and claimed by the present inventors as the machine to conduct session contextualization.
Session End Mark:
   The mark (M) recognized by session processor 30-sp as the final mark (M) to be received and processed with respect to the current session 1.
“no setting”:
   If the standard type of a mark (M) is left blank, than this indicates a normal “in session” mark (M) to be processed in accordance with the teaching herein provided.

Referring next to FIG. 23d, there is shown a block diagram teaching how the session manifest 2-m object is relatable to one or more default mark sets, where each mark set can represent either a template or actual session attendee 1c group or individual. For example, an actual default mark set for a group in ice hockey might be “Wyoming Seminary Varsity Boys,” which is then used to aggregate the actual team roster of individual session attendees 1c, or the team's “players.” In this case, the default mark sets are pre-established and associated with the session manifest 2-m. Preferably, at some point soon after the initiation of the current session 1, the console 14 can parse the actual default mark sets, starting at the group level an then nested to the individual level, to find the actual marks (M) for the “Wyoming Seminary Varsity Boys,” team and then their players to be issued to the session processor 30-sp (see bottom of FIG. 11b.) Alternatively, the default mark sets can be used as templates, in which case the list elements hold both a template mark (M) and a list of one or more context datum that serve as prompting cues for the console 14. In this situation, the default mark set for the actual team with its nested mark sets for the individual players does not need to pre-exist. Rather, the console 14 can read the templates (for example for the “home team” including “home team players”) and know how to prompt the user to accept this information at session 1 (e.g. game) time. Also using the template marks (M) and their pre-established template context datum (CD), the session console can “fill-out” actual marks (M) with actual related datum (RD) as entered by the user on the console 14. These marks (M) and related datum (RD) are then issued to session processor 30-sp, similar to the approach for a pre-established actual default mark set as described in the prior paragraph.

As with many other teachings herein, those skilled in the art of software systems will image other possible implementations and arrangements that vary from FIG. 23d that depicts the preference of the present inventors, but is not considered mandatory. What is important is that a default set of actual marks (M) and related datum (RD), fully describing one or more session attendees 1c, whether groups or individuals or some combination, can be pre-established and associated with the manifest 2-m (or some equivalent,) prior to the session time 1b. What is also important is that conversely, a set of template marks (M) and associated context datum (CD) can be pre-established and associated with the manifest 2-m (or some equivalent,) such that a console 14 could parse manifest 2-m and automatically prompt for and build actual (M) and (RD) at session time 1b. However, what is of greatest importance is that ultimately, whether pre-established or prompted at run-time, whether using the proposed default mark sets of FIG. 23d or simply using “hard-coded” software logic embedded into console 14 software, the session attendee 1c information is loaded into the appropriate marks (M) and related datum (RD) for issuing to the session processor 30-sp in a normalized format. Referring next to FIG. 23e, there is shown a combination node diagram (copied from the DCG of FIG. 23a) with a corresponding block diagram detailing the relationship between the mark (M) and the event (E), the two key objects used to represent internal session knowledge. At the top FIG. 23e, there is repeated session context aggregator [Cn], to which are attached mark(s) (M) and event(s) (E). As was discussed in relation to the prior figure, marks (M) can be both template and actual objects—as can events (E) (and all other objects listed on the DCG except for related datum (RD).) It is first useful to understand marks (M) and events (E) as templates, or logical placeholders that allow for the pre-session, “externalized” development of the various contextualization rules (L). As prior discussed, this provides for one of the key objectives and novel aspects of the present invention, namely that content structure (both input, transitional and output) as well as content processing (contextualization) rules are all themselves data, external to the system. As such, the content definitions and external rules may be established prior session 1, and are not “hard-coded” into the processing system—which in turn means they are exchangeable between processing systems, between developers and the marketplace, and between various session contexts [Cn].

However, before considering marks (M) and events (E) in their template forms, it is best to return to one of the major conceptual underpinnings of the present invention, which is also one of the herein taught key novel aspects. Sessions 1 are universal. In abstract, they are simple. A session 1 happens in some “place”; this is the session area 1a. This session area 1a can be real or virtual (e.g. a location within a computer gaming “world.”) A session area 1a is typically contiguous, but does not have to be. A session happens at some time, over time; this is the session time 1b. This session time 1b must have duration, and is typically continuous, but does not have to be. Sessions 1 have one or more objects (live participants or things) of interest to record becoming the content; these are the session attendees 1c. These attendees can be real, virtual or abstract. They can be groups, individuals or parts, organic or inorganic—there is not restriction other than the assumption that a session has at least one object that moves, or can move; this movement is the session activity 1d. Session activity 1d is real, virtual or abstract in relation to the attendees 1c. Session activity 1d movement is very often in the physical dimensions (i.e. over the width, length and height of the session area 1a,) but does not have to be. In the most abstract sense, session activity 1d is movement in at least one attribute of one object (session attendee 1c.)

The present example of an ice hockey game is easy to see in light of these herein taught definitions. The session area 1a is the ice sheet where the game is played, and really also the team benches and penalty boxes. The session time 1b is the duration of the game itself. The session attendees 1c are the teams (groups,) made up of players (individuals,) with at least a centroid and stick (parts.) The session activity 1d is the game action—both during “in play” and “out of play” time. The disorganized content 2a is the raw recordings, typically in video from one or more cameras, and possibly with audio. The disorganized content 2a is also the manual or electronic scoresheet. The present invention seeks to automatically and semi-automatically capture all disorganized content to its automatic contextualization—or organizing into meaningful, sorted “chunks” of session content. From the example of ice hockey, it is easy to see the extension of the present teachings into all other sports, as well as theater plays and music concerts. All of these applications have sessions 1 the equivalent of “tryouts,” “practices,” “games,” “camps” etc.—and for all of these sessions 1, organized content 2b is highly useful. Slightly less easy to see is that sessions 1 are also outdoor commencements, inside assemblies, trade show presentations, classroom sessions, casino gaming tables and slot machines over time, etc. A bit harder to see is that sessions 1 are also virtual, such as a trading session on Wall Street where the session area 1a is “wall street” (the abstract concept, not “Wall Street” the actual place,) and the session time 1b is perhaps an entire trading day. In this example, the session attendees 1c are the various stocks, and the session activity 1d is the changes to their attributes (e.g. price) and the movement of their shares (e.g. quantity bought and sold.) Sessions 1 are also single or multi-player video gaming sessions, or a user interacting with a program on a computer.

The present invention teaches that a session 1 must have at least one “dimension” (modeled as the session area 1a) in which objects (attendees 1c) have the freedom to move (activity 1d) over session time 1b. It is important to note that the “dimension” does not need to be a physical dimension, and can even be a single dimension, and not two as “area” implies (i.e. width and length.) Herein, the term “session area” is abstract and means the one or more dimensions about which the attributes of the objects to be tracked or measured, or are free to move. All that is required is one dimension for describing the movement of one attribute on one object in order to define a session 1. In the case of stocks on Wall Street, the dimension could be “price” and/or “quantity.”

The goal of the present invention is to create a single system capable of universally modeling any arrangement of session area, time, attendees and activities in advance of the session. Another goal of the present invention is to allow rules to be developed that refer to the attributes of the attendees, which are fee to change value over time, so that these changes become the underpinning of the organized content 2b, essentially forming the index 2i into the various recordings, whatever they may be. These universal modeling and rules must be external to the system and exchangeable within the market. They should be combinable to form new constructs and they should be understandable in any local (human language system.) Ideally they will be uniquely identifiable by session context [Cn] and ownership. Preferably they will have universal and continuous version control, down to the individual SPL object. Any device capable of sensing, detecting or otherwise learning about the session activities 1d should be capable of inputting normalized observations to the system—any devices, no matter the underlying technology, can become an external device 30-sp by complying with the universal data exchange protocols. The systems should be nestable and recursive and operate in a both local and/or global configuration. The ideal system outputs some or all of its organized content with recognition of ownership and customizable to one or more organization strategies—the output content should also be fully tagged supporting the semantic (Web 3.0) searching.

Given these understandings, and returning to FIG. 23e, the session activity 1d of interest can be modeled by a single object, the “event” (E). While the word “event” can be somewhat confusing, it is herein taught to be some or all of the entire session time 1b. In one sense, an ice hockey game by itself is an “Event” (with capital “E”,) which the present invention refers to as a “session.” The present invention certainly supports an individual event (E) spanning the entire session time 1b, but in practice this is of limited value and mostly what the marketplace already has as a useable index 2i. What is desirable is that any individual “event” (with a small “e”) can be automatically “chopped” out of the big “Event” (session) for individual consumption, e.g. a goal scored is a desirable event (E) to add to the index 2i. In sports, events (E) are roughly equivalent to individual “plays”—but this analogy breaks down quickly with sports such as ice hockey, were plays are much less structured. An event (E) is than the duration of any consistent attendee 1c behavior, or activity 1d over time. In this case consistent is a very general word meant that can also be interpreted as “pertinent.” The invention teaches that “pertinence” can be told to the system by human observers who are indicating something that they know about the current session activities 1d—such as a scorekeeper indicating a “shot taken” or “penalty,” etc. The present invention further teaches that “pertinence” can be automatically determined following structured rules (L) that look for relevance by comparing the various session attendee 1c attributes that are changing over time, to either simple or complex thresholds.

What is fundamental about an event (E) is that it has a start time and stop time spanning some duration. What is desirable is that this event can be correctly used to index 2i into the recorded, disorganized content 2a, thereby making it organized content 2b. In order to properly set the start and end times of any given event (E), the system must know where to “mark” the session time 1b. Therefore, whether the observation is manual, semi-automatic or fully automatic, for it to be useful to the present invention is must be communicated as a normalized mark (M) at an instant of session time 1b, that may or may not have related datum (RD). As marks (M) are received by the system (specifically session processor 30-sp,) they may or may not “start” or “stop” any given event (E). As will be taught in more detail with respect to FIGS. 25a through 25i, marks may also “create” events (E), which should simply be thought of a “pre-establishing” an anticipated future event (E), to be started by some other detected session attendee 1d behavior. (For example in ice hockey, the referee calls a penalty which is then entered by the scorekeeper via console 14, this “creates” the penalty event (E). However, the penalty event (E) is then subsequently started when the game clock (session attendee 1c) starts to move, all as will be understood by those skilled in the sport of ice hockey.)

Therefore, specifically referring to the top of FIG. 23e, what is needed an herein taught is a method for pre-associating the relationship from any one type of possible detected mark (M) to any one or more possible and desirable events (E). This association, or the marks (M) “affect” on the event (E) in question, can be to either create (Ac), start (As) or stop (Ap) the event (E). Each possible affect, create (Ac), start (As) or stop (Ap), has a rule (L) which governs its execution by session processor 30-sp (all of which will be taught in detail via examples with respect to upcoming FIGS. 25a through 25i.)

Turning now to the lower half of FIG. 23e, there is shown the preferred object classes for implementing a given mark's (M) relationship and possible affect (A) on a given event (E). Specifically, on the lower left is shown the class symbol for a mark type (M) (that may have associated context datum (CD) and therefore related datum (RD) as previously taught but not repeated here.) As previously mentioned, the mark (M) in this case is a template used to establish rules (L), not an actual mark (M) observed by an external device 30-sp during a game. In this sense, it is useful to think of the template a type, or kind of mark. However, in all other ways there is no difference between the template mark “type” (M) (in OOPs the “base kind”) and the actual mark (M) (in OOP's a single instance of the base kind.) Likewise, to the right of mark type (M) is event type (E), representing a kind of event (E) that might happen in a session. Above event type (E) is the affect object (A), which is also and always a template. Affect (A) has an associated rule (L) shown as rule stack (LS) that “allows the affect” to happen, i.e. governs the proposed effect of affect (A) of mark (M) on event (E). Rule (L) and rule stack (LS) are virtually identical to the teachings associated with FIG. 21c, but will be taught in more detail in upcoming FIG. 24d. (As will be understood by those skilled in the art of embedded systems, it is desirable to have a single, simple, execution apparatus and method for executing all system rules (L). This provides for the opportunity of creating a customized ALU, for instance on an FPGA or ASIC chip, for executing the normalized SPL herein taught, especially including all rules (L)—all as will be understood by those skilled in both software systems and digital computer architecture.)

Still referring to the bottom of FIG. 23e, it should also be understood that the consideration of a mark's (M) effect on an event (E) is the process step of integration 30-3, taught in FIG. 5. Essentially, marks (M) are the combinable parts of an event (E), that along with their related datum (RD) and final association (create, start, stop or some combination) describe (or “tag”) the event (E). As taught in FIG. 22b, affect object (A) includes an attribute called “type,” which refers to the type of effect the mark (M) is allowed to have on the event (E), including: creates, starts, stops, creates and starts, starts and stops, or creates, starts and stops a given event (E). Again, detailed examples from ice hockey will be given shortly with respect to FIGS. 25a through 25i. As will also be made more clear with respect to the upcoming figures, when a given actual mark (M) arrives at the session processor 30-sp, the session processor 30-sp refers to the type of mark (M) to find all of the one or more possible affect objects (A) it has associated with it. For each found affect object (A), the session processor 30-sp executes the associated rule (L) to determine if the result is “true” (indicating to “do the requested effect”,) or “false” (indicating to “skip the requested effect.”) If a rule (L) executes to true, before associating the current mark (M) to be the actual indication of event (E) start or stop time, the session processor 30-sp checks the affect object (A) to see if a “replacement” mark (M) should be used instead—thus, one differentiated session activity 1d (attendee(s) 1c behavior) can trigger an effect, while then using another mark (M) to set the actual time of the effect, all of which will be shortly taught by detailed example.

Still referring to the bottom of FIG. 23e, affect object (A) includes either an attribute, or has an associated “spawn” mark type (M)—one for resetting or replacing the event's (E) start time, the other for the stop time. A spawn mark (M) is specifically a new mark (M) generated within session processor 30-sp and not provided by an external device. If it exists, spawn mark type (M) is always “spawned” from the current mark (M) that was sent by the external device 30-xd and is given a mark time that is either forward or backward on the session time line 30-stl. (Note that there are no rules (L) that additionally govern this last step.) For instance, a “shot” mark (M) received from the scorekeeper's console 14 may be used to create, start and stop a shot event (E), where the shot event (E) ends at the time of the “shot” mark (M) (simply because the scorekeeper indicates a shot after it happens.) However, the start time of the event (E) can be set by a new “shot buffer” mark (M) spawned backwards in time from the “shot” mark (M), e.g. 3 seconds earlier.

In addition to spawn marks (M), each affect object (A) includes either an attribute, or has an associated “reference” mark type (M)—which like the spawn mark (M) is used to adjust the actual start or stop time of the event (E). Unlike the spawn mark (M), the reference mark (M) is chosen from the list of existing actual marks (M) that have already been received by session processor 30-sp and match the indicated mark type. In order to select the actual reference mark (M), session processor 30-sp uses the associated rule (L) which governs the choice (again, for which sufficient examples will be provided shortly.) One example is the situation where the clocked has been stopped by a referee after a goal has been scored. With the clocked stopped and after the actual time of the goal, the scorekeeper uses console 14 to indicate (or mark/observe) that the goal was scored by team A, player 99, etc. When the session processor 30-sp receives this “goal mark” (M), it looks for associated affects (A) and ultimately creates a “team goal scored” event (E). The “goal mark” (M) creates, starts and stops the event (E), but it uses a reference mark as the actual stop time (and spawns a mark for the actual start time,) all as will be taught by detailed example shortly. In this case, the reference mark is the last “clock stopped” mark (M) received by the session processor 30-sp, as will be understood by those familiar with the sport of ice hockey.

And finally, as will be discussed in greater detail with respect to upcoming FIGS. 38a, 38b and 38c, after spawn marks (M) are created for associated with a given event (E), they are fed-back to the session processor 30-sp as a recursive process and may themselves then initiate addition cascading effects on additional events (E).

Referring next to FIG. 24a, there is shown a node diagram depicting the associations between a create, start and stop mark (M) and an event (E), each governed by a rule, all placed upon a session time line 30-stl. Specifically, event type (E) 4-a is shown over session time line 30-stl. Attached to the leftmost end (time-wise, the beginning) of event (E) 4-a is mark type (M) 3-x, whose effect is to create the event. Also attached to the leftmost end of event (E) 4-a is mark type (M) 3-y, whose effect is to start the event. And finally, shown attached to the rightmost end (time-wise, the ending) of event (E) 4-a is mark type (M) 3-z, whose effect is to stop the event. Also shown are related datum (RD) attached to each mark type 3-x, 3-y and 3-z. Furthermore, each connection between a mark type and the event has an associated rule (L) that governs its implementation.

It is noted that FIG. 24a is meant to depict both template and actual objects, as will become even clearer as the specification continues. As will be appreciated form a careful reading of the present teachings, all marks 3-x, 3-y and 3-z could be the same mark (M) or different marks (M) in any combination (to be taught in upcoming figures.)

Furthermore, as will be understood, not all events (E) require a create mark (M)—all that is needed to give the event (E) duration are start and stop marks (although for consistency the present inventors prefer to assign a create mark for all events.) And finally, the same mark type (M) could act as the create, start and stop marks (M), but have a different rule (L) for each affect (A). While the present inventors prefer the simplicity of this arrangement, it should not be construed as a limitation, but rather and exemplification since variations are possible, as will be understood by those familiar with software systems.

Referring next to FIG. 24b, there is shown event (E) and its possible related create, start and stop marks (M) with their associated event and mark type list objects populated by the session processor 30-sp. When received from an external device 30-xd or another session processor 30-sp, incoming marks (M) as well as internally generated/instantiated marks (M) are all placed onto their appropriate lists by type. As marks (M) create, start and/or stop events (E), the session processor 30-sp adds the event (E) to its appropriate list as a part of object instantiation, as will be understood by those familiar with software systems in general, and especially OOP techniques, and as will be taught further in the next figure.

Referring next to FIG. 24c, the event (E) list taught in FIG. 24b is shown to have three distinct views, namely the “created events,” “stated events” and “stopped events” views. (As will be appreciated by those skilled in the art of software systems, these could actually be three separate lists that have a different view to merge them together to accomplish the depiction in FIG. 24b. All of these choices are considered designer preferences and immaterial to the novel teachings of the present invention.) As will be obvious from a careful review of FIG. 24c, this depiction is a time-wise build up to the net representation shown in FIG. 24a. Hence, marks (M) (such as 3-x, 3-y and 3-z) come in over session time and create, start and stop events (E) (such as 4-a,) moving it from created list view, to started list view, to stopped list view. Again, a single mark (M) is all it takes to create, start and stop a single event (E), and therefore it would not be necessary to actually have the session processor move the event object (E) from list to list, but rather to simply go straight to adding the event (E) to the stopped event list. Also, while every event (E) must have a distinct and time ordered start and stop point denoted by a mark (M), as will be appreciated by a careful reading, not every event (E) needs to be created distinctly from being started. Although there are advantages for this create first, start later approach as will be discussed shortly, the present invention should not be limited to requiring a create time and mark, but should rather be considered sufficient with a start and stop time only, and then expanded by the concept of an additional create time and mark, all as will be appreciated by the careful reader.

Referring next to FIG. 24d, there is depicted the object class implementation of an integration rule (L). Note that the upper half of FIG. 24d is exactly similar to FIG. 21c, which depicts a differentiation rule (L). In fact, the objects, their attributes and methods as taught with respect to FIG. 21c are purposefully meant to be the same. As those skilled in the art of software systems in general and OOP techniques in particular will understand, keeping all rule (L) object aggregations the same lends itself to object reuse, which ultimately supports the embedding of the objects and their methods into custom hardware, such as an FPGA or ASIC—terms that will be familiar to those skilled in the art of embedded systems. In fact, all rules (L), whether for the differentiation stage 30-2, integration stage 30-3 (now being reviewed,) synthesis stage 30-4, expression stage 30-5 or aggregation stage 30-6 (see FIG. 5,) are implemented in object aggregations exactly similar as taught in FIG. 21c and now repeated in FIG. 24d. The only different between rules (L) at the various stages are the data sources that they may reference. For instance, while differentiation requires access to individual external device [ExD] or tracked object—session attendee (TO).[SAt] indexed data sources [i|DS], or the tracked object database 2-otd that is simply the collection of (TO).[SAt]. [i|DS], integration requires access to the mark type and event type lists taught in FIGS. 24b and 24c. However, while most often integration rules (L) are processed based solely upon internal session knowledge, each rule (L) technically shares the ability to recover operands from the external device and track object—session attendee data sources. In fact, all rules (L) for every contextualization stage 30-2 through 30-6 could theoretically access any type of data object taught herein as content if necessary, but in practice these datasets may be held separate from each other for network or other efficiencies—none of which should be construed as limitations to the present invention.

Referring next to FIGS. 25a through 25j, there are shown a series of nine cases, or examples drawn from the sport of ice hockey, of how incoming mark(s) (M) from one or more external devices [ExD] are integrated by the session processor 30-sp to form an event (E). While understanding the marks (M) and events (E) used as examples may require familiarity with the sport of ice hockey, a careful reader will see and understand how events (E) are created, started and stopped in various possible combinations, including the altering of the event's (E) start or stop time be substituting, or replacing, the originating start or stop mark (M) with either an internally spawned mark (Ms) or a reference mark (Mr)—both of which are identical in their object structure to a primary mark (M) 3-pm received from either an external device [ExD] 30-xd or session processor 30-sp.

Before moving on to make specific comments about each FIG. 25a through 25j, in general it is noted that the purposes of the examples are to teach the stage 30-3 of integration, where incoming marks are combined into events following external rules. While all of the examples will work to accomplish their implied function for indexing an ice hockey game via the creation of events, none of the examples are meant to limit the present invention's use for contextualizing an ice hockey game to only those types of events shown herein, or even to the taught way of forming each example event shown herein. As will be well understood, the present invention can receive equivalent marks from various different external devices employing different technologies to sense the same session activities. For instance, machine vision can be used to read the changes on a game clock face, or the game clock itself can be altered to issue marks when it starts and stops—both approaches are valid and create sufficiently equal marks. Hence, FIGS. 25a through 25j are strictly meant to teach the herein novel and important concept of “integration” based upon universal, normalized “differentiated” marks (observations with related data) as issued by external devices or another session processor.

Referring now specifically to FIG. 25a, there is shown an example where a single external device [ExD] of a scoreboard reader 30-xd-12 (as first taught in FIG. 9) issues two successive marks (M1)=“clocked started” and (M2)=“clocked stopped” that are integrated to form a single instance of the event type (E) named “Game Play.” Hence, a Game Play event (E) represents the consistent “clock running” behavior and its start and stop edges are thresholded by the detections using machine vision of the movement and then non-movement of the game clock face, all as previously described.

Referring now specifically to FIG. 25b, there is shown how the same mark (M1)=“clocked started” that was issued by the scoreboard reader 30-xd-12 [ExD] is additionally integrated into a single instance of the event type (E) named “Face-Off.” In this case, clock started M1 is used to both create and start the Face-Off (E), but then directs the session processor 30-sp to spawn a new mark M1s to stop the Face-Off (E) as some future time, e.g. 3 seconds after the clock has started. As was first taught in reference to FIG. 23e, this spawn mark directive is held in conjunction with the affect (A) object that represents the “clock started-effects-face-off” external rule. (Note that the present inventors, in regards to both the current invention via object tracking differentiation, and teachings in related applications especially including PCT/US2007/019725 entitled System and Methods for Translating Sports Tracking Data Into Statistics and Performance Measurements, have shown that there are various automatic means for determining when team possession begins.) Therefore, the teachings of FIG. 25b should not be taken as specifically showing how a Face Off event must be determined, but rather as an example of any event created, started and stopped as shown with incoming marks from any external device(s). It is possible and anticipated that the scoreboard could issue a mark (M1) without requiring machine vision to read its face. It is also anticipated that by tracking at least the x, y locations of the puck (game object) and players using various technologies, that a sufficient deterministic threshold formula can be implemented (especially as taught in PCT/US2007/019725) such that a “home team has possession” or “away team has possession” mark (M2) could be issued to stop the face-off event, rather than having to spawn a mark (M2) at an assumed future stop time, always giving the event type a fixed duration—all as will be understood by those familiar with the sport of ice hockey and a careful reading of the present specification.)

Referring now specifically to FIG. 25c, there is shown an example where a single external device [ExD] of the scorekeeper's console 14 (as first taught in FIG. 11a) issues a single mark (M1)=“shot” that is integrated to form a single instance of the event type (E) named “Home Shot.” Hence, a Home Shot event (E) represents the consistent “home team taking a shot” behavior and its stop and start edges are thresholded by the manual observation that the shot has happened (M1) (the stop edge) and the assumption that the shooting effort started x seconds in the past, denoted by the spawned (backward) mark (M1s) (the start edge.)

Note that the present inventors prefer, and fully expect that the start and stop edges of a “Shot” event (E) are detected using some automatic technology for creating machine measurements 300 (see FIG. 2,) such as machine vision based external device 30-rd-c or RF based external device 30-dt-rf (see FIG. 8.) Hence, in the preferred system, the scorekeeper using console 14 does not have to press the “home shot” or “away shot” buttons, which then trigger a “shot” mark (M) to be issued with related datum (RD) of “team” set to “home,” or “away,” respectively. But rather, a tracking system capable of following at least the players' and puck (game object) centroids is employed to automatically determine both the start and stop times of a shot, either issuing two separate marks (M1) and (M2) for start and stop times respectively, or issuing a single mark (M1) that follows the shot, where the start time is carried as related datum and used by session processor 30-sp to spawn backward a new start mark—all as will be understood by a careful study of the present teachings.

Referring now specifically to FIG. 25d, there is shown an example where a single external device [ExD] of the scorekeeper's console 14 (as first taught in FIG. 11a) issues a single mark (M1)=“Home Goal” that is integrated to form a single instance of the event type (E) named “Home Goal.” In this case, the home goal mark (M1) is used to create the Home Goal (E) and also to spawn a new start mark (M1s). Before the spawning operation, session processor 30-sp uses the reference mark type and associated rule (L) found on/associated with the affect object (A) to select a new stop mark (Mir). In particular, the (A) affect indicates that the “reference stop mark” should be taken from the list of all marks of type “Game Clock Mark”; specifically, the game clock mark whose related datum of “Official Period” and “Official Time” match those same related datum on the original home goal mark (M1)—all of which is indicated by the associated external rule (L). Typically, this particular mark (M1r) would tend to be the newest on the mark type=game clock list, but does not have to be depending upon when the “home goal” mark (M1) is actually processed. Also note that to arrive at the appropriate start time, the session processor spawns backward from the actual session time found on the reference stop mark (M1r), rather than the actual session time found on the original home goal mark (M1)—all as easily indicated on the (A) object.

Referring now specifically to FIG. 25e, there is shown an example where the scorekeeper's console 14 issues the same single mark (M1)=“Home Goal” taught in FIG. 25d, which in this case is integrated to form a single instance of the event type (E) named “Home Goal Celebration.” As with the Home Goal (E), the home goal mark (M1) is used to create the Home Goal Celebration (E). However, after this, a spawn mark (M1s) is generated to stop (rather than start) the Home Goal Celebration (E)—for instance after a duration of 3 seconds. Like FIG. 25d, before the spawning operation, session processor 30-sp uses the reference mark type and associated rule (L) found on/associated with the affect object (A) to select a new mark (M1r), which is now used as the start mark, rather than the stop mark.

Referring now specifically to FIG. 25f, there is shown an example where the scorekeeper's console 14 first issues a “home penalty” mark (M1) that is integrated to create (but not start or stop) a corresponding “Home Penalty” event (E). As can be seen by a careful study of FIG. 25f, this new event instance is added to the create list associated with the event type=Home Penalty. Following the “home penalty” mark (M1), the scoreboard reader 30-xd-12 issues a “game clock” mark (M2) which then serves to start the Home Penalty event (E) (as will be understood by those familiar with the sport of ice hockey.) Furthermore, session processor 30-sp now moves the specific instance of the Home Penalty event (E) from the created, to the started list. (As will be understood by those familiar with software systems and OOP, there are various ways to accomplish the “moves” from created, to start, to stop lists. For instance, there could be a single event type list with a property that is changed to indicate the “state” of the event instance on the list; i.e. “created,” “started” or “stopped.” The present inventors prefer using separate lists because of the resulting efficiency when the lists tend to grow and most of the searching is done to the smaller created and started lists—all as will be understood by a careful reader familiar with the subject matter, in this case ice hockey, and software systems, in particular databases.)

Pausing for a moment, anyone sufficiently skilled in the sport of ice hockey will note that it is often the case that several penalties for the same team can occur, or be given by a referee, at the same time—or in this case, during the same game “time out.” If there are two or less penalties for the same team, they both start together. If a third or more penalties is assigned at once, or an additional penalty is assigned while two others are already being served, this creates what is referred to as a “stacked penalty.” In this sense, because only two penalties can be enforced at one time for a given team, the third and more penalties must “wait,” or remained “stacked up” until at least one or both of the other current penalties expires or is removed (for instance by the opposing team scoring a goal.) While all of this will be well understood by those familiar with ice hockey, it is not important to understanding the present invention. What is important is to see that even in this complex situation of stacked penalties, the present teachings are more than capable of following rules to discern which “created” penalties are pending (i.e. “not started,” i.e. “stacked”) vs. those that are currently being “served,” (i.e. they are on the “started” list.) Understanding this is a key to developing external rules as to when to start a stacked penalty—again, which happens when a current penalty is stopped. (This “stop” action will be discussed shortly with respect to FIG. 25g.)

While developing integration rules (L) for handling the starting of created events when other events stops is entirely within the scope, and unique to the advantages of the present invention, there are other possible ways of accomplishing the same functions. Specifically, the understanding of which penalties are assigned to a team, which are
2) Other session processors [SP], operating under different sub-contexts [Cx] to make “higher-level observations” about session 1, or for that matter any related non-session 1 activities 1d valid to the processing of session 1 within the main context [Cn], and
3) Session l's current session processor [SP], operating under context [Cn], spawning new marks (M) to shift, or adjust the integrated events (E) start and stop time beyond the original triggering mark (M), or any selected reference mark (M).

What is now being taught is the additional internal generation of secondary marks (Ms) by session processor 30-sp using a “count objects within container” [(M)V(E)]-(E) model. While this new secondary mark (Ms) is intentionally identical in structure to all other marks (M), it is always generated through the process of counting other mark (M) or event (E) objects “contained” within the “container” event (E)—these are also referred to as “summary” marks because there information (i.e. observation) typically represents a counting or totaling of information.

At the top of FIG. 29, there is repeated session context aggregator [Cn], to which is attached a summary mark (Ms) along with its associated “container” event (E), (which can be either a primary event (E) or secondary/combined event (Ec).) Also attached to summary mark (Ms) is the “contained” object, whose presence within the durations of the “container” event (E) instances is to be “summarized”/“counted”/“totaled,” where the “contained” object can be either a mark (M) (that can be primary, secondary or tertiary), or an event (E) (that can be primary or secondary.) And finally, also associated with summary mark (Ms) there is shown external rule (L) that is used to “filter” the instances of the container event (E), thus selecting which instances (if any), (and therefore spans of session time,) are to be summarized for the specified summary object.

In the lower portion of FIG. 29, there are shown the template objects associated with the secondary mark [(M)V(E)]-(E) construct herein depicted—i.e. objects that are used by the session processor 30-sp to control the process of secondary mark synthesis, stage 30-f of FIG. 5. Specifically, there is the “summary mark” (Ms) itself, also referred to as a “secondary” mark, which is intentionally identical in format and object structure to the primary mark (M) already disclosed. Associated with each secondary mark (Ms) is the container event type (E), which can be any primary or secondary (combined) event as previously taught. Further associated with the container event type (E) is a rule (L) that acts to filter the actual event (E) instances within the container event type (E). In addition to the container object, one “contained” object must also be associated with the summary mark (Ms). This “contained” object may be either a mark (M) with an associated rule (L) for filtering, or an event (E) with an associated rule (L) for filtering. As previously mentioned, the “contained” mark or event may be primary, secondary (or tertiary in the currently be “served” (and how much time is left on them,) and which are “stacked” waiting for a current penalty to end, is preferably embedded into the scorekeeper's console 14. Using embedded logic in this case has the added benefit of allowing the console 14 to show the scorekeeper the state of each penalty, current or stacked—which is a useful benefit. If this understanding of the penalty rules is embedded into the scorekeeper's console 14, then the console 14 merely needs to issue “penalty started,” and “penalty stopped” marks to control when the various penalty event instances are started and stopped respectively (after being created by a “home penalty” mark event.) As will be appreciated, by moving the more sophisticated rules logic to the scorekeeper's console 14, this reduces the necessary intricacy of the external rule (L) that must be associated with the event type of “home penalty” or “away penalty.”

Both approaches will work and are specifically taught and claimed in the present invention. Furthermore, as will be appreciated, the exact same external rules logic could be implemented in the scorekeeper's console 14—in fact, this is preferred. In this case, there is no “hard coded”/embedded logic in console 14, but rather this external device 14 implements its own version of a session processor 30-sp using a “ice hockey game scorekeeper's marks context” (Cx), which in turn simply pre-processes all scorekeeper marks along with perhaps the scoreboard reader's marks, and then issues additional marks (e.g. “penalty 5 stopped,” “penalty 7 started”, etc.) which are sent to the current session 1's “main” session processor 30-xp, using session context [Cn] for an “ice hockey game.”

Referring next to FIG. 25g, there is shown session a continuation of the integration of the “Home Penalty” event (E) created and started in FIG. 25f. Specially, scorekeeper's console 14 issues either a “home penalty” mark (M3), with related datum of status=“expired,” or issues a “away goal scored” mark (M3). As will be understood by those skilled in the sport of ice hockey, either situation causes the “Home Penalty” event (E) to stop. Furthermore, session processor 30-sp moves the given event instance from the started to stopped lists in either case.

Referring next to FIG. 25h, an additional “infraction” event type is taught. Prior to discussing these details, as will be understood to those familiar with ice hockey, when a penalty is called on player, it is beneficial to “look forward” and create the “penalty” event that covers the time the team must compete while that particular player is under penalty. This “penalty” event is not necessarily the same as another useful event—the “situation” event, or better referred to as “power play” or in this case “short handed” event. In ice hockey, just because a player is going on a penalty is not enough to determine if the team is up or down a player during the upcoming play. As was alluded to in reference to FIG. 25f, understanding the net resulting situation is dependent upon the number of overlapping penalties called on both teams. However, as was also shown, this has a deterministic (i.e. rules based, or logically determinable) solution with one definite outcome; i.e. “5 on 4 for 2:00 minutes,” or “4 on 3 for 37 seconds,” etc. As will be obvious to those familiar with both ice hockey and software, the underlying information (operands) necessary to create a sufficient external rule (L) for determining the “situation” event are only the number of current penalties started and still if effect at the time of a new penalty—the count of which is easily determined when complete created, started and stopped lists are managed per event type, as will be appreciated by those familiar with software systems.

Referring still to FIG. 25h, in addition to the “penalty” and “situation” events, it is also useful to create an “infraction” event, which will cover the time from when the penalty was called (i.e. the referee raised his hand in the air over his head,) until the time the game clock was stopped by the referee blowing his whistle, so that the penalty could be assigned. (Note that in ice hockey, after spotting an infraction, the referee does not stop game play until the team committing the penalty has taken possession of the puck—typically assumed to be when a player on the about-to-be-penalized team touches the puck.) Note that the present inventors offer automatic ways of determining both when the referee calls a penalty by detecting when they raise their hand over their head, (see external device 30-xd-16 in FIG. 13a,) and when the referee blows their whistle indicating to stop the clock and game play (the same or similar external device 30-xd-16.) If these devices are not available, then the present invention has flexibility to provide alternative solutions. For instance, as specifically depicted in FIG. 25h, when a penalty mark (M1) is received by the session processor 30-sp from the scorekeeper's console 14, this can be used to create the “Home Infraction” event (E). The rule (L) may then also indicate to search for the last game clock mark matching the penalty to use as the event's stop mark (M1r), after which a spawn mark (M1s) is directed backward in time sufficiently far enough to cover the expected and typical infraction duration (e.g. 20 seconds max) in order to start the event—all as will be well understood by a careful reading of the present invention and familiarity with ice hockey.

Referring next to FIG. 25i, as will be understood by those familiar with ice hockey, it is desirable to create a single event (E) covering the entire shift of the player who ends up causing the penalty. Hence, a coach might want to review, or watch all of the “player penalty shifts” for a game—hence, they want these clips automatically “chopped” out of the game video and put into the session index 2i. This would be very useful and yet is difficult and time consuming to accomplish by manual observation and labor alone, thus becoming prohibitive. To best accomplish this, the present inventors have first taught the player shift detecting bench external device 30-xd-13, (see FIG. 10a.) As will be seen, as players exit the bench to begin their shift and ultimately re-enter the bench to end their shift, the player detecting bench senses their RF antenna as it first goes missing and then returns to the RF detection field and issues marks accordingly—all as was taught and will be understood by those skilled in RF system and ice hockey. These “start shift,” “stop shift” marks can also be generated by other technology, such as machine vision 30-rd-c or RF triangulation 30-dt-rf external devices for tracking player and puck movements in the session area 1a, not just the bench area—as discussed earlier especially in relation to FIG. 8. Regardless of the underlying technology, the net result is that all player movements on and off the ice create “player shift” events (E).

Referring to FIG. 25j, a more sophisticated example is taught that reveals the flexibility and capability of the (M)-(A)-(E) (“mark-affects-event”) model and implementation—specifically, the “player penalty shift” event type. As will be understood, the “player shift” event type taught in relation to FIG. 25i, with all of its associated create, start and stop marks is then a searchable data source (see FIG. 24d) for contributing operands to external rules (L) developed to control other event types, for example the “player penalty shift.” In this case, and as shown in FIG. 25j, when a “home penalty” mark (M1) is first received from scorekeeper's console 14, it can be used to create a “home penalty shift” event, but only if the associated rule (L) executes to true. In this rule (L), the list of all “home player shift” events started (but not stopped) is searched for a match (via related datum) to the player number assigned as related datum to the “home penalty” mark (M1). If there is no match, then the player might not have been in the game—e.g. the player was called for a penalty while sitting on the bench, or the penalty was called on the team, etc. (as will be understood by those familiar with ice hockey.) If there is a match, then the “home penalty shift” event is created and the searched for and found matching “player shift” start mark is used in reference as the new “home penalty shift” start mark (M1r). And finally, based upon the (A) object directives, the session processor 30-sp will then search for and find the appropriate game clock mark that matches the related datum on the “home penalty” mark for when the game clock was stopped, and uses this mark in reference to be the stop mark (M2r)—all of which will be understood by the careful reader and teaches the novel benefits of the integration methods herein taught. All of the prior taught “case 1” through “case 9” examples covered in FIGS. 25a through 25j, are meant to be general examples, to teach the apparatus and method of “integration” for extrapolation to any type session activity 1d, as well as specific examples, to be taught and claimable for use with ice hockey, but should not be construed as limitations in any way to the present invention because of the lack of additional examples. As anyone skilled with ice hockey knows full well, as do the present inventors, there are many other “events” and associated rules based upon observed marks that are desirable. The events chosen in case 1 through 9 were determined by the present inventors to be sufficient, especially for showing how events (E) are created, started and stopped by a session processor 30-sp, in response to the receiving of marks (M) created by either external devices [ExD] or (other concurrent session processors 30-sp operating under different “sub-context” (Cx),) all under the governance of rules (L), associated with a combination of (M)-(A)-(E) objects and “external” to the program code representing the session processor 30-sp, where the collections of (M)s, (A)s, (E)s and (L)s objects are aggregated under the session context of [Cn].

Furthermore, while alternative ways were taught for creating the case 1 through 9 example event types, especially in accordance with the types of incoming marks controlled by the types of external devices, it is possible to imagine other ways of creating the same event types based upon variations of marks (M), affects (A) and or rules (L)—all as will be obvious to those skilled in the art of software, familiar with the sport of ice hockey and who have studied the novel teachings herein provided. Therefore, the present invention should not be limited to the specific event types taught for ice hockey, nor should it be limited to ice hockey as a context in general, but rather the ideas herein should now be recognized through recording, object tracking, differentiation and integration to be fully applicable to any abstract session 1 as first taught in relation to FIG. 1a and FIG. 1b. As will also be shown forthwith, there are other ways to create some of the events similar to those taught in case 1 through 9—for instance the “home penalty shift,” rather than using the (M)-(A)-(E) primary integration. As will be taught shortly, events such as the “player shift” may be inclusively combined with the “home infraction” event to result in the indexing of the “home penalty shift,” as a useful alternative to the examples just illustrated.

Referring next to FIGS. 26a through 26c, this is shown a sample session 1 comprising ice hockey game activities 1d. The upper part of each figure is in a spreadsheet, or table format and sequences (across all figures) from 1 to 27 consecutive marks (M) being sent by external devices [ExD] to a session processor 30-sp for integration into events (E) using rules (L). In particular, each figure, from top to bottom depicts:
Sequence (number):
   This is purely meant to show the consecutive sequence of marks (M) and events (E) for teaching purposes, illustrating ongoing session processor 30-sp actions;
   In practice, while the present inventors do not prefer to keep a master list of all marks (M) received (or events (E) created) in consecutive sequence (although individual mark (M) type and event type (E) lists are preferred,) as will be obvious to those skilled in the art of software systems and databases, this list can be easily made by sorting all marks (M) (or events (E)) by their associated session times corresponding to the session time line 30-stl which acts to synchronize all actual session objects;
Period/Game Time:
   This is data exemplary of ice hockey and comes from the interface with the game clock via external device scoreboard reader 30-xd-12 (or some equivalent for detecting game time and clock starts, stops and resets);
   This is related datum (RD) assumed to be associated with each (M) generated and transferred to the session processor 30-sp for integration into events (E);
Mark (M) Generated with Related Data (RD):
   Various marks (M) and preferred additional information (RD) expected from a typical ice hockey game, similar to those examples used in FIGS. 25a through 25j;
Effected Event Type with Rules:
   As shown especially in the top of FIG. 23e, each actual mark (M) received belongs to a template mark type (M) that has a pre-known relationship, represented as Affect object (A), to presumably one or more event types (E), where the effects are to create, start and stop individual event (E) instances following the rules (L) (if any) associated with the given Affect (A);
Changes to Event Type Lists:
   This wording shows the action the session processor 30-sp takes regarding the management for each given event type list, as a result of processing, or integrating the current mark (M) into an event (E) instance;
Event (type) Waveforms:
   These are digital waveforms going from “zero” meaning no event instance now occurring, to “one” meaning event instance now occurring, of some session attendee(s) 1c behavior, or session activity 1d, represented by the event type (E);
   As will be understood by those familiar with both analog and digital systems, the view of a given session activity 1d, which is a particular session attendee(s) 1c behavior, as a continuous digital waveform of either “behavior now not occurring” or “behavior now occurring” is helpful for later combining or synthesis of waveforms, to be taught in relation to upcoming figures.

Still referring to FIGS. 26a through 26c, no additional specification is provided as the present inventors believe the example data contained in each figure is sufficient of both explicit ice hockey examples and the general integration process for any session 1, of any session context [Cn]. What is of most importance in these figures is the understanding of how the present apparatus and methods taught herein translate sensed session activities 1d, which are typically complex, interwoven, continuous, and multi-valued, into multiple simple continuous digital “on-off” waveforms, where the transitions (edges) carry significant information with respect to their associated marks (M), and the marks related datum (RD)—all of which greatly supports the further synthesis of these same waveforms into “higher meaning” as combined waveforms and secondary marks (all as to be further taught.)

Referring next to FIG. 27, there is shown a combination node diagram (copied from the DCG of FIG. 23a) with a corresponding block diagram detailing the relationship between a “combined” or “secondary” event (E) and its related two or more “combining” events. While the present inventors have introduced the terms of “primary” (mark (M) and event (E)) versus “secondary” (mark (M) and event (E),) these terms should be understood as representative of each object's construction process, rather than indicative of either the object's relative importance or actual structure (which is intentionally identical.) As herein taught, a “primary” mark (M) is meant to represent new information to the current session processor 30-sp (which may be output by some other session processor 30-sp or originally sensed by an external device.) These new observations and their related data are initially processing via the (A) affect objects for integration into “primary” events (E)-which then are events effected by “primary” marks (M). Note that some events (E) will be created, started and/or stopped by a combination of “primary,” “secondary” or “tertiary” marks (M), but are still considered “primary” because they are generated through the process of the “marks-affect-events” (M)-(A)-(E) model. What is now being taught is “events-combine into-events,” (E)-(x)-(Ec) model, where the resulting event is always a “secondary” event, while the input events may be either “primary” or “secondary.” Hence, while a secondary event (E) is intentionally identical in structure to a primary event (E), it is always generated through the process of combining event (E) waveforms—as is now being taught. (Note that the meaning of “secondary” and “tertiary” marks (M) will be taught later in the specification.)

At the top of FIG. 27, there is repeated session context aggregator [Cn], to which are attached two (or more) “primary” or combining event(s) (E), associated by link objects (x) to which is also associated “secondary” or combined event (E). Also shown attached to secondary event (E) is event combining rule(s) (L). In the lower portion of FIG. 27, there are shown the template objects associated with the secondary event (E)-(x)-(Ec) construct herein depicted—i.e. objects that are used by the session processor 30-sp to control the process of events synthesis, stage 30-4 of FIG. 5. Specifically, there is the “combined event” (Ec) itself, also referred to as a “secondary” event, which is intentionally identical in format and object structure to the primary event especially taught in FIGS. 24a through 24c. Associated with each combined event (Ec) is a rule (L) (shown as the rule stack without the root placeholder rule (L) object.) The operands of this rule (L) are at least two or more event types (E) for combining, where the operands of the individual stack elements may (among other mathematical and logical functions) be the logical negation of the operand (E) waveform—as indicated by operator stack elements. (As will be understood by those familiar with electronic systems, the logical negation of a digital waveform creates the inverse waveform, switching the “0” off and “1” on states.) Note that as an operand, each event type (E) includes all (and only those) instances that are now “started” but not yet “stopped.” (However, inverting the combining event (E) indicates to look for only not “started” events, as will be well understood by those familiar with electronic and digital waveform combining.)

Still referring to FIG. 27, also associated with each stack element referencing an operand is additional “filter” rule (L). A filter rule (L) is used to limit which actual event instances, of the reference operand event type (E), are to be considered for combining; hence, beyond the built in rule that an event (E) is combinable if it is “started” and not yet “stopped.” For example with ice hockey, if the event type (E) to combine was “Player Shift,” then the filter rule (L) might indicated a player number (as an operand) to be matched to the related datum (RD), perhaps associated with the event (E)'s start mark (e.g. the “player off bench” mark (M) received from the player detecting bench 30-xd-13, shown in FIG. 10a,) which will have the player number as related datum (RD). And finally, associated with each combined event (Ec) is a combining method indicative of function to be used for/upon each of the associated combining events (E). As will be taught in greater detail with respect to upcoming FIGS. 28a through 28d, the present inventors prefer two types of combining methods, namely “exclusive” and “inclusive.” As will be obvious to those familiar with software systems and digital waveforms, other methods are imaginable and not meant to be outside of the present teachings. Furthermore, the present teachings limit a single method to be applied to all combining events (E) of a combined event (Ec). As will be obvious from a careful study of this specification, the resulting combined event (Ec) may then also become an input combining event (E) to form another combined event (Ec)—and so on. For those familiar with mathematical functions, this construct as taught in FIG. 27 essentially allows a combined event (Ec) to be either a result in and of itself, or a “term” to then be used in combination (or nesting) with other terms of combined (secondary) events, or with other primary combining events (E), thus creating a simple yet extensible waveform algebra for creating “higher” session knowledge.

Still referring to FIG. 27, especially as will be further taught in relation to upcoming session processor related FIGS. 38a through 38c, session processor 30-sp preferably performs its various processes in an arranged sequence: starting with integration of marks using the (M)-(A)-(E) model followed by synthesis of secondary combined events (Ec), using the (E)-(x)-(Ec) model. In this case, just as an incoming mark (M) triggers the session processor 30-sp to look for any associated affects (A) on events (E), if the associated event (E) is started, then the session processor 30-sp adds it to a list of newly started events (E) based upon the incoming mark (M) for later potential combining, while it preferably then goes on to finish all processing of the incoming mark (M) (for instance because mark (M) may have possible affects (A) on several events (E), all of whose states are ideally resolved before the synthesis operation.) After the session processor 30-sp completes its integration of incoming mark (M), it then refers to the list of newly started events (E) if any, each to serve as the inputs for the next synthesis operation.

Therefore, for each newly started combining event (E), the session processor 30-sp searches to determine if there is a potential combined event (Ec) to be synthesized, and then follows the directives on the construct objects show in the lower half of the present FIG. 27. It may be that the present “triggering” event (E) has an associated filter rule (L) that upon evaluation may or may not be met. If met, session processor 30-sp must then check to find another occurring event (E) on each of the (at least one) additional combining event types (E) referenced by combining rule (L)—all of which must meet their associated filter rules (L), if any. Assuming all combining events (E) are found in the proper state (i.e. “on”=started, or NOT “on, etc.) and meet all filtering rules (L) if any, then an instance of the combined event type (Ec) is created and started, (or conversely stopped as will be understood by a careful reading,) depending upon the edges of the combining events (E) being processed—all of which will be subsequently taught in greater detail.

Referring next to FIG. 28a, there is depicted various digital waveforms for teaching the concepts of serial vs. parallel events as well as continuous vs. discontinuous events, all of which will be familiar to those skilled in the art of either analog or digital waveforms. Below the depicted waveforms is provided a table showing the types of combined events (Ec) that will be output by synthesizing the various types of combining events (E) acting as input, as will also be obvious to those skilled in the understanding of waveforms. Again, this figure is meant to define the use and meaning of the terms of serial, parallel, continuous and discontinuous waveforms, as well as to teach how they combine—all of which is common understanding and therefore requires no further teaching.

Referring now to FIG. 28b, the method of “exclusive” synthesizing is taught via example and in reference to the event combining objects first defined in FIG. 27. Specifically, in exclusive synthesis the output waveform will only be “high,” or “on,” when all of the input waveforms are likewise “high.” This is a familiar concept in waveform analysis and in logical functions is called “ANDing” the inputs. In the present example, there are three input waveforms as follows: the Period event type (Ex), the ZonePlay event type (Ey) and the Penalty event type (Ez). (Note that the integration of both the Period and Penalty event types has been prior discussed, especially in relation to example cases 1 through 9 in FIGS. 25a through 25j, while the ZonePlay event will be taught further in relation to upcoming FIGS. 36a through 36h, but was eluded to in reference to zone-of-play detecting external device 30-xd-270.) As will be understood by those familiar with ice hockey, it is desirable to automatically determine (or index) the times when all three of these input events are “on,” hence when the game is in a period, the game action in a specific zone, and there is a current penalty, the combination event (Ec) of which could be called “Penalties by Zone within Period.” As will be obvious by a careful review of FIG. 28b, the combined event (Ec) waveform is only “high,” or “on,” when all the other referenced waveforms are also “high”—this is exclusive combining or waveform “ANDing.” Given the three input event types (Ex), (Ey) and (Ez) as shown, it is noted that at any time any single instance of any of the types could start, or stop, as a matter of integration. As previously mentioned, after any instance is started or stopped, and therefore an appropriate event instance is added to its respective “started” or “stopped” list, it is then also added to the newly started-stopped event instance list. After session processor 30-sp completes integration, it then reviews this newly started-stopped event instance list to consider if any of the events on the list are first referenced as a combining event (E) for a combined event (Ec). If so, then that event instance (E) triggers the overall evaluation of combined event (Ec), to determine if a new (Ec) instance should be either started, or stopped. Prior to discussing this method in greater detail, it should be noted that it is possible, even in the present example, that all of the combining events (such as the present (Ex), (Ey) and (Ez)) are started or stopped “together” at the same session time line 30-stl moment based upon the same incoming mark (M). For example, when a “period end” mark (M) is received from the scorekeeper's console 14, sufficient (M)-(A)-(Ex), (Ey) and (Ez) models can be created that stop and all open instances of these three combining events. As will be understood by those skilled in the art of ice hockey, at least at the end of the final period 3 of a game, when the current period event (Ex) is stopped, any “open”/“started” penalty events (Ez) should also be stopped (even if they have not expired,) as well as any “open”/“started” zone events (Ey) (of which there is always one zone event “open,” since it is a “continuous” event waveform, i.e. the game play must always be in some zone at all times—see FIG. 28a.) Obviously, it is also possible that only one or two or the three event types (Ex), (Ey) and (Ez) will have an instance that is started or stopped in response to a incoming mark (M)—any combinations are possible.

With this understanding, the job of the session processor 30-sp is to consider all newly updated events (E) as a result of integration to be potential “event combining triggers,” for which a determination is then made to see if the associated combined event's (Ec) rules (L) are fully satisfied to warrant a state change, i.e. a start or stop. Specifically, for the event convolution method of exclusion, if at least one newly started/stopped event (E) is found as potentially combining into event (Ec), then the session processor 30-sp will do the following:
1) If the combining event (E) (e.g. an instance of (Ez)—the penalty event) was just started, and all other combining event types (e.g. (Ex) and (Ey) referenced by the combing rule (Ec)-(L) currently have a started event instance (e.g. the game is in a period and the game action is always in some zone,) then a new instance of the secondary event (Ec) will also be created and started (e.g. a new instance of the “Penalties by Zone within Period” event);
   a. In this case, the create and start marks on the instance of the combining event (Ez), that first causes the creation of a new instance of the combined event (Ec), will be used as that new combined event instance's create and start marks;
   b. The present inventors also prefer attaching the create and start marks of the other combining event instances (e.g. (Ex) and (Ey)) to the newly created combined event (Ec) instance as a means of creating meaning via associated marks and related datum, as will be understood from a careful reading of the present data objects;
      i. However, as will also be understood by those skilled in software systems in general, and OOP techniques in particular, all that is necessary is to associate with each newly created secondary event (Ec) instance id, the object id's of the combining event (E) instances, thus forming a node structure that fully describes the newly combined events (Ec) as well as all subsequent events that may be further combined upon this new secondary event (Ec) via further synthesis. As will be understood, each combining event instance (E) that actually creates and starts a combined event instance (Ec), serves as the create and start mark for the combined event (Ec), thus properly setting the waveform's leading/starting edge on the session time line, 30-stl. Note that if multiple combining events (E) started simultaneously based upon the same incoming mark via integration as previously discussed, then each event (E) would actually attach the same create/start marks, or at least the same start time, all as will be obvious from a careful consideration of the present teachings;
      ii. As this node structure builds in sophistication for the nesting of synthesized secondary events (Ec), the internal knowledge includes all associated create, start and stop marks, along with associated related datum, for each combining event (E) instance contributing to the combined event (Ec) instance, all which can be recovered via well known data transversal methods or pre-associated/“copied forward” to each new combined event (Ec) instance for quicker access—the actual method of which is immaterial to the present teachings, and
2) If any of the combining events (E) (e.g. an instance of (Ey)—the zone event) was just stopped, and there is a currently an “open”/“started” instance of the combined event (Ec), then the combined event (Ec) is closed, using the stop marks from the trigger event (again, e.g. an instance of (Ey)).

Hence, as a careful reader will see, the exclusive convolution method starts a combined event (Ec) when the “last” combining event(s) (E) are started, and stops the combined event when the “first” combining event(s) (E) are stopped.

Referring now to FIG. 28c, the method of “inclusive” synthesizing is taught via example and in reference to the event combining objects first defined in FIG. 27. Specifically, in inclusive synthesis the output waveform will be “high,” or “on,” when at least one of the input waveforms are likewise “high.” This is a familiar concept in waveform analysis and in logical functions is called “ORing” the inputs. In the present example, there are two input waveforms as follows: the Home Player Shifts event type (Ex), and the Away Goal event type (Ey). (Note that the integration of both the Home Player Shifts and Goal event types has been prior discussed, especially in relation to example cases 1 through 9 in FIGS. 25a through 25j.) As will be understood by those familiar with ice hockey, it is desirable to automatically determine (or index) the times when one “line” of offensive and defensive players (typically five in all) are on the ice for a combined “shift” when an opponent scores a goal. (In ice hockey all of these players are given a “minus” for this shift as a statistic.) What is further difficult is that there may be less than five players, in fact only three, and these players typically did not start the individual shifts at the same time—and they may also not stop them at the same time. What is desirable to determine as a combined event (Ec) could be called the “Goals Against Shifts” which include all player shifts when an opponent's goal is scored, and start with the earliest start time of any of these shifts, and stops with the latest stop time of any of these shifts. As will be obvious by a careful review of FIG. 28c, the combined event (Ec) waveform is “high,” or “on,” when any of the other referenced waveforms are also “high,” which also overlap in duration what is chosen as the “triggering” event, e.g. the AwayGoal (Ez)—this is inclusive combining or waveform “ORing.”

With this understanding, as prior discussed in relation to FIG. 28b, the job of the session processor 30-sp is to consider all newly updated events (E) as a result of integration to be potential “event combining triggers,” for which a determination is then made to see if the associated combined event's (Ec) rules (L) are fully satisfied to warrant a state change, i.e. a start or stop. However, unlike the method for exclusive convolution taught in FIG. 28b, with inclusive convolution, while there will be two or more combining event types (E) (e.g. (Ex) and (Ey)) necessary to form the combined event type (Ec), only one of these will be designated as the “trigger” (e.g. (Ez).) (Note that for exclusive convolution as prior taught, all combining events (E) act as triggers.)

Specifically, for the event convolution method of inclusion, if an instance of the combining “trigger” event (E) (e.g. (Ez)) is newly started, then the session processor 30-sp will do the following:
1) If the triggering event (E) (e.g. Ez) was just started, then start a new instance of the combined event (Ec), assigning the triggering event's create mark (M) to be the create mark (M) on the new combined event (Ec) instance;
2) To set the start mark (M) for the new combined event (Ec) instance, evaluate all other combining (and non-triggering) event types (E) (e.g. Ex) associated with the combined event type (Ec) via the combining rule (L). For each associated non-triggering event type (E), search through all currently started (if any) event instances. (Note that for a serial event type (such as the Period event,) there will only be one started instance at any given session moment, while for a parallel event type (such as the example HomePlayerShifts,) there may be multiple started instances at any given session moment.) After searching all event instances of all non-triggering combining event types (E), the session processor 30-sp will use the earliest start mark (M) found to act as the start mark (M) on the newly instantiated combined event (Ec), and
3) The session processor 30-sp will also associate all started instances of all non-triggering event types, even if they are not contributing the start mark (M), with the newly instantiated combined event (Ec), thus correctly building the combined event's (Ec) information and providing means for stopping the combined event as will be explained next.

Specifically, for the event convolution method of inclusion, if an instance of the combining “trigger” event (E) (e.g. (Ez)) is already started, then the session processor 30-sp will do the following:
1) After each integration operation as triggered by an incoming mark (M), the session processor will examine the newly started/stopped event list to see if any of the events (E) on this list have object ids that match the list of actual event instances associated with the currently started, inclusively combined event type (Ec) instance (which of course implies that these non-triggering, combining events (E) were already started by the time the triggering, coming event (E) was started, as will be understood by a careful reading of the present figure's specification), and
2) For each non-triggering combining event (E) instance found on the newly started/stopped event list, the session processor 30-sp will check to see if this is the only remaining associated combining event type (E) instance still started and now just being stopped (again, to be found in association, the event (E) must have already been started and so now its presence on the newly started/stopped list will be due to its having just been stopped via integration—all of which is evident to the careful reader, although the fact of its start or stopped state is also contained on the list itself.) If the combining event (E) instance is in fact the last remaining associated non-triggering event still open, and now just being stopped, then the session processor 30-sp will use its stop mark (M) as the stop mark (M) for the now being stopped instance of the associated combined event type (Ec).

Referring next to FIG. 28d, there is shown a nuance to the understanding of inclusive event convolution, or combining. Specifically, when comparing potentially associated started instances of non-triggering (also called the “included”) events (E) (e.g. Ex) with the started instance of the triggering event (E) (e.g. Ez), then it is possible that they will overlap in distant Case 1 through 4 variations as shown, namely: Case 1 where the included event “expands into” the triggering event, Case 2 where it is fully “contained by” the triggering event, Case 3 where it “extends out of” the triggering event and Case 4 where it “overlays” the triggering event. The present teaching prefers that an additional qualifier is included with each associated non-triggering, combining event (E) as referenced as an operand in a stack element associated with a rule (L) governing a combined event (Ec), specifically for indicating which type(s) of non-triggering events should be included in association with the resulting combined event (Ec) instance—as will be understood by those familiar with software systems, and by a careful reading and understanding of the concepts taught herein. As will also be understood, and as further depicted in FIG. 28d, a further option is possible where the non-triggering, combining event must overlap the triggering event, for instance by some minimum percent or amount of session time, or some other related datum, such as for example “game time.” (For example, this would be a way to not associate a player shift if does not sufficiently overlap the opponent goal triggering event by some minimum related datum game time, perhaps only 1 second, which might be the case if the player was already leaving, but not yet off, the ice—all as will be understood by those familiar with ice hockey.)

Now referring to FIG. 29, the is shown a combination node diagram (copied from the DCG of FIG. 23a) with a corresponding block diagram detailing the relationship between a “secondary” or “summary” mark (Ms) and its related “container” event (E), as well as the mark (M) or event (E) object to be summarized/counted. Up until this point in the specification, the mark (M) object has been shown to be created by:
1) External devices [ExD] making “primary observations” about the session 1; case of a mark,) and is the object whose presence within a valid filtered container event (E) is to be “counted” or summarized, as will be taught forthwith.

Referring next to FIG. 30a, there is shown a block diagram depicting the summarization of marks (M) within a valid container (E) for the issuing of new summary (or secondary) mark (Ms). After the session processor 30-sp performs both integration, forming new primary events (E) from incoming marks (M), as well as event synthesis, forming new secondary events (Ec) from combinations of other primary and secondary events (E), the it turns to the task of synthesizing secondary marks (Ms) using the [(M)V(E)]-(E) model. To drive (or trigger) the synthesis of secondary marks (Ms), the session processor scans the newly stopped events (E) list that is built during integration. (Note, this may be either a distinct list of only newly stopped events, or it may be a filtering, i.e. for “stopped” events only, of a combined list of newly effected events built during the integration of the current mark (M), where the affect could be create, start or stop. As will be understood by those skilled in the art of software systems, any approach or some variation will suffice.) Therefore, based upon the results of the integration of primary events for an incoming primary mark (M), for each next newly stopped event (E), the session processor 30-sp searches all summary marks (Ms) associated with the context [Cn] to determine if any are referencing the given container event (E) type. If such a summary mark (Ms) is found, then the session processor 30-sp does the following:
1) Apply the associated container event filter rule (L), if any, in order to accept or reject this new container event instance as valid for summarization;
   a. Note that both event filtering and mark filtering have been prior discussed and in general are the identical process of choosing individual, actual object instances from the list of all instances of a given event or mark type, based upon the filtering rule (L)'s formula, which typically examines at least one related datum or associated object core attribute for matching purposes, all as will be well understood by those familiar with software systems in general and OOP techniques in particular, and from a careful reading of the present specification;
2) If the current, and newly stopped container event (E) instance passes it filter, than the session processor 30-sp creates a new instance of the current summary mark (Ms) (and adds it to the list of all marks (Ms) of the same type.) For this new instance of the summary mark (Ms), the session processor will:
   a. Associate the container event (E)'s object id (which is always done for all new actual objects being contextualized via any of the various process models as discussed herein);
   b. Preferably copy all or some of the related datum (RD) now associated with any of the container event (E)'s create, start or stop marks (M), to become related datum (RD) for the new summary mark (Ms) instance;
      i. Note that in order to specify exactly which related datum (RD) to copy, associated with which mark (M), associated in the create, start or stop position with respect to the container event (E), it would be necessary to add additional software classes, or objects to the [(M)V(E)]-(E) model taught in FIG. 29—as will be obvious to those skilled in the art of OOP. Although not shown in FIG. 29, as depicted in FIG. 30a, the present invention assumes and claims that model [(M)V(E)]-(E) includes the necessary additional (E)-(M)-(RD) objects, understood to fully identify (or “address”) individual “container event—associated create, start or stop mark—related datum,” hence specifying which (RD) should be conditionally inherited by the new summary mark (Ms) instance;
      ii. It should be further noted that the (RD) to be copied from the container to the new summary mark (Ms) instance may have an associated “copy or calculate” rule (L) (see the bottom of FIG. 23b,) that effectively triggers a resetting of its value at this “copy forward”=“attachment” time, thus creating a powerful tool since as previously explained, this rule (L) has access to all of the actual objects so far created for a session 1, whether events (E) with their related marks (M)-(RD), or received marks (M)-(RD), which can be used as operands, operated upon using all expected mathematical and logical operations;
   c. Automatically adds a related datum (RD) to the summary mark (Ms) instance preferably called “Container Event Duration,” which it then sets equal to the total session time 1b spanned by the container event (E), calculable as the event's stop time less the start time, as will be well understood by those familiar with time formats in software systems;
   d. Automatically adds a related datum (RD) to the summary mark (Ms) instance preferably called “Count of Contained Marks,” which it defaults to zero “0” and then does the following:
      i. Using the type of the associated mark (M) object to be summarized, searches this mark type (M)'s list of all instances to determine which individual, actual instances occur within the start-stop session time 1b duration “contained,” or bounded by the container event (E), where each and every contained mark (M), is then:
         1. Checked against the filter rule (L), if any, associated with the mark (M) object to be summarized. If the contained mark (M) meets the filter rule (L), then:
         a. The “Count of Contained Marks” (RD) is incremented, and
         b. Any and all related datum (RD) associated with the found contained mark (M) is copied onto the new summary mark (Ms) instance, using a similar type of additional (M)-(RD) extension to the [(M)V(E)]-(E) model as prior discussed for the inheriting of container event (E) related datum (RD), for uniquely specify which contained mark (M) related datum (RD) to copy;
         c. Note that for the second, third and so on contained marks (M) being summarized into new summary instance (Ms), as its (RD) is being copied forward, its unique value may not match the value already associated with the summary mark (Ms) from a previous inherit. In this case, a new summary mark (Ms) is created to hold this different “permutation” of unique (RD) values, thus starting a new count.

Referring next to FIG. 30b, similar to FIG. 30a, there is shown a block diagram depicting the summarization of events (E) (rather than marks (M),) within a valid container (E) for the issuing of new summary (or secondary) mark (Ms). The process steps described for summarizing contained marks (M) in FIG. 30a, are exactly the same as for summarizing contained events (E), with the follow notes:
1) In addition to the new related datum (RD) of “Container Event Duration” automatically added to the new summary mark (Ms), the session processor will:
   a. Add a new related datum (RD) of “Count of Contained Events,” exactly similar in purpose and process as to the “Count of Contained Marks,” prior discussed in relation to FIG. 30a, and
   b. Add a new related datum (RD) of “Total Contained Event Duration,” which is set to the total session time 1b represented by the zero or more contained events (E), where:
      i. In reference to the bottom of FIG. 30b, it is possible as prior discussed for the contained event (E) to either “expand into,” be “contained by,” “extend out of,” or “overlay” the container event (E), in which case only the overlapping duration of the contained event (E) is summed into the “Total Contained Event Duration” related datum, as will be understood by those familiar with software and time calculations.

Now referring to FIG. 31, the is shown a combination node diagram (copied from the DCG of FIG. 23a) with a corresponding block diagram detailing the relationship between a “tertiary” or “calculation” mark (Mc) and its related calculation rule (L). The object structure of the tertiary calculation mark (Mc) is intentionally identical to that of primary marks (M) and secondary marks (Ms). Where primary marks (M) are externally made “observations” of the session 1 and its activities 1d, secondary (Ms) and tertiary (Mc) marks can be considered as internally made “observations” of session 1 activities 1d, specifically where secondary summary marks (Ms) are simply “counts” of recurring behavior, and tertiary calculation marks (Mc) are more sophisticated calculations, or samplings, of ongoing complex behavior—as will be appreciated especially by those familiar with sports. Both of the “session internal” observation marks (Ms) and (Mc) would be familiar as “statistics” for a sporting event.

To best recognize the intended functional difference between a summary mark (Ms) and calculation mark (Mc), it is noted that the rule (L) attached to a context datum (CD) of the calculation mark (Mc) is in effect an equation, or formula, with multiple potential operands sampled at the various session times when calculation mark (Mc) instances are internally generated, thus tracing either a simple or complex function as the session 1 progresses. For instance, while summary marks (Ms) would count the total shots marks (M) contained in a period event (E), a calculation mark could be set up to determine the ration of shots taken per shift for the home team vs. away team, which could be plotted for the entire game based upon the set sampling rate (to be discussed in relation to the “trigger object” of the calculation mark (Mc).) As will be seen, calculation marks (Mc) can draw operands from all internal session knowledge including from other calculation marks (Mc) (and for that matter external object tracking data 2-otd if available via the network)—thus creating an ability to nest calculations marks (Mc) similar to terms in a complex algebraic function.

Referring to the top of FIG. 31, there is shown a tertiary calculation mark (Mc) associated both with context [Cn] and calculation rule (L). The lower half of FIG. 31 depicts the associated preferred software classes for implementing this “mark—calculation rule” (Mc)-(L) model for governing the synthesis of tertiary marks, as will be understood by those familiar with OOP. Specifically, each calculation mark (Mc) should have one or more associated context datum (CD), each with their own “copy or calculate” rule (L). (Hence, in practice multiple complex functions can be sampled throughout the session 1 at identical session 1 times via the same calculation mark (Mc).) Also associated with mark (Mc) is a trigger object, which can be either another mark (M), or an event (E). (Again as before, any primary, secondary marks or events can be used as a trigger object.) Each trigger object has an associated filter rule that controls whether or not a new calculation mark (Mc) instance is created for each actual trigger object instance. And finally, if an event (E) is used as a trigger, a “set time” attribute or object is associated with the event (E) to control the actual trigger point, i.e. either at creation, start or stop time. All of this teaching will be fully understood by a careful reading of the prior specification leading up to this FIG. 31.

In terms of processing sequence, as will be understood in light of the synthesis patterns already disclosed, after completing synthesis of all summary marks (Ms), the session processor 30-sp searches all calculation marks (Mc) for the context [Cn] to see if they have a trigger object equal to either the currently integrated mark (M) or one of the newly created, started or stopped events (E), as a result of integration. For each found calculation mark (Mc), the session processor 30-sp first evaluates the filter rule (L) associated with the trigger object (M) or (E), and in the case of trigger (E), make sure that the “set time” appropriately matches the state of the event (E). If the actual trigger object (M) or (E) passes the filter rule (L) and matches the “set time” (if an event,) then the session processor will create a new instance of the calculation mark (Mc) object and add it to that mark type's list. After this, for context datum (CD) found in association with the calculation mark (Mc), the session processor 30-sp will add a related datum (RD) to the new calculation mark (Mc) instance. Session processor 30-sp will use the “copy or calculate” rule (L) associated with the context datum (CD) in order to set the value of the matching related datum (RD), all as will be understood by a careful reading of the present invention, and also especially with respect to FIG. 23b.

Referring next to FIG. 32a, this is shown a block diagram depicting the concurrent flow of session 1 information in the form of differentiated marks (M) and recorded data 1r (for example, but not limited to, video 1rv and audio 1ra) into the present system. Much of the past specification has strictly focused on the “index” 2i, or contextualization side of the current teachings. However, the present invention also has value in the ways in which it both synchronizes the index to the recordings, and in the way it can use the contextualization to chop, mix and blend multiple recordings (especially video,) into a single stream for expression. Starting in the upper-left of FIG. 32a, there is shown (for example) two external devices, namely the session console 30-xd-14 and the scoreboard reader 30-xd-12. As prior taught, these devices are capable of differentiating both human (session console) and machine (scoreboard reader) observations for transmission as marks (M) and related data (RD) across a mark message pipe 30-mmp. Also as prior discussed, each mark (M) carries ownership information including which external devices 30-xd and differentiating rules 2r-d were employed to create the observation. As will be understood by those familiar with network and messaging systems, the mark type and ownership information may be used to establish a subscription protocol, where other services of the present invention such as session controller 30-sc, session processor 30-sp, recording synchronizer 30-rs and full stream compressor 30-rcm may then becomes subscribers to the individual streams.

At the top of FIG. 32a, it can be seen that session console 30-xd-14 was responsible for initially starting a session by issuing the “session start mark” which is then received by the session controller 30-sc. Session controller 30-sc then preferably instantiates new copies of all necessary services such as session processor 30-sp, recording synchronizer 30-rs and recording stream compressor 30-rcm and subscribes them to the current session 1's id. Although not shown in the present figure for simplicity, session console 30-xd-14 also follows the session start mark (M) with any number of additional marks (M) drawn from both the session registry 2-r (therefore being “how” marks (M) identifying the external device [ExD] group and individual objects that will be issuing marks (M) throughout session 1), as well as the session manifest 2-m (therefore including the “when,” “where,” “what,” and “who” marks (M))—all as taught especially in relation to FIG. 11b. Session controller 30-sc then also preferably communicates with all registered external devices 30-xd (via the mark message pipe 30-mmp,) in order to initialize their functioning and provide them with the current session 1's id for embedding into their issued marks (M). In addition to this coordination by the session controller 30-sc, as will be understood by those familiar with both software systems and network protocols, the present inventors anticipate that each instantiated service may be running on their own independent “computing node,” e.g. [CN1] through [CN4], which is most likely distinct from the computing platform of each external device 30-xd. Therefore, the present invention additional employs the well known “network time protocol” to synchronize the internal clocks on all computing nodes [CN1] through [CN4] running services, and on all external devices 30-xd. As will be understood, this ensures that the flow of marks (M) and recordings 1r can be coordinated based upon a locally synchronized time. As will be further understood, other variations are possible without deviating from the novel teachings herein. For instance, the session controller 30-sc could be eliminated simply having the session processor 30-sp perform the overall system coordination tasks. Also, all of the preferably separate services such as 30-sp, 30-rs and 30-rcm could be joined into a single process. It would also be possible to establish a different protocol other than NTP for synchronizing the time across various network devices and computers. While all of these variations are possible, what can be seen is that the present invention uniquely teaches any number of distinct external devices 30-xd, based on any technologies, for recording and/or differentiation a session 1 into a stream of normalized marks (M) with related data (RD) and/or recordings 1r, all time synchronized and following a subscription model. What can also be seen is that at least one of these marks (M) serves to signal the start of the contextualization of session 1 after which some process then instantiates services for integrating and synthesizing the on-going stream of differentiated marks (M) into events (E) forming the index 2i for organizing recordings 1r. These differentiated marks (M) may represent human observations, machine observations, or combination human-machine observations—what is common is that they all follow a normalized protocol such that their observation method and apparatus becomes irrelevant to the downstream services, thus disassociating differentiation from integration and synthesis via the common interface contract of the mark and related datum. What should also be understood is that the instantiated services receive a context [Cn] from the initializing external device via a mark (M) which is then used to recall a domain contextualizing graph providing the template objects describing the internal session knowledge and rules for performing the successive contextualization stages of at least integration 30-3, synthesis 30-4 and then expression 30-5. Many other novel distinctions and advantages of the present invention are and will be obvious to the careful reader, still yet other distinctions and advantages are yet to be taught.

Still referring to FIG. 32a, the present inventors now focus on the novel way in which the present invention employs the stream of marks (M), mostly but not limited to primary or spawned, to act as additional triggers for the controlling of both the recording synchronizer 30-rs and the recording stream compressor 30-rcm. Specifically, what can be seen is that each external recording device, such as video recorder 1rv or audio recorder 1ra, will follow some accepted protocol such as TCP/IP for steaming its captured data. While variations are possible, the present inventors prefer that each distinct stream of video or audio has its own recording synchronizer 30-rs either “always on” and accepting the stream, or instantiated by the session controller 30-sc (in reference to the external devices “how” marks (M),) to receive only that stream. As will be understood by those skilled in the art of machine vision, and even more so the uses of IP security cameras, the video data is likely to come in at some fixed, but not necessarily constant rate of perhaps 25, 30 or event 60 image frames per second. While this is the “fixed rate,” it may be an average and in real situations there may be slight delays between frames beyond the fixed rate and worse yet, under some circumstances image frames may be “dropped,” especially if network traffic is overloaded. Therefore, the present inventors prefer that the recording synchronizer 30-rs, one for each various type of recording steam such as 1-rv and 1-ra, perform some or all of the follow functions:
Unpack the incoming recorded data from its first protocol, e.g. TCP/IP, and repack it into a data-agnostic, universal data protocol such as UDP (as will be understood by those skilled in the art of software and network systems);
Time stamp each data frame (regardless of recording format, e.g. video, audio, etc.) in NTP time to synchronize with all other internal session knowledge and recordings, and
For video data in particular, also keep a last valid frame and use this frame to replace any dropped current frame thus removing any “data holes” in the video stream, further supporting synchronized video playback using typical tools such as the Windows Media Player that will tend to shift video frames ahead in time to cover “data holes,” (as will be well understood by those familiar with video playback software.)

Hence, recording synchronizer(s) 30-rs serve to repack all recording streams into a common protocol such as UDP for multicasting across a network 30-mcn, to time stamp each data frame based upon the NTP for synchronizing with all other internal session knowledge, and to remove any “data holes” such as dropped frames in a video stream 1r. These various UDP streams are then multicast across the network 30-mcn to various subscribers on other computing nodes such as [CN4] (or remain on the same computing node, e.g. [CN3]), to be received into frame buffer 30-fb. The overall purpose of frame buffer 30-fb is to suspend the incoming recording stream (preferably in the memory of the computing node [CN4]) while the session 1 continues on for a certain time, thus uniquely allowing for a delay in recording stream post-processing. For example, if a single video frame held 1 MB of information, and there were 30 video frames per second, then a frame buffer 30-fb with access to 180 MB (=30 fps*60 seconds/min) could suspend or delay 1 minute of video. As will be understood by a careful reading of the present invention, and in particular with respect to the teaching example of ice hockey, a lot can happen in 1 minute with respect to the session activity 1d and resulting observed marks (M) and events (E). While the frame buffer 30-fb does not have to delay for a specific time to meet the novelty of the present invention, what is important is that some delay provides the opportunity for observation marks (M) and events (E) to be differentiated, integrated, synthesized and expressed such that they may then be used to controllably direct, and provide a near-real-time index to recording compressor 30-rcm, sitting on the output side of frame buffer 30-fb.

Still referring to FIG. 32a, preferably frame buffer(s) 30-fb include input and output control switches that are regulated by recording compressor 30-rcm which receives at least the incoming stream of primary marks (M) and possibly spawned marks (Ms). In future patent applications, the present inventors intend to teach novel object structures, such as shown in FIG. 23a, for embedding recording controller rules (L) responsive to marks (M) and events (E). As can be imagined, such rules (L) might indicate to “turn on input switch to frame buffer” in response to receiving the “session start” mark (M) (and vice versa with the “session stop” mark.) As will be taught, especially in relation to upcoming FIGS. 36a through 36h, not only will events (E) be integrated to indicate an important behavior such as a “goal,” but they will also be available to indicate “zone of play” and “play in view” (per each recording camera.) By delaying multiple various video streams 1rv long enough to decide for instance, what is the “zone of play” (i.e. where is the session activity 1d, e.g. game action,) what cameras 1 to n have this “play in view,” and when did certain key behaviors actually happen (e.g. goal scored,) the system may replicate the current manual functions of a production truck as it chooses between multiple camera feeds to best create a single blended video stream. Thus, the careful reader will see that the present system has created the advantage of being able to “look backwards” in time as it chooses its broadcast assembly strategy. As will be taught in more detail with respect to upcoming FIG. 32c, this arrangement shown in FIG. 32a for synchronizing internal session knowledge (M) and (E) with delayed recordings 1r, forms the basis of a rules (L) based automatic system for shunting various recording feeds into one or more clipping buckets or streams by controllably turning on and off frame buffer 30-fb input and output switches, thus providing significant value to the marketplace.

Referring next to FIG. 32b, there is shown an arrangement very similar to that taught in relation to FIG. 32a except that the recording compressor service 30-rcm tasked with capturing “full session” video, is replaced by clip-and-compressor service 30-ccm, tasked with creating small independent video clips which can for instance be complied into a highlights database (e.g. with ice hockey a season highlights database of all goals scored.) As will be fully understood by those familiar with software systems, these two services 30-rcm and 30-ccm can easily be made one service object that controllably functions in the different manors stated, all of which have value. The present inventors prefer separate objects because in practice there are different potential video transcoding and compression format requirements which might call for optimized internal software methods—thus different apparatus. For instance, the original video stream 1rv is preferably in High Definition, which is also preferable for the storage of the full session recording. However, because of the need to ship video clips over the internet where bandwidths are a limiting factor, the highlight clips of individual goals may be best transcoded down into VGA format, all as will be well understood by those familiar with video processing.

And finally, with respect to both FIGS. 32a and 32b, the present invention teaches the novel use of spawn marks, for instance to move “backwards” in time (e.g. 3 seconds before a goal is scored) to properly shunt frame buffers 30-fb, especially for clipping highlights via clip compressor 30-ccm. (The careful reader will see that knowledge of these spawn mark (Ms) time skips should be coordinated with the total delay time built into the frame buffer 30-fb.) What is of particular interest and novel to the present teachings, is that session processor 30-sp, which generates the spawn mark(s) (Ms), has no particular understanding at the point of mark (Ms) generation whether a given spawn mark (Ms) will be used to create, start or stop an event (E), or to control some frame buffer 30-fb via services such as 30-ccm, or both. Also, FIG. 32a refers to using primary marks (M) to be directly interpreted by rules (L) (similar to integration,) as the preferred “Method 1” for controlling frame buffers 30-fb and resulting data stream compression. Conversely, FIG. 32b refers to using both primary marks (M) and specially spawned marks (Ms) (e.g. “start clip,” “pause buffer,” “stop clip,” etc.) as an alternate “Method 2” for controlling likewise frame buffers 30-fb and resulting data stream compression. Obviously, both methods are “rules based” since Method 1 uses rules (L) at the point of compression and Method 2 uses rules (L) at the point of integration. Various combinations are also possible without departing from the teachings and scope of the present invention.

Referring next to FIG. 32c there is depicted a block diagram vertically aligning along session time 30-stl, first the concurrent inputs from external devices 30-xd of differentiated marks (M) and then all recordings (represented as only video 1rv,) and second the concurrent session 1 outputs from two broadcast mixers 30-mx-1 and 30-mx-2 which are blended session recording streams 2b-r1 and 2b-r2 respectively (both of which are examples of organized content 2b.) As also previously taught, all internal session knowledge of actual (M) and (E) objects created by session processor 30-sp during integration, synthesis and expression is time synchronized with all recordings, such as 1rv, as especially held in frame buffers 30-fb via the preferred well known NTP protocol, where this real-time defines the session time line 30-stl. What is most important to see from FIG. 32c is as follows:
1. Internal session knowledge (in the form of actual (M) and (E) objects, whether primary, secondary or tertiary, whether externally or internally generated) builds up over time to create a rich understanding of session activity behavior 1d;
2. Session 1 disorganized recordings 2a (such as 1rv and 1ra) are ideally delayed, or buffered via 30-fb for some limited time such as 1 minute, while internal session knowledge is developed by session processor 30-sp;
3. The present system includes several real-time unattended services such as, but not limited to, external devices 30-xd, the session processor 30-sp, recording synchronizers 30-rs, frame buffers 30-fb, recording clip compressors 30-ccm, recording compressors 30-rcm not shown, but “upgraded” into more sophisticated broadcast mixers 30-mx, all controllably instantiated, or “always-on” and initiated by, session controller 30-sc (not shown) in response to session “start” and the ultimately session “stop” marks (M). Each of these real-time services may run on one or more computing nodes [CNx] (not shown) and as such use well known standards such as network time protocol NTP to accomplish synchronization, and
4. While session 1 inputs of externally generated marks (M) and recordings 1r are real-time and synchronized, session 1 output recording streams, such as 2b-r1 and 2b-r2, created by rules (L) driven broadcast mixers 30-mx-1 and 30-mx-2 respectively, are provided either in real-time, or preferably in “delayed time,” at least enough to provide sufficient buildup of internal session knowledge that facilitates optimum mixing decisions, as will be understood by those familiar with broadcasting standards.

Still referring to FIG. 32c, broadcast mixers such as 30-mx-1 and 30-mx-2 are similar to recording compressors 30-rcm and video clip compressors 30-ccm and, as will be understood by those familiar with OOP, could therefore be the same object acting out different methods based upon differing attribute settings; all of which is immaterial to the teachings of the present invention. What is important to understand regarding broadcast mixers 30-mx versus compressors 30-rcm and 30-ccm, is that these services include additional access to all recording (e.g. video) clips produced by all clip compressors 30-ccm (e.g. highlight replays from various video angles,) all of which are automatically organized and semantically “tagged” by the present invention using the (E)-(M)-(RD) model, along with preferable access to externally generated recordings 2b-ext (such as commercials, sound effects, graphics, etc.,) all of which include relevant semantic tagging provided by the content source in the normalized (E)-(M)-(RD) format implemented by the present invention. What is further important to note about broadcast mixers 30-mx is that they also use external blending and mixing rules (L) to govern the creation of their output recording streams 2b-r, the fact of which is novel to the present invention for forming universal, normalized session broadcasting “standards” that can pre-developed by the marketplace (e.g. broadcast production experts) using the herein taught SPL, and then sold or distributed worldwide for use by apparatus conforming to the present invention, thus providing for the automatic creation of organized session 1 broadcasts. Now referring to FIG. 33, there is shown a combination node diagram (copied from the DCG of FIG. 23a) with a corresponding block diagram detailing the relationship between an event (E) and an event naming rule (L), also referred to as a “descriptor” rule. This aspect of the present invention fits within the “expression” stage 30-5 that is executed by the session processor 30-sp (see FIG. 5.) There are many aspects to content expression 30-5, and this “auto-naming of events” is just one function, similar to the way the synthesis includes three functions, namely event combining to form secondary events, mark and event “counting” to form secondary marks, and internal session knowledge “formulaic sampling,” or triggered calculations to form tertiary marks. As prior discussed especially in relation to FIG. 4, the automatic “chunking” (via integration and synthesis) of session activities 1d into various interwoven events (E) is highly useful (see stages 20-1 and 20-2 in FIG. 4.) As individual, actual event (E) instances are created, they are naturally categorized, (a step referred to as classification” in FIG. 4) by their event type. Events (E) can be further classified beyond their natural event type using the additional related datum associated with each event instance via its various create, start and stop marks, as well as its linkages to other objects and the attributes carried on the event (E) object itself as inherited from the Core Object (see FIG. 20a.) In addition to logical classification of events (E) into groups, sub-groups, and so on, events (E) can be uniquely described or named, which is now being taught with respect to the present figure. The expression function of logical classification into an automatic foldering system will be discussed in relation to upcoming FIGS. 34a and 34b.

The careful reader will see that the present teachings that allow for the association of context datum (CD) to any given mark (M) that can be copied into or calculated at some “set-time” within the integration or synthesis process, really means that the session processor 30-sp can add its own “observational details” to any given mark (M) describing any given event (E) at the appropriate time in that event's (E) life-cycle, i.e. creation, starting or stopping. These additional “observational details” will show up as related datum(s) (RD) carried by marks (M) but not set with actual values until some internal processing point has been reached. Once reached, the session processor 30-sp will follow the associated “copy or calculate” rule (L) (see FIG. 23b) and the resulting related datum (RD) value may be any of the well known data types including text or numbers. As text (or a time, etc.,) the value could generally be considered as “descriptive” or “qualitative,” whereas as a number (especially a calculated number,) the value could be considered as “quantitative.” In either case, these new “internal observations” held as related datum (RD), can be broadly considered as “descriptors” or “tags” giving expressive handles to each actual event (E) instance (all of which can be generally considered “semantics” and in support of the highly organized Web 3.0 concepts known to those familiar with logical Internet architecture.) These handles may be used when automatically creating the “first and second organizational structures” first taught in FIG. 4 as stages 20-3, 20-4, 20-5 and 20-6.

Referring still to FIG. 33, the present inventors teach a more complex type of descriptor than a single related datum (RD) that is set by copying from, or calculating with, various “internal session knowledge.” Specifically, this descriptor is either the “short name,” “long name” or “prose” describing a given event (E) instance. For example, “Home Goal 3” might be a short name, whereas “Home Goal 3 Scored by 17 in P1 @ 15:07” might be a full name and the event's prose might be: “At 15:07 in the first period, number #17 Hospodar took a pass from #29 Donavan to put the Jr. Flyer's up 1 to 0, which was enough for a victory as the Jr. Flyer goalie Aman stopped all 23 of the Colonials shots.” Collectively, this creation of these three levels of descriptors is referred to as “auto-naming of events” (E), and is controllable by the same descriptor rule (L).

As shown at the top of FIG. 33, each event type (E) may have associated one or more descriptor rule (L) objects, where each rule (L) must be of “stack type” “short name,” “long name” or “prose.” As will be understood especially by those familiar with software systems, the choice of these three “stack types” is exemplary and sufficient, but not necessary for the present invention. What is important is the teaching of how any name or description, of any length or complexity, can be created automatically as a part of the systematic and deterministic processing of disorganized content 2a into organized content 2b, especially where these resulting names and descriptions are instrumental to forming the content index 2i (see FIG. 1b.) Descriptor rule (L) can best be thought of as a “conditional concatenating rule” for assembling any number of tokens, each buildable from other tokens, into a final desired description of any complexity. Attached to the descriptor rule (L) is a sequence of one or more individual stack elements, where each element represents the next token (operand) of the desired description. Each stack element includes an optional prefix or suffix that is appropriately bound via concatenation to the returned token (as will be understood by those familiar with language systems.)

Still referring to FIG. 33, the descriptor rule (L) also includes the prior taught “set-time” object which is used to indicate whether the event type (E) to be named, is named at creation, start or stop time (or any combination thereof, thus implementing “re-naming.”) Optionally attached to the descriptor rule (L) is an additional “reset” event (E) with its own set-time object. If this “reset” event (E) is established, then the creating, starting or stopping of one of its instances triggers the further resetting, or updating, of the descriptions of all event instances of the event type for which the descriptor rule (L) applies. For example, the short and even full names for each “goal” event (E) might have a set-time of “when the individual event is created,” whereas the prose for each “goal” event (E) might have a set-time of “when the Game event is stopped.” Obviously, by the end of the “Game” event (E), there is significantly more internal session knowledge, especially including the game's final score (e.g. represented as the list of all “Home Goal” and “Away Goal” events (E), or even the list of all “Home Goal” and “Away Goal” marks (M)—both would suffice.) By creating the final prose for each “Goal” event (E) instance at the stop time of the “Game” event (E), it is possible to add to the prose clauses such as: “it was the game winning goal.”

Also referring to FIG. 33, each stack element's operand serving as a single token can be copied directly from a data source including any internal session knowledge, set to a constant, or even copied or calculated using a rule (L), (if a rule (L) is associated with the stack element and optionally set to provide its stack value.) If a copy or calculate rule (L) is associated with the stack element but set to provide its true/false veracity, then it will be interpreted to conditionally keep or remove the stack element's token, based upon its veracity, from the final short name, long name or prose—essentially providing for “conditional tokens.” (Note that one copy and calculate rule (L) could be attached to a stack element for returning its stack value as the operand/token, while another copy or calculate rule (L) could be attached to the stack element for returning its veracity and thus controlling the inclusion of the element's operand in the final descriptor rule (L)'s returned description.) What is additionally taught is that the stack element's operand/token, can itself be drawn from another descriptor rule (L), thus allowing for both recursion and nesting for the formation of compound sentences and even paragraphs as will be obvious to those skilled in language sciences. (Also note that a copy or calculate rule (L) with returned veracity may be used on a stack element whose operand is being set by another descriptor rule (L), thus making the returned description conditional.)

As with the other stages of contextualization, this auto-naming step of expression stage 30-5 happens in a pre-set sequence within the session processor 30-sp. Specifically, after integration 30-3 and synthesis 30-4 (see FIG. 5,) the list of all newly created, started or stopped events (E) is used by session processor 30-sp to search for associated descriptor rules (L) (meaning that the event (E) instance may need to be described based upon the then associated set-time,) and for associated descriptor rules (L) referencing any of the newly created, started or stopped events (E) as a trigger for resetting the description of one or more other event (E) instances that are not on the newly created, started or stopped events list.

Referring next to FIG. 34a, there is shown a diagram focused on the expression stage 30-5 (see FIG. 5) of the present invention where internally generated and owned session knowledge 2b, represented in the highly semantic, normalized (E)-(M)-(RD) model, is automatically associated with owned foldering trees 2f, that are dynamically populated by session processor 30-sp in reference to auto-foldering templates 2f-t with ownership 1d-o. Organized content 2b placed in owned 1d-o folder trees 2f is then made accessible to individual content users 11 via the session media player 30-mp, for which they have ownership rights 30-mp-o. Using session media player 30-mp, users 11 may access and traverse content foldering tree 2f, assuming that have sufficiently obtained permission 2f-p matching content and foldering ownership 1-d-o and 2f-o, respectively. As will be well understood by those familiar with marketplaces and ownership management, it is possible that out of the same session 1, some foldering trees 2f are created with ownership 2f-o while others are not, thus providing “paid” vs. “free” content 2b access. Furthermore, it is even possible that some foldering trees 2f contain organized content 2b that comes from multiple sources (including the same or multiple sessions contextualized with the same or different context [Cn], the same or different session attendees 1c doing the same or different session activities 1d, in the same or different session areas 1a at the same or different session times 1b.) It is also possible that some nodes of tree 2f contained “paid” content while other have “free” content, even mixed into a single node. And finally, it is also possible and fully anticipated by the present inventors that foldering trees 2f can be connected, where one tree's root attaches to another's leaf (or root,) thus forming an permission-ownership restrictable gateway into additional organized content, where the entire nesting of foldering trees 2f may be controlled by a single organization or shared worldwide via the internet thus providing for an automatically populated, universal, normalized and semantically tagged, organized content distribution and sharing system—which supports the goals for what is also known as Web 3.0.

As will be further understood by a careful reading of the present invention, there is a natural relationship between the organizing index 2i, which can be seen to include the folder tree 2f, holding events (E), tagged by their create, start and stop marks (M) with related data (RD), and the captured recordings 1r. This natural relationship is first established by associating with all actual internal session knowledge objects (i.e. (E)-(M)-(RD)), as well as all captured recordings 1r and all their subsequent clipped, mixed and otherwise compressed versions, the session 1 actual object [Sn] (taught in relation to FIG. 20c,) which therefore acts as an aggregator. As will be seen, this then overlays the internal session knowledge via the session time line 30-stl onto all session 1 recordings 1r and their derivatives, thus forming the master index 2i. This index 2i is essentially reconfigurable into various customized indexes in the form of foldering trees 2f, each tree 2f of which maintains this natural relationship to recordings 1r. It is possible that recordings 1r can be provided in their entirety (e.g. all the video from all cameras, plus all audio, etc.) or in any subset (e.g. single clips, blended and mixed video, etc.) to go with the accessing index 2i—all of which is accomplished in the “aggregate organized content” stage 30-6 (see FIG. 5.)

As can be seen from the teachings herein, session processors 30-sp, working independently to automatically contextualize individual and local sessions 1 by forming their master index 2i via integration and synthesis of normalized differentiated observations from any number of external devices, can be controllably directed using auto-foldering templates 2f-t to disperse their content either locally, or worldwide via a subscription based content clearing house 30-ch that receives full or partial organized session content 2b, either as full or partial recordings 1r with necessary associated full or partial indexes 2i in the form of populated folder trees 2f. Some or all of these organized content 2b and index 2i dispersements may then be joined by associating various folders 2f via any of their nodes, thus together forming a worldwide foldering tree transversable via the session media player 30-mp with permission restrict able gateways at every folder system's 2f root node.

Still referring to FIG. 34a, after session processor 30-sp completes at least integration and synthesis, for each stopped event (E) on the newly created, started and stopped event list, a check is made to find any and all folder 2f nodes that are associated via auto-foldering template 2f-t with the given stopped event (E). Before completing the association of the stopped event (E) with the particular folder node, the session processor 30-sp will execute any associated filter rule (L) that will essentially review the event (E)'s associated marks (M) and related data (RD) (e.g. to make sure the “player no.”=“29”,) the veracity of which governs the final linkage.

Referring next to FIG. 34b, there is shown a representative node diagram for the auto-folder template 2f-t first taught in FIG. 34a, along with its preferred implementation as object classes starting with a folder object 2f-r serving as the root that is attached to session manifest object 2-m, all as will be understood by those familiar with OOP. Each template 2f-t, must have one and only one root folder 2f-r, to which is further attached ownership object 1d-o that globally applies to all other “sub”-folders 2f-s, nested beneath the root. For instance, the root folder 2f-r ownership object 1d-o might specify (or have attached) the session attendee is group object representing the home team of “Wyoming Seminary.” At this point, every sub-folder is now “owned” by the home team, and if the away team (e.g. “Northwood”) attempted to gain access through the root folder 2f-r using the session media player 30-mp, they would (could) be denied. As will be seen, further ownership restrictions can be placed on sub-folders 2f-s, (which then apply to all folder descendants,) for example restricting the “sub-tree” to the individual session attendee is of “head coach.”

Associated with each and every sub-folder 2f-s is a “standard type” enumerator indicating that the folder is either “static,” or “dynamic.” In order to understand this distinction, it is best to first know that at the start of each session 1, the session processor 30-sp (or an associated expresser 30-e object used by the session processor 30-sp to handle all foldering operations,) searches for all auto-foldering template root objects 2f-r associated with the current manifest 2-m. (For example, there may be templates for the home and away teams (e.g. to hold the entire game's worth of events (E),) perhaps also the league officials (to hold all infraction events (E),) and then maybe for a college scout (to hold all shift events (E) for a given youth player.) For each root 2f-r found, the expresser 30-e first “walks” the template, node by node in order to create the corresponding “actual” foldering tree that will be populated with “actual” events (E). If the sub-folder 2f-s is “static,” then the corresponding “actual” sub-folder is created using the same object name and description (e.g. “Games.”) If the sub-folder 2f-s is “dynamic,” then it will have an associated “descriptor” rule (L) (exactly as taught in relation to FIG. 33,) that will serve to return a stack value which is a concatenation of one or more tokens to be used to name the sub-folder (e.g. “vs. Northwood, Oct. 1, 2009”—which might be the name of an individual game held within the “Games” parent folder.) Underneath this, there might be another static sub-folder 2f-s pre-named “Period 1,” or “Power Plays,” etc.

It should also be noted that when the expresser 30-e finds the foldering template 2f-t and then begins to transverse it nodes to create associated actual nodes (i.e. sub-folders 2f-s,) it may find that an actual folder tree mirroring template 2f-t was already established—for instance by the processing of a prior session 1 with the same context [Cn] (e.g. as created for the last game played.) This can be known because all actual foldering trees are associated in the local database with the ownership object 1d-o linked to the actual root 2f-r. When the expresser 30-e finds that a pre-existing actual root 2f-r has already been created in association with the owner object 1d-o, then it will use this root to be “updated” according to the template 2f-t. Hence, as expresser 30-e walks the template nodes, it will likewise walk the pre-established actual tree nodes. For each template static folder 2f-s, the expresser 30-e will not have to create a new actual sub-folder because one of the same name already exists (i.e. there is only one “Games” sub-folder.) However, when expresser 30-e encounters a dynamic sub-folder 2f-s, it will always execute the descriptor rule (L) to come up with a sub-folder name. If this name/sub-folder 2f-s does not already pre-exist in the actual folder tree, then a new sub-folder 2f-s is added to the existing tree (e.g. a sub folder under “Games” with a name of “vs. LaSalle, Oct. 9, 2009.”) Note that if there are static sub-folders 2f-s (such as “Period 1,” or “Power Plays,” etc.) on the template 2f-t underneath a dynamic folder (such as “vs. LaSalle, Oct. 9, 2009”,) then expresser 30-e will automatically create these static sub-folders 2f-s, because they obviously are not going to be found in the pre-existing actual foldering tree, as will all be understood from a careful reading, especially by those familiar with software systems and node diagrams.

Still referring to FIG. 34b, each sub-folder 2f-s may (or may not) have attached one or more event types (E) that inform expresser 30-e which actual events (E) are to be loaded into or associated with the given sub-folder. (As previously mentioned with respect to FIG. 34a, preferably all stopped events (E) on the newly integrated and synthesized events list are used as potential events for associating with sub-folder(s) 2f-s.) Before automatically associating a new actual event (E) with one or more actual sub-folder(s) 2f-s, expresser 30-e will first execute the filter rule (L) associated directly with the event type (E) found in template 2f-t. If this filter rule (L) executes to “true” (e.g. because (RD) of “Period”=1,) then the event (E) (e.g. “Face-Off”) may be attached to the sub-folder 2f-s (e.g. “Period 1.”) However, the sub-folder 2f-s itself (e.g. “Period 1”,) may have its own directly associated “gate-keeper” rule (L), that is meant to filter any and all events (E) of every type that may be attached to the sub-folder. Hence, a sub-folder 2f-s (e.g. “Period 1”) gate-keeper rule (L) might check for a related datum (RD) of “team” to make sure it is set to “home,” thus only associating face-offs events (E) won by the home team, or shot events (E) taken by the home team, etc., with the given sub-folder 2f-s (e.g. “Period 1”.) (Note, these event type (E) filter rules (L) and sub-folder 2f-s gate-keeper rules (L) may not exist, one may exist without the other, or they may both exist—all combinations are useful as will be understood by a careful reader.) As will be understood by a careful reading of the present invention, an event type (E) may be assigned to zero, one or multiple sub-folders 2f-s in zero, one or multiple templates 2f-t. For that matter, using the link object (X) (see FIG. 20e,) any given sub-folder 2f-s can be given an additional parent object id, thus allowing one sub-folder 2f-s to attach to multiple parent folders 2f-s in the same tree template 2f-t (and corresponding actual tree.)

Referring next to FIG. 35a, there is depicted the present inventors' preferred screen layout for the session media player (SMP) 30-mp that allows individual users 11 to access session 1 contextualized organized content 2b via one or more actual foldering trees (such as 2f-al and 2f-a2,) which then become the defacto content index 2i. In combination with FIGS. 35b and 35c, the various parts of the SMP will be taught—some parts of which will be familiar in comparison to current state-of-the-art players such as the Windows Media Player or Quicktime, etc. What is similar is that like all current media players the present SMP includes a “session video display panel,” whose function is well understood as the area where video and other content is ultimately presented to the user 11. Directly below the video display panel is also a familiar “session time line” (to be introduced in FIG. 35b,) that like the rest of the SMP 30-mp screen objects/constructs is tightly interwoven with the content index 2i, creating novel and useful functionality to be herein taught. Below the session time line is a new “event time line” (to be introduced in FIG. 35c,) that automatically displays correctly time positioned and sized buttons representing all events (E) of current focus. Below this is the familiar media playback controls, i.e. allow the user to “play,” “pause,” “stop,” etc. the video/content playback. Directly above the session video display panel is the “video display title bar” (to be introduced in FIG. 35b) that automatically changes to name the currently presented content 2b. Along the right-hand edge of the SMP 30-mp are the buttons for switching camera views (which is the focus of upcoming FIGS. 37a and 37b.) And finally, along the left-hand edge of the SMP 30-mp is the “session foldering pane,” serving as the content index 2i.

As will be appreciated by those skilled in the art of software program screen designs, the individual SMP 30-mp elements (as just listed and to be taught further,) may be rearranged in their positional layout and/or “hidden,” “docked,” made detachable, etc. without departing from the novel teachings herein. While there are design aspects (i.e. the actual proposed layout) that the present inventors' considered novel, it is important to separate this novel design from the novel apparatus and method, so as to fully understand how the SMP 30-mp differs from current media players. Furthermore, the SMP 30-mp could be implemented in portions or in whole, as a “rich” (installed) desktop program or as a web-app, in any current or future programming language, without departing from or leaving the intended scope of the present invention. (All of which is also true for the entirety of the present application and teachings.)

Specifically referring to FIG. 35a, along the lower portion of the figure there is shown user 11 who is expected to initiate SMP 30-mp in any usual manner. Unlike a typically media player, the SMP 30-mp will first determine if it is being run in association with “user owned content” or not. For instance, the user 11 may be a coach starting up the SMP 30-mp on their desktop, in which case the SMP 30-mp will search for and may find an associated content local repository 30-lrp on user 11's computer or computer network. If this repository 30-lrp exists, the SMP 30-mp will search to see how many actual folder 2f-a ownership objects 1d-o are in the repository 30-lrp. If there is only one such object 1d-o (even if there are multiple actual trees 2f-a sharing it,) and the entire foldering tree is “owner-homogenous,” (i.e. none of the tree sub-folders 2f-s have their own unique, overriding ownership object 1d-1 such as “head coach” vs. “players,”) then also depending upon the type of database connection (e.g. “private” vs. “shared”/“public”,) the SMP 30-mp may presume that the present user 11 has defacto permission to access any and all content in the local repository 30-lrp—in which case the “user login” step is skipped. However, if the SMP 30-mp finds multiple ownership objects id-o with attached actual folders 2f-a, or finds that at least one actual foldering tree 2f-a includes ownership 1d-1 restricted sub-folders 2f-s, or determines that the repository 30-lrp is set up for shared/public—restricted access, then for these and other considered obvious reasons, the SMP 30-mp will conduct a familiar user login step.

Also found at the bottom of FIG. 35a, repository 30-lrp will include an ownership object 30-mp-o that serves booth as a template, whose optional attributes govern the new user 11 login questions, and as an actual object storing these particular ownership attribute “answers” in association with a known user 11's unique identity (such as the traditional attributes of username and password, thus saving time for the user 11)—all of which will be understood by those familiar with software systems. As would be obvious, the present inventors teach that any current or future method of safely encrypting each individual user 11's ownership object 30-mp-o may be used to protect user 11's identity and worldwide actual folder 2f-a access rights.

The present inventors prefer and anticipate at least four attributes for identifying the user 11 beyond their identity (i.e. “user name” & “password.”) Specifically, the login script may also prompt for ownership attributes such as (but not limited too):
1. Organization:
   a. For example, in a shared repository 30-lrp at an institution such as an ice hockey facility or high school, there will typically be more than one organization conducting sessions 1 that have been contextualized and stored in repository 30-lrp. At an ice hockey facility, example organizations would be “Wyoming Seminary Boys Ice Hockey—Varsity,” “Wyoming Seminary Girls Ice Hockey—Junior Varsity,” “Team Comcast AAA Travel Ice Hockey Club,” while at a high school, organizations might include the “Glee Club,” “Spring Concert,” “Varsity Baseball,” etc.;
2. Group:
   a. For example, within a given organization, there may be more than one individual group, such as with the “Team Comcast AAA Travel Ice Hockey Club,” that might include the individual teams in the club, such as “Midget Major,” “Midget Minor,” down through “Mites,” all of which represented skill and age brackets that will be familiar to those associated with youth ice hockey;
3. Individual:
   a. For example, within a given group, there are obviously different individuals that can be identified by various means such as name, position, number, etc., and
4. Role:
   a. For example, within a given group, there may be more than one “type” of individual, such as with a sports team there might be the “Head Coach,” “Assistant Coach,” “Forward—Defensive Player,” “Goalie,” etc.

The present inventors prefer that the individual attributes included in the ownership template object 30-mp-o, and therefore also the actual ownership objects 30-mp-o associated with an individual user 11, be made to automatically match those attributes found associated to each and every actual foldering tree 2f-a's ownership objects 1d-0, 1d-1, that is transversable or has been transverse by user 11. In this way, as the individual user 11 begins to access more and more actual foldering tree's 2f-a, the attributes on their actual ownership object 30-mp-o will continue to automatically “grow” in response to the ownership attributes required by each next tree 2f-a transversed. This allows the owner to dynamically build up a custom description of themselves via their personal ownership object 30-mp-o, that is recallable via a secured process, and which essentially “opens up” the mesh of actual foldering tree's 2f-a to which they have access. As existing trees 2f-a are updated (including changes to their ownership at the root 2f-r or any sub-folder 2f-s,) or new folder tree's 2f-a are either interlinked to an existing tree 2f-a or linked directly to one of the repository's 30-lrp root ownership template objects 30-mp-o, the user 11 may find expanded content indexes 2i as foldering trees 2f-a accessible via the foldering pane of their SMP. As will be appreciated by those skilled with on-line ordering systems, it is fully expected that the SMP will allow user 11 to purchase permission rights 2f-p via the internet at any necessary point in time where they desire access to additional organized content 2b via some portion of the actual tree 2f-a mesh forming content index 2i. The present inventors prefer that each permission rights “certificate” object 2f-p is also securely encrypted and either or both directly associated with their actual ownership object 30-mp-o, or impacting upon at least one attribute of their ownership object 30-mp-o—thus providing them with appropriate permission attribute values matching the ownership attribute values found on the given actual folder tree 2f-a. As will be further appreciated, the user's personal ownership object 30-mp-o, which is growing in attributes overtime to match various portions of a worldwide content index 2i, may have access to this object via the internet at any time, where the objects 30-mp-o, may be securely managed by some entity on their server(s). The user's personal object 30-mp-o may also reside securely in their personal control, such as on their local computer, an encrypted USB stick, or on a “smart chip,” embeddable on virtually any personal carry item. As will also be understood, permission certificate objects 2f-p for providing access into new actual folders 2f-a, may include expiration dates and renewal times, etc. that will in effect alter the user's personal object 30-mp-o, their describing attributes and their future content access rights.

As the careful reader will see and understand, the ability of the present invention to exponentially grow a worldwide mesh of interwoven actual foldering trees 2f-a, each with roots 2f-r and associated ownership objects 1d-0, provides for the establishment of a worldwide, customizable content index 2i, connected across computing platforms, and transversable by any user 11 gaining access to the index 2i via an actual folder tree 2f-a at any point within the mesh. In fact, the present inventors fully expect and it is within the scope of the present teachings that several “organizing indexes 2i,” represented as distinct actual foldering trees 2f-a, will be pre-established by one or more organizing communities (e.g. the NHL for ice hockey,) or entities (e.g. Google for all content.) These organizing trees 2f-a may not contain actual event (E) content themselves, but merely include links to perhaps additional “sub-organizing” trees 2f-a, and ultimately to various other “session context”/industry specific actual trees 2f-a, all of which collectively form a worldwide catalogue (index 2i) of organized content 2b, automatically being updated by any number of session processors 30-sp acting independently but under the governance of contextualization (i.e. organizing rules (L)) that match the cataloguing (index 2i) system. The present inventors teach this as their preferred implementation of the “semantic web,” or Web 3.0.

Still referring to FIG. 35a, it should also be understood that the present inventors view each user 11's interaction with the SMP as a session 1. Furthermore, as discussed in relation to FIG. 5, SMP 30-mp preferable includes within itself a session processor 30-sp with optional local repository 30-lrp. As user 11 views allowed organized content 2b via actual folders 2f-a, they may provide comments or notations, etc. of value. These comments and notations are then transmittable back to any one or more other session processors 30-sp with local content repositories 30-lrp, or to a central repository 30-crp. By including a session processor 30-sp within the SMP 30-mp, then these comments and notations are transmittable in the normalized marks, in the universal (M)-(RD) model. For example, with an actual event (E) selected for viewing by coach user 11, the SMP may see that there is a related datum (RD) attached to the actual event (E) called “Coach's Rating” with a “set-time” of “SMP review.” The SMP 30-mp will then also see attached to the “Coach's Rating” related datum (RD) the governing context datum (CD) with a “value list” limiting the allowed choices for this “rating.” The SMP 30-mp may then allow user 11 to select a rating value using the “value list” as a template, after which their choice becomes the value of the “Coach's Rating” (RD) now being set at “SMP review time”—all as will be fully appreciated by a careful reading of the present invention. After this, SMP 30-mp acting as an external device 30-xd to collect manual observations 200 (see FIG. 2,) will for instance issue an actual “Rating” mark (M) with the Coach's Ration (RD) now set (note that this “Rating” mark (M) may have other (RD) such “Player's Rating,” etc.)

As will also be understood by a careful consideration, as an external device 30-xp for capturing manual observations 200, SMP 30-mp is directly comparable to session console 14 (see FIG. 11a,) and the present inventors specifically relate the two. As will also be seen by way of analogy, the SMP user 11, viewing recordings of an original session 1, becomes a secondary observer. To support these observations, additional individual buttons for capturing user 11's observations may be placed on additional sub-screens (beyond those shown in FIGS. 35a through 35c and similar to especially those taught in relation to sub-screen 14-s5, of console 14.) Furthermore, also like console 14, these additional screens and/or buttons may automatically switch, appear and disappear based upon the otherwise detected states of the now recorded session 1, and as embedded in the actual sessions's [Sn]-(E)-(M)-(RD) model. All of this becomes an important distinction and claim of the present inventors as a better tool for performing the traditional “post-session” tagging, or video editing, that traditional software packages now provide (such as from vendors like XOS Tech in the sporting industry.) Hence, where traditional packages require the user 11 to build up their own index 2i equivalent, and offer no means for effectively normalizing this index 2i across a marketplace (as well as all of the other benefits herein taught,) the present invention provides a means by which this normalized “context specific” (e.g. ice hockey) language, expressed as the template DCG for the context [Cn] (see FIG. 23a,) can be used to drive customizable screens and button that generate standardized marks (M) and related data (RD) for mixing with the original referee 400, manual 200 and machine 300 observations (first taught in FIG. 2.) Further keeping in mind the representation of the SMP 30-mp as an external device 30-xd, and the user 11's current interaction with the SMP 30-smp as a new session 1 (beginning with login and ending with the program exit/logout,) then it is foreseeable that the SMP 30-mp could be recording in video/audio the entire new session 1, perhaps via the computers attached web-cam. As such, user 11's interaction with the SMP, including which actual foldering tree(s) 2f-a they choose to view, which sub-folder(s) 2f-s they then visit, which event(s) (E) in these sub-folders they select to watch & re-watch, in what order and how much time are all differentiable machine observations 300 that the SMP 30-mp can automatically make about the user 11's new “session activity” 1d (now referring to their interaction as a new session 1, unique from the original session(s) 1 that they are viewing during their interaction.) As user 11 reviews selected events (E) of the original session(s) 1, they may make comments in any excepted way including visible, audible and tactile (e.g. keyboard entries, telestrations, etc.), etc. The beginning and ending of the comments may be differentiated by simply detecting when they start and stop, when user 11 controllably starts and stops them via some button or equivalent, or they may be recalled based upon the index 2i (i.e. [Sn]-(E)-(M)-(RD)) already being created be differentiating user 11's transversal of the foldering pane including associated original session 1 events (E)—all as will be well understood by a careful reader. Thus the reader will note another unique and useful aspect to the present invention, namely that the SMP 30-mp not only acts as an interactive reviewing tool, but also at the same time an external device 30-xd as well as a context [Cn] driven session processor 30-sp—all of which provide automatic, normalized and universal ways to feedback additional manual observations 200 regarding the original session(s) 1 under review, and then also to create useful contextualization for the new session 1 they are conducting.

Still referring to FIG. 35a, automatically populated actual folder trees such as 2f-al and 2f-a2 may exist within the local content repository 30-lrp being accessed by user 11 and may further have ownership 1d-0 matching user 11's actual ownership object 30-mp-o, properly including the necessary permission certificate objects 2f-p. For these given actual folder trees, such as 2f-al and 2f-a2, they are included in the SMP's session foldering pane, which the present inventors prefer to implement as “GUI component” often referred to as an explorer bar. The actual choice of UI style is immaterial, except that again the SMP 30-mp as taught is considered by the present inventors to be a unique and useful design in and of itself—for which all available properties rights attach. As will be seen from a review of FIG. 35a and from prior figures, as the explorer bar opens up, its selections follow the foldering tree sub-folders 2f-s and each sub-folder's associated actual events (E)—the names for all of which were automatically generated by the session processor 30-sp (and/or its invoked expresser object 30-e) using descriptor rules (L) as well as event naming rules (L). The names typically shown are expected to be the “short names.”

Referring next to FIG. 35b, the teachings regarding the SMP 30-mp are continued from FIG. 35a. First, special attention is drawn to SMP's “session time line” that is automatically time bounded to the “Bounding Event Type” associated with the auto-foldering template 2f-t (related to the actual foldering tree in use, e.g. 2f-a1, or 2f-a2.) (Note that this bounding event type (E) may be associated with the template 2f-t root object 2f-r, for instance as either a connected event (E) via a link (X), or as a referencing attribute added to foldering root object 2f-r.) This bounding event type (E) serves to set the session time line (unlike a normal media player time line that is automatically set to the length of the video to be displayed.) The chosen event type (E) (for binding to the session time line) must be serial as opposed to parallel (see FIG. 28a.) so that there is no ambiguity as to the start and stop times on the session time line itself. As an example, a ice hockey sports context [Cn] might set the session time line to be a bounded by the “Period” event type (E). In this case, when the SMP 30-mp opens the actual foldering tree 2f-al or 2f-a2 via the session foldering pane, it first determines the associated bounding event type (E) and then finds the first occurrence (actual instance) of this event (E), e.g. “Period 1.” The start and stop times of this “Period 1” instance (E) of the “Period” event type (E) are then used to “bound” the session time line, i.e. give it a start and stop time relating to the overall session time line 30-stl.

Everything that user 11 subsequently views is assured to be time-wise “contained” within this bounding event (E) instance, again e.g. “Period 1,” until user 11 controllably moves away from this instance to the next or previous instance of the same bounding event type, again e.g. “Period,” using the “previous” and “next” buttons to the left and right of the session time line. In addition to using the “previous” and “next” buttons, the user may also select any event (E) from the actual foldering tree 2f-a, whose start time is outside of the current bounding event (E) and therefore session time line. Therefore, simply by selecting any actual event (E) in actual foldering tree 2f-a, the SMP 30-mp will review that specific event (E)'s start time and then automatically ensure that the session time line is adjusted in accordance with the bounding event type (E) to properly contain the session time at least overlapping the start of the selected event (E).

Also referring to FIG. 35b, as the SMP automatically adjusts its session time line to reflect user 11's transversal of actual foldering tree 2f-a, it likewise preferably adjusts the video display title bar directly over the session video display panel. For instance, the present inventors prefer that the video display title be concatenated from: (Tree 2f-a root 2f-r “name”)+(selected sub-folder(s) “name(s)”) . . . +selected event(s) “long name”). (See FIG. 35b for an example.) It is also noted with respect to FIG. 35b that each actual foldering tree 2f-a can be accessed as a valid data source via any rule (L) object—exactly similar to event lists, mark type lists, the tracked object database 2-otd and external devices (as shown in relation to FIG. 24d.) And finally, as will be discussed alternately with respect to upcoming FIGS. 37a and 37b, the SMP 30-mp preferably alters the naming of the video view control buttons depicted along its right edge to be oriented to the user as best as possible (e.g. the views are named “attack” or “defense” oppositely based upon whether user 11's group (e.g. team) is associated to be “home” or “away”—all as will be understood by those familiar with sports and especially ice hockey.)

Referring now to FIG. 35c, specifically regarding the event time line, when user 11 opens a sub-folder 2f-s (e.g. “Home-Goals”) in the session foldering pane that includes actual events (E), the SMP immediately highlights those actual events (E) (e.g. “Goal No. 2” and “Goal No. 3”) that occurred within the current bounding event type (E) instance (e.g. “Period 2.”) The SMP then also automatically adds a selection button to the event time line representing all actual events (E) in the selected sub-folder 2f-s lying within the bounding event instance currently governing the session time line. These buttons are correctly positioned and sized (widthwise) on the event time line to match their relative start and stop time locations on the session time line. When user 11 clicks on one of these actual event (E) buttons (e.g. “Goal No. 3”,) the familiar slider bar button on the session time line is repositioned to the start of the selected event. Also, by either right clicking, mouse-hovering for x time, (or some other acceptable method,) over any actual event (E) either on the event time line or in the foldering pane, the SMP will either display (or calculate on the fly,) the prose description for that event (E) if the appropriate descriptor rule (L) has been established. (See FIG. 35c for an example “prose” description of the example “Goal 3” event.) And finally, the event time line preferably includes its own “previous” and “next” buttons will allow the user to cycle forwards and backwards in time through all actual events (E) displayed on the present event time line as bounded by the bounding event type.

Especially regarding the event time line, but also in respect to all of the SMP 30-mp features herein taught, useful variations are expected and lie within the scope of the present invention. For instance, the present inventor's anticipate allowing the SMP user 11 to manage several concurrent event time lines, each stacked one upon another, thus providing for a simple way to viewing how different events “interacted” during the captured session 1. For example, in ice hockey one event time line might hold “power-play” events, while others might hold “zone-of-play,” and yet another “shots” and “goals.” Hence, the present invention of the SMP 30-sp should not be limited to a single event time line, and further that the event time lines must be displayed in the space indicated in FIG. 35a through 35d. In order to display several time lines concurrently, (similar to a channel guide for a cable broadcaster,) the present inventors anticipated allowing the space used by the session video panel to toggle and serve as an alternate area for showing additional event time lines. The present inventors also anticipate allowing the session video display panel, or copies of the panel, to be shown on second monitors attached to user 11's computing device—as will be well understood by those familiar with personal computing platforms.

Referring next to FIG. 35d, there is shown SMP 30-mp with additional teachings specific to sessions 1 that have a scoreboard or publically displayed controlling time, such as a sporting event. First, the present inventors prefer capturing a sub-frame, or “windowed” area of the video being made for scoreboard differentiation (see FIG. 9) (as will be understood by those familiar with machine vision techniques.) Hence, scoreboard reader external device 30-xd-12 provides not only scoreboard differentiation marks (M) such as “game clock started,” “stopped” and “reset,” but also a small video file of the actual game clock synchronized with all other captured video. (Therefore, the scoreboard reader 30-xd is acting both as recorder-detector 30-rd and a differentiator 30-df, see FIG. 5.) Note that this is one significant advantage of using a machine vision/camera technology to differentiate the scoreboard, as opposed to receiving electronic signals generated by the scoreboard itself for creating the taught differentiation marks (which is viable and herein alternately taught as acceptable.) Using the preferred and taught machine vision based scoreboard reader 30-xd provides the game clock video portrayed in FIG. 35d to be either overlaid graphically onto any of the currently displayed camera views, or alternately to be displayed on some other convenient location on SMP 30-mp. As will be obvious to those skilled in any game clocked sport such as ice hockey, having this actual game clock video, synchronized to all other displayed session 1 views, is highly beneficial.

Now referring to the bottom of FIG. 35d, there is represented the serial “Game Play” event type (E) with all of its actual event (E) instances laid in time sequence to pictorially match the bounding event type (E) instance (e.g. “Period 2.”) Keeping in mind that the present inventors suggest differentiating the game clock start and stop marks (M) into individual instances of the “Game Play” event (E), it will then be understood that the present inventors prefer including a “skip ‘un-official’ time” check box (or similar UI component) along with the SMP's other media playback controls. This feature controls whether the SMP automatically skips, or conversely plays through, “non-game” time—i.e. time when the game clock was “stopped” (all as will be well understood by those familiar with sports.) This is a useful function as it serves to compress the session time line to represent only the most important session activity 1d, which for a sports game is typically when the game clock is started and running. Note that the present inventors alternately anticipate, but do not prefer that the session time line itself could be compressed in space to “physically” remove this “non-game” time. Similar to this ability to skip “un-official” time, the SMP 30-mp also preferably includes a check box to “skip ‘non-event’ time.” If this is checked and the user selects play, then that SMP will “jump” from event (E) to event (E) as they occur in time sequence on the event time line, e.g. allowing an ice hockey coach to simply watch all “shot” events in a period, without either having to watch the game play in between, or having to select each “shot” event individually.

Referring now to FIG. 36a there are shown top-view layouts of six example session areas 1a drawn from sports including: American Football, Soccer, Baseball, Ice Hockey, Basketball and Tennis. These examples will be used to show the present invention's abstraction of the session area 1a into sub-areas, which then are assigned to external devices 30-xd, which are then represented as normalized data objects; thus forming the physical-logical interface for gathering session attendee 1c tracking data. While these teachings apply broadly to any session area 1a, not just sporting areas, and while many technologies are known for tracking athletic motion, the present example will focus on the use of camera based image analysis (machine vision) to track the ongoing movement in an ice hockey game.

This abstraction of the “where-in” session area 1a by the present invention is intentionally consistent with the overall approach to each dimension of session 1, i.e. “who,” “what” “where,” “when” and “how.” For example, the normalization of marks (M) (sensed observations) and the external device 30-xd [ExD] that creates them. It is exactly this normalization protocol that allows session processor 30-sp to be made unaware of the source device or technology behind any individual mark (M), and therefore also allows rules (L) to be pre-established based upon an agnostic mark (M), where that mark (M) might actually be created in multiple different ways depending upon the other aspects of the session 1, such as the session area 1a, session attendees 1c and session activities 1d. For example, different underlying technologies are already in use between different sports to track the game object, such as the puck (IR), soccer ball (RF) and baseball (machine vision.) What is important to the present invention is that a mark type (M) can be used to hold the individual “observations,” or data samples, of any game object's current detected location within any session area 1a—no matter how it is tracked, and what session area 1a it is tracked through.

As the careful reader will see, the present invention thus allows rules (L) to be pre-established using these “session agnostic” abstractions which may be aggregated by sub-contexts (Cx) and assignable to auxiliary concurrent session processors 30-sp, whose integration then feeds the main context [Cn] being contextualized by its own processor 30-sp. This in turn is similar to how a human observer understands a person walking, vs. jumping, vs. running, and or the ideas of blocking and encroaching, regardless of the type of sport (i.e. activity 1d or area 1a.) As will be understood, this universal abstraction and normalization of session 1 dimensions (again, “who,” “what” “where,” “when” and “how,”) ultimately will allow for the independent development across the marketplace of contextualization governance, whether it applies to detection & recording 30-1, differentiation 30-2, integration 30-3, synthesis 30-4, expression 30-5, aggregation of content 30-6 or review of content 30-7.

Referring next to FIG. 36b, each of the six example session areas 1a has been partially abstracted into specific sub-areas, or zones. What is most important to note is that each area from FIG. 36a is becoming both less specific as well as structured. Referring next to FIG. 36c, there are depicted two of the six session areas 1a, namely ice hockey and baseball, for further teaching. Shown at the top of the present figure and as first introduced in relation to FIGS. 20c and 20d, the session area object [SAr] is now put into direct relationship with the example sub-area divisions proposed for an ice hockey rink in FIG. 36b. One of the reasons the present inventors prefer machine vision as the core object tracking technology for monitoring session activities 1d such as sports, is that it employs cameras whose resulting video also has direct benefit to the participants 1c and fans, i.e. beyond extracted tracking data. Basically, people like to watch, and more easily learn from, video as opposed to text data and even most animation. And, unlike RF technologies that are less area specific, cameras are more easily aligned with a given sub-area(s), which has benefits as herein taught. Therefore, when assigning session area objects [SAr], the present inventors prefer keeping in mind the direct value to a viewing audience of video captured. This in turn favors the idea of having all zones horizontally and vertically aligned to the overall session area 1a, which works well for most sports except perhaps baseball. Without any additional specification, a preferred example of zones to session area [SAr] alignments is provided for baseball in the lower half of FIG. 36c.

Still referring to FIG. 36c, as taught earlier in the specification, and as true with all objects in the SPL, the session area [SAr] object is derived from the core object, shares its core attributes, and then in particularly adds the following preferred attributes:
1. Owner ID:
   a. Which is used to link with a “session area” owner object that acts as an aggregator object, similar to the session object [S], which aggregates all organized content 2b and index 2i as contextualized for a given session 1. While not depicted with the session object [S] or session area object [SAr] in FIG. 20c or 20d, this session area owner object is depicted in FIG. 6 as the individual ownership 1a-o class connected to the session area at the top of the figure;
2. Area Type:
   a. Similar to the implications of the “Family Size” attributed on the session attendee [SAt] and external device [ExD] objects, the area type is used to indicate if this is a:
      i. Individual:—meaning the entire session area 1a possibly used for a single session 1 by attendees 1c doing activities 1d (e.g. the ice sheet itself and preferably also the team bench are penalty box areas;)
      ii. Part:—meaning one “zone” or sub-area within an “individual” session area 1a (e.g. the “Defensive,” “Neutral” and “Attack” zones in ice hockey, which actually are logical rather than physical but those familiar with ice hockey will see that this is addressed by “Zone 1,” “Zone 2” and “Zone 3”), and
      iii. Group:—which is multiple “individual” session areas 1, such as four ice sheets within a single ice hockey facility, or seven playing fields, two stages and eighty classrooms within an educational facility.
   b. (Note that Family Size can accomplish this same type of three tier representation as a “one-to-many-to-many” family size configuration is the equivalent of a “group-to-indivdival(s)-to-part(s)” area type configuration. Either of these classification attributes will work and are sufficient and their use should be considered exemplary and not limiting to the scope of the present invention);
3. Starting Coverage E-W Line:
   a. For sessions where individual zones are best aligned horizontally and vertically to the entire area (such as the sports of American Football, Soccer, Ice Hockey, Basketball and Tennis,) then this absolute dimension, along with the following Ending Coverage E-W Line, serves to easily indicate a zone (i.e. part)'s relationship to the session area 1a (i.e. individual.) As will be obvious to those skilled in the sports of these examples, various choices can be made as to measurement systems. The present inventors prefer a universal approach where the longitudinal axis of the session area 1a is assumed to be north-south, and where the north half, or end, of the field is assumed to be closest to the home team bench. While this actual choice of alignment is immaterial to the teachings herein, what is beneficial and herein taught is that one local positioning strategy is developed for normalizing session activity 1d rules (L) across the various team sports, all as will be understood by a careful study of the present invention;
4. Ending Coverage E-W Line:
   a. (see above Starting Coverage E-W Line), and
5. Coverage Rectangle:
   a. For session areas 1a that are less conducive to the horizontal and vertical alignment of zones, such as the sport of baseball, the present inventors still prefer rectangular zones because of their easy match to camera fields-of-view. In the case of this type of session area 1a, then the coverage rectangle attribute will suffice to correlate both the zone and associated session areas [SAr] via the coordinates of their corner points, all as will be understood by those familiar with geometric shapes.

Referring next to FIG. 36d, the example session area of an individual ice sheet is shown in perspective, along with the buildup of the preferred arrangement of “physical” external devices [ExD] (cameras), connected to “logical” session areas [SAr] via the “session area to external device link” object [SAL]. First it is noted that while a preferred arrangement is depicted, the actual arrangement of physical external devices [ExD] (cameras) might easily change (for example if the ice sheet has a scoreboard hanging centrally over its neutral zone,) and as such this configuration, as well as the suggested zones and session areas [SAr] are to be considered exemplary and sufficient, but not necessary or limiting to the present invention.

What will be obvious to those skilled in the sport of ice hockey and familiar with the restrictions of state-of-the-art machine vision, cameras acting as external devices [ExD] may be permanently affixed in a non-moving position to capture the session activity 1d in either; less than one zone, (such as “goalie” Cam(era) 3 hanging directly over Zone 3,) or one entire zone, (such as “zone” Cam(era) 2, at angles viewing Zone 3,) or more than one entire zone, (such as “half-ice” Cam(era) 1, at angles viewing half of Zone 2 and all of Zone 3.) What is important to see is that although especially cameras as external devices [ExD] may easily have their detecting & recording fields-of-view aligned horizontally and vertically with a zone and there the entire session area 1a, it is not either always conducive or even desirable to have a one-to-one relationship with camera [ExD] and session area [SAr]. For these reasons, the present inventors prefer using a cross-link object referred to as the “session area to external device link” object, whose symbol is [SAL].

Still referring to FIG. 36d, the link object [SAL] allows a single physical external device [ExD] (such as “half-ice” Cam(era) 1,) to be connected to both the [SAr] logical objects representing Zone 3 and Zone 2—in which case each [SAL] object carries the appropriate Starting and Ending E-W Line attributes as will be obvious from a careful study of this and the prior FIG. 36c. The entire set of objects, i.e. [SAr]-[SAL]-[ExD] forms the logical-physical infrastructure representing the “where” (session area 1a) dimension of a session 1. And finally, as will be further appreciated by those skilled in the art of machine vision, additional attributes may be associated with each link [SAL] object for properly orienting the detecting & recording external device [ExD] (in this case a camera) to the session area [SAr]. As will be seen in the lower right hand corner of FIG. 36d, but not further discussed and also assumed to be well understood by those familiar with machine vision and camera calibration, these attributes preferably include those that can be used to represent the fixed camera's vertical distance from the session area 1a, as well as its recording orientation, all supporting the calculation of that cameras field-of-view.

Referring next to FIG. 36f, there is shown the same physical-to-logical SPL object structure first taught in FIG. 36d, specifically relating to an ice hockey sheet. Note that the object structure as a diagramed in FIG. 36d has simply been rotated counter-clockwise ninety degrees and then augmented at the bottom to show additional association with two moving side view cameras and two microphones. Directly to the right of this rotated SPL physical-to-logical representation is repeated the SPL object symbols for the session area/sub-area [SAr], external device [ExD] and their linkage [SAL]. For each symbol is then repeated its preferred additional attributes as already taught in earlier diagrams, (specifically FIG. 20d for [SAr] and [ExD] and FIGS. 36d and 36e for [SAL].) With respect to FIG. 36f, what is most important to see is that the entire SPL arrangement forms an addressable external data source, which can be referenced to find any operand for any stack element of any external rule (L), especially as taught in relation to FIG. 21c (focused on differentiation,) and FIG. 24d (focused on integration, synthesis and expression.) As will be well understood by those familiar with software systems, any data source actually available to any differentiator 30-df or session processor 30-sp (with expresser 30-e,) may be referenced in any rule (L), whether that rule is for differentiation, integration, synthesis or expression.

As supported by the teachings of FIGS. 36a through 36f and their concentration on the abstraction and normalization of the session area 1a, what is most important to see regarding the entire present invention is how it has abstracted the session 1 and its various dimensions of “who,” “what” “where,” “when” and “how” into pre-definable template/actual objects. The present inventors have combined these and other objects into a normalized session processing language (SPL), such that the governance of the contextualization processes from differentiation through expression, including the definition of potential session information and actual session knowledge, may be represented in a universally exchangeable method that remains external to the workings of the apparatus performing the content contextualization.

Referring next to FIG. 36g, at the top of the figure is shown a pictorial representation of an ice hockey sheet, broken into its three zones, onto which an exemplary path is traced of the “center-of-play,” as it starts at time “t0”=game clock starts, and ends at time “t9”=game clock stopped. First, it should be noted that prior FIG. 10b taught at least one simple way of tracking the center-of-play movement, specifically using zone detecting tripod external device 30-xd-270, which is capable of at least approximating the current-of-play as well as the direction of flow. Furthermore, other inventors have taught ways of tracking the game object, such as a hockey puck using IR, or a soccer ball using RF, and players, such as using RF emitters in their helmets or shin-pads—all of which is well known in the prior art and can also be used as approximations to the center-of-play. Finally and however, the present inventors in this and prior applications, continue to teach and prefer the use of machine vision techniques to at least track player and game object shapes, if not also identity—all of which is also sufficient for determining center-of-play movements and yet provides the additional benefits of recorded video as content 2b. What is important for the present FIG. 36g, is to understand that all of the session activity marks (M) exemplified as “t0” through “t9” are determinable using today's technologies and as such are herein taught to have further value.

Still referring to FIG. 36g, it will be obvious to the careful reader that the abstract “center-of-play” object may be estimated on a periodic basis in synchronization with the detecting technology, in this case cameras running at 30 frames per second or higher. The actual method for aggregating the detected motion is important but not the focus of the present invention. What is necessary is that at a given moment, the “next location” sensed and determined by the external devices [ExD] tracking session activities 1d across the entire session area 1a (e.g. see FIG. 36f,) becomes available as object tracking data 2-otd which may be differentiated via external rules (L)—all as prior taught. What is also important is that this next location is relatable to Zones 1 through 3, in this example, and therefore also to the entire session area 1a. Hence, because of the physical-to-logical mapping taught in FIGS. 36a though 36f, it is possible to use the either the starting or ending coverage E-W line for a given session area [SAr] as an operand in a differentiation rule (L) for the thresholding of the center-of-play's current zone—all as will be obvious to the careful reader. For example, as the current N-S location (preferred “x” coordinate) of the center-of-play abstract session attendee object [SAt] increases across the 70′ threshold, and yet is still below the 130′ threshold, the a mark (M) may be differentiated indicating that the center-of-play is now in zone-of-play 2, also referred to in hockey as the neutral zone. Furthermore as will be understood, the flow-of-play is currently going “northward,” (as preferred by the present inventors.)

The top of FIG. 36g thus shows the importance of mapping the external devices [ExD] to session areas [SAr] so as to provide the calibration information necessary to differentiate important session activity 1d marks (M) including but not limited to the current “flow-of-play” direction and/or “zone-of-play” area; where these marks (M) may then be appropriately integrated into the “flow-of-play” and “zone-of-play” events whose partial waveforms are depicted. The lower half of FIG. 36g shows teaches how these same differentiated “t0” through “t9” marks can also be used to integrate multiple “play-in-view” event types, for instance one per fixed overhead Cam(era) 1 through Cam(era) 7 (see FIG. 36d.) As will be obvious from a careful consideration, the “play-in-view” is different from the “zone-of-play,” most especially because there is not a one-to-one relationship between any given cameras field-of-view and the entire zone—all as prior taught. Hence, the ability to store the actual coverage areas of the individual cameras 1 through 7 on one or more link [SAL] objects, provides the underlying data source operands for sufficiently differentiating the center-of-play's boundary, or “edge” crossings between and across the various camera fields-of-view—and thus for more importantly integrating the “play-in-view” event waveforms as depicted.

Referring next to FIG. 36h, there are depicted exemplary “play-in-view” event (E) waveforms for the seven exemplary cameras of FIG. 36d. These waveforms are horizontally aligned in parallel along with the session time line 30-stl with other event (E) waveforms previously taught or eluded to, specifically including: “goal & celebration,” “highlights,” “face-off,” “flow-of-play,” “zone-of-play” covering for example a single segment of “game-play,” (i.e. for ice hockey from the mark (M) of game-clock “started” to the mark (M) of game-clock “stopped,” as might perhaps last one to two minutes.) Below this along the session time line 30-stl are shown the same “t0” through “t9” exemplary differentiated marks (M) of prior FIG. 36g. What is most important to see is how this graphically represented actual internal session knowledge in the form of marks (M) and events (E) starts to build into a significant understanding of not just the session activities 1d, but also of the relevance of the recording devices (such as cameras 1 through 7) and their recordings, to those activities 1d.

As will be shown with respect to upcoming FIGS. 37a and 37b, knowing this relevance, in other words which camera recordings have the “play-in-view” at any given moment, provide a sufficient and beneficial way for automatically controlling which cameras views are displayed in the session media player's (SMP) 30-mp video display panel at any given moment (see FIG. 35a through 35d.) While other ways for automatically changing the currently displayed camera view in the SMP's video display panel are possible, (such as by providing the SMP with at least the center-of-play [SAt] object's current (X) location with respect to the session area 1a as relatable to each camera's fields-of-view,) the method implied in FIG. 36h is simple to calculate, thus reducing the processing burden on the SMP. Therefore, the current teachings of this “play-in-view” per camera technique for automatically switching and blending camera views of a session 1 should be considered as exemplary and sufficient, but not as limiting to the scope of present invention. Furthermore, the careful reader will see the correlation between these “play-in-view” events (E) and their parallel session activity events (E) shown in the present FIG. 36h, and the teachings and content expression tasks of FIGS. 32a, 32b and 32c, which especially introduced service objects including recording compressor 30-sc, clip compressor 30-ccm and broadcast mixer 30-mx. Hence the reader will see that the present inventors have taught a normalized, universal way of abstracting any session 1 and its area 1a, but most especially all session l's and areas 1a that are for a given session activity 1d (e.g. ice hockey,) so that typical “production booth” decisions for switching between camera views based at least upon the location of current session activities 1d, heretofore a manual limited process, can effectively and advantageously be fully automated via their encapsulation in pre-established external rules (L) for exchange within the marketplace using the herein taught SPL.

Referring next to FIG. 37a, there is shown a block diagram of an auto-foldering tree 2f-t template which uses a single “camera views” sub-folder 2f-s-cv and its descendants to capture and hold all “play-in-view” type events (E) (that are really session activity 1d “what” events.) Similar to predefining the Session Time Line's “boundary event type” (e.g. to be the “period event”,) the SMP 30-mp may alternately include an attribute to hold the name of the “camera views” sub-folder 2f-s-cv. This folder and its descendants are then used to define the SMP's “Camera View Control Bar,” on the right side of the media player, as first taught in FIGS. 35a through 35d.

Note that the present inventor prefers using a link (X) object, such as 2f-s-be-x and 2f-s-ce-x, to make an association between the root folder object 2f-r and the “boundary event” sub-folder 2f-s-be as well as “camera views” sub-folder 2f-s-cv, respectively. The name of the link object (X) would be ideally set to “boundary” or “cameras” respectively, such that any session media player (SMP) 30-mp could then quickly search any links (X) associated with the root 2f-r on the chosen actual auto-foldering tree 2f-a shown in the session foldering pane, in order to find these two SMP controlling objects (that may or may not exist within the scope of the invention.) As will be understood by those familiar with software systems and in particular OOP techniques, this preferred method and others are possible, and therefore the present invention should not be limited to the way it which the association is made, but rather the novel practice of optionally limiting the session time line 30-stl during interactive use by association with a “boundary event” type (E) and by optionally augmenting the automatic choice of camera views during interactive use (as now being discussed,) by association with a set of “play-in-view” type events (E) organized into camera view sub-folders, such as 2f-s-cv's descendants.

Still referring to FIG. 37a, when the SMP 30-mp is launched by a specific user, that user's “team” ownership attribute (e.g. “Team x”) is identified during the login process, for instance because it is an attribute on the ownership object associated with the root(s) 2f-r of the actual auto-foldering tree(s) 2f-a found in the local database, and therefore presumed by the SMP 30-mp to be required for content access (all as prior discussed.) In this example, once the “Team x” name is identified, it is then used to select specific actual session foldering tree(s) 2f-a for display in the session foldering pane, which then act as content indexes 2i. In recap, the actual tree(s) 2f-a themselves were created using the auto-foldering rules (L) associated with the auto-folder template 2f-t for that “owner”=“Team x.” These rules (L) allow sub-folder 2f-s names to by dynamically generated (i.e. “set”) at Session Time. For example, if the user's “Team x” was the “Home” team (on the session manifest 2-m,) then the rule (L) for naming the “camera view” group-folders will come up with “Home Attack Views” and “Home Defend Views.” Conversely, if the user's “Team x” was the “Away” team, then the sub-folders 2f-s will be appropriately named “Away Attack Views” and “Away Defend Views.” (The same logic applies to the individual camera view sub-folders (such as the descendants of 2f-s-cv.)

Referring next to FIG. 37b, if these appropriate controlling sub-folders, i.e. event boundary 2f-s-eb and camera views 2f-s-cv are established, then during SMP 30-mp playback, these folders are dynamically checked as the familiar “slidar bar” on the session time line plays forward or backward, or as a specific event (E) is selected on the event time line. The associated SMP View buttons are preferably brightened or dimmed based upon if any given camera view is determined to have the session activity 1d “play-in-view” or “not,” at any given session time line moment. As the careful reader will understand, rather than just highlighting which camera views contain session activity 1d at any given session time line moment, SMP 30-mp could also automatically switch between these various camera views—essentially “pressing the camera button” for the user. While this functionality is considered within the scope of the present invention, the present inventors may in the future expand upon additional aspects of the rule based control of this novel “automatic-camera-view” selection function of the present teachings.

Returning to FIG. 37a, there is also shown the establishment of an additional “session area” link 2f-s-sa-x to, for example, the “zones” sub-folder 2f-s-sa. As will be understood, the “zone” sub-folder 2f-s-sa is really a session area 1a (“where”) classification that is placed with the “boundary” events sub-folder 2f-s-be, which is really a session time 1b (“when”) classification (which controls the SMP's session time line.) By doing this, as each boundary event is toggled, resetting the time line, the SMP may automatically search the session area event sub-folders 2f-s-sa in order to “paint” the session time line. (For example, with ice hockey the color green might be used for the Home team's attack zone events (E), whereas red might be used for the defend zone events (E), and yellow (of nothing) for the neutral zone events (E).)

By a careful reading of the present invention, especially as it relates to the functionality of the session media player 30-mp, and as will be understood by those familiar with sports, there are three types of generic events that occur across virtually all team sports and therefore have wide and useful applicability if automatically understood by the SMP for dynamic alteration of the SMP's UI elements; including the session time line, event time line, camera view control bar, video display bar, session foldering pane, etc. Specifically, these three events are:
1. Session Activity “play-in-view” events (E):
   a. sorted by “recording device” sub-folders:
      i. where each “recording device” preferably includes a specific video recording device such as “Cam 1” 1rv, (but could be any area specific recording device, such as a directional microphone 1ra);
      ii. where each sub-folder can be dynamically populated using filter rules (L) with “play-in-view” of e.g. “Cam 1” events (E) based upon at least the team, their “attack” vs. “defend” direction of play (e.g. “north” or “south”,) within a current division of the session time (e.g. “period 1” vs. “period 2”,) also based upon an understanding of the session area parts (e.g. “zones”) and their relationship to “Cam 1” via the physical-to-logical interface;
         1. where each sub-folder may also be dynamically named (e.g. “Half-Ice”) via folder naming rules (L), the name of which is assigned its own button on the SMP's camera view control bar;
   b. sorted by “session area” sub-folders:
      i. where these sub-folders represent session area parts (e.g. “zone 1” vs. “zone 2”,) and are dynamically named (e.g. “Home Attack”,) via folder naming rules (L), based upon the team and their direction of “attack” vs. “defend” within a current division of session time (e.g. “period 1” vs. “period 2”);
         1. where each sub-folder name (e.g. “Home Attack”) is assigned its own button group on the SMP's camera view control bar, within which named camera view buttons are placed;
      ii. sorted by “session time” segment sub-folders (e.g. “Period 1” vs. “Period 2”)
2. Session Time “boundary” events (E);
   a. for example a “period,” “quarter” or “half” which can be used to name sub-folders, each holding and sorting appropriate “zone of play,” “play in view” events (E), etc.;
   b. and for which the SMP will automatically time-wise limit the video and other recordings reviewable at one time under the control of its session time line UI object;
3. Session Area “zone” events (E);
   a. where the session areas (e.g. “zone 1” vs. “zone 2”) are mapped via the physical-to-logical interface and relatable to a “north” vs. “south” direction, which is further relatable to a “home” vs. “away” team “attack” vs. “defend” direction, which itself may be dependent upon the session time segment (e.g. “Period 1” vs. “Period 2”), and
   b. where the SMP can colorize its session time line to any individual color representative of these session areas, where the session area of play events (E) (e.g. “zone of play”) are used to control this colorization process.

Referring next to FIG. 38a, there is shown a block diagram which teaches how the combination of all mark-affect-events (A) objects associated with a single (M) (e.g. primary mark 3-pm) form a single “mark program” 3-MP. As will be understood in reference to prior FIG. 23e, each Affect (A) object carries both a “level no.” and “sequence no.” attributes, the combination of which may be used to dictate the order in which the session processor 30-sp attempts to effect events (E) for each incoming mark (M) received for integration. (For example, with primary mark (M) representing the “game clock”/started observation is received by session processor 30-sp, it may be desirable to: first start the “game play” event, second start the “face-off” event, third start any penalty events, etc.) Note that the preferred use of “level no.” and “sequence no.” will be taught further in respect to upcoming FIG. 38b.

Still referring to FIG. 38a, as has been prior taught, when executing a given affect (A) on a given event (E), dictated for instance by primary mark (M) 3-pm, the session processor 30-sp may have cause to create a new “spawn” mark (M) 3-pm-s (all as prior taught especially in relation to FIGS. 25a through 25j.) Typically, spawn marks 3-pm-s are used to adjust the start or stop time of the effect event (E), making this time different from the session time carried on the primary mark 3-pm. This essentially allows the affect (A) to re-position the event (E)'s start or stop time either “forward” or “backward” in session time from the current mark 3-pm (again, all as prior taught.) As the careful reader will note, all spawn marks 3-pm are then also integrated by session processor 30-sp, either immediately (thus “interrupting” the current mark program 3-PM,) or held until after full completion of the current mark program 3-PM, as indicated preferably by an attribute on the affect (A) object. To the session processor 30-sp, by design all marks (M), whether primary, secondary or tertiary, whether spawned or referenced, are identical and therefore all affects (A) associated to a spawn mark 3-pm-s form a new mark program 30-PM. As will be understood by those skilled in software systems, the present flexible design allows for both the nesting and recursion of mark programs 3-PM, forming a powerful tool for integrating “observation” marks (M) into events (E).

Referring next to FIG. 38b, there is now shown a representation of the cyclical actions of session processor 30-sp, as it receives new primary marks (M), such as 3-pm-“32” via the mark message pipe 30-mmp, and then proceeds under the direction of each mark's “program,” to conduct the various levels of processing herein taught covering the aspects of integration 30-3, synthesis 30-4, expression 30-5 as well as being a recorder controller 30-rc. Specifically, starting with the stream of primary marks (M) contained within mark pipe 30-mmp and as output by any one or more external devices 30-xd or other session processors 30-sp, the current session processor 30-sp performs the following method steps using its apparatus:
1. Marker Receiving Queue:
   Under the direction of the session registry 2-g (which holds the “how” list of external sources of marks (M) as prior taught,) the session processor 30-sp coordinates with the mark message pipe 30-sp to subscribe to various external devices 30-xd and session processors 30-sp. Once subscribed, all of that devices or processors generated marks (M) will be presented to the current session processor's “Marker Receiving Queue,” where they may be optionally filtered, especially on session time, and where no mark is processed for a session 1 before the “start” mark (M), and likewise no mark is processed after the “stop” mark (M);
2. “Current” Session Processor:
   At the start of a session 1, and associated with the start mark (M) (e.g. as published by session console 14 for a sporting event such as ice hockey,) there will be either a session manifest 2-m object, or preferably the relevant information contained in manifest 2-m as provided in the form of “who,” “what,” “where,” “when,” and “how” primary marks (M) (see bottom of FIG. 11b.) In particular, the first “what” mark (M) will inform session processor 30-sp of the session context [Cn], i.e. “what” type of session activity 1d is to be recorded and contextualized, e.g. “sports—ice hockey—game.” Using session context aggregator object [Cn], session processor 30-sp has access to the Domain Contextualization Graph (DCG) shown in FIG. 23a, from which it will amongst other things derive all integration (M)-(A)-(E), synthesis (E)-(x)-(Ec), etc. models taught herein, which ultimately include rules (L). These rules (L) are either connected directly to some primary mark (M)'s affect (A) on a primary event (E), or connected to either an associated synthesis of a combined event (Ec), summary mark (Ms) or calculation mark (Mc), or associated expression of folders (Fn) as well as event and folder naming. In their entirety, rules (L) form “mark programs” for execution by session processor 30-sp;
      a. Related Datum “plugging” (at Mark Receive time):
         The session processor 30-sp reviews each new mark (whether externally or internally generated) which includes inspecting each associated related datum (RD). Especially as taught in relation to FIG. 23b, each related datum (RD) associates with a context datum (CD) and its related objects. Upon inspection, session processor 30-sp may determine that a particular related datum (RD) is to be “set” at this “mark receive time,” in which case processor 30-sp will follow the “copy or calculate” rule (L) associated with the context datum (CD) to in effect “plug” the related datum (RD);
      b. Add Mark to List (at Mark Receive time):
         Especially as taught in relation to FIG. 24b, each new instance of a received mark (M), whether externally or internally generated, is added to its appropriate mark type (M) list;
      c. Process Current Mark Program:
         As herein taught, session processor 30-sp (or its agent services such as expresser 30-sp or external recorder controller 30-rc,) will follow the governance/“rule” objects (L) as found in the current context's [Cn]Domain Contextualization Graph to conduct the stages of integration 30-3, synthesis 30-4, expression 30-5 and possibly aspects of moveable recording device adjustment (if these aspects are not separately adjusted by recorder controller 30-rc,) all of which has been taught herein and will be further summarized in upcoming paragraphs;
      d. Related Datum “plugging” (at Event Close time):
         Similar to plugging at the time of mark receipt, session processor 30-sp my find that the associated context datum (CD) of a related datum (RD) to be “copied or calculated” has a set time of “event close,” or even “time of attachment,” all of which happens interwoven with the execution of the related mark programs;
3. Marker Export Filter:
   The session processor 30-sp following its directed session context [Cn] may be informed, such as via the mark message pipe 30-mmp subscription process, that some other external device(s) 30-xd, session processor(s) 30-sp or clearing house(s) 30-ch are requesting the export of one or more of the processed mark types (M) (or events (E)). If this is the case, current session processor 30-sp the feeds the requested content in the form of normalized marks (M) and events (E), either separately or in lists, or aggregated by folders (F), or in any other form obvious to those skilled in the art of software systems, to the requesting subscriber;

Where, step (2.c.) “Integrate Current Marker following Mark Program,” includes the following stages:
1. Integration 30-3:
   a. Marks-Affect-Event processing;
      (especially as discussed in relation to FIGS. 23e through 25j)
2. Synthesis 30-4:
   a. Event Combining;
      (especially as discussed in relation to FIGS. 27 through 28d)
   b. Summary Mark Creation;
      (especially as discussed in relation to FIGS. 29 through 30b)
   c. Calculation Mark Creation;
      (especially as discussed in relation to FIG. 31)
3. Recording Controlling:
   a. Recorder adjustment calculations
      (especially as discussed in relation to FIG. 5)
4. Expression 30-5:
   a. Video Blending & Mixing
      (especially as discussed in relation to FIGS. 32a through 32c)
   b. Event Auto-Naming (short and long names)
      (especially as discussed in relation to FIG. 33, with the note that the present inventor prefers rule (L) organized to complete all short and long naming before creating “prose,” which ultimately become descriptive stories about one or more events (E), or even an summary of the entire session l's activity 1d)
   c. Session Commentary (prose)
      (especially as discussed in relation to FIG. 33, see note about in (4.b))
   d. Auto-Foldering
      (especially as discussed in relation to FIGS. 34a through 34b)
   e. Auto-Notification
      While not specifically addressed within the present specification, those skilled in the art of software systems and especially those familiar with internet based services, single entity and social web-sites, as well as communications with portable devices such as cell phones, will fully understand that once the present invention has adequately organized content 2b with index 2i, including all internal session knowledge such as events (E) with descriptions, especially long names and prose, that there are then several well known means and methods for the “auto-notification,” or disbursement to subscribing customers, of this contextualized content—all of which is considered within the scope and teachings of the present invention.

As will also be seen by a careful review of FIG. 38b, and understood based upon prior discussion, the present invention establishes an important feedback loop where session processor 30-sp, under the direction of any given affect (A) rule (L), may spawn new marks (M)-s which can either:
1. Have no further effect than to attach to the designated event (E);
2. Be used to initiate its own “mark program,” to be executed by the session processor 30-sp directly following the completion of the current marks (M) program, and in order of creation if the current mark program has created more than one spawn mark (M)-s, and
3. Be used to initiate its own “mark program,” to be executed by the session processor 30-sp immediately interrupting the current mark program.

Furthermore, this feedback loop includes the automatic creation of secondary (summary) marks (Ms) and tertiary (calculations) marks (Mc), which may also be processed according to the same three options listed above for spawn marks (M)-s and where the choice of whether the feedback is “none,” “immediate” or “directly following,” is set on the individual mark type. As those skilled in the art of software systems will understand, this internal feedback loop in combination with the mark programs, especially where the individual mark programs are “concatenated on the fly” across several object models that may be developed at different times by different individuals, forms a powerful and flexible system for nesting and recurring governance logic. As will also be understood, because multiple session processors 30-sp may be employed during any one or more session(s) 1 to work in conjunction using different contexts, such as main context [Cn] and supporting context(s) (Cx), it is possible to provide principals of context encapsulation, where the execution of one collective set of one or more mark programs is effectively isolated from any other by placing them in separate aggregating contexts (Cx).

These session processors 30-sp do not need to run concurrently. The present inventors envision one or more processors 30-sp running at “real-time” to contextualize a session 1, and then “broadcasting” (exporting) the resulting content either directly to other remote “subscribing” session processors (themselves receiving content from multiple session processors in real or post time,) or to a clearing house 30-ch for other current or future subscribers. For example with respect to ice hockey, the present inventors anticipate using one session processor at a individual ice rink conducting a game to create content for local market consumption while at the same time exporting content at least including session (game) start, stop marks, goal scored marks, penalty marks, etc. over the internet. This exported content may then be received by another single session processor running on a remote server hosting a league web-site, where the league's session processor is contextualizing a session 1 that is the entire hockey season, and its external devices are the many session processors running at the individual ice hockey rinks were the games are being played. Using this present teachings, it is even possible and anticipated for example, that a single high school will run one session processor for each school academic, sporting, musical, theatrical, social event, etc., whose key content (ideally including results (M), (Ms) and (Mc) with some highlight events (E) and associated blended multi-media) is then exported to another “central” session processor, running for the entire school year, and receiving the individual session(s) 1 content for further integration, synthesis and expression. (Note that in this scenario, the individual session 1 processors are acting as differentiators for the “central” session processor—a feature that can continue on for any number of additional levels, perhaps moving from school, to school district, to region, to state to national levels.)

Referring next to FIG. 38c, there is shown a block diagram built off of FIG. 38b that teaches how the session processor 30-sp handles processing when two or external primary marks (M) are received simultaneously. Even further, as will be understood by those familiar with various sensing technologies especially including machine vision, the determination of an exact session time of a differentiated behavior is often problematic and limited, depending upon the desired time accuracy. For instance, the typical image capture and analysis rates for a machine vision based tracking system such as preferred by the present inventors is 30 frames per second. This is especially true if working in high definition color with multiple camera views—all of which will limit bandwidth, especially if system cost is a real consideration. In these cases, it is obvious that the object tracking database 2-otd taught herein will have some “per sample” time error of at least one-half of the sample rate—all as will be well understood by those familiar with engineering systems and concepts. However the largest problem may be the nature of objectively measuring human activities, such as sports, to a very exact time frame—for instance a computer system will tend to assign session times in the milli-seconds, whereas the exact time a player, for example, leaves their team bench for a shift may be accurate to within plus or minus one tenth of a second.

In addition to the underlying time errors due to the conversion of the “analog” session 1 to “digital” object tracking data 2-otd or outright primary marks 3-pm, and further in addition to the inherent time errors especially with the measurement of human behavior, there is also the possibility of additional time errors due to network signal delays if the external device 30-xd capturing the session data sample (e.g. image frame) is not also assigning the session time of the sample as coordinated system-wide via techniques such as NTP (network time protocol,) all as prior discussed. As will be obvious to a careful reader, these possible sources of inaccuracy regarding the actual session time assigned to a given external mark (M), create the possibility that marks (M) could actually be processed out of order by session processor 30-sp. Hence, the present inventors prefer associating with each mark type (M)—external device type [ExD] combination, some plus-minus potential session time error. This error is ideally carried as an attribute on the link (X) object between the mark type (M) and the external device [ExD], although other arrangements are possible as will be well understood by those skilled in software systems. Still referring to FIG. 38c, this plus-minus session time error tends to broaden any given marks possible “spot” on session time line (again, always depending upon the accuracy of the underlying technologies,) and is therefore herein referred to as the marks (M) “spot size.” When the session processor 30-sp receives a given mark (M), e.g. “M29,” it therefore preferably delays the processing of the mark (M) by at least the sum of its spot size plus the largest spot size expected for any other possible mark (M) associated with the current context [Cn]—as will be understood by a careful consideration. Especially during this preferred (but not mandatory) delay, the marker queue may receive one or more additional marks (M), e.g. “M31” and “M32” that when considering their spot sizes, overlap the current mark (M), e.g. “M29.” Furthermore, it is possible that the session processor 30-sp via its marker queue received some mark (M), e.g. “M30,” at the exact same session time as the current mark (M) “M29.” In any case, FIG. 38c shows for example marks (M) as “M29,” “M30,” “M31” and “M32” which are all considered to be “simultaneous.”

In the situation of simultaneous marks (M), the present inventors preferred and teach that session processor 30-sp will execute their mark programs in parallel on a level by level basis. For instance, all mark-affect-event rules (L) for all simultaneous marks (M) are processed first before the next level of event combining rules (L). It is further preferred that some system is employed to assign which of the simultaneous marks (M) is processed first within a given level that accounts for the mark's type (M), even in relation to other possible mark types (M) that may be simultaneous. For instance, the DCG graph could be augmented to include “precedence” link (X) objects between any two marks (M), establishing which mark (M) is to be executed first in a simultaneous situation—or some variation that accounts for multiple marks (M) and therefore helps to obviate potential “deadly embraces” familiar to those skilled in software systems.

Another anticipated approach is to assign priority levels to each mark type (M) via an additional object attribute and for marks with matching priorities, the first mark actually received into the queue might then be processed first—again, one level at a time across all simultaneous marks (M). It should also be noted that there is no restriction to the number of levels that the session processor 30-sp can recognize and/or that can be included in an individual mark program. Hence, there is also no inherent reason why any given processing stage (e.g. “marks-effects-event” or “event combining” rules) must only have one level (as depicted in FIGS. 38b and 38c.) It is both anticipated and preferred by the present inventors that the very first stage of integration be broken into several levels that might preferably perform all “stop” affects (A) before a next level that performs all “start” affects (A). What is most important to note is that the present invention uniquely provides for sophisticated governance of session contextualization that includes the ability to processes multiple marks (M) in parallel, interweaving their contextualization stages via leveling as herein taught.

### CONCLUSION AND RAMIFICATIONS

Thus the reader will see that the present invention teaches its objects and advantages as summarized in the opening of the specification.

From the foregoing detailed description of the present invention, it will be apparent that the invention has a number of advantages, some of which have been described herein and others of which are inherent in the invention. Also, it will be apparent that modifications can be made to the present invention without departing from the teachings of the invention, including the sub-division of useful parts for lesser apparatus and methods, still wholly encompassing one or more ideas herein taught.

It is understood that the examples and embodiments that are described herein are for illustrative purposes only and that various modifications and changes in light thereof will be suggested to persons skilled in the art and are to be included with the spirit and purview of this application and scope of the appended claims and their full scope of equivalents. For example, the order of processing of the stages and steps of contextualization is preferred and sufficient but can be adjusted and rearranged with acceptable tradeoffs. Stages and steps that are depicted in series may instead occur in parallel. Stages or steps may be skipped, other stages and steps may be added, etc. Also for example, the software object/class descriptions, encapsulations, attributes and methods suggested and preferred by the present inventors to best embody the taught apparatus and methods are a hybrid of well understood object oriented concepts. Other software modalities are sufficiently equivalent to alternately embody the taught apparatus and methods without departing from the teachings herein. Furthermore, objects could be combined or broken apart, associations between objects could be varied, and attributes could be shifted between objects or converted into new objects. Existing objects could be converted into attributes or methods within other existing or new objects, etc. Accordingly, the scope of the invention is only to be limited as necessitated by the accompanying claims.

What we claim is:

1. A method for characterizing session activity, where the session includes one or more attendees moving along at least one dimension in a session area over a session time, comprising the steps of:
tracking a set of one or more features about the session attendees, session area or session activity to be characterized throughout the session time forming an object tracking database;
for each desired characterization, designating a corresponding session mark type and pre-establishing a corresponding formula that references one or more of the tracked features in the object tracking database and that is executable each time the object tracking database is updated for determining if the formula result crosses an activity threshold, and
issuing uniquely identifiable session marks for the mark type each time the activity threshold is crossed for characterizing that session activity represented by the formula, where the session mark includes the current session time and zero or more of the features as related data that were either used in the formula or available at that time from the object tracking database.

2. The method of claim 1 for further creating events with duration to use and an index into the session activity information, comprising the additional steps of:
for each desired index, designating a corresponding session event type and selecting which session mark types may start the event type and which session mark types may stop the event type;
for each issued session mark, if its mark type starts an event type then creating a new uniquely identifiable session event, where the session event includes a start reference to the issued session mark, and
for each issued session mark, if its mark type stops an event type, and uniquely identifiable session event exists without a stop reference, then making the session mark the stop reference for that session event.

3. The method of claim 2 for conditionally allowing session marks to start or stop events, comprising the additional steps of:
for each session mark type selected to start or stop a designated event type, associating an affect formula that references any of the combined information represented by all unique session marks and events already existing for the session, and
before starting or stopping a designated event based upon an issued mark, first evaluates the affect formula that if true the action is carried out but if false is not.

4. The method of claim 3 for providing indexed session recordings based upon the indexed session activity, comprising the additional step of:
using one or more cameras or microphones to record the session activities synchronous over session time with the object tracking database.

5. The method of claim 4 for allowing manual observations made about session activity to effect index entries, comprising the additional steps of:
for each desired observation, designating a corresponding session mark type, providing the manual observer with an input device for indicating observations including at least the session time along with other relevant information, and issuing a uniquely identifiable session marks for the corresponding mark type each time the observer engages the input device, where the session mark includes the current session time and zero or more other relevant observation data as related data.

6. The method of claim 5 for conditionally adjusting the start and stop times of events, comprising the steps of:
for each affect formula, further associating another mark type designated as the spawn mark along with a plus or minus time increment;
when evaluating affect formulas to allow or disallow a session mark to start or stop a session event, if the formula evaluates to true and has an associated spawn mark type, then issue a new uniquely identifiable spawn session mark where the mark includes the current session time plus or minus the time increment and is associated with the effected session event as the start or stop reference, and
also associating the unique session mark that triggered the evaluation of the affect formula to the effected session event as an attached reference.

7. The method of claim 6 for conditionally replacing the start or stop mark of an event with some other existing uniquely identifiable session mark, comprising the steps of:
fore each affect formula, further associating another mark type designated as the replacement mark along with an associated replacement selection formula for uniquely selecting any session mark that may exist by itself or in association with a session event,
when evaluating affect formulas to allow or disallow a session mark to start or stop a session event, if the formula evaluates to true and has an associated replacement mark type, then further evaluate the replacement selection formula to select some other existing session mark which is then associated with the effected session event as the start or stop reference, and
also associating the unique session mark that triggered the evaluation of the affect formula to the effected session event as an attached reference.

8. The method of claim 7 for further combining events to create new events and therefore new indexes, comprising the additional steps of:
establishing a new combined event type and associating with it an event combing rule that references two or more other event types, and specifies if the combining convolution is ANDing or ORing;
each time a new unique session event is started that matches an event type referenced for combining, then evaluate the associated combining rule to see if at least one session event of each referenced combing event type is started but not stopped, if so than create a new unique session event for the associated combined event type;
if the combining convolution is ANDing, than set the start reference on the combined session event to the start reference on the session event that initiated the evaluation of the combining rule, otherwise set the start reference to the earliest found on all other referenced session events started but not stopped, and then additionally associate all combining session events not selected as the start reference to be attached references to the new combined session event;
each time a new unique session event is stopped that matches an event type referenced for combining and the combining convolution is ANDing, then associate the stop reference on the unique session event just stopped, to be the stop reference on all combined session events that are started but not stopped and whose type matches the associated combined event type, and
each time a new unique session event is stopped that matches an event type referenced for combining and the combining convolution is ORing, then for all combined session events whose type matches the associated combined event type and that are started but not stopped, search all attached combining session events to verify that they are all stopped, if so, then associate the stop reference on the unique session event that just stopped, to be the stop reference on each verified combined session events.

9. The method of claim 8 for summarizing the counts of session marks or events contained within another session event, comprising the additional steps of:
establishing a new summary mark type and associating with it a container event type and a summarized object of either a mark type or another event type;
each time a new unique session event is stopped that matches a container event type for a summary mark, then if the summarized object is a mark type, search for all unique session marks matching that type which have a current session time that equals or lies between the newly stopped session event's start and stop times, and then create a new unique session mark for the summary type that includes the current session time, the count of all summarized marks found as well as an association with the newly stopped session event, and
each time a new unique session event is stopped that matches a container event type for a summary mark, then if the summarized object is an event type, search for all unique session events matching that type whose start-stop time duration at least partially overlaps that of the newly stopped session event, and then create a new unique session mark for the summary type that includes the current session time, the count of all summarized events found, the sum total of all of their overlap durations, as well as an association with the newly stopped session event.

10. The method of claim 9 for creating calculation session marks, further comprising the steps of:
establishing one or more context datum types and associating with each one a copy or calculate rule;
establishing a new calculation mark type and associating with it one or more context datum types, a trigger object to be either an event type or another mark type, and if the trigger is an event type that also specifying a calculation set-time;
each time a unique session event is just started or just stopped whose type matches a calculation mark's trigger object, if the set-time associated with the trigger matches the current state of the just started or just stopped session event, then create a new unique session mark for the calculation mark type that includes the current session time and an associated related datum for each context datum type associated with the calculation mark type, where the copy or calculate rule is executed to set the value of the related datum from any of the combined information represented by all unique session marks and events already existing for the session, and
for each unique session mark whose type matches a calculation mark's trigger object, then create a new unique session mark for the calculation mark type that includes the current session time and an associated related datum for each context datum type associated with the calculation mark type, where the copy or calculate rule is executed to set the value of the related datum from any of the combined information represented by all unique session marks and events already existing for the session.

11. The method of claim 10 for automatically describing session events, further comprising the steps of:
for each event type to be described, establishing a descriptor rule that has a set-time and one or more associated and sequenced stack elements, where each stack element comprises a prefix, operand and suffix, where the operand can be associated with either a constant, a data source pointing to any related datum associated with any session mark or session event, a copy and calculate rule referencing any related datum associated with any session mark or session event, or another descriptor rule, and an optionally exclusion rule evaluated to either true or false, and
for each unique session event that is just started or just stopped, if there is a descriptor rule associated with its event type and the descriptor's set-time matches the current state of the just started or just stopped session event, then for each stack element in sequence, that element's operand is set by either its associated constant, data source, copy and calculate rule or other descriptor rule after which is it concatenated with the prefix and suffix to form the stack's token, the token of which is then concatenated to all prior stack element tokens if the stack element's exclusion rule exists and evaluates to false.
